(19) United States
(12) Patent Application Publication
(10) Pub. No.: US 2019/0287194 A1
(43) Pub. Date: Sep. 19, 2019

(54) SYSTEM AND METHOD FOR A DIGITAL PLATFORM FOR OPTIMIZING INSPECTION RESOURCES

(71) Applicant: BRITISH COLUMBIA SAFETY AUTHORITY, Vancouver (CA)

(72) Inventors: Soyean KIM, Burnaby (CA); Bingying LI, Richmond (CA); Milad Amir TOUTOUNCHIAN, Vancouver (CA); Ziqian ZHU, Vancouver (CA); Thomas Sing Lam CHEUNG, Vancouver (CA); Peter John GORNIAK, Vancouver (CA)

(21) Appl. No.: 16/355,097

(22) Filed: Mar. 15, 2019

Related U.S. Application Data
(60) Provisional application No. 62/644,276, filed on Mar. 16, 2018.

(51) Int. Cl. G06Q 50/16; G06N 5/00; G06N 20/20

(52) U.S. Cl. CPC G06Q 50/163; G06N 20/20; G06N 5/003

(57) ABSTRACT

A computer-implemented system and method for allocating inspector resources to sites are provided. The method comprising: retrieving or receiving, by a computer processor, electronic signals representing one or more property values for a property; receiving, by the processor, an electronic request to predict a hazard level; processing, by the processor, the one or more property values to assess the likely hazard level; and transmitting, by the processor, the predicted hazard level, in real-time or near real-time, to a display device.

### CROSS-REFERENCE

This application claims the benefit of and priority to U.S. provisional patent application No. 62/644,276 filed on Mar. 16, 2018, the entire content of which is herein incorporated by reference.

### FIELD

This relates to providing a digital platform, and in particular, to system and method for a digital platform for allocating and optimizing personnel resources for conducting property inspections.

### BACKGROUND

Some property owners or managers would conduct every single inspection scheduled for a property, or at least a majority of the inspections. As a large number of these safety inspections are time sensitive, how to conduct the inspections in an efficient manner is problem in the property management industry. In some cases, there may be safety hazard in a property that are not visible to a human eye. In addition, targeting high risk work sites is not easy, and safety workers often miss or neglect work sites that may pose serious safety concerns.

In addition, safety regulators have the authority to inspect certain types of equipment to ensure it meets safety requirements. It is often not cost effective to inspect every piece of regulated equipment every year.

Improvements are therefore desired.

### SUMMARY

In accordance with one aspect, there is provided a computer system for allocating inspection resources to sites where an inspection has been requested, the computer system may include: a processor; and a non-transitory computer-readable memory device storing machine-readable instructions; wherein the processor is configured to, when executing the machine-readable instructions, perform the steps of: retrieving or receiving electronic signals representing one or more property values for a property; receiving an electronic request to predict a hazard level; processing the one or more property values to predict the requested hazard level; and transmitting the predicted hazard level, in real-time or near real-time, to a display device.

In some embodiments, the processor may be configured to, when executing the machine-readable instructions, perform the steps of: retrieving or receiving electronic signals representing one or more property values for a property; receiving an electronic request to predict a probability of a hazard being a high-risk hazard; processing the one or more property values to predict the probability of the hazard being a high-risk hazard; and transmitting the predicted probability of the hazard being a high-risk hazard, in real-time or near real-time, to a display device. A high-risk hazard may be determined based on a pre-determined threshold.

In some embodiments, the one or more property values comprises at least one of: existing hazards, inspection history, permit, owner, contractor, safety officer profile, compliance history and enforcement history.

In some embodiments, the processor is configured to determine the hazard level using a machine learning model.

In some embodiments, the machine learning model is trained to find a hazard level above a pre-determined threshold.

In some embodiments, the machine learning model comprises a tree-based classifier.

In some embodiments, the system may include a database configured to store profiles of one or more safety officers.

In some embodiments, at least one of the stored profiles of the one or more safety officers comprise an assigned zone.

In some embodiments, at least one of the stored profiles of the one or more safety officers comprise a workload value.

In some embodiments, the processor is configured to determine one or more tasks for at least one of the one or more safety officers based on the workload value in the profile of the at least one of the one or more safety officers.

In some embodiments, the processor is configured to determine one or more tasks for at least one of the one or more safety officers based on a geographical location of a property under inspection.

In accordance with one aspect, there is provided a computer-implemented method for allocating inspection resources, the method may include: retrieving or receiving, by a computer processor, electronic signals representing one or more property values for a property; receiving, by the processor, an electronic request to predict a hazard level; processing, by the processor, the one or more property values to predict the requested hazard level; and transmitting, by the processor, the predicted hazard level, in real-time or near real-time, to a display device.

In some embodiments, the one or more property values comprises at least one of: existing hazards, inspection history, permit, owner, contractor, safety officer profile, compliance history and enforcement history.

In some embodiments, the method may include predicting the hazard level using a machine learning model.

In some embodiments, the machine learning model is trained to find a hazard level above a pre-determined threshold.

In some embodiments, the machine learning model comprises a tree-based classifier.

In some embodiments, the method may include storing profiles of one or more safety officers.

In some embodiments, at least one of the stored profiles of the one or more safety officers comprise an assigned zone.

In some embodiments, at least one of the stored profiles of the one or more safety officers comprise a workload value.

In some embodiments, the method may include determining one or more tasks for at least one of the one or more safety officers based on the workload value in the profile of the at least one of the one or more safety officers.

In some embodiments, the method may include determining one or more tasks for at least one of the one or more safety officers based on a geographical location of a property under inspection.

### BRIEF DESCRIPTION OF THE DRAWINGS

In the figures, which depict example embodiments:

FIG. 1 is a schematic diagram of an example digital platform for conducting property inspections, according to some embodiments.

FIG. 2 is a block diagram of an example system for the digital platform, according to some embodiments.

FIG. 3 shows an example user interface displayed by the digital platform, according to some embodiments.

FIG. 4A shows an example hazard map for electrical systems, according to some embodiments.

FIG. 4B shows example hazard map for gas systems, according to some embodiments.

FIG. 5 shows an example set-up for a gas system, according to some embodiments.

FIG. 6 shows an example set-up for an electrical system, according to some embodiments.

FIG. 7 shows an example process performed by the digital platform, according to some embodiments.

FIG. 8 shows the Hazard Map Rating Factors.

FIG. 9A shows the EL Hazard Map scale for 0 (No Hazard) and 1-2 (Business as usual/support for continuous improvement)

FIG. 9B shows the EL Hazard Map scale for 3 (Cause for concern) and 4-5 (The safety system has failed).

FIG. 10A shows the Hazard Map for General—No Hazard and All—Shock for 0 (No Hazard) and 1-2 (Business as usual/support for continuous improvement).

FIG. 10B shows the Hazard Map for General—No Hazard and All—Shock for 3 (Cause for concern).

FIG. 10C shows the Hazard Map for General—No Hazard and All—Shock for 4-5 (The safety system has failed).

FIG. 11A shows the Hazard Map for All—Thermal effects for 0 (No Hazard) and 1-2 (Business as usual/support for continuous improvement).

FIG. 11B shows the Hazard Map for All—Thermal effects for 3 (Cause for concern).

FIG. 11C shows the Hazard Map for All—Thermal effects for 4-5 (The safety system has failed).

FIG. 12A shows the Hazard Map for Service—Shock for 0 (No Hazard) and 1-2 (Business as usual/support for continuous improvement).

FIG. 12B shows the Hazard Map for Service—Shock for 3 (Cause for concern).

FIG. 12C shows the Hazard Map for Service—Shock for 4-5 (The safety system has failed).

FIG. 13A shows Part 1 of the Hazard Map for Service—Thermal effects for 0 (No Hazard) and 1-2 (Business as usual/support for continuous improvement).

FIG. 13B shows Part 2 of the Hazard Map for Service—Thermal effects for 0 (No Hazard) and 1-2 (Business as usual/support for continuous improvement).

FIG. 13C shows Part 1 of the Hazard Map for Service—Thermal effects for 3 (Cause for concern).

FIG. 13D shows Part 2 of the Hazard Map for Service—Thermal effects for 3 (Cause for concern).

FIG. 13E shows Part 1 of the Hazard Map for Service—Thermal effects for 4-5 (The safety system has failed).

FIG. 13F shows Part 2 of the Hazard Map for Service—Thermal effects for 4-5 (The safety system has failed).

FIG. 14A shows the Hazard Map for Service—Equipment Damage for 0 (No Hazard) and 1-2 (Business as usual/support for continuous improvement).

FIG. 14B shows Part 1 of the Hazard Map for Service—Equipment Damage for 3 (Cause for concern).

FIG. 14C shows Part 2 of the Hazard Map for Service—Equipment Damage for 3 (Cause for concern).

FIG. 14D shows the Hazard Map for Service—Equipment Damage for 4-5 (The safety system has failed).

FIG. 15A shows the Hazard Map for Service—System Operation for 0 (No Hazard) and 1-2 (Business as usual/support for continuous improvement).

FIG. 15B shows the Hazard Map for Service—System Operation for 3 (Cause for concern).

FIG. 15C shows the Hazard Map for Service—System Operation for 4-5 (The safety system has failed).

FIG. 16A shows the Hazard Map for Renewable Energy Systems—System Operation for 0 (No Hazard) and 1-2 (Business as usual/support for continuous improvement).

FIG. 16B shows the Hazard Map for Renewable Energy Systems—System Operation for 3 (Cause for concern).

FIG. 16C shows the Hazard Map for Renewable Energy Systems—System Operation for 4-5 (The safety system has failed).

FIG. 17A shows the Hazard Map for Main Distribution—Shock for 0 (No Hazard) and 1-2 (Business as usual/support for continuous improvement).

FIG. 17B shows the Hazard Map for Main Distribution—Shock for 3 (Cause for concern).

FIG. 17C shows the Hazard Map for Main Distribution—Shock for 4-5 (The safety system has failed).

FIG. 18A shows the Hazard Map for Main Distribution—Thermal effects for 0 (No Hazard) and 1-2 (Business as usual/support for continuous improvement).

FIG. 18B shows the Hazard Map for Main Distribution—Thermal effects for 3 (Cause for concern).

FIG. 18C shows the Hazard Map for Main Distribution—Thermal effects for 4-5 (The safety system has failed).

FIG. 19A shows the Hazard Map for Main Distribution—Equipment Damage for 0 (No Hazard) and 1-2 (Business as usual/support for continuous improvement).

FIG. 19B shows the Hazard Map for Main Distribution—Equipment Damage for 3 (Cause for concern).

FIG. 19C shows the Hazard Map for Main Distribution—Equipment Damage for 4-5 (The safety system has failed).

FIG. 20A shows the Hazard Map for Main Distribution—Power supply/system interruption for 0 (No Hazard) and 1-2 (Business as usual/support for continuous improvement).

FIG. 20B shows the Hazard Map for Main Distribution—Power supply/system interruption for 3 (Cause for concern).

FIG. 20C shows the Hazard Map for Main Distribution—Power supply/system interruption for 4-5 (The safety system has failed).

FIG. 21A shows Part 1 of the Hazard Map for Main Distribution—System operation for 0 (No Hazard) and 1-2 (Business as usual/support for continuous improvement).

FIG. 21B shows Part 2 of the Hazard Map for Main Distribution—System operation for 0 (No Hazard) and 1-2 (Business as usual/support for continuous improvement).

FIG. 21C shows Part 2 of the Hazard Map for Main Distribution—System operation for 3 (Cause for concern).

FIG. 21D shows Part 2 of the Hazard Map for Main Distribution—System operation for 4-5 (The safety system has failed).

FIG. 22A shows the Hazard Map for Sub Distribution—Shock and Sub Distribution—Thermal effects for 0 (No Hazard) and 1-2 (Business as usual/support for continuous improvement).

FIG. 22B shows the Hazard Map for Sub Distribution—Shock and Sub Distribution—Thermal effects for 3 (Cause for concern).

FIG. 22C shows the Hazard Map for Sub Distribution—Shock and Sub Distribution—Thermal effects for 4-5 (The safety system has failed).

FIG. 23A shows the Hazard Map for Sub Distribution—Equipment damage and Sub Distribution—Power supply/system interruption for 0 (No Hazard) and 1-2 (Business as usual/support for continuous improvement).

FIG. 23B shows the Hazard Map for Sub Distribution—Equipment damage and Sub Distribution—Power supply/system interruption for 3 (Cause for concern).

FIG. 23C shows the Hazard Map for Sub Distribution—Equipment damage and Sub Distribution—Power supply/system interruption for 4-5 (The safety system has failed).

FIG. 24A shows the Hazard Map for Grounding and Bonding—Thermal effects for 0 (No Hazard) and 1-2 (Business as usual/support for continuous improvement).

FIG. 24B shows the Hazard Map for Grounding and Bonding—Thermal effects for 3 (Cause for concern).

FIG. 24C shows the Hazard Map for Grounding and Bonding—Thermal effects for 4-5 (The safety system has failed).

FIG. 24D shows Part 1 of the Hazard Map for Grounding and Bonding—Shock for 0 (No Hazard) and 1-2 (Business as usual/support for continuous improvement).

FIG. 24E shows Part 2 of the Hazard Map for Grounding and Bonding—Shock for 0 (No Hazard) and 1-2 (Business as usual/support for continuous improvement).

FIG. 24F shows Part 1 of the Hazard Map for Grounding and Bonding—Shock for 3 (Cause for concern).

FIG. 24G shows Part 2 of the Hazard Map for Grounding and Bonding—Shock for 3 (Cause for concern).

FIG. 24H shows Part 1 of the Hazard Map for Grounding and Bonding—Shock for 4-5 (The safety system has failed).

FIG. 24I shows Part 2 of the Hazard Map for Grounding and Bonding—Shock for 4-5 (The safety system has failed).

FIG. 24J shows Part 3 of the Hazard Map for Grounding and Bonding—Shock, the Hazard Map for Grounding and Bonding—Equipment damage and Grounding and Bonding—Poser supply/system interruption for 0 (No Hazard) and 1-2 (Business as usual/support for continuous improvement).

FIG. 24K shows Part 3 of the Hazard Map for Grounding and Bonding—Shock, the Hazard Map for Grounding and Bonding—Equipment damage and Grounding and Bonding—Poser supply/system interruption for 3 (Cause for concern).

FIG. 24L shows Part 3 of the Hazard Map for Grounding and Bonding—Shock, the Hazard Map for Grounding and Bonding—Equipment damage and Grounding and Bonding—Poser supply/system interruption for 4-5 (The safety system has failed).

FIG. 25A shows the Hazard Map for Feeders—Shock and Feeders—Thermal effects for 0 (No Hazard) and 1-2 (Business as usual/support for continuous improvement).

FIG. 25B shows the Hazard Map for Feeders—Shock and Feeders—Thermal effects for 3 (Cause for concern).

FIG. 25C shows the Hazard Map for Feeders—Shock and Feeders—Thermal effects for 4-5 (The safety system has failed).

FIG. 26A shows the Hazard Map for Feeders—Equipment damage for 0 (No Hazard) and 1-2 (Business as usual/support for continuous improvement).

FIG. 26B shows the Hazard Map for Feeders—Equipment damage for 3 (Cause for concern).

FIG. 26C shows the Hazard Map for Feeders—Equipment damage for 4-5 (The safety system has failed).

FIG. 27A shows the Hazard Map for Feeders—Conductors for 0 (No Hazard) and 1-2 (Business as usual/support for continuous improvement).

FIG. 27B shows the Hazard Map for Feeders—Conductors for 3 (Cause for concern).

FIG. 27C shows the Hazard Map for Feeders—Conductors for 4-5 (The safety system has failed).

FIG. 28A shows the Hazard Map for Branch Circuits—Shock and Branch Circuits—Thermal effects for 0 (No Hazard) and 1-2 (Business as usual/support for continuous improvement).

FIG. 28B shows the Hazard Map for Branch Circuits—Shock and Branch Circuits—Thermal effects for 3 (Cause for concern).

FIG. 28C shows the Hazard Map for Branch Circuits—Shock and Branch Circuits—Thermal effects for 4-5 (The safety system has failed).

FIG. 29A shows the Hazard Map for Branch Circuits—Equipment Damage for for 0 (No Hazard) and 1-2 (Business as usual/support for continuous improvement).

FIG. 29B shows the Hazard Map for Branch Circuits—Equipment Damage for 3 (Cause for concern).

FIG. 29C shows the Hazard Map for Branch Circuits—Equipment Damage for 4-5 (The safety system has failed).

FIG. 30A shows the Hazard Map for Branch Circuits—Power supply/system interruption for 0 (No Hazard) and 1-2 (Business as usual/support for continuous improvement).

FIG. 30B shows the Hazard Map for Branch Circuits—Power supply/system interruption for 3 (Cause for concern).

FIG. 30C shows the Hazard Map for Branch Circuits—Power supply/system interruption for 4-5 (The safety system has failed).

FIG. 31A shows the Hazard Map for Outlets—Shock for 0 (No Hazard) and 1-2 (Business as usual/support for continuous improvement).

FIG. 31B shows the Hazard Map for Outlets—Shock for 3 (Cause for concern).

FIG. 31C shows the Hazard Map for Outlets—Shock for 4-5 (The safety system has failed).

FIG. 32A shows the Hazard Map for Outlets—Thermal effects for 0 (No Hazard) and 1-2 (Business as usual/support for continuous improvement).

FIG. 32B shows Part 1 of the Hazard Map for Outlets—Thermal effects for 3 (Cause for concern).

FIG. 32C shows Part 2 of the Hazard Map for Outlets—Thermal effects for 3 (Cause for concern).

FIG. 32D shows the Hazard Map for Outlets—Thermal effects for 4-5 (The safety system has failed).

FIG. 33A shows the Hazard Map for Outlets—Equipment damage for 0 (No Hazard) and 1-2 (Business as usual/support for continuous improvement).

FIG. 33B shows the Hazard Map for Outlets—Equipment damage for 3 (Cause for concern).

FIG. 33C shows the Hazard Map for Outlets—Equipment damage for 4-5 (The safety system has failed).

FIG. 34A shows the Hazard Map for Fixtures and Fittings—Shock, Fixtures and Fittings—Thermal effects, and Fixtures and Fittings—Equipment damage for 0 (No Hazard) and 1-2 (Business as usual/support for continuous improvement).

FIG. 34B shows the Hazard Map for Fixtures and Fittings—Shock, Fixtures and Fittings—Thermal effects, and Fixtures and Fittings—Equipment damage for 3 (Cause for concern).

FIG. 34C shows the Hazard Map for Fixtures and Fittings—Shock, Fixtures and Fittings—Thermal effects, and Fixtures and Fittings—Equipment damage for 4-5 (The safety system has failed).

FIG. 35A shows the Hazard Map for Appliances/Equipment/Utilization—Shock and Appliances/Equipment/Utilization—Thermal effect for 0 (No Hazard) and 1-2 (Business as usual/support for continuous improvement).

FIG. 35B shows the Hazard Map for Appliances/Equipment/Utilization—Shock Appliances/Equipment/Utilization—Thermal effect for 3 (Cause for concern).

FIG. 35C shows the Hazard Map for Appliances/Equipment/Utilization—Shock Appliances/Equipment/Utilization—Thermal effect for 4-5 (The safety system has failed).

FIG. 36A shows the Hazard Map for Appliances/Equipment/Utilization—Equipment damage for 0 (No Hazard) and 1-2 (Business as usual/support for continuous improvement).

FIG. 36B shows the Hazard Map for Appliances/Equipment/Utilization—Equipment damage for 3 (Cause for concern).

FIG. 36C shows the Hazard Map for Appliances/Equipment/Utilization—Equipment damage for 4-5 (The safety system has failed).

FIG. 37A shows the Hazard Map for Space heating—Shock, Space heating—Thermal effects, Space heating—and Space heating—Equipment damage for 0 (No Hazard) and 1-2 (Business as usual/support for continuous improvement).

FIG. 37B shows the Hazard Map for Space heating—Shock, Space heating—Thermal effects, Space heating—and Space heating—Equipment damage for 3 (Cause for concern).

FIG. 37C shows the Hazard Map for Space heating—Shock, Space heating—Thermal effects, Space heating—and Space heating—Equipment damage for 4-5 (The safety system has failed).

FIG. 38A shows the Hazard Map for Motor circuits—Shock and Motor circuits—Thermal effects for 0 (No Hazard) and 1-2 (Business as usual/support for continuous improvement).

FIG. 38B shows the Hazard Map for Motor circuits—Shock and Motor circuits—Thermal effects for 3 (Cause for concern).

FIG. 38C shows the Hazard Map for Motor circuits—Shock and Motor circuits—Thermal effects for 4-5 (The safety system has failed).

FIG. 39A shows the Hazard Map for Motor circuits—Equipment damage and Motor circuits—Power supply/system interruption for 0 (No Hazard) and 1-2 (Business as usual/support for continuous improvement).

FIG. 39B shows the Hazard Map for Motor circuits—Equipment damage and Motor circuits—Power supply/system interruption for 3 (Cause for concern).

FIG. 39C shows the Hazard Map for Motor circuits—Equipment damage and Motor circuits—Power supply/system interruption for 4-5 (The safety system has failed).

FIG. 40A shows the Hazard Map for Transformers—Shock and Transformers—Thermal effects for 0 (No Hazard) and 1-2 (Business as usual/support for continuous improvement).

FIG. 40B shows the Hazard Map for Transformers—Shock and Transformers—Thermal effects for 3 (Cause for concern).

FIG. 40C shows the Hazard Map for Transformers—Shock and Transformers—Thermal effects for 4-5 (The safety system has failed).

FIG. 41A shows the Hazard Map for Transformers—Equipment damage for 0 (No Hazard) and 1-2 (Business as usual/support for continuous improvement).

FIG. 41B shows the Hazard Map for Transformers—Equipment damage for 3 (Cause for concern).

FIG. 41C shows the Hazard Map for Transformers—Equipment damage for 4-5 (The safety system has failed).

FIG. 42A shows the Hazard Map for Regulated Work—Site condition: EL-26-2017 and Energized work/qualified persons for 0 (No Hazard) and 1-2 (Business as usual/support for continuous improvement).

FIG. 42B shows the Hazard Map for Regulated Work—Site condition: EL-26-2017 and Energized work/qualified persons for 3 (Cause for concern).

FIG. 42C shows the Hazard Map for Regulated Work—Site condition: EL-26-2017 and Energized work/qualified persons for 4-5 (The safety system has failed).

FIG. 43A shows the Hazard Map for Regulated Work—Thermal effects for 0 (No Hazard) and 1-2 (Business as usual/support for continuous improvement).

FIG. 43B shows the Hazard Map for Regulated Work—Thermal effects for 3 (Cause for concern).

FIG. 43C shows the Hazard Map for Regulated Work—Thermal effects for 4-5 (The safety system has failed).

FIG. 44A shows the Hazard Map for Hazardous locations—Thermal effects—All classes, All zones for 0 (No Hazard) and 1-2 (Business as usual/support for continuous improvement).

FIG. 44B shows the Hazard Map for Hazardous locations—Thermal effects—All classes, All zones for 3 (Cause for concern).

FIG. 44C shows Part 1 of the Hazard Map for Hazardous locations—Thermal effects—All classes, All zones for 4-5 (The safety system has failed).

FIG. 44D shows Part 2 of the Hazard Map for Hazardous locations—Thermal effects—All classes, All zones for 4-5 (The safety system has failed).

FIG. 45A shows the Hazard Map for Hazardous locations—Thermal effects—Class II, wood dust for 0 (No Hazard) and 1-2 (Business as usual/support for continuous improvement).

FIG. 45B shows the Hazard Map for Hazardous locations—Thermal effects—Class II, wood dust for 3 (Cause for concern).

FIG. 45C shows the Hazard Map for Hazardous locations—Thermal effects—Class II, wood dust for 4-5 (The safety system has failed).

FIG. 46A shows the Hazard Map for Hazardous locations—Thermal effects—Class II, all locations for 0 (No Hazard) and 1-2 (Business as usual/support for continuous improvement).

FIG. 46B shows the Hazard Map for Hazardous locations—Thermal effects—Class II, all locations for 3 (Cause for concern).

FIG. 46C shows the Hazard Map for Hazardous locations—Thermal effects—Class II, all locations for 4-5 (The safety system has failed).

FIG. 47A shows the Hazard Map for Hazardous locations—Thermal effects—Class III for 0 (No Hazard) and 1-2 (Business as usual/support for continuous improvement).

FIG. 47B shows the Hazard Map for Hazardous locations—Thermal effects—Class III for 3 (Cause for concern).

FIG. 47C shows the Hazard Map for Hazardous locations—Thermal effects—Class III for 4-5 (The safety system has failed).

FIG. 48A shows the Hazard Map for Hazardous locations—Equipment damage and Hazardous—locations Power supply/system interruption for 0 (No Hazard) and 1-2 (Business as usual/support for continuous improvement).

FIG. 48B shows the Hazard Map for Hazardous locations—Equipment damage and Hazardous locations—Power supply/system interruption for 3 (Cause for concern).

FIG. 48C shows the Hazard Map for Hazardous locations—Equipment damage and Hazardous locations—Power supply/system interruption for 4-5 (The safety system has failed).

FIG. 49A shows the Hazard Map for Miscellaneous—Equipment damage for 0 (No Hazard) and 1-2 (Business as usual/support for continuous improvement).

FIG. 49B shows the Hazard Map for Miscellaneous—Equipment damage for 3 (Cause for concern).

FIG. 49C shows the Hazard Map for Miscellaneous—Equipment damage for 4-5 (The safety system has failed).

FIG. 50A shows the Hazard Map for Miscellaneous—Shock—Medical for 0 (No Hazard) and 1-2 (Business as usual/support for continuous improvement).

FIG. 50B shows the Hazard Map for Miscellaneous—Shock—Medical for 3 (Cause for concern).

FIG. 50C shows the Hazard Map for Miscellaneous—Shock—Medical for 4-5 (The safety system has failed).

FIG. 51A shows the Hazard Map for Miscellaneous—Shock—Pools, Spas and Hot Tubs and Miscellaneous—Shock Life Safety System, Fire Alarm for 0 (No Hazard) and 1-2 (Business as usual/support for continuous improvement).

FIG. 51B shows the Hazard Map for Miscellaneous—Shock—Pools, Spas and Hot Tubs and Miscellaneous—Shock Life Safety System, Fire Alarm for 3 (Cause for concern).

FIG. 51C shows the Hazard Map for Miscellaneous—Shock—Pools, Spas and Hot Tubs and Miscellaneous—Shock Life Safety System, Fire Alarm for −5 (The safety system has failed.

FIG. 52A shows the GA Hazard Map scale for 1-2 (Business as usual/support for continuous improvement).

FIG. 52B shows the GA Hazard Map scale for 3 (Cause for concern) and 4-5 (Deemed to be unsafe).

FIG. 53A shows the Hazard Map for Gas Meter/Fuel Supply—Install—Relief venting for 1-2 (Business as usual/support for continuous improvement).

FIG. 53B shows the Hazard Map for Gas Meter/Fuel Supply—Install—Relief venting for 3 (Cause for concern).

FIG. 53C shows the Hazard Map for Gas Meter/Fuel Supply—Install—Relief venting for 4-5 (Deemed to be unsafe).

FIG. 54A shows the Hazard Map for Gas Meter/Fuel Supply—Install—Damage and Gas Meter/Fuel Supply—Sizing Design Pressure for 1-2 (Business as usual/support for continuous improvement).

FIG. 54B shows the Hazard Map for Gas Meter/Fuel Supply—Install—Damage and Gas Meter/Fuel Supply—Sizing Design Pressure for 3 (Cause for concern).

FIG. 54C shows the Hazard Map for Gas Meter/Fuel Supply—Install—Damage and Gas Meter/Fuel Supply—Sizing Design Pressure for 4-5 (Deemed to be unsafe).

FIG. 55A shows the Hazard Map for Gas Meter/Fuel Supply—Use—Pressure relief for 1-2 (Business as usual/support for continuous improvement).

FIG. 55B shows the Hazard Map for Gas Meter/Fuel Supply—Use—Pressure relief for 3 (Cause for concern).

FIG. 55C shows the Hazard Map for Gas Meter/Fuel Supply—Use—Pressure relief for 4-5 (Deemed to be unsafe).

FIG. 56A shows Part 1 of the Hazard Map for Piping/Tubing System—Installation—Damage for 1-2 (Business as usual/support for continuous improvement).

FIG. 56B shows Part 2 of the Hazard Map for Piping/Tubing System—Installation—Damage for 1-2 (Business as usual/support for continuous improvement).

FIG. 56C shows Part 1 the Hazard Map for Piping/Tubing System—Installation—Damage for 3 (Cause for concern).

FIG. 56D shows Part 2 the Hazard Map for Piping/Tubing System—Installation—Damage for 3 (Cause for concern).

FIG. 56E shows the Hazard Map for Piping/Tubing System—Installation—Damage for 4-5 (Deemed to be unsafe).

FIG. 57A shows the Hazard Map for Piping/Tubing System—Installation—Leak and Piping/Tubing System—Sizing for 1-2 (Business as usual/support for continuous improvement).

FIG. 57B shows the Hazard Map for Piping/Tubing System—Installation—Leak and Piping/Tubing System—Sizing for 3 (Cause for concern).

FIG. 57C shows the Hazard Map for Piping/Tubing System—Installation—Leak and Piping/Tubing System—Sizing for 4-5 (Deemed to be unsafe).

FIG. 58A shows the Hazard Map for Pressure Controls—Install—Relief Venting for 1-2 (Business as usual/support for continuous improvement).

FIG. 58B shows the Hazard Map for Pressure Controls—Install—Relief Venting for 3 (Cause for concern). and 4-5 (The safety system has failed).

FIG. 58C shows the Hazard Map for Pressure Controls—Install—Relief Venting for 4-5 (Deemed to be unsafe).

FIG. 59A shows the Hazard Map for Pressure Controls—Sizing—Design pressure for 1-2 (Business as usual/support for continuous improvement).

FIG. 59B shows the Hazard Map for Pressure Controls—Sizing—Design pressure for 3 (Cause for concern).

FIG. 59C shows the Hazard Map for Pressure Controls—Sizing—Design pressure for 4-5 (Deemed to be unsafe).

FIG. 60A shows the Hazard Map for Venting Systems—Install—Combust Prdt and Venting Systems—Sizing—Combust Prdt for 1-2 (Business as usual/support for continuous improvement).

FIG. 60B shows the Hazard Map for Venting Systems—Install—Combust Prdt and Venting Systems—Sizing—Combust Prdt for 3 (Cause for concern).

FIG. 60C shows the Hazard Map for Venting Systems—Install—Combust Prdt and Venting Systems—Sizing—Combust Prdt for 4-5 (Deemed to be unsafe).

FIG. 61A shows the Hazard Map for Air Supply—Install—Combust Prd and Air Supply—Sizing—Unsafe Ops for 1-2 (Business as usual/support for continuous improvement).

FIG. 61B shows the Hazard Map for Air Supply—Install—Combust Prd and Air Supply—Sizing—Unsafe Ops for 3 (Cause for concern).

FIG. 61C shows the Hazard Map for Air Supply—Install—Combust Prd and Air Supply—Sizing—Unsafe Ops for 4-5 (Deemed to be unsafe).

FIG. 62A shows the Hazard Map for Gas appliances/equipment—Install—Unsafe Ops for 1-2 (Business as usual/support for continuous improvement).

FIG. 62B shows the Hazard Map for Gas appliances/equipment—Install—Unsafe Ops for 3 (Cause for concern).

FIG. 62C shows the Hazard Map for Gas appliances/equipment—Install—Unsafe Ops for 4-5 (Deemed to be unsafe).

FIG. 63A shows the Hazard Map for Gas appliances/equipment—Use—Unsafe Operation for 1-2 (Business as usual/support for continuous improvement).

FIG. 63B shows the Hazard Map for Gas appliances/equipment—Use—Unsafe Operation for 3 (Cause for concern).

FIG. 63C shows the Hazard Map for Gas appliances/equipment—Use—Unsafe Operation for 4-5 (Deemed to be unsafe).

### DETAILED DESCRIPTION

Limited resources tend to restricted access to all inspection sites. To ensure a safer and more efficient process for property inspections, a digital platform is developed, implementing machine learning modules, to determine the necessity of physical inspections based on defined policy rules.

In addition, safety regulators have the authority to inspect certain types of equipment to ensure it meets safety requirements. It is often not cost effective to inspect every piece of regulated equipment every year. Disclosed herein is a platform intended to use multiple data points to identify sites where it is more likely that safety hazards will exist so that safety officers can target those sites for inspections, avoid inspecting equipment that is likely to be functioning safely, and thereby maximize the value of their time.

Disclosed herein is a digital platform configured to facilitate property inspections. The platform is configured to provide an efficient, objective and systematic process to inspect properties. The platform may prioritize inspections based on risk evaluated by machine learning. In some embodiments, the machine learning model may provide an interpretation for each prediction using Lime, which can provide high transparency to our Safety Officers. In some embodiments, Dynamic Zoning may re-assign workload from overloaded Safety Officers to other Safety Officers based on a geographic location of one or more Safety Officers. The platform generally ensures that property inspections can be targeted to sites with the highest likelihood of safety hazards, and that they can be done systematically, efficiently, and with low bias.

It will be appreciated that numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing implementation of the various example embodiments described herein.

The embodiments of the systems and methods described herein may be implemented in hardware or software, or a combination of both. However, these embodiments may be implemented in computer programs executing on programmable computers, each computer including at least one processor, a data storage system (including volatile and non-volatile memory and/or storage elements), and at least one communication interface. For example, the programmable computers may be a server, network appliance, set-top box, embedded device, computer expansion module, personal computer, laptop, personal data assistant, cloud computing system or mobile device. A cloud computing system is operable to deliver computing service through shared resources, software and data over a network. Program code is applied to input data to perform the functions described herein and to generate output information. The output information is applied to one or more output devices to generate a discernible effect. In some embodiments, the communication interface may be a network communication interface. In embodiments in which elements are combined, the communication interface may be a software communication interface, such as those for inter-process communication. In still other embodiments, there may be a combination of communication interfaces.

Each program may be implemented in a high level procedural or object oriented programming or scripting language, or both, to communicate with a computer system. However, alternatively the programs may be implemented in assembly or machine language, if desired. In any case, the language may be a compiled or interpreted language. Each such computer program may be stored on a storage media or a device (e.g. ROM or magnetic diskette), readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product including a physical non-transitory computer readable medium that bears computer readable and computer usable instructions for one or more processors. The medium may be provided in various forms, including one or more diskettes, compact disks, tapes, chips, magnetic and electronic storage media, and the like. The computer useable instructions may also be in various forms, including compiled and non-compiled code.

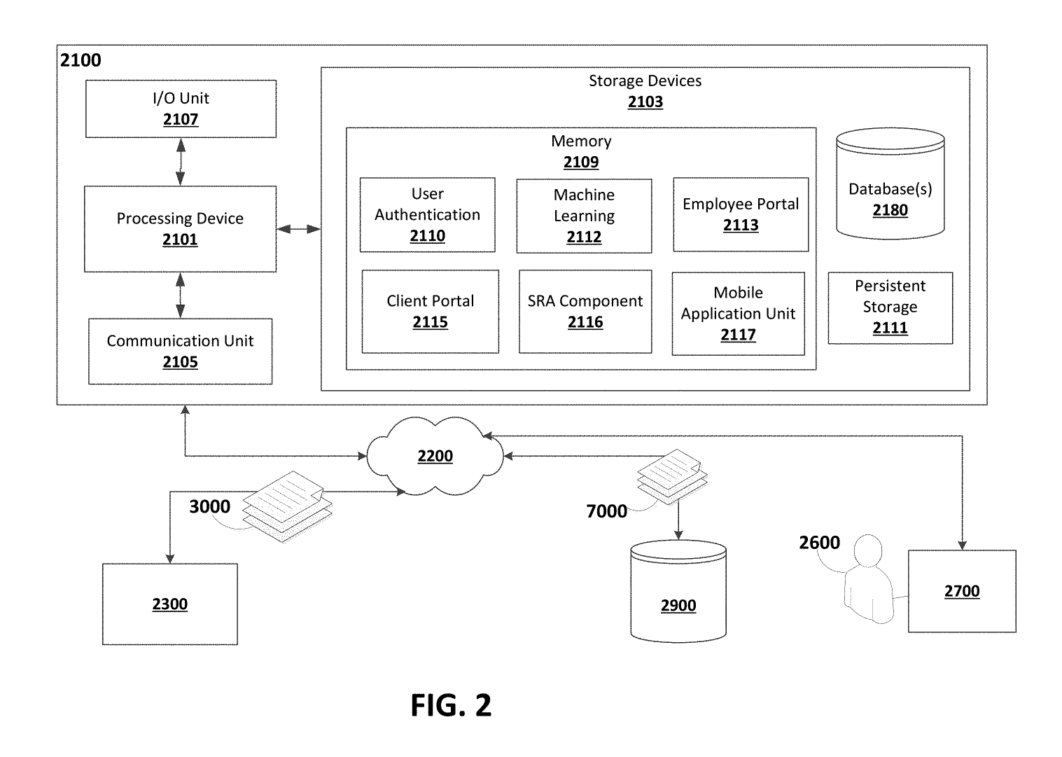

Referring now to FIG. 2, which illustrates a block diagram of an example digital platform 2100 (or simply “system 2100”), which may be one example of system 100, according to some embodiments. The system 2100 may include I/O unit 2107, processing device 2101, communication unit 2105, one or more storage devices 2103. Storage device 2103 may include memory 2109, databases 2108 and persistent storage 2111.

System 2100 may be connected via a network 2200 to one or more partner portals or databases 2300, 2900 for facilitating property inspections. For example, system 2300 may be a system used by a property manager, which may send one or more documents 3000 to system 2100 for requesting a property inspection. For another example, system 2900 may be a system of a government branch, which may send or receive documents 7000 for representing asset owners. System 2700 may be a user system used by client 2600 to view or manage his or her user account.

A processing device 2101 can execute instructions in memory 2109 to configure user authentication unit 2110, user profile unit 2118, and interface module 2115. A processing device 2101 can be, for example, any type of general-purpose microprocessor or microcontroller, a digital signal processing (DSP) processor, an integrated circuit, a field programmable gate array (FPGA), a reconfigurable processor, or any combination thereof.

Memory 2109 may include a suitable combination of any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like.

Each I/O unit 2107 enables system 2100 to interconnect with one or more input devices, such as a keyboard, mouse, camera, touch screen and a microphone, or with one or more output devices such as a display screen and a speaker.

Each communication interface 2105 enables system 2100 to communicate with other components, to exchange data with other components, to access and connect to network resources, to serve applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these.

User authentication unit 2110 is operable to register and authenticate users (using a login, unique identifier, and password for example) prior to providing access to applications, documents, a local network, network resources, other networks and network security devices. System 2100 may serve one user or multiple users. For example, user authentication may be performed through verification of a PIN or security code sent to a mobile device, correct login information (e.g. username and password). Users of digital platform 2100 may include clients, safety officers, government branches, and so on.

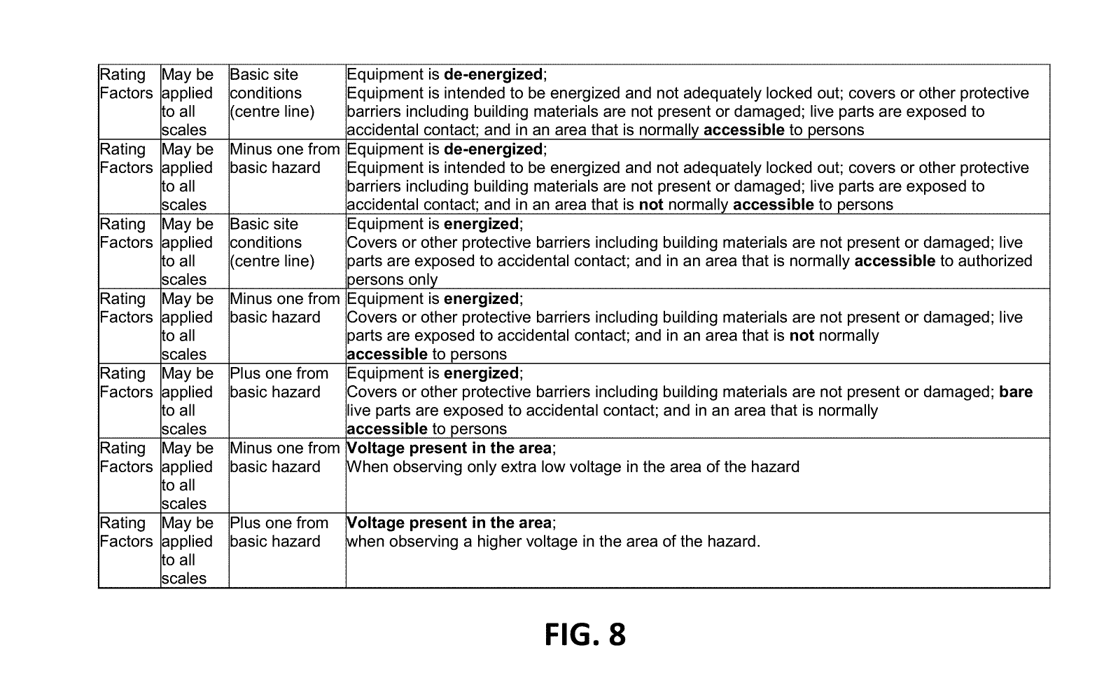

Machine learning unit 2112 may contain one or more engines for training a machine learning model, which may be represented as data sets in database 2180. As described herein, the machine learning unit 2112 is configured to perform analytics on information in order to determine a hazard level. In some embodiments, the machine learning unit 2112 is configured to maximize finding of hazards above a threshold. The threshold may be pre-determined. For example, the threshold may be defined based on information contained in FIGS. 8 to 63C, such as levels three or above.

Client portal 2115 and employee portal 2113 may be configured to construct a user interface for a user of platform 2100. Depending on the type of device or browser used, client portal 2115 and employee portal 2113 may be configured to construct the user interface best suited to display information on the device and/or browser in the HTTP request.

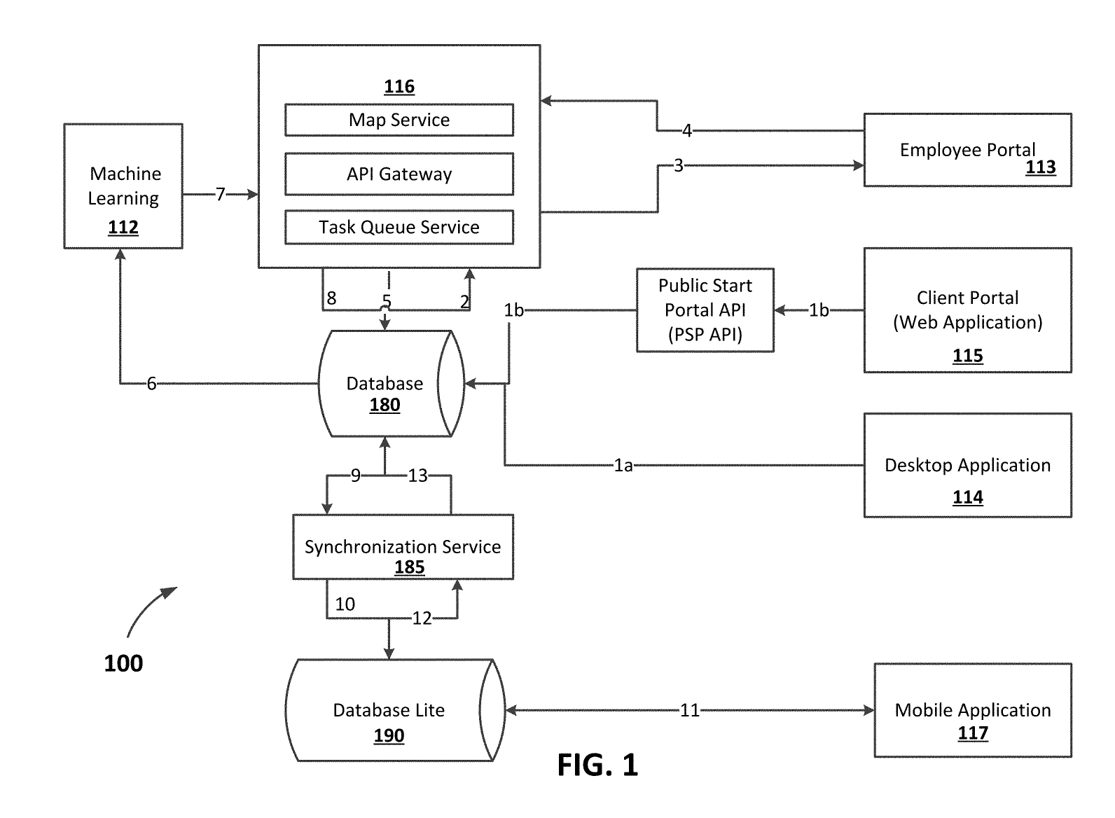

SRA component unit 2116, 116 (see also FIG. 1) may be configured to include map services, API gateway and task queue service. It may be configured to communicate with the machine learning model 112, 2112 and employee portal 113, 2113. It may be configured to communicate with database 180, 2180.

Mobile application unit 2117 may be configured to communicate with one or more mobile devices, to optimize a display screen suitable for the mobile devices, and to receive and transmit electronic signals to the mobile devices.

Persistent storage 2111 may be configured to store information associated with the system. Storage device 2103 and/or persistent storage 2111 may be provided using various types of storage technologies, such as solid state drives, hard disk drives, flash memory, and may be stored in various formats, such as relational databases, non-relational databases, flat files, spreadsheets, extended markup files, etc.

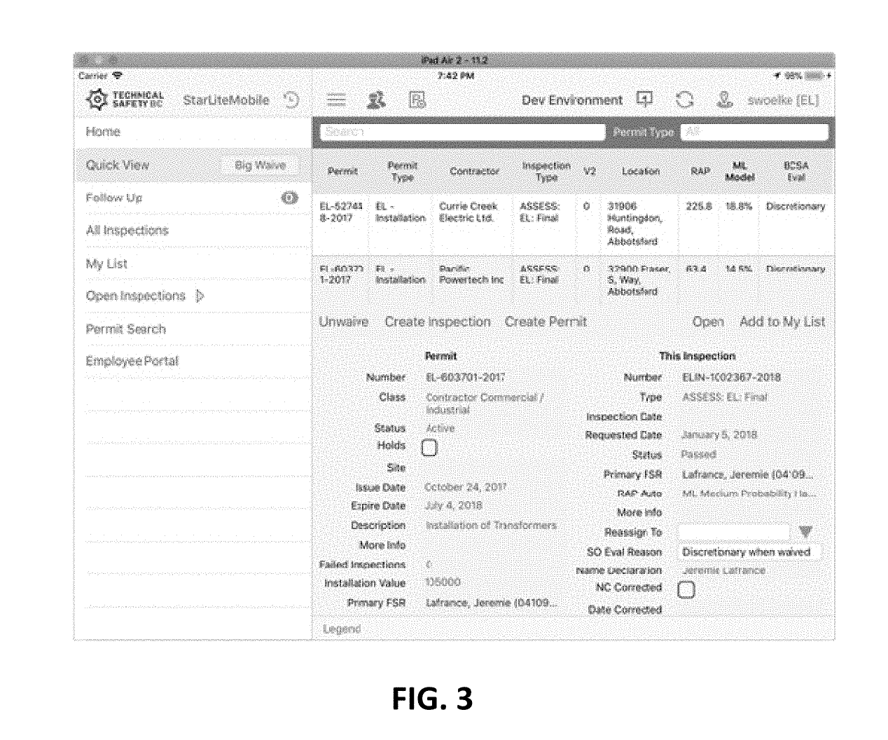

FIG. 3 shows an example user interface. It provides the Safety Officers with the view of work information, and also machine learning evaluation. It also provides a user interface for a Safety Officer to record findings from operations.

In some embodiments, when property inspection work is to be carried out, the system 2100 may be configured to receive, over an network 2200, and record the information of Permits 3000, the Asset Owners and Contractors 7000 in database such as 2180. Permit information 3000 may be sent from a permit database 2300, while asset owner or contractor information 7000 may be sent from an owner or contractor database 2900. A user 2600 (e.g. a safety officer) may use a user device 2700 to access and manage system 2100.

System 2100 may generate a list of inspections based on existing and/or retrieved information. Then, one or more Safety Officers may go to the work sites for inspections. There may be defined rules of identifying non-compliances and the detailed map between as found conditions to the hazard levels, level 0 to 5, see e.g. FIGS. 8 to 63C:
0: No hazard
1: Non-compliances are considered to have a negligible impact on safe operation.
2: Conditions found are considered to present hazards if left uncorrected.
3: Conditions found are considered to present safety hazards if left uncorrected.
4: Considered to present an imminent hazard
5: Conditions found may contribute to a fatality, injury or incident.

Starting from level 3, the conditions found are considered to present safety hazards if left uncorrected. These may be categorized as high hazard and an object of machine learning model 2112 in system 2100 is to maximize the possibility of finding high hazard.

In some embodiments, database 118, 2118 may collect and store data of inspections, permits, contractors, and owners from external systems 2300, 2900. Database 118, 2118 may also store operations data such as hazard rating, record of non-compliances, and Safety Officers' travel.

In some embodiments, compliance and enforcement data, which keeps information regarding enforcement actions over various properties, may also be stored and retrieved and processed by machine learning model 2112.

In addition, Compliance and Enforcement team will take actions to enforce the contractors with outstanding non-compliance history and they store these data in the Compliance and Enforcement system, which is another important source of our training data.

The system may keep the travel history of Safety Officers, which may be used for managing the workload in Dynamic Zoning.

Data of As Found Hazards, Inspections, Permits, the Asset Owners and Contractors, and the travel information of Safety Officers are stored in one or more databases 2180, 180, 190. With the connection between the machine learning unit 2112, 112, which may be on a separate server, and databases, the machine learning unit may query available data and process them on the server. In some embodiments, the data may be enriched with Compliance and Enforcement history extracted from compliance and enforcement server or database. All of these constitute a training set and an objective of the training is to maximize the possibility of finding high hazards.

Missing data may be imputed in some embodiments. As the data collection process is not perfect, there may be some missing information about inspections, permits, clients, and contractors. Safety Officers may need to make judgement based on incomplete data. Supplying the missing data may be a problem. Missing data may be imputed by implementing rules for filtering out impure data according to a different type of missing data. In some embodiments, data normalization is performed one or more types of data.

In some embodiments, data aggregation by rolling (window) function is implemented. The system may track some or all of the historical performance of permits, owners, and contractors in terms of as found high hazards and noncompliance. In the process of building model and making the predictions, information may be collected and processed, by application of a rolling function (rolling/window function: operate on a set of rows (defined by time in our case) and returning a single value (i.e. average high hazard found on the permit) for each row from the underlying query).

In some embodiments, feature selection is done by consulting the experts from Safety Management and Operations and by experimenting using cross validation. Features having correlations with low or high risk may be identified and coded accordingly.

In some embodiments, text information may be an importance source for indicating the risks. The text can be transformed to numeric values to be read and processed by system 2100. If there are only a few unique values of the text feature, they may be categorized. Otherwise, text may be tokenized and vectorized.

Machine learning model 112, 2112 may be implemented to determine a hazard level based on one or more property values. For example, machine learning may be trained to minimize risk and maximize the possibility of finding high-level hazard. A high-level hazard may be pre-determined to be a level that is above a threshold (e.g. level 3). Tree based classifier may in some embodiments be used to implement and train the machine learning model.

Tree based classifiers starts with a training set consisting of pre-classified records (in our case, as found high hazard (level 3 to 5) and low hazard (level 0 to 2) of the historical inspections). The goal is to build a tree that can distinguish the as found high hazard inspections from and low hazard ones based on all meaningful features. With comparing the homogeneity within each partition, the learning process is to determine the best partition among all possible tree splittings until a full tree is generated.

To obtain better predictive performance, ensemble methods may be applied which construct more than one decision tree and conclude the final prediction from the outputs of all trees.

Ensemble exponentially increased the complexity of fitting the model. XGBoost algorithm may be implemented, which optimizes the implementation of ensemble tree model for scalability. With the ensembled tree model, when a new inspection created, the model can be used to evaluate the probability of being identified as as-found high hazard.

In some embodiments, PageRank may be implemented to leverage Safety Officers' knowledge to improve the operations efficiency.

The PageRank algorithm may be implemented based on historical inspection data. First, a graph may be designed based on the understandings of the relationships among all the variables. This graph may contain multiple vertices (extracted from different variables) and edges (links among the vertices). The edges and their directions may be designed based on the understandings of these vertices. Second, the data may be implemented into this graph and PageRank scores may be calculated using simple iterative algorithms. In the end, new data points which needs to be ranked based on the PageRank scores will be added to the previous graph, and their corresponding PageRank scores will be listed.

The goal of using PageRank algorithm is to learn Safety Officer's habits and help assign inspections to them based on their preferences.

In some embodiments, stratified random sampling may be used to collect training data for machine learning model. Stratified sampling involves dividing the population into small groups based on the interests and randomly sampling from these groups. Stratified random sampling is chosen because: 1. relationships among these small groups can be observed; 2. a representative sample from the population may be generated even when there is an inaccessible group. Stratified random sampling is a good approach to reduce human selection bias. It makes sure each subgroup will have representatives in the sample. Therefore it will provide a sample data group with better coverage of the population. In each group, simple random sampling is applied which also reduces the sampling bias by giving each unit the same probability to be chosen.

Platform or system 2100 is configured to predict the inspection hazard level based on inspection data and property variables. The system can use non-compliance as a feature in the model deployment, and generate predictions based on a combination of results from XGBOOST, recommendation system (PageRank) and other decision rules in the organization.

In some embodiments, system 2100 may use dynamic zoning to optimize and balance a daily workload of safety officers based on a current workload, a travel distance and applicable PageRank scores.

In some embodiments, sample plan is used to collect more data for future machine learning training since sample plan can capture some sites that are ignored by a machine learning model.

In some embodiments, system 2100 may implement LIME which can display one or more machine learning prediction results on a user interface display, so that safety officers can understand why the an inspection is tagged as mandatory.

FIG. 1 is a schematic diagram representing an example environment of a digital platform or system 100, according to some embodiments. In some embodiments, the system may include a machine learning component 112, a Structure Resource Allocation (SRA) component 116, an employee portal 113, a database 180, a web client portal 115, a desktop application 114, a synchronization service 185, a database 190 for mobile application and a mobile application 117.

Machine learning model 112 may be implemented to determine a hazard level and/or to evaluate an inspection priority.

Structure Resource Allocation (SRA) Component 116 may be configured to manage safety officer assessment distribution and it consists of the following components: Map Service, API Gateway, and Task Query Service. API Gateway is a REST API which allows other applications like employee portal and client portal to retrieve information in the Structure Resource Allocation Component. Map Service is a component of Structured Resource Allocation (SRA) Engine which allows the user to modify inspection zone boundaries and assign inspection zones to the safety officers. Task Query Service is based on Celery Distributed Task Queue service which focus on real time process and task scheduling. The Task Query Service retrieve results from machine learning component and it pushes the data to the database.

Desktop Application 114 is a desktop application which allow internal users to manage permit, inspection, certification license information. The information will be saved in the database 180.

Client Portal 115 is an external web application designed for consumer, contractors and etc. to apply for permits, pay invoices, schedule inspection and allow clients to manage their accounts.

Client Portal 115 calls the PSP Rest API to send the client data to database 180, which is the central storage for permit, inspection, certification, license information. Different applications and systems can retrieve permit information from this centralized location.

Employee portal 113 is an internal web application designed for internal employee to support clients via client view feature in client portal.

Employee portal 113 has access to the Map Service in Structured Resource Allocation program to modify inspection zone and assign inspection zone to safety officers. The data is stored in the database 180.

Machine learning model 112 may predict a hazard level based on past inspections to better identify physical inspections which would result finding hazards. It retrieves the inspection information from the database 180 and it uses Machine Learning algorithm to evaluate inspection priority for the Safety Officers.

Synchronization Service 185 can extract a subset of STAR data for different safety officers to feed the Mobile Application 117. The Sync service pushes the machine learning result and inspection data to the database 190, which contains a subset of STAR database which feed data to the Starlite mobile application including machine learning results.

Mobile Application 117 can be a mobile application which is a light version of the web application. Mobile Application 117 displays a snapshot of the inspection status and details on the mobile device. Safety Officer uses Starlite on the road to review and manage inspections. The Quick View screen in Mobile Application 117 gives a summary of all assigned inspections status and machine learning score to the safety officer.

In addition, as the Inspections, Permits, and Contractors data being continuously updated from Operations through Mobile Application 117, it is an instant source for feeding machine learning model. The model will adjust its predictions by the updated information and then it will feed the adjustment back to Mobile Application 117.

Through field testing, it is shown that the digital platform described herein provides much greater accuracy in identifying high safety hazards than previous methods of analysis and can improve Safety Officer efficiency in identifying high hazards by 80%

### Testing and Evaluation

Evaluation of system 2100 shows that it is efficient in determining hazard levels and allocating work to safety officers. A hit rate may be used to evaluate the performance of machine learning algorithms. Hit rate is equal to the number of high hazard found by mandatory tagged from machine learning and physically inspected inspections over the total number of all the physically inspected mandatory tagged inspections by machine learning. That is, it may be a number of 3-5 as found hazards found by physically completed mandatory inspections divided by the number of physically completed mandatory inspections. In addition to hit rate, completion rate can also be used to evaluate system 2100. Completion rate stands for the number of mandatory tagged inspections that are inspected physically over the total number of mandatory tagged inspections.

Model Evaluation may include two parts: AB testing and continuous model evaluation.

Before deploying the machine learning model 112, 2112 in the system, the actual performance of models may be evaluated by AB testing. A team of safety officers was separated to Group A and Group B, and two months of data were collected.

Continuous model evaluation is important after the deployment of model. With the operations team, the metrics for monitoring the performance and learning progress of machine learning model may be defined.

The same procedures may be used to pre-process the data of new inspections and permits. Then pre-trained models may be used to score these inspections.

To ensure the transparency of machine learning, LIME (Local Interpretable Model Explanation) is integrated in this process to explain the prediction of each inspection.

During the testing period, it is noticed that the inspections and risk of inspections are not distributed evenly, geographically speaking. However, each Safety Officer has an assigned zone based on city. It resulted in the uneven workload between Safety Officers. To solve this problem, Dynamic Zoning may be implemented. Instead of fixed zone for Safety Officers, inspection assignment may be allocated and adjusted by the system 2100, based on the workload of Safety Officers and the distance (considering the driving time and geographic limitation).

Then, the scored results with assignment adjustment may be extracted through API and then be presented to the Safety Officers on mobile application 117 via database 190, after synchronization service 185.

As the operations of property inspection is carried out in real time, the inspection data may be used as training set. As a result, the model may learn to produce more accurate predictions in the long run.

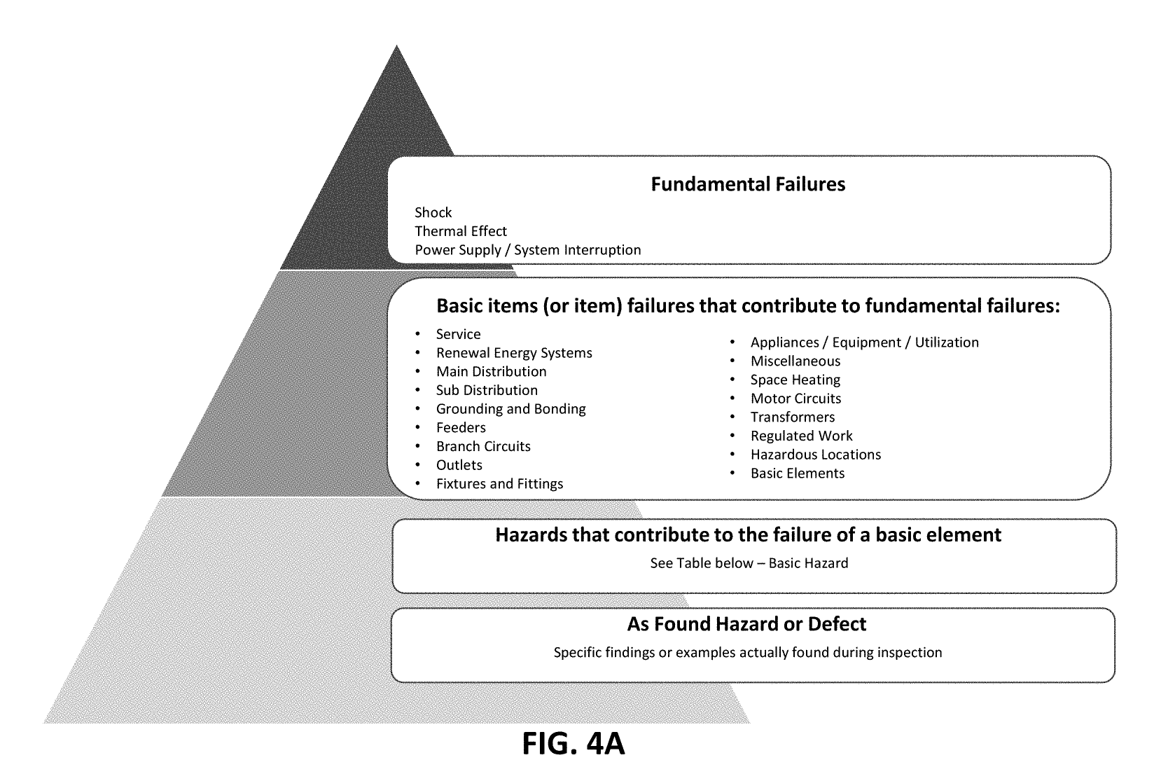

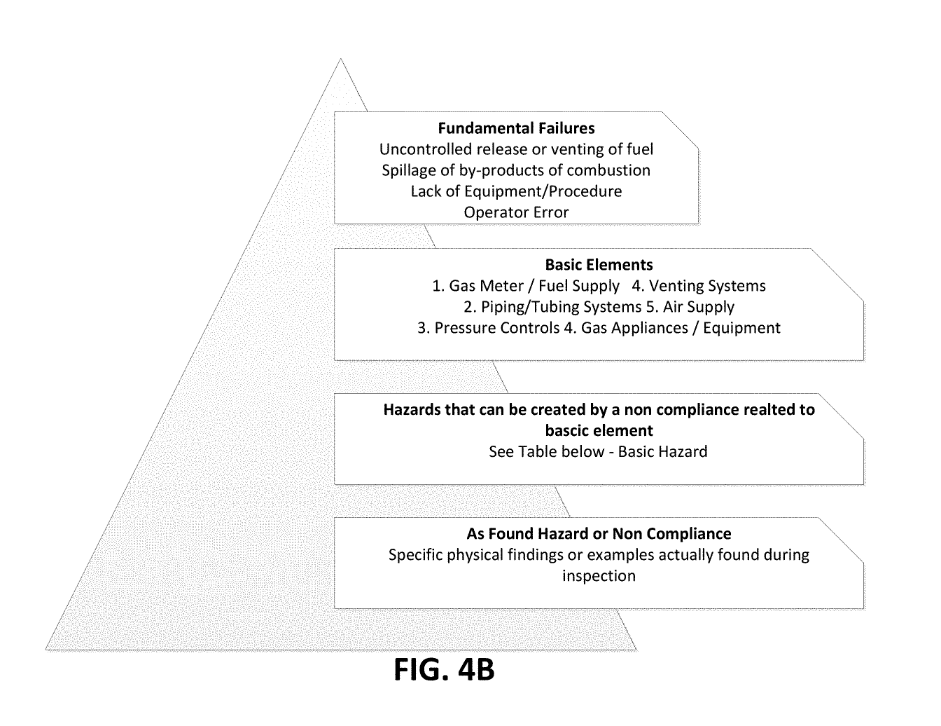

FIG. 4A shows an example hazard map for electrical systems, according to some embodiments. FIG. 4B shows example hazard map for gas systems, according to some embodiments. These two maps illustrate example high-risk, medium-risk and low-risk hazard levels. For example, a high-risk hazard for an electrical system can be any item that can cause fundamental failures such as shock, thermal effect, and power supply or system interruption. For another example, a high-risk hazard for a gas system can be uncontrolled release or venting of fuel, spillage of by-products of combustion, lack of equipment/procedure, and operator error.

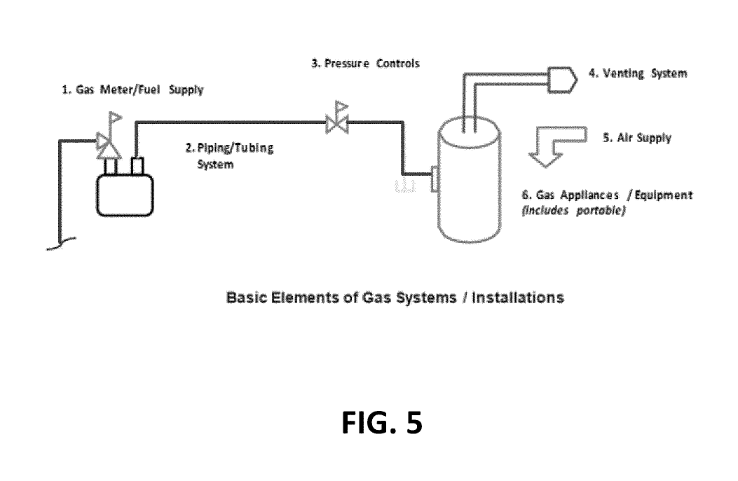

FIG. 5 shows an example set-up for a gas system, according to some embodiments. The example gas system may include basic elements such as gas meter/fuel supply, pipping system, pressure controls, venting system, air supply and gas appliances and equipment.

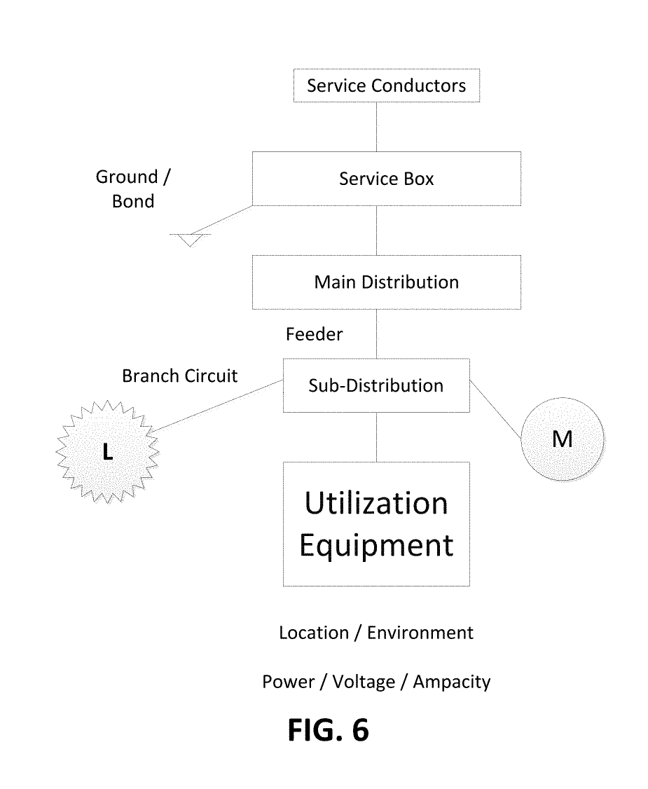

FIG. 6 shows an example set-up for an electrical system, according to some embodiments. The example electrical system may include: service conductors, service box which can be connected to ground, main distribution, sub-distributions, and utilization equipment. Sub-distribution can be connected to branch circuits.

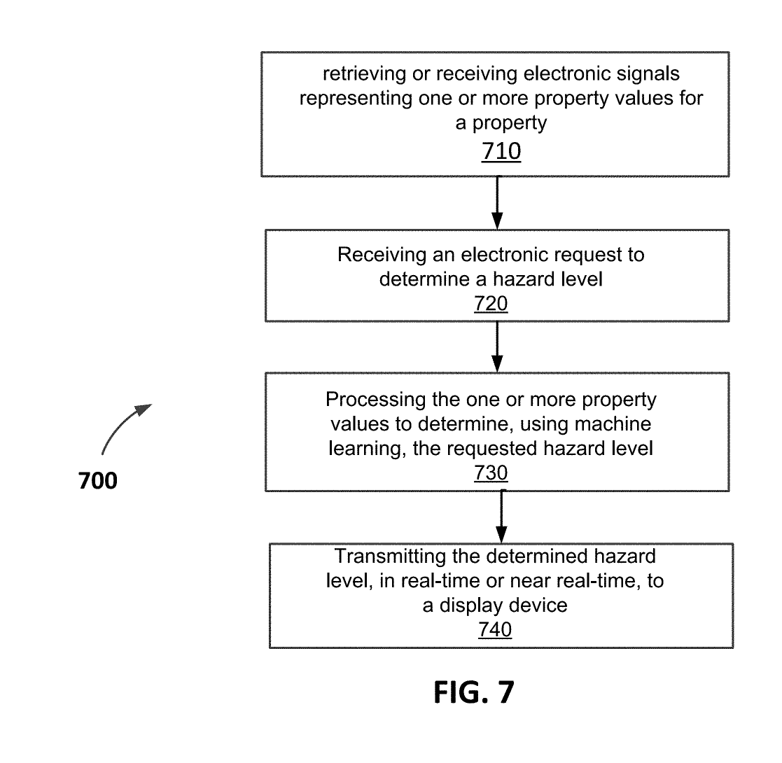

FIG. 7 shows an example process 700 performed by the digital platform, according to some embodiments. The digital platform 2100 may be configured to: at step 710, receive or retrieve, by a computer processor, electronic signals representing one or more property values for a property; at step 720, receive, by the processor, an electronic request to determine a hazard level; at step 730, process, by the processor, the one or more property values to determine the requested hazard level; and at step 740, transmit, by the processor, the determined hazard level, in real-time or near real-time, to a display device.

In some embodiments, the one or more property values comprises at least one of: existing hazards, inspection history, permit, owner, contractor, safety officer profile, compliance history and enforcement history.

In some embodiments, the method may include determining the hazard level using a machine learning model.

In some embodiments, the machine learning model is trained to find a hazard level above a pre-determined threshold.

In some embodiments, the machine learning model comprises a tree-based classifier.

In some embodiments, the method may include storing profiles of one or more safety officers.

In some embodiments, at least one of the stored profiles of the one or more safety officers comprise an assigned zone.

In some embodiments, at least one of the stored profiles of the one or more safety officers comprise a workload value.

In some embodiments, the method may include determining one or more tasks for at least one of the one or more safety officers based on the workload value in the profile of the at least one of the one or more safety officers.

In some embodiments, the method may include determining one or more tasks for at least one of the one or more safety officers based on a geographical location of a property under inspection.

FIG. 8 shows the Hazard Map Rating Factors.

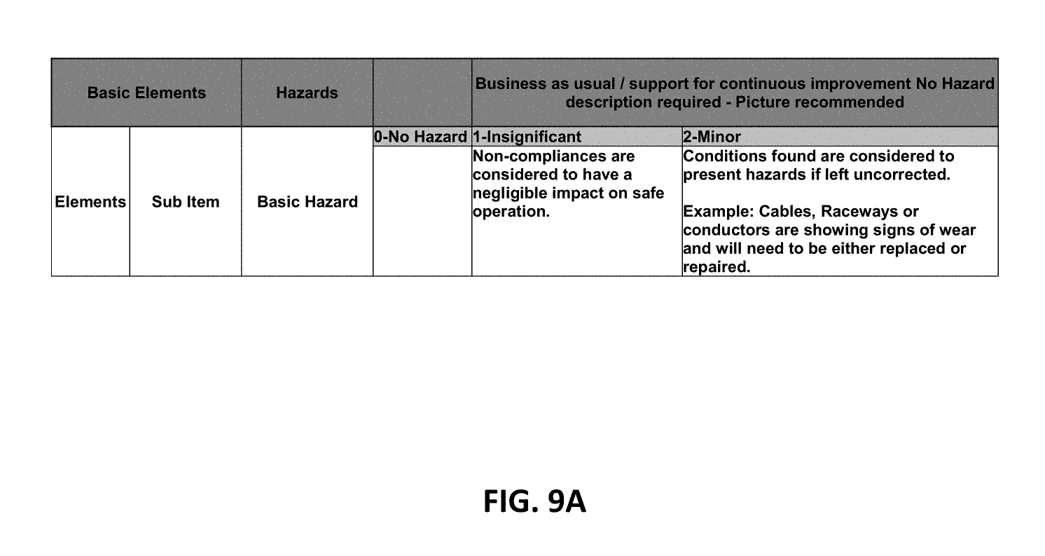

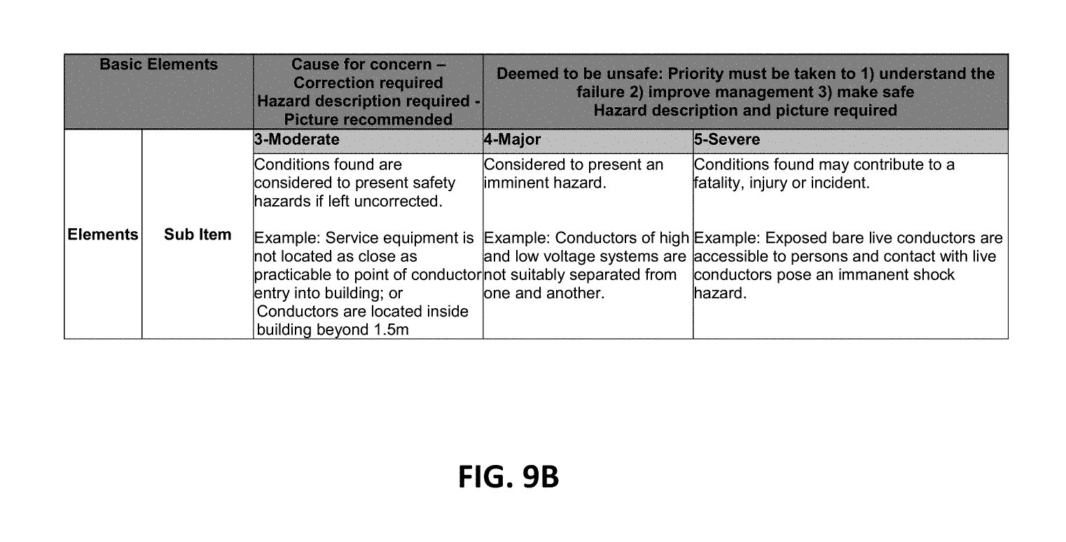

FIG. 9A shows the EL Hazard Map scale for 0 (No Hazard) and 1-2 (Business as usual/support for continuous improvement)

FIG. 9B shows the EL Hazard Map scale for 3 (Cause for concern) and 4-5 (The safety system has failed).

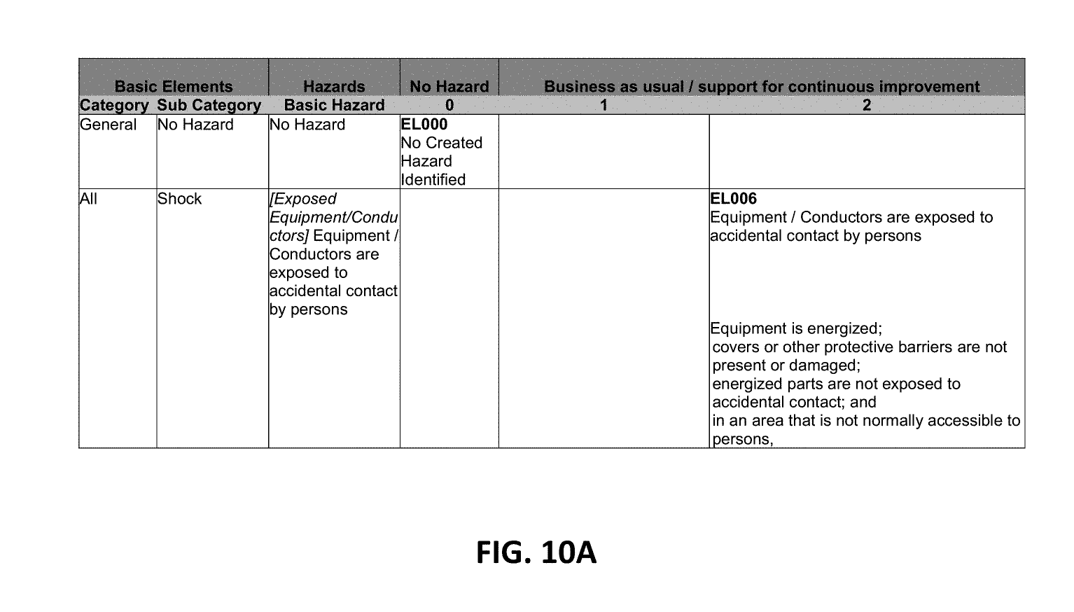

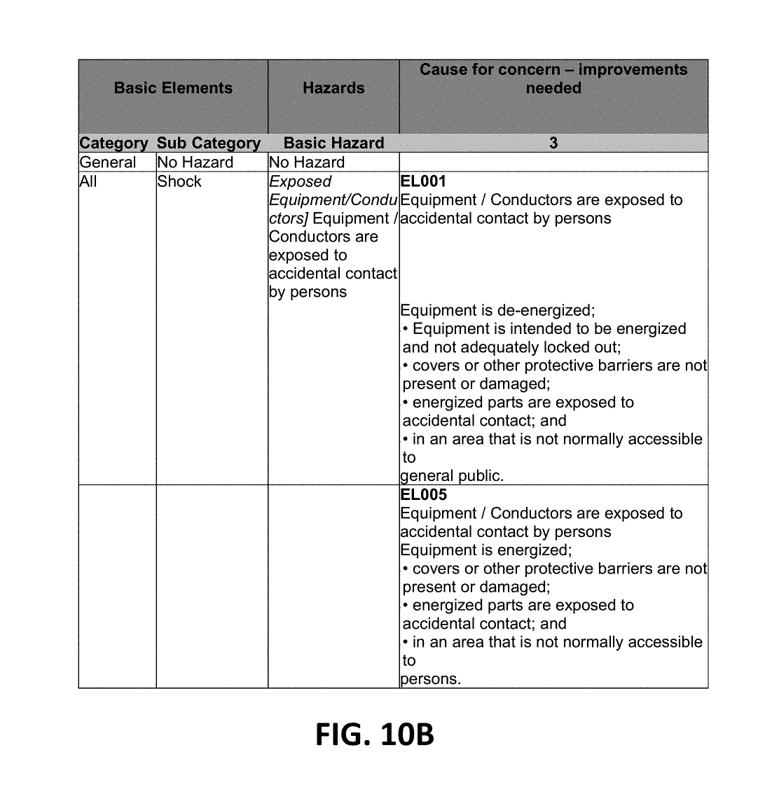

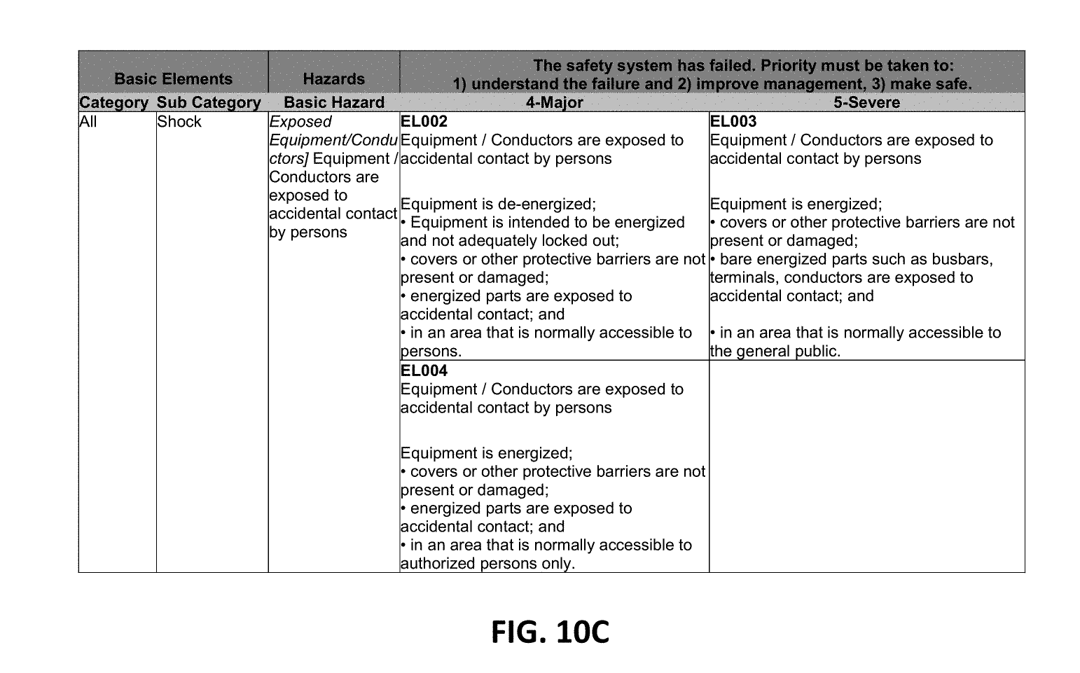

FIG. 10A shows the Hazard Map for General—No Hazard and All—Shock for 0 (No Hazard) and 1-2 (Business as usual/support for continuous improvement).

FIG. 10B shows the Hazard Map for General—No Hazard and All—Shock for 3 (Cause for concern).

FIG. 10C shows the Hazard Map for General—No Hazard and All—Shock for 4-5 (The safety system has failed).

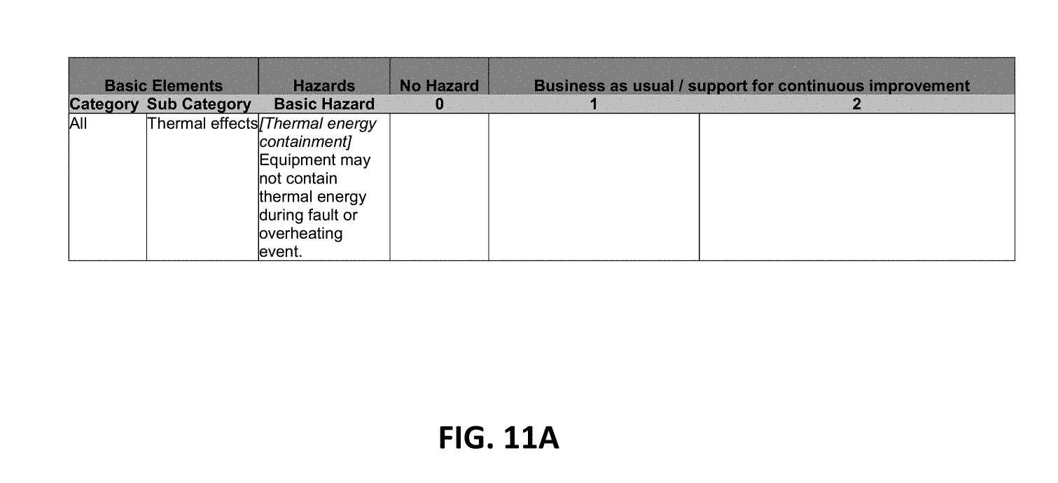

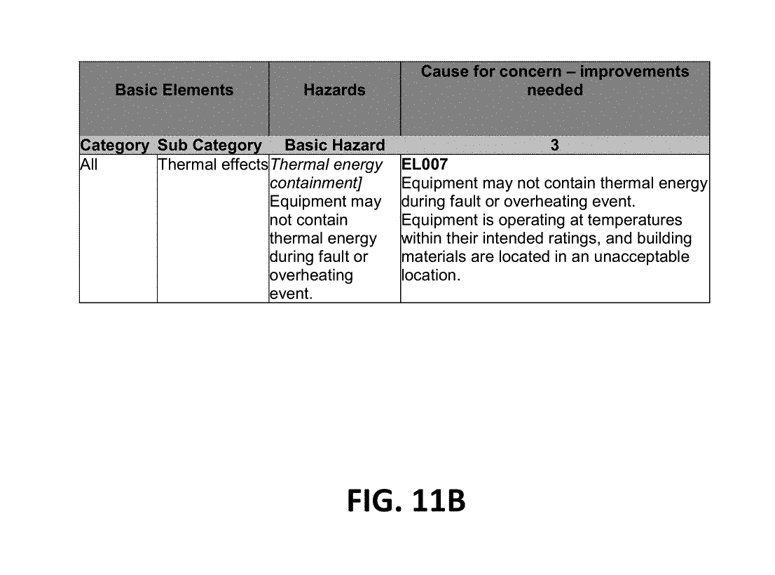

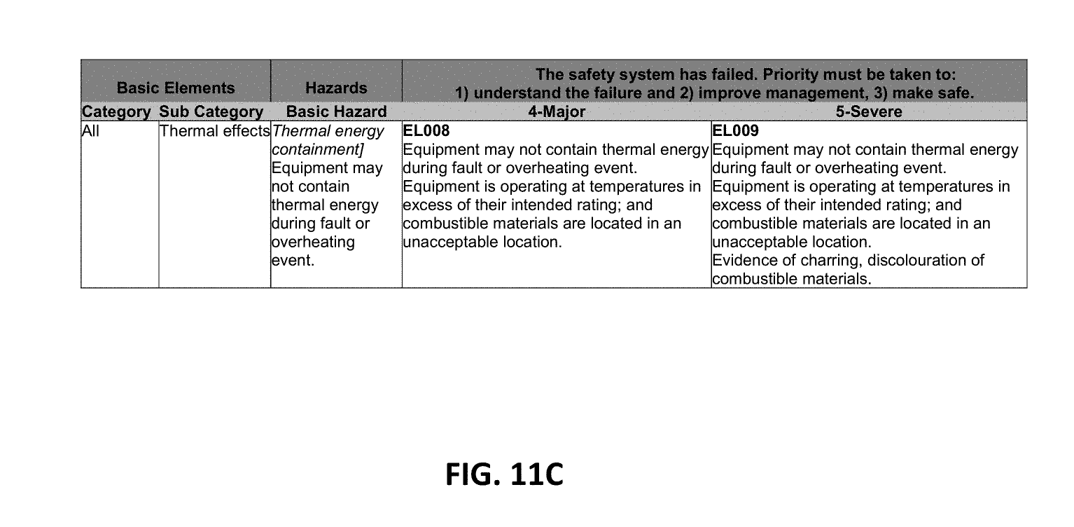

FIG. 11A shows the Hazard Map for All—Thermal effects for 0 (No Hazard) and 1-2 (Business as usual/support for continuous improvement).

FIG. 11B shows the Hazard Map for All—Thermal effects for 3 (Cause for concern).

FIG. 11C shows the Hazard Map for All—Thermal effects for 4-5 (The safety system has failed).

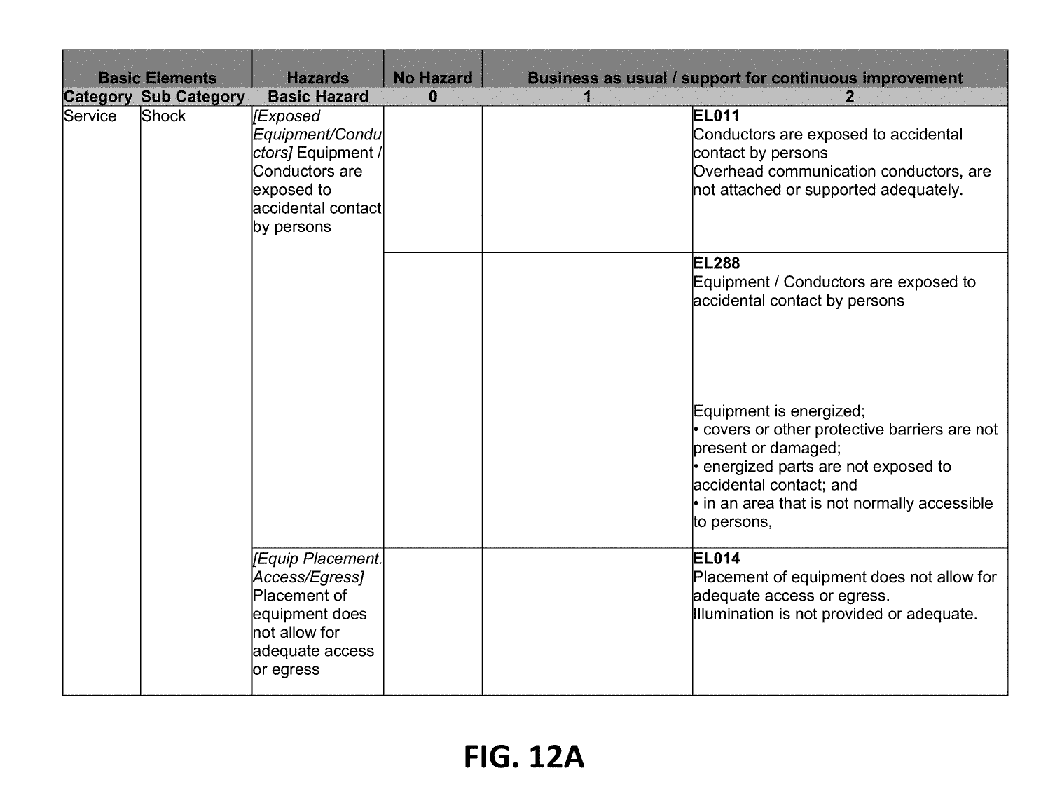

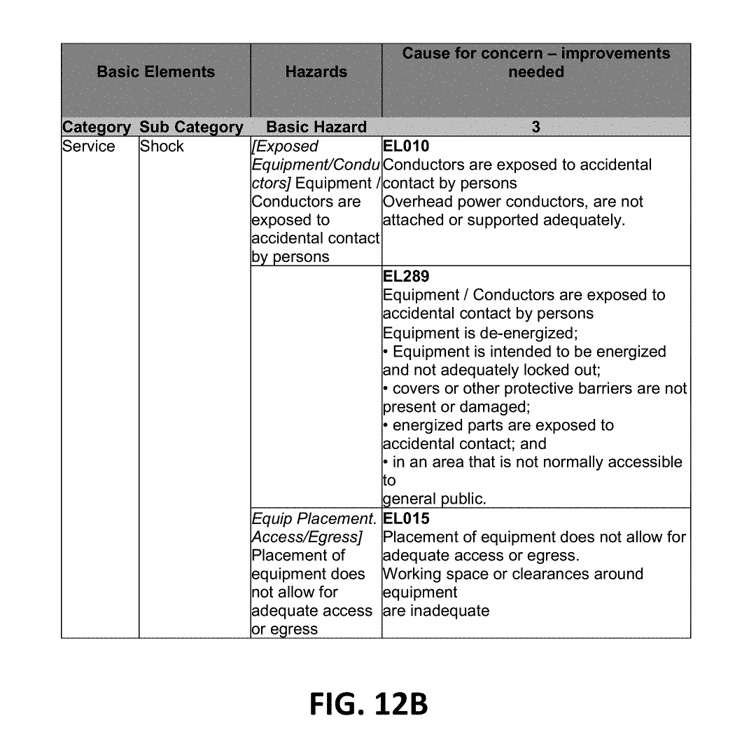

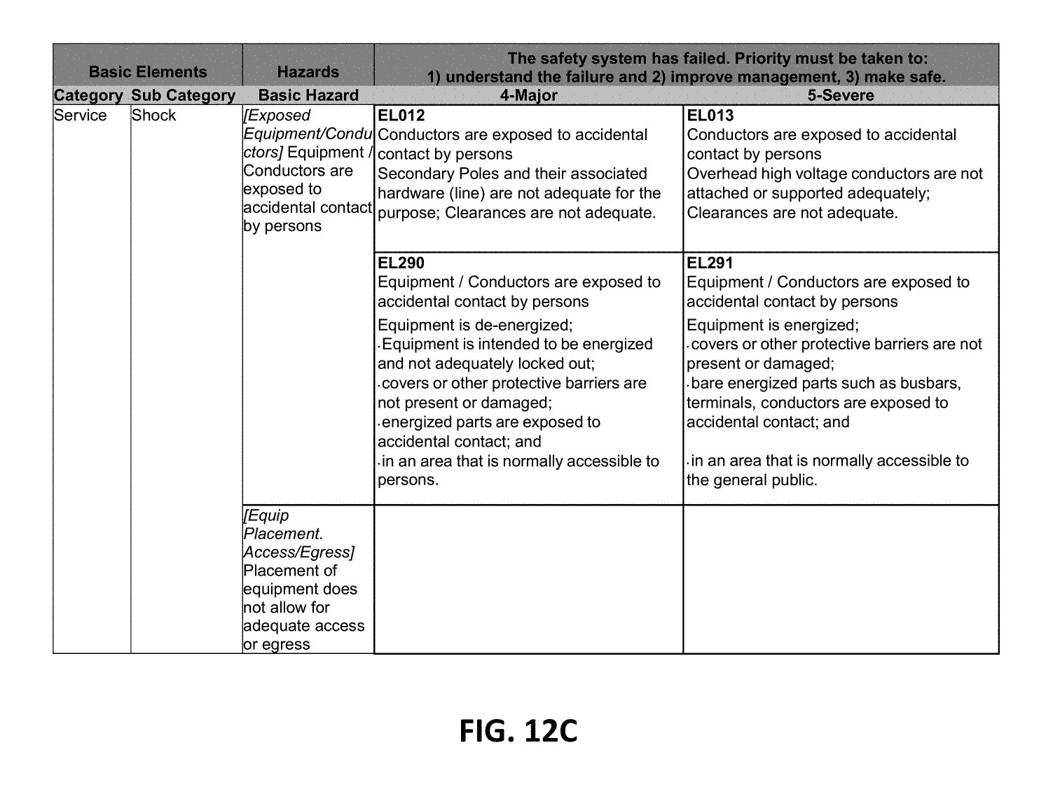

FIG. 12A shows the Hazard Map for Service—Shock for 0 (No Hazard) and 1-2 (Business as usual/support for continuous improvement).

FIG. 12B shows the Hazard Map for Service—Shock for 3 (Cause for concern).

FIG. 12C shows the Hazard Map for Service—Shock for 4-5 (The safety system has failed).

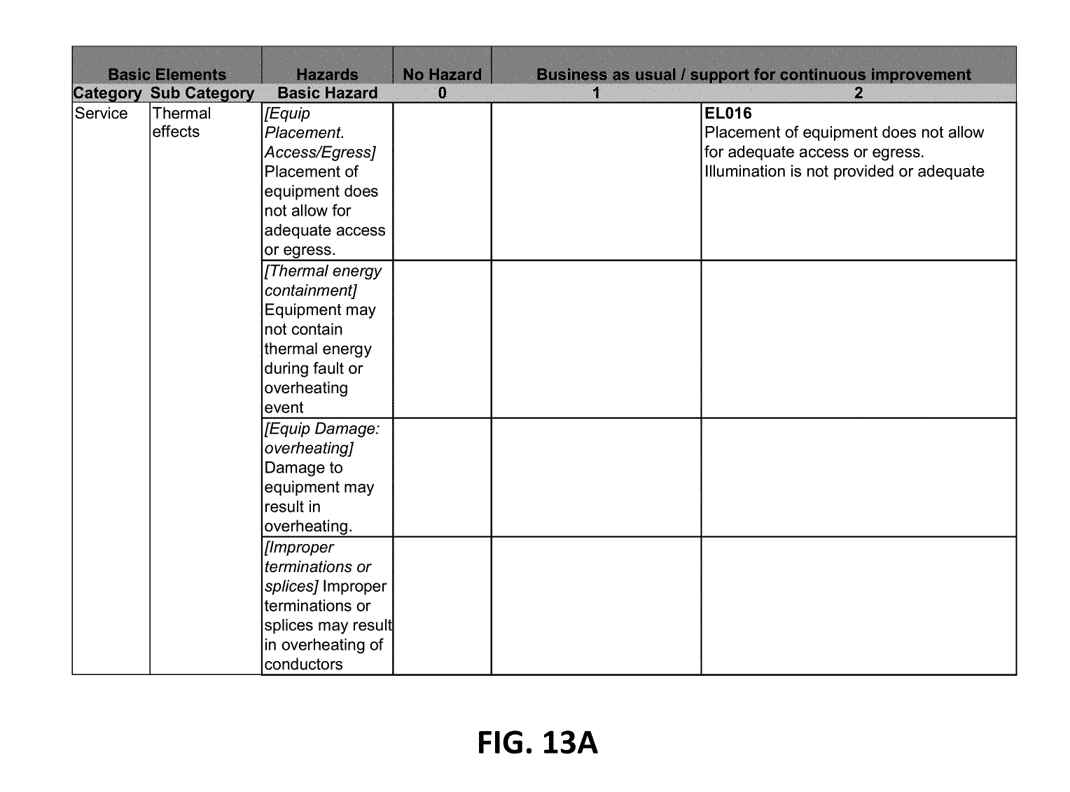

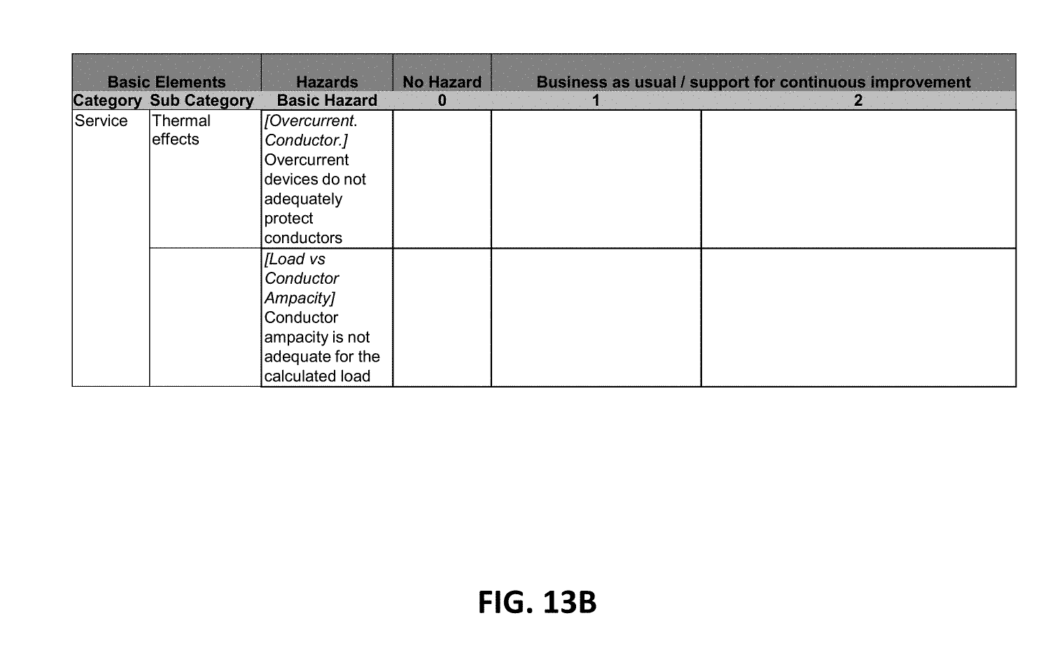

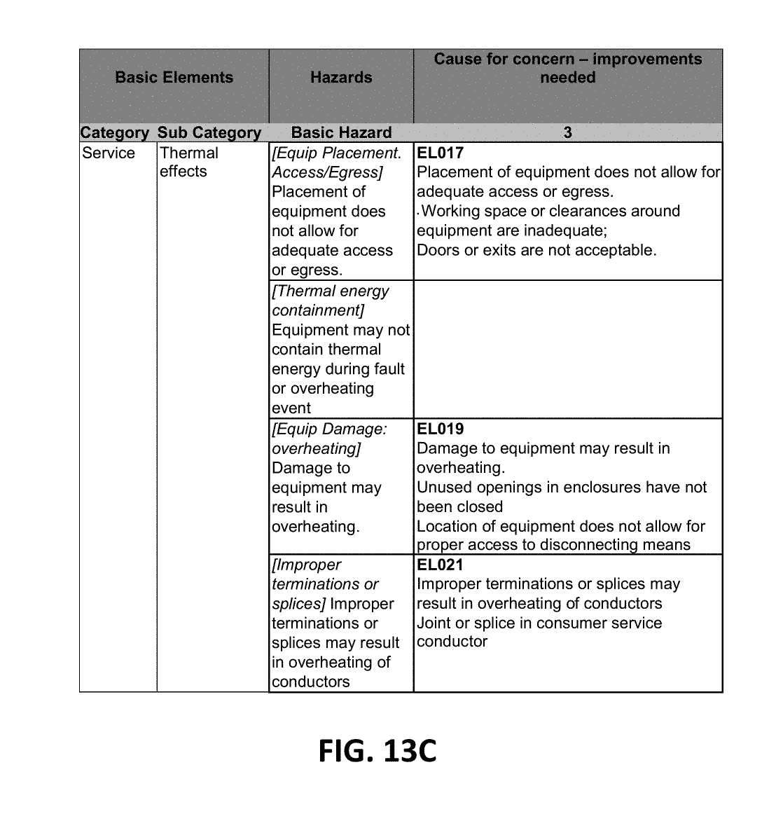

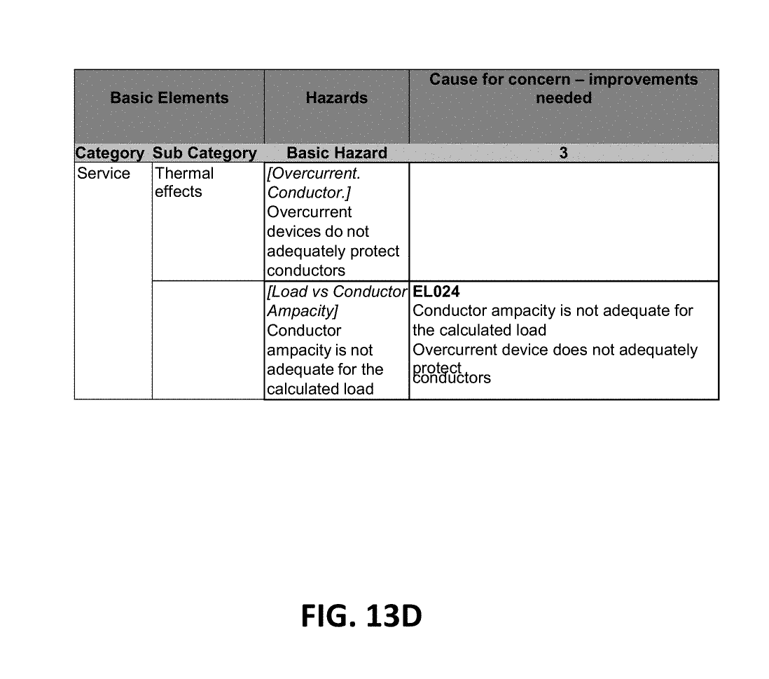

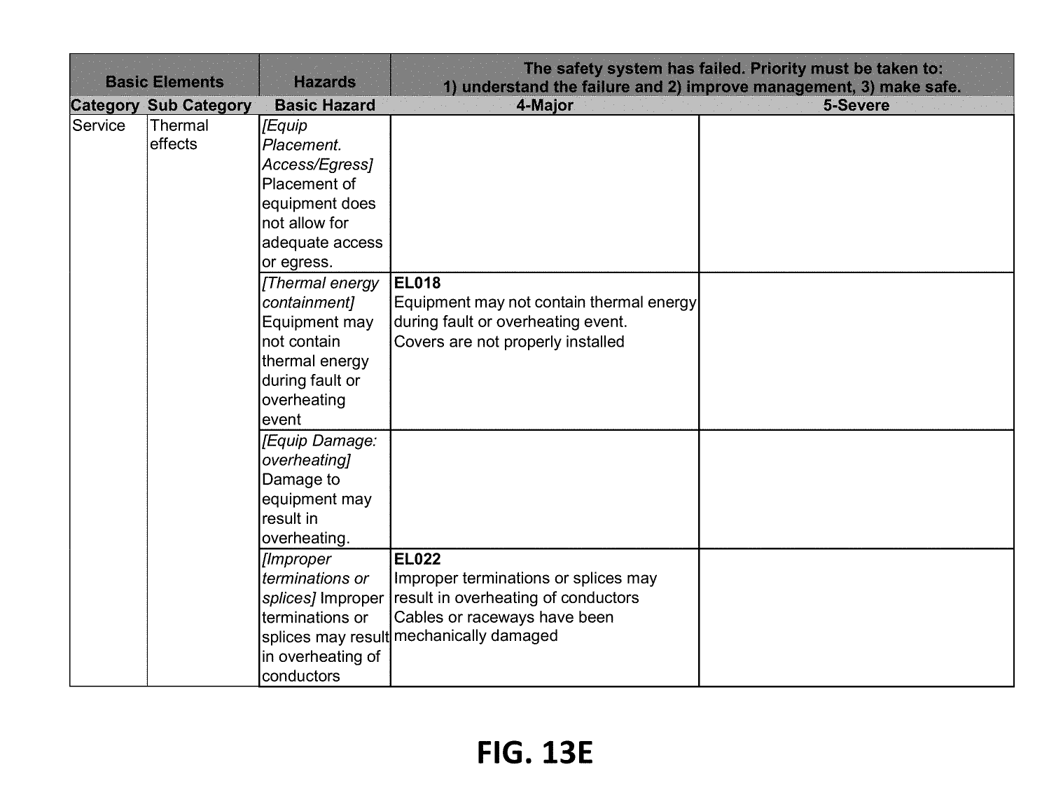

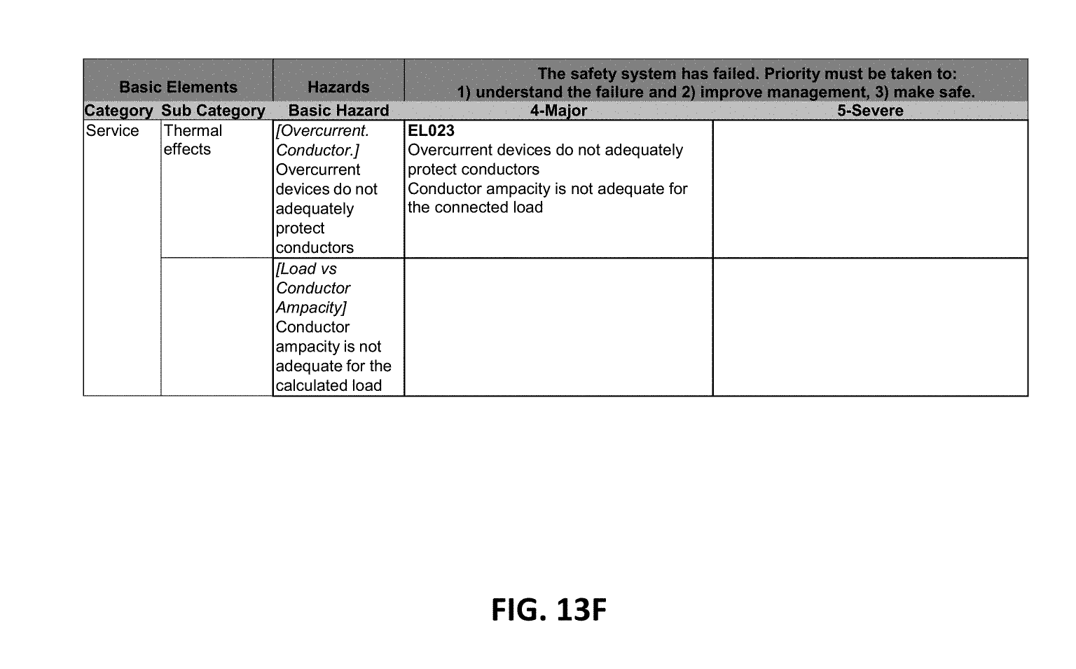

FIG. 13A shows Part 1 of the Hazard Map for Service—Thermal effects for 0 (No Hazard) and 1-2 (Business as usual/support for continuous improvement).

FIG. 13B shows Part 2 of the Hazard Map for Service—Thermal effects for 0 (No Hazard) and 1-2 (Business as usual/support for continuous improvement).

FIG. 13C shows Part 1 of the Hazard Map for Service—Thermal effects for 3 (Cause for concern).

FIG. 13D shows Part 2 of the Hazard Map for Service—Thermal effects for 3 (Cause for concern).

FIG. 13E shows Part 1 of the Hazard Map for Service—Thermal effects for 4-5 (The safety system has failed).

FIG. 13F shows Part 2 of the Hazard Map for Service—Thermal effects for 4-5 (The safety system has failed).

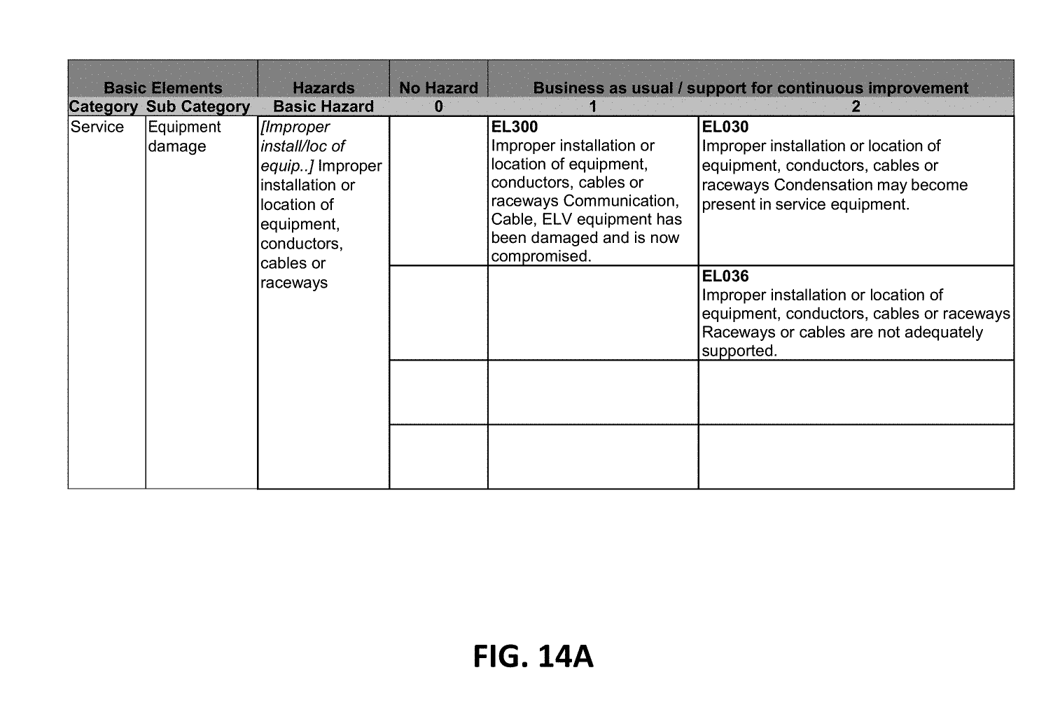

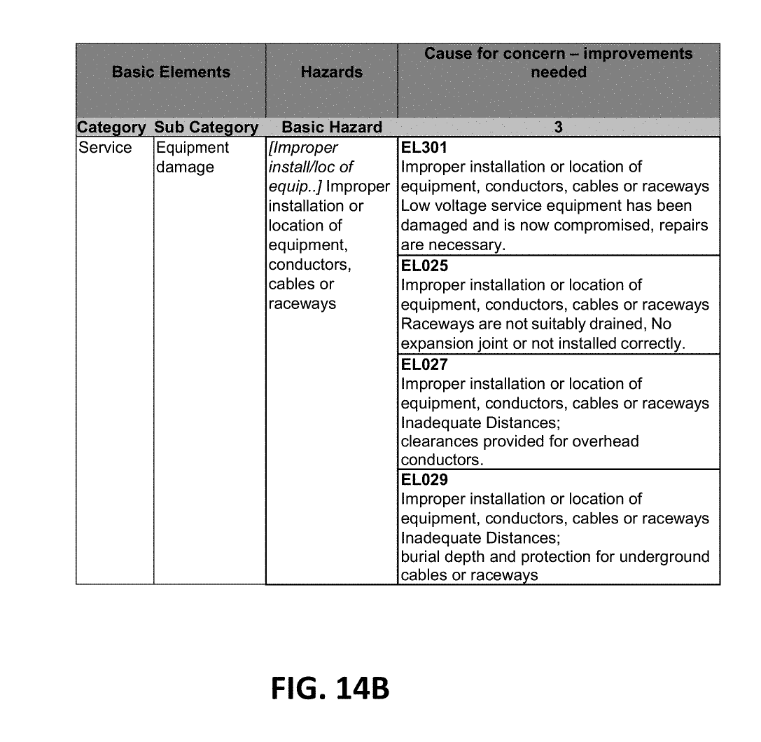

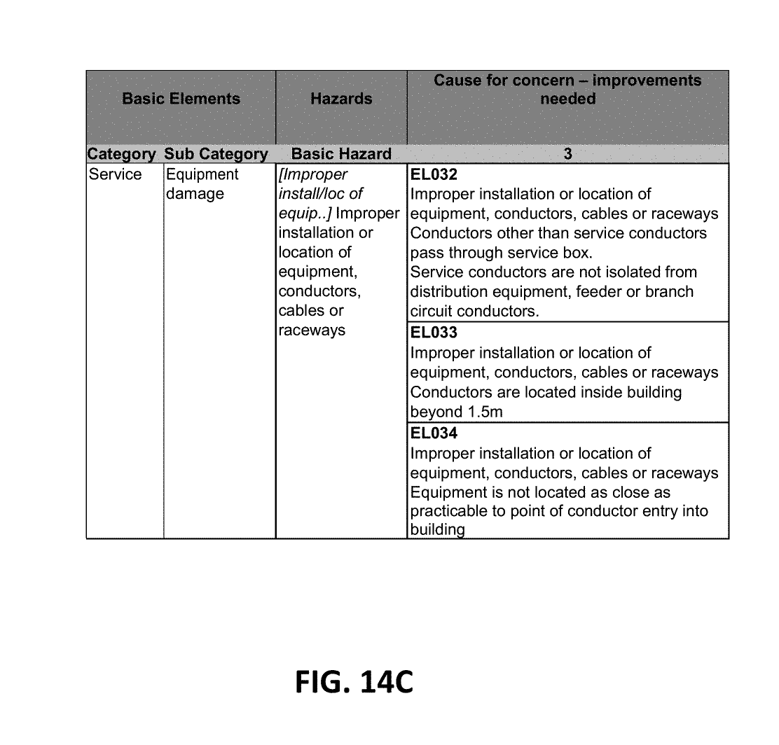

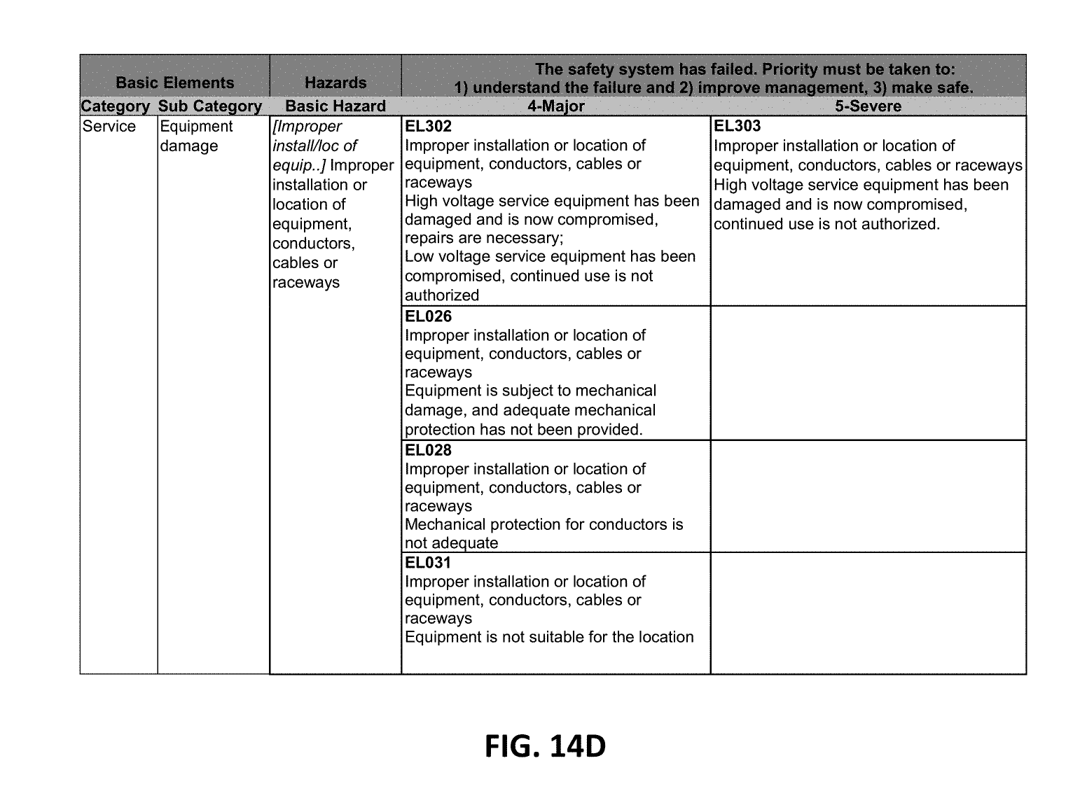

FIG. 14A shows the Hazard Map for Service—Equipment Damage for 0 (No Hazard) and 1-2 (Business as usual/support for continuous improvement).

FIG. 14B shows Part 1 of the Hazard Map for Service—Equipment Damage for 3 (Cause for concern).

FIG. 14C shows Part 2 of the Hazard Map for Service—Equipment Damage for 3 (Cause for concern).

FIG. 14D shows the Hazard Map for Service—Equipment Damage for 4-5 (The safety system has failed).

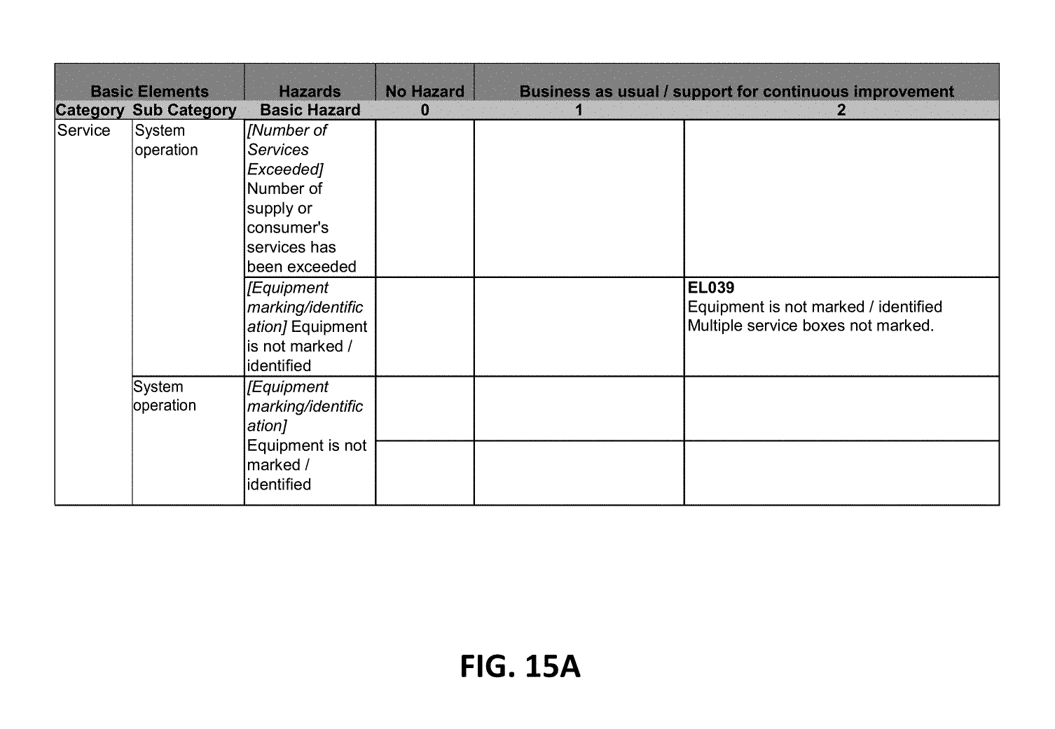

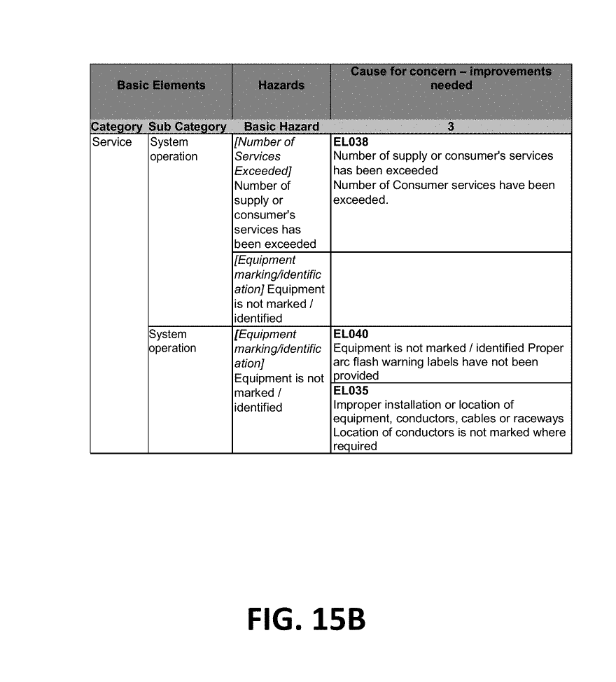

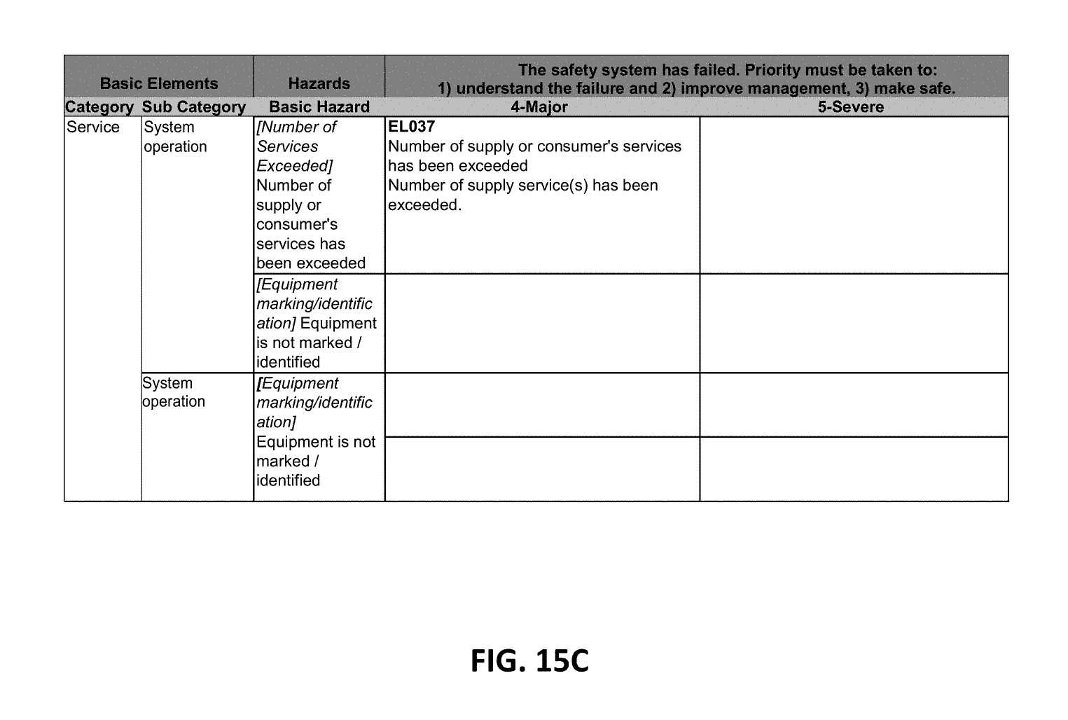

FIG. 15A shows the Hazard Map for Service—System Operation for 0 (No Hazard) and 1-2 (Business as usual/support for continuous improvement).

FIG. 15B shows the Hazard Map for Service—System Operation for 3 (Cause for concern).

FIG. 15C shows the Hazard Map for Service—System Operation for 4-5 (The safety system has failed).

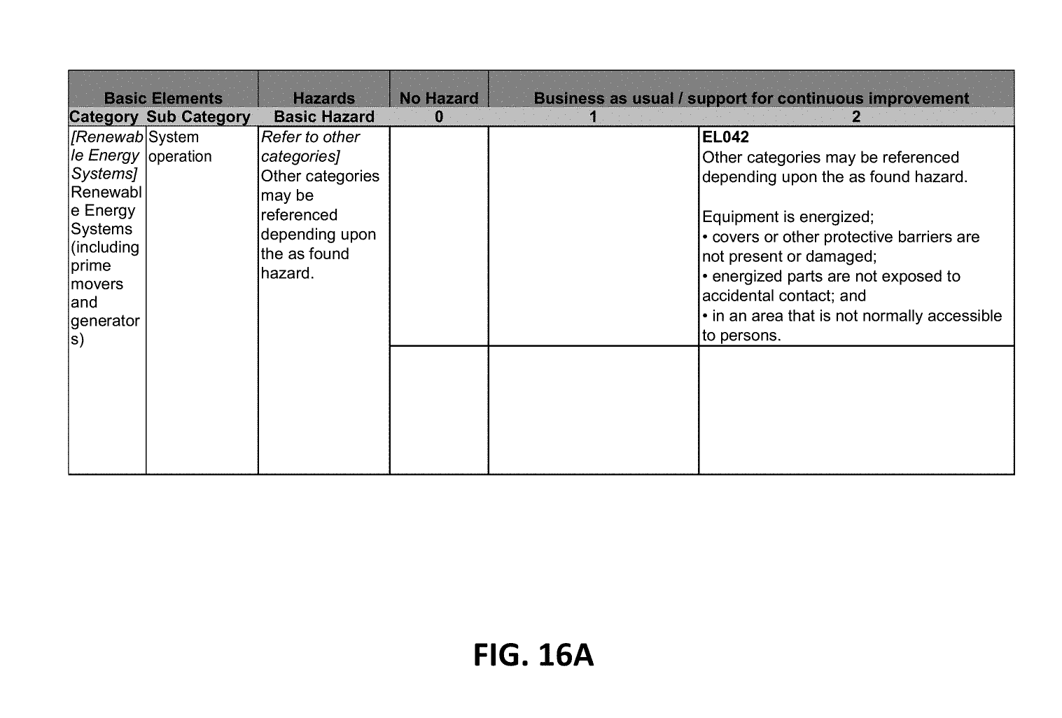

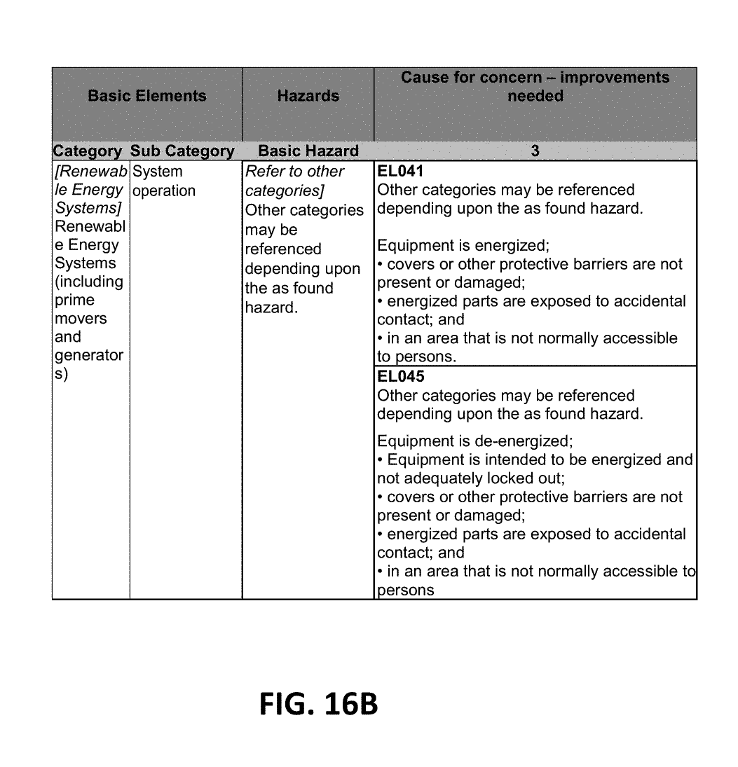

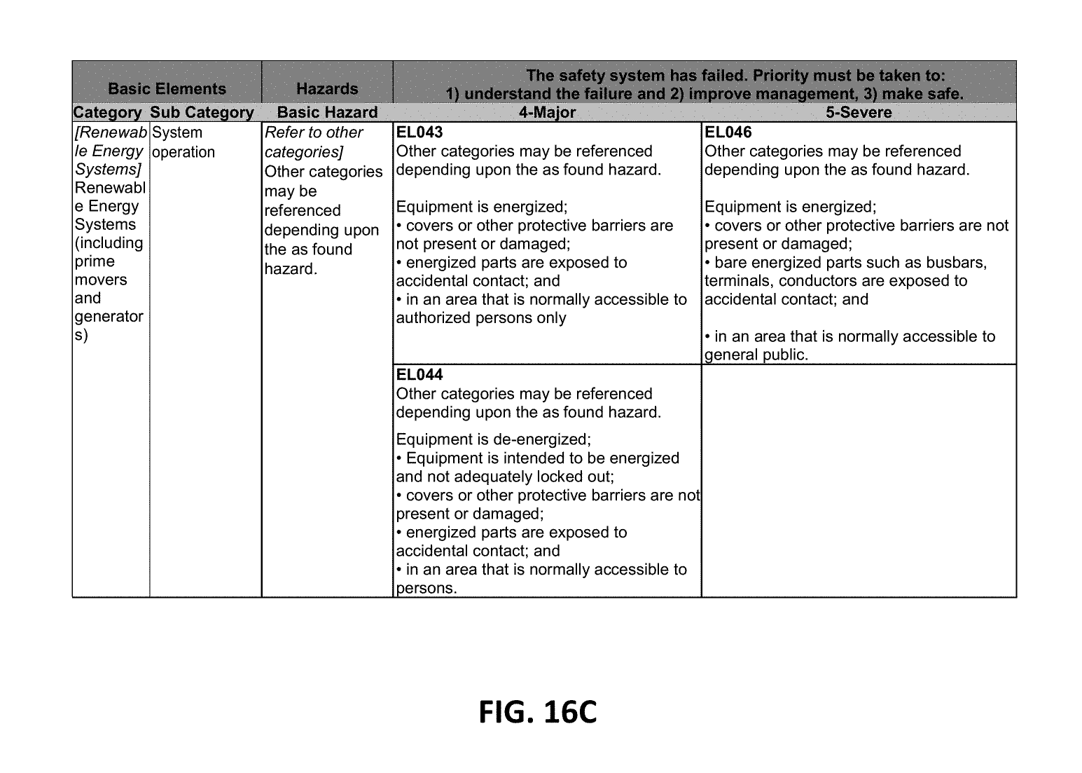

FIG. 16A shows the Hazard Map for Renewable Energy Systems—System Operation for 0 (No Hazard) and 1-2 (Business as usual/support for continuous improvement).

FIG. 16B shows the Hazard Map for Renewable Energy Systems—System Operation for 3 (Cause for concern).

FIG. 16C shows the Hazard Map for Renewable Energy Systems—System Operation for 4-5 (The safety system has failed).

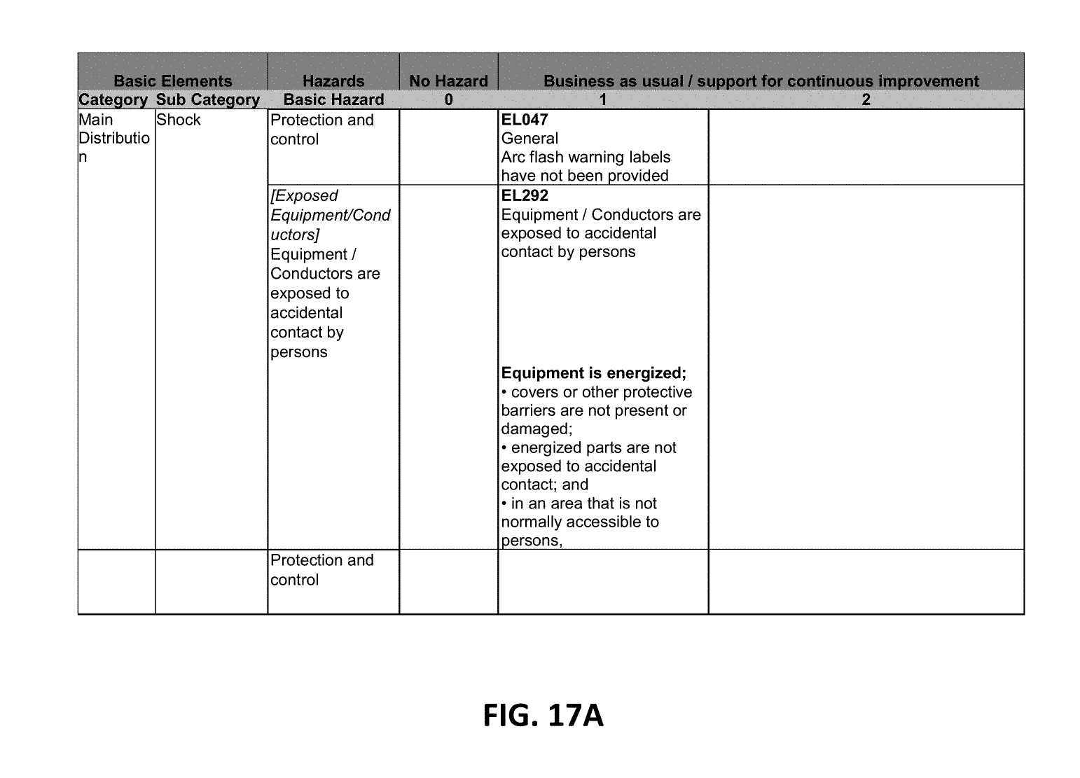

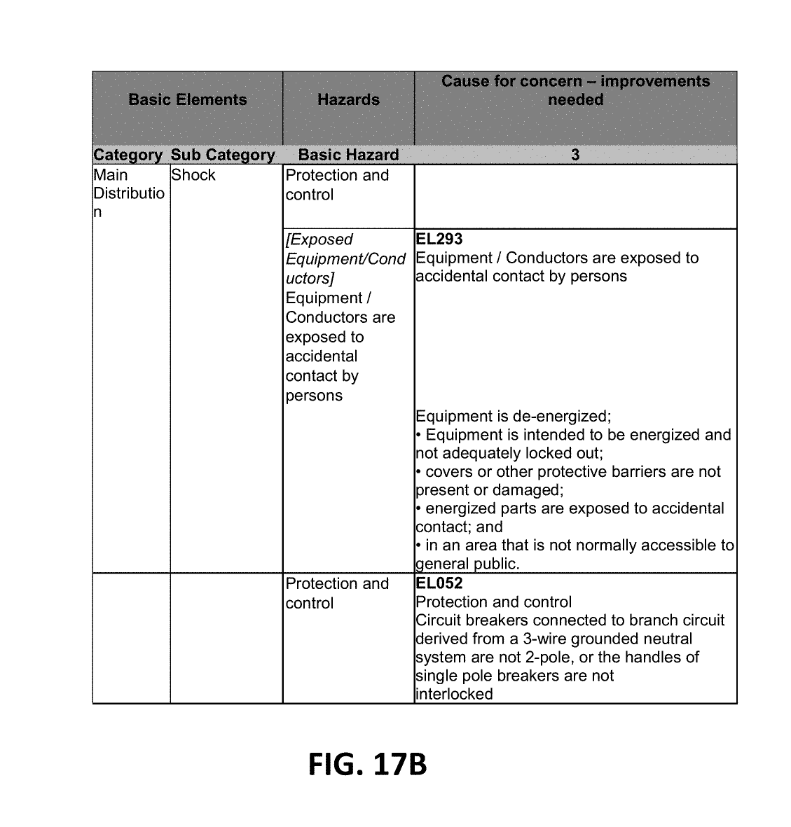

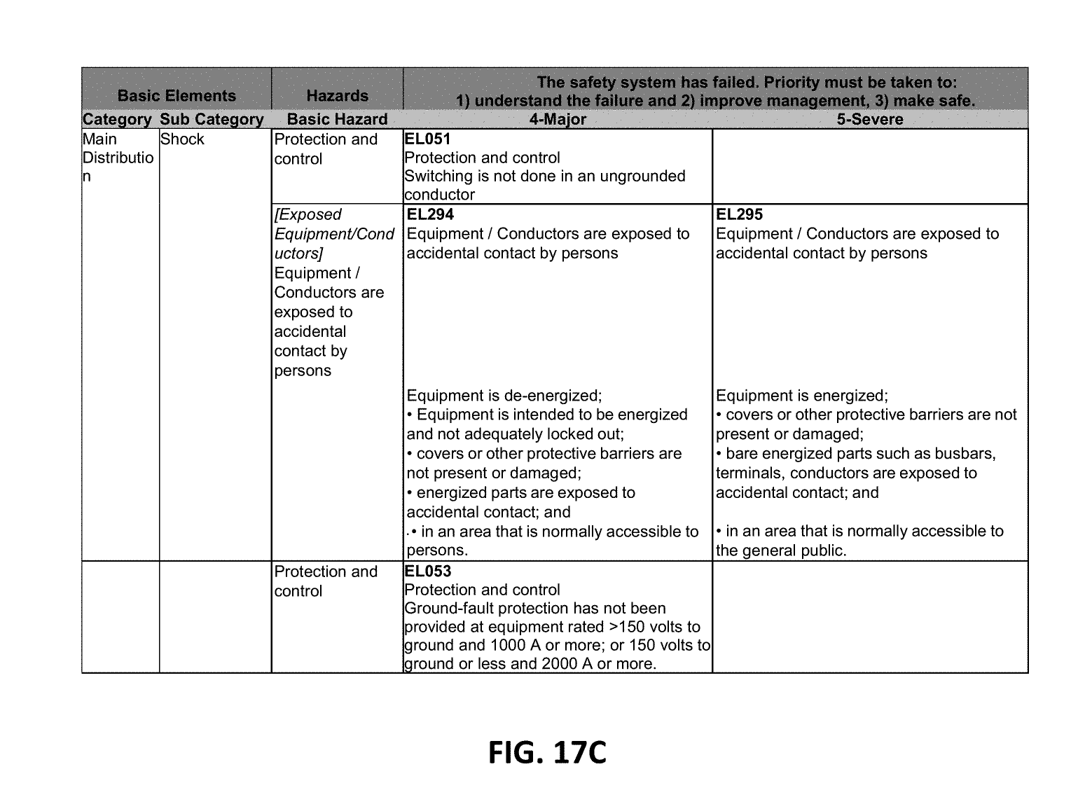

FIG. 17A shows the Hazard Map for Main Distribution—Shock for 0 (No Hazard) and 1-2 (Business as usual/support for continuous improvement).

FIG. 17B shows the Hazard Map for Main Distribution—Shock for 3 (Cause for concern).

FIG. 17C shows the Hazard Map for Main Distribution—Shock for 4-5 (The safety system has failed).

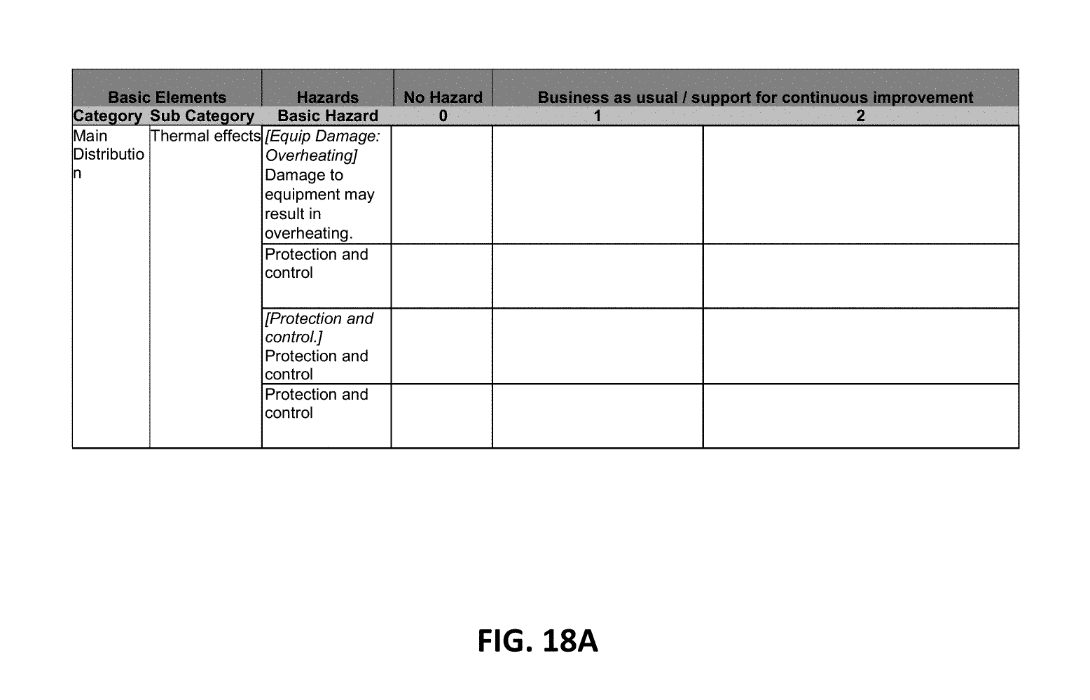

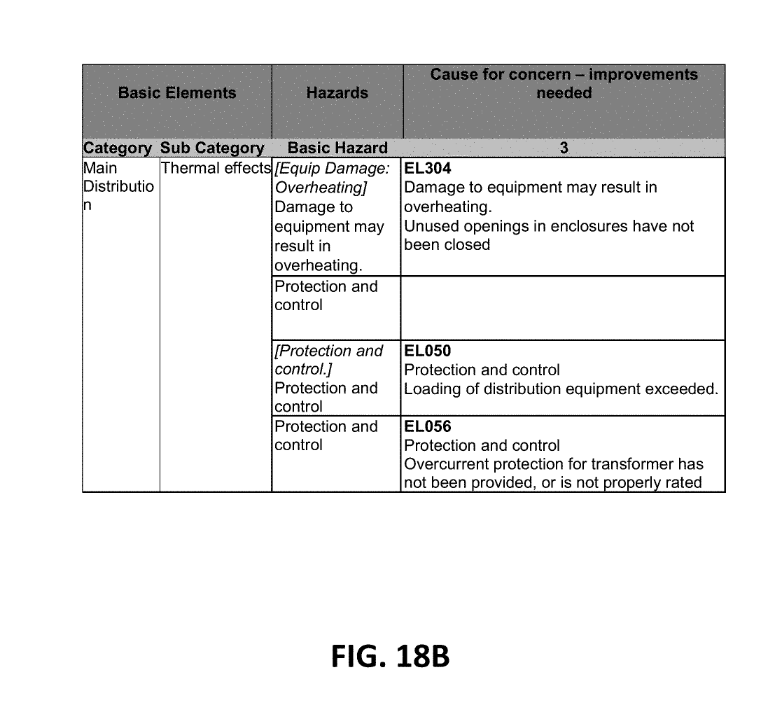

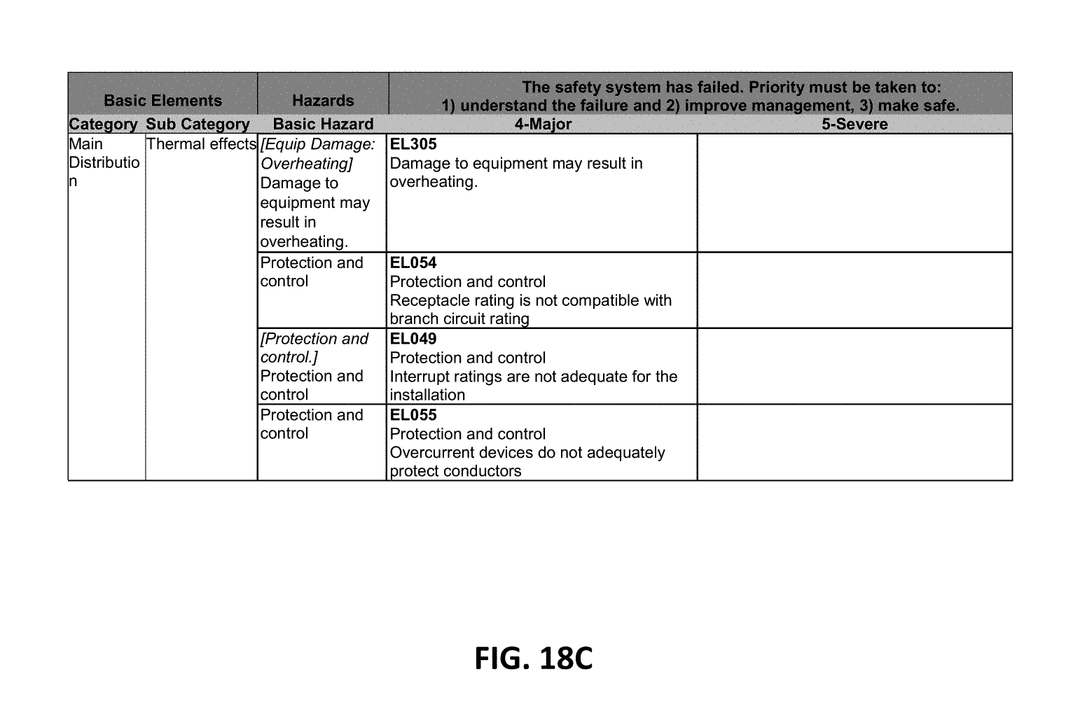

FIG. 18A shows the Hazard Map for Main Distribution—Thermal effects for 0 (No Hazard) and 1-2 (Business as usual/support for continuous improvement).

FIG. 18B shows the Hazard Map for Main Distribution—Thermal effects for 3 (Cause for concern).

FIG. 18C shows the Hazard Map for Main Distribution—Thermal effects for 4-5 (The safety system has failed).

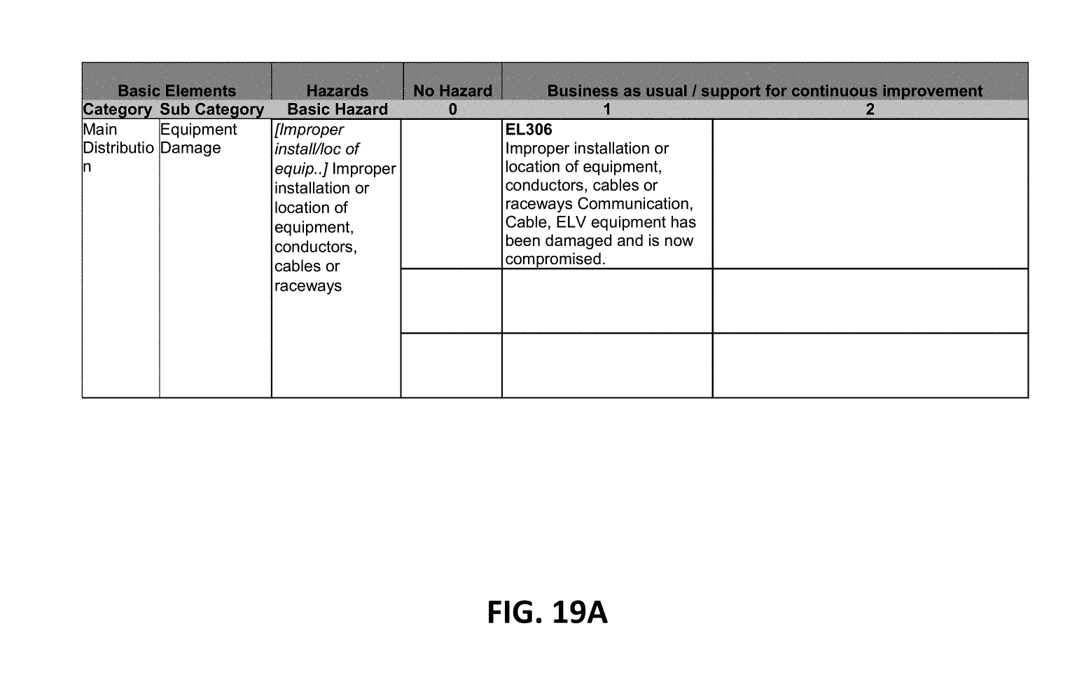

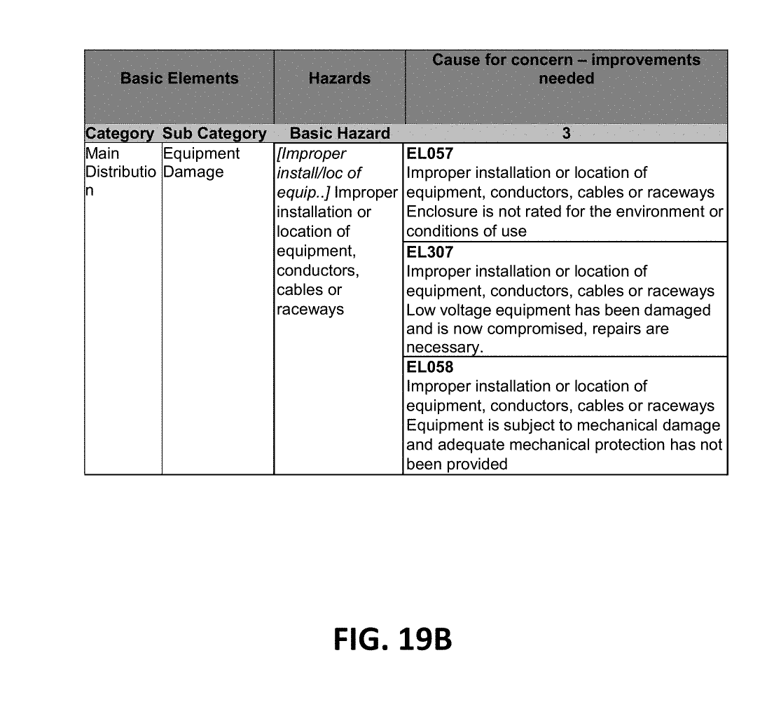

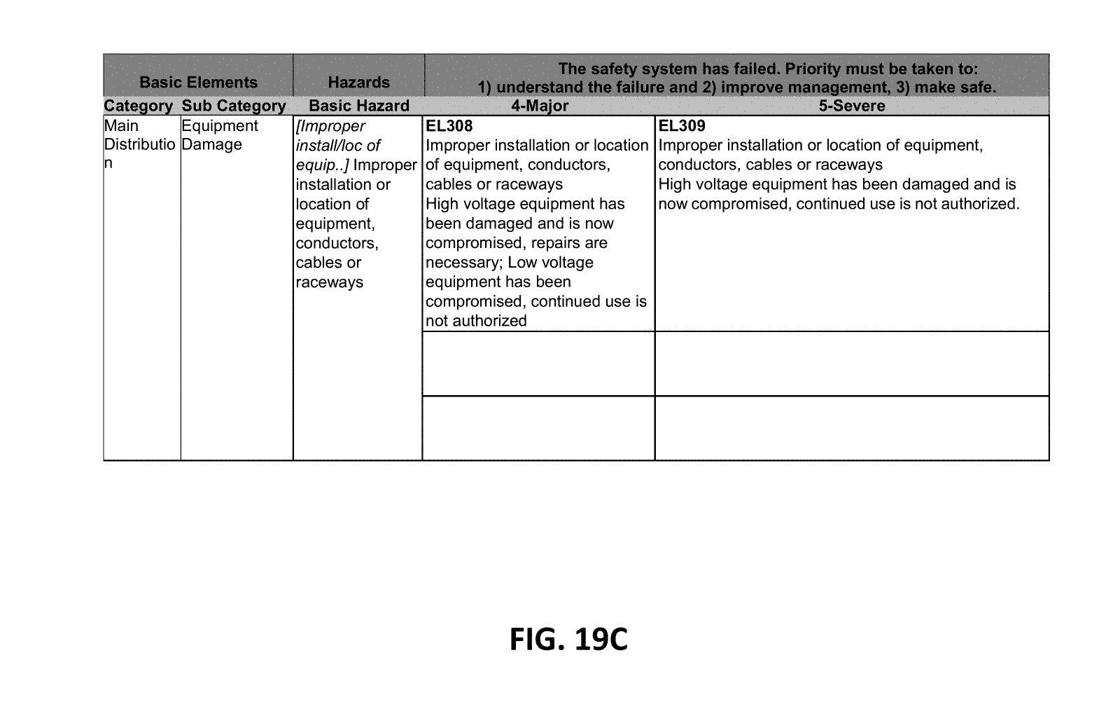

FIG. 19A shows the Hazard Map for Main Distribution—Equipment Damage for 0 (No Hazard) and 1-2 (Business as usual/support for continuous improvement).

FIG. 19B shows the Hazard Map for Main Distribution—Equipment Damage for 3 (Cause for concern).

FIG. 19C shows the Hazard Map for Main Distribution—Equipment Damage for 4-5 (The safety system has failed).

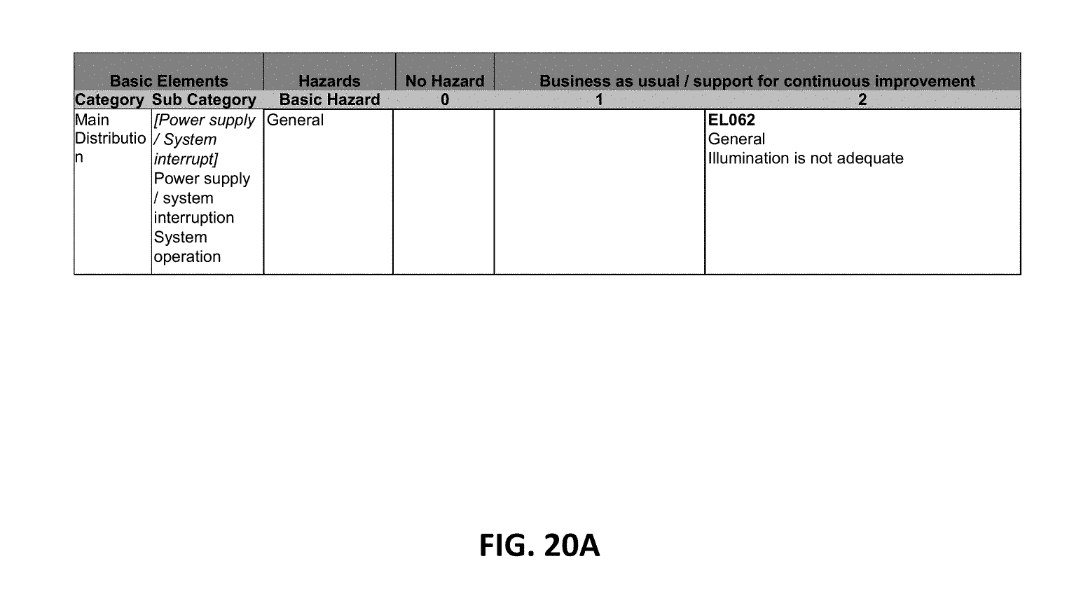

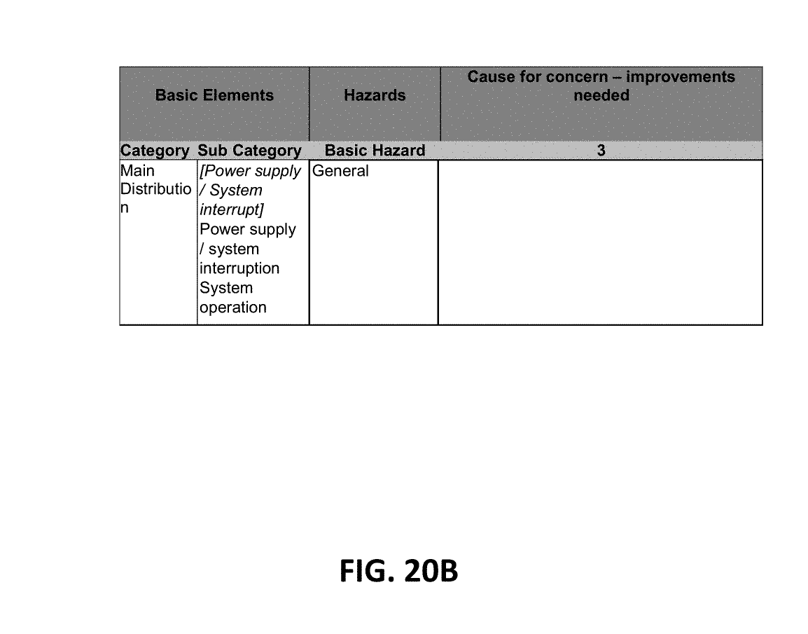

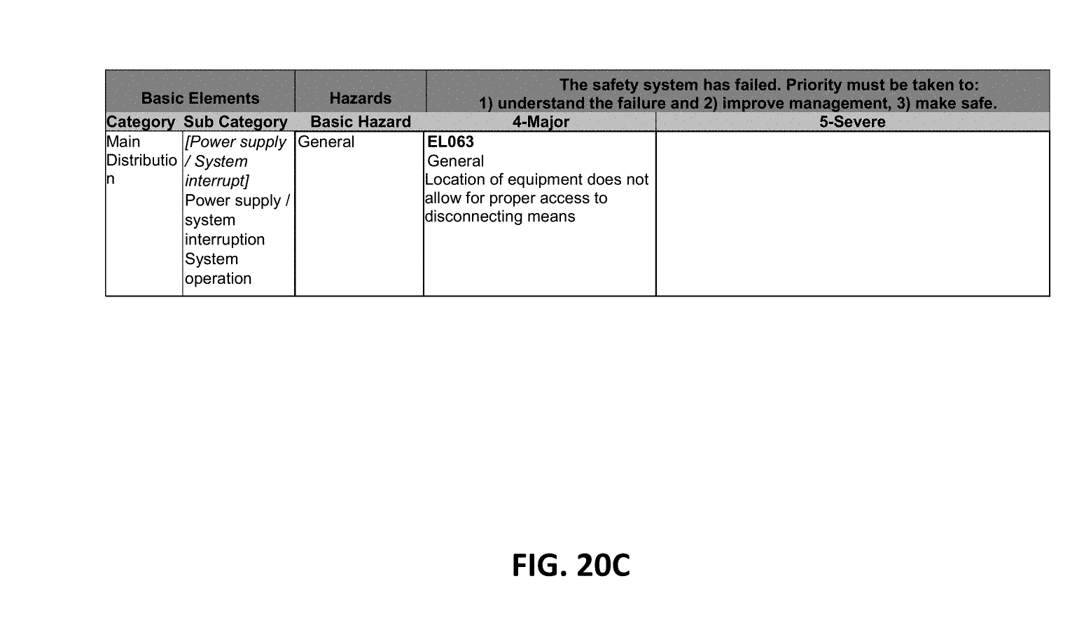

FIG. 20A shows the Hazard Map for Main Distribution—Power supply/system interruption for 0 (No Hazard) and 1-2 (Business as usual/support for continuous improvement).

FIG. 20B shows the Hazard Map for Main Distribution—Power supply/system interruption for 3 (Cause for concern).

FIG. 20C shows the Hazard Map for Main Distribution—Power supply/system interruption for 4-5 (The safety system has failed).

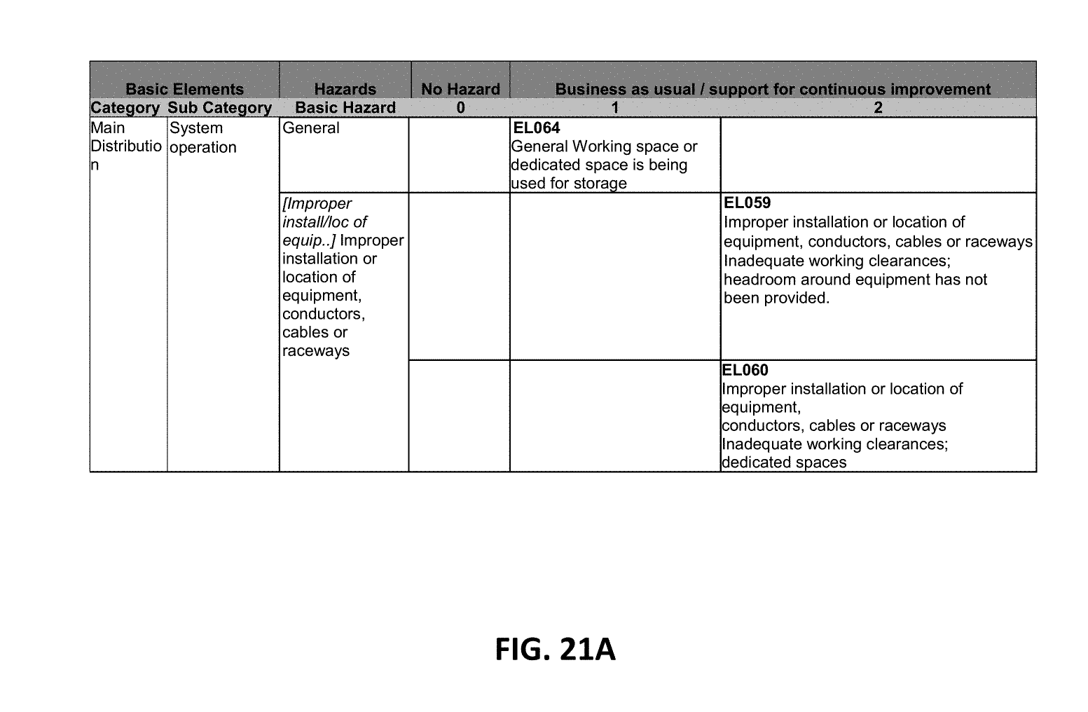

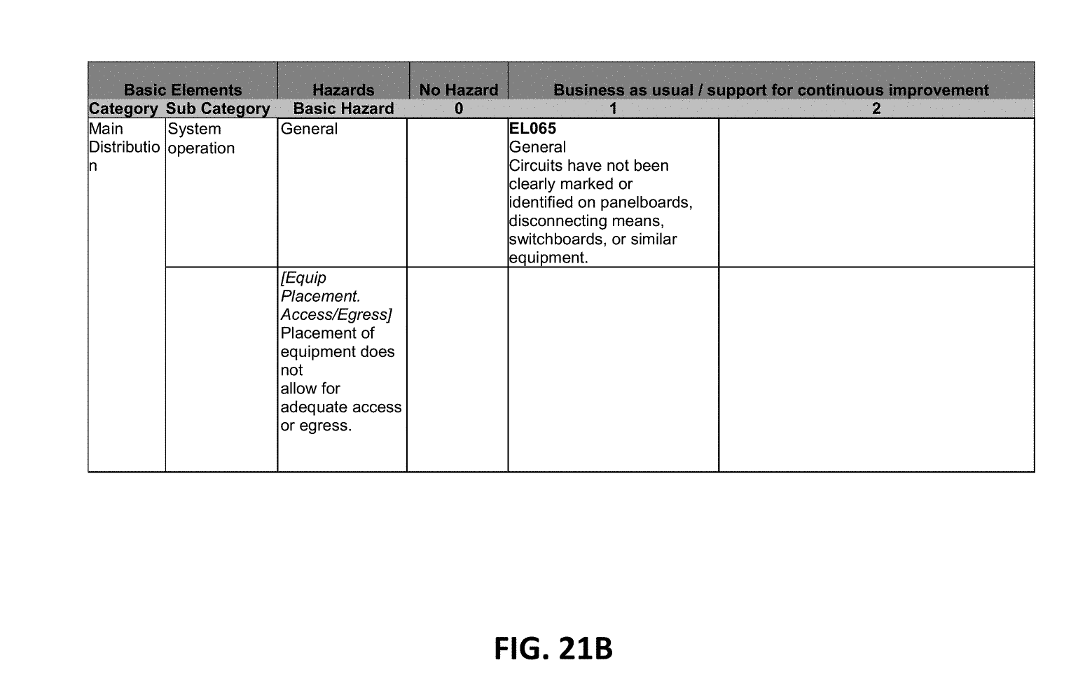

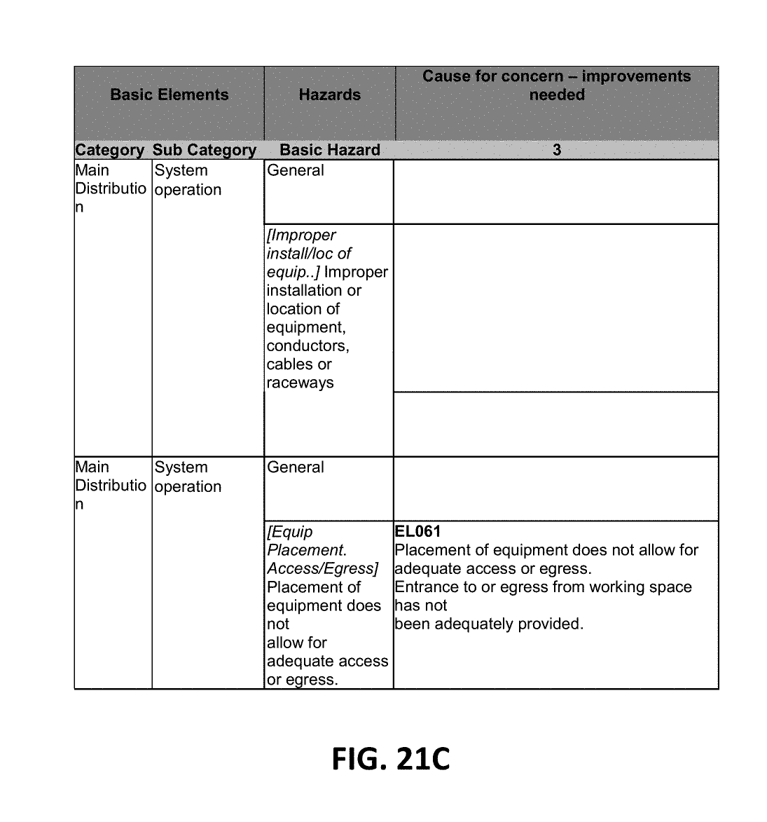

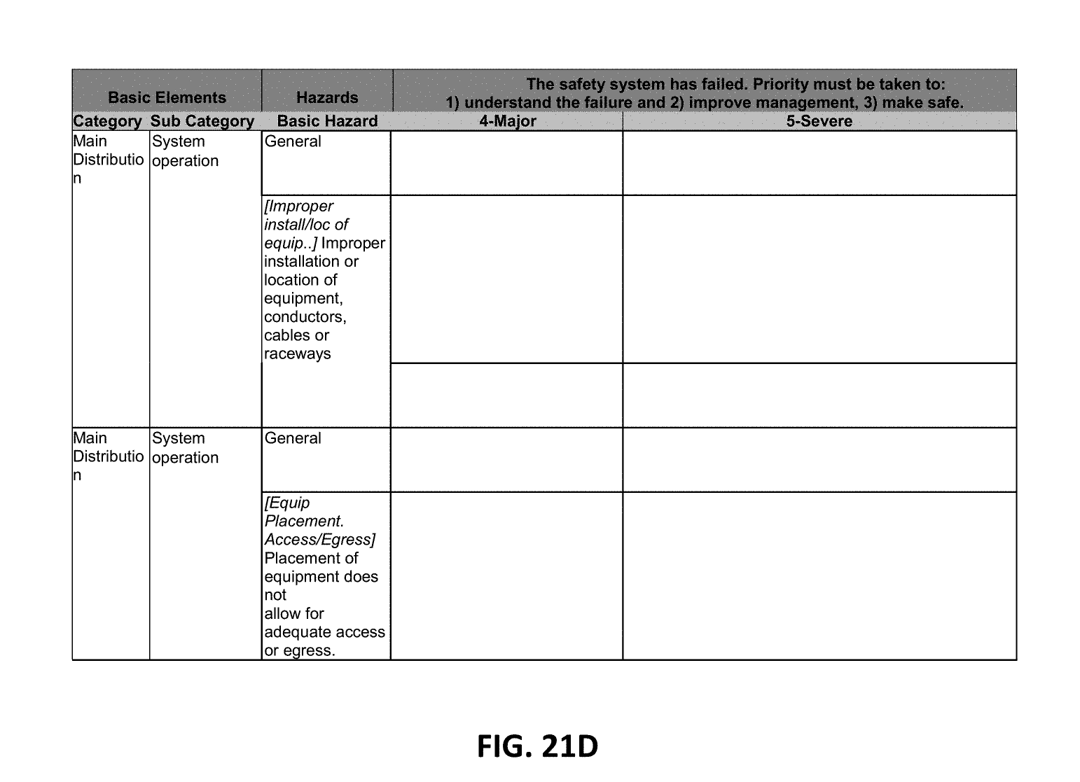

FIG. 21A shows Part 1 of the Hazard Map for Main Distribution—System operation for 0 (No Hazard) and 1-2 (Business as usual/support for continuous improvement).

FIG. 21B shows Part 2 of the Hazard Map for Main Distribution—System operation for 0 (No Hazard) and 1-2 (Business as usual/support for continuous improvement).

FIG. 21C shows Part 2 of the Hazard Map for Main Distribution—System operation for 3 (Cause for concern).

FIG. 21D shows Part 2 of the Hazard Map for Main Distribution—System operation for 4-5 (The safety system has failed).

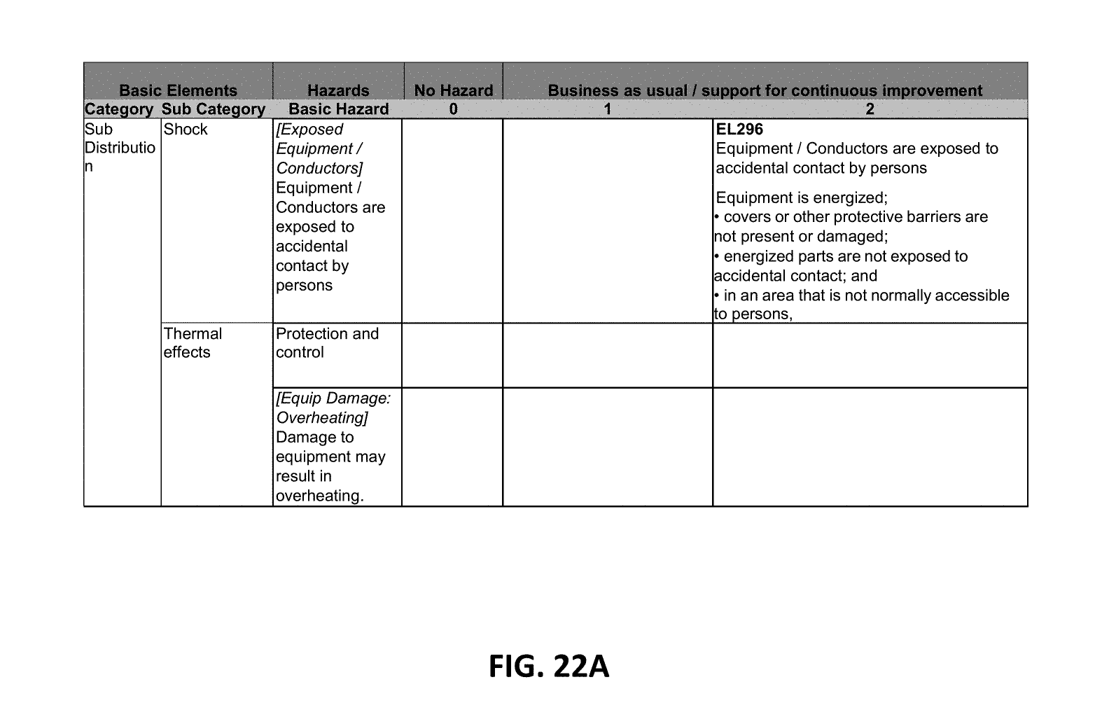

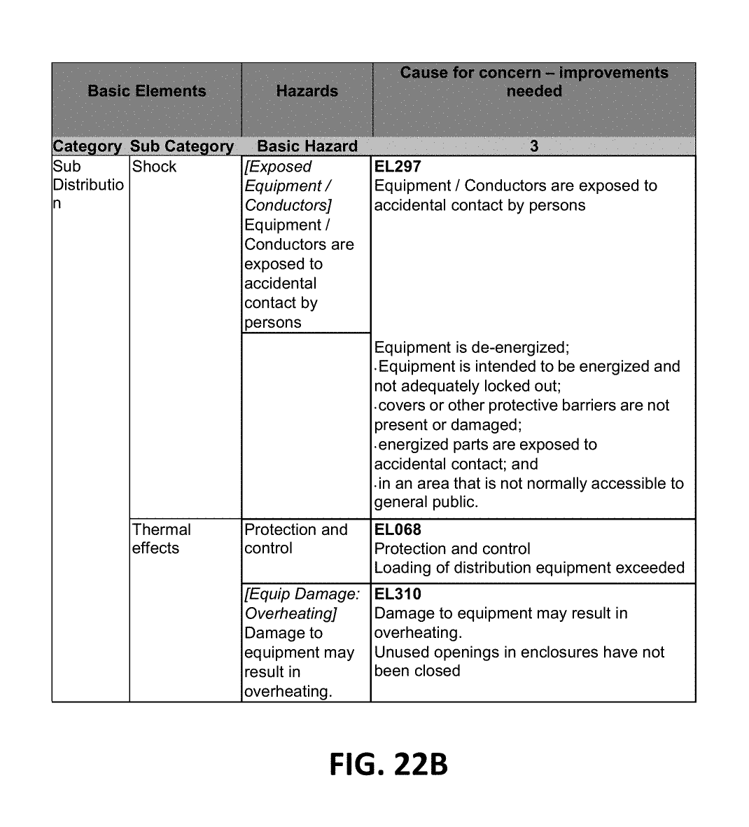

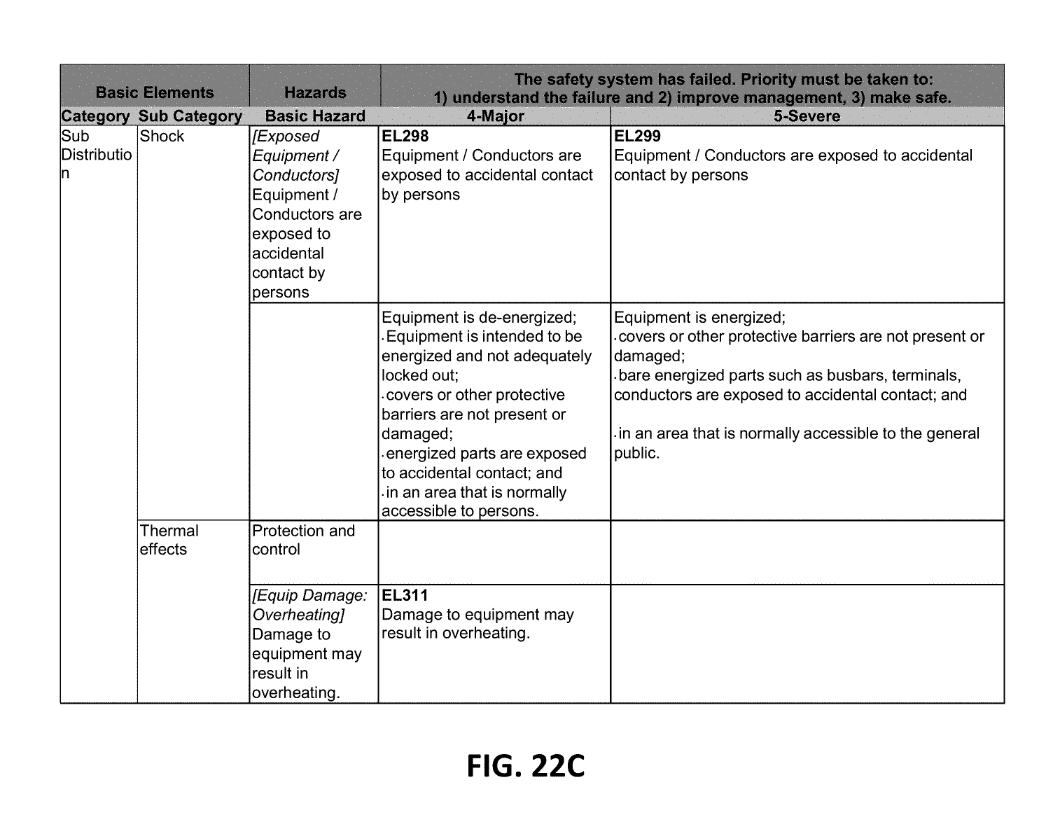

FIG. 22A shows the Hazard Map for Sub Distribution—Shock and Sub Distribution—Thermal effects for 0 (No Hazard) and 1-2 (Business as usual/support for continuous improvement).

FIG. 22B shows the Hazard Map for Sub Distribution—Shock and Sub Distribution—Thermal effects for 3 (Cause for concern).

FIG. 22C shows the Hazard Map for Sub Distribution—Shock and Sub Distribution—Thermal effects for 4-5 (The safety system has failed).

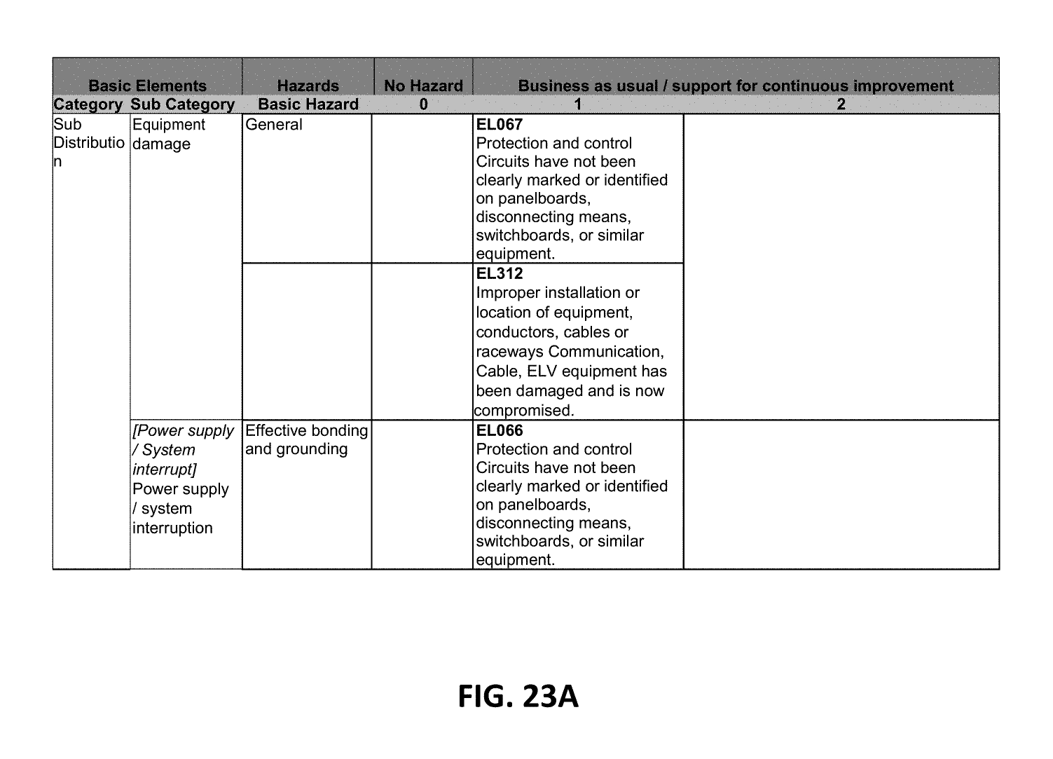

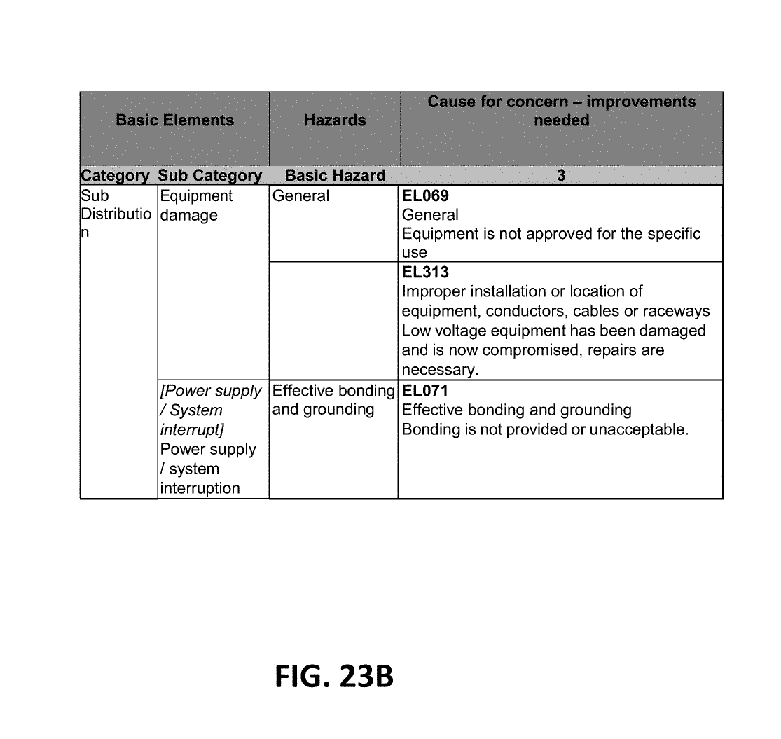

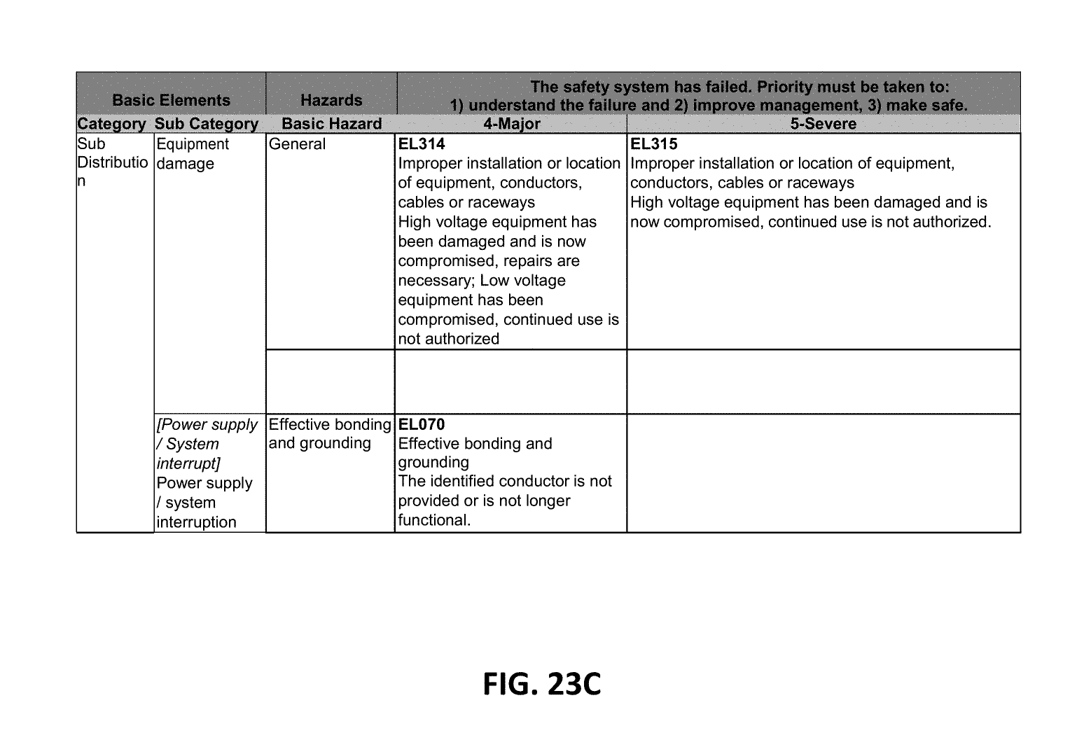

FIG. 23A shows the Hazard Map for Sub Distribution—Equipment damage and Sub Distribution—Power supply/system interruption for 0 (No Hazard) and 1-2 (Business as usual/support for continuous improvement).

FIG. 23B shows the Hazard Map for Sub Distribution—Equipment damage and Sub Distribution—Power supply/system interruption for 3 (Cause for concern).

FIG. 23C shows the Hazard Map for Sub Distribution—Equipment damage and Sub Distribution—Power supply/system interruption for 4-5 (The safety system has failed).

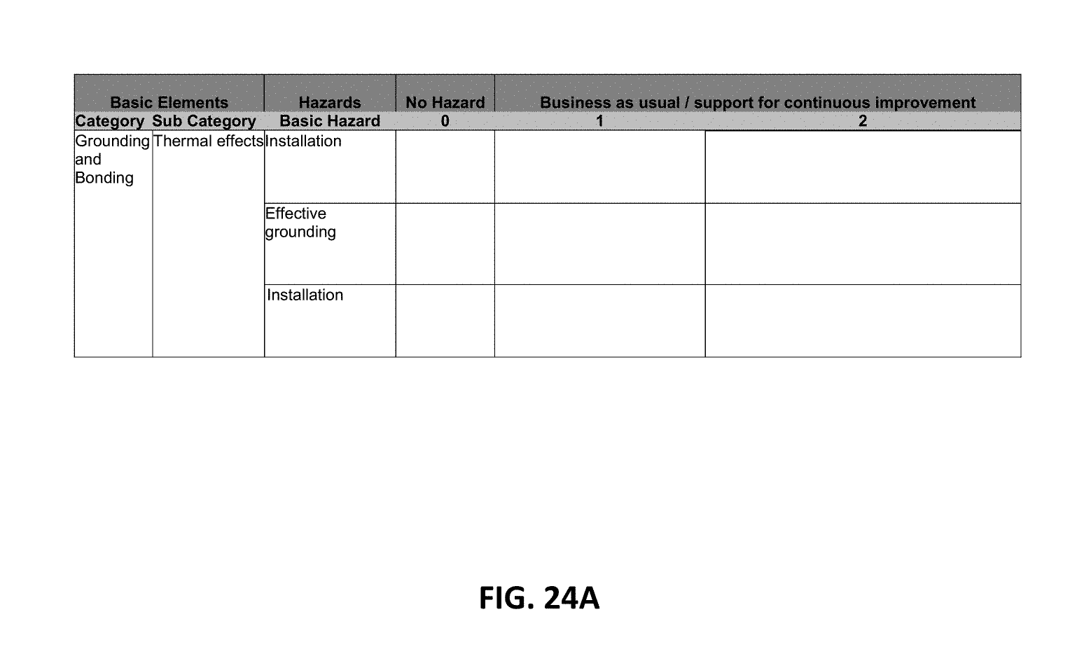

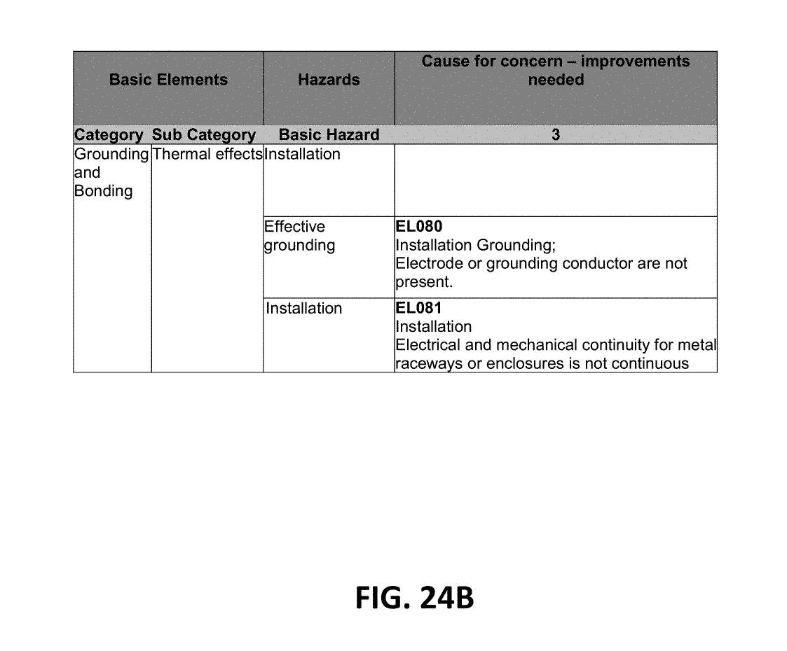

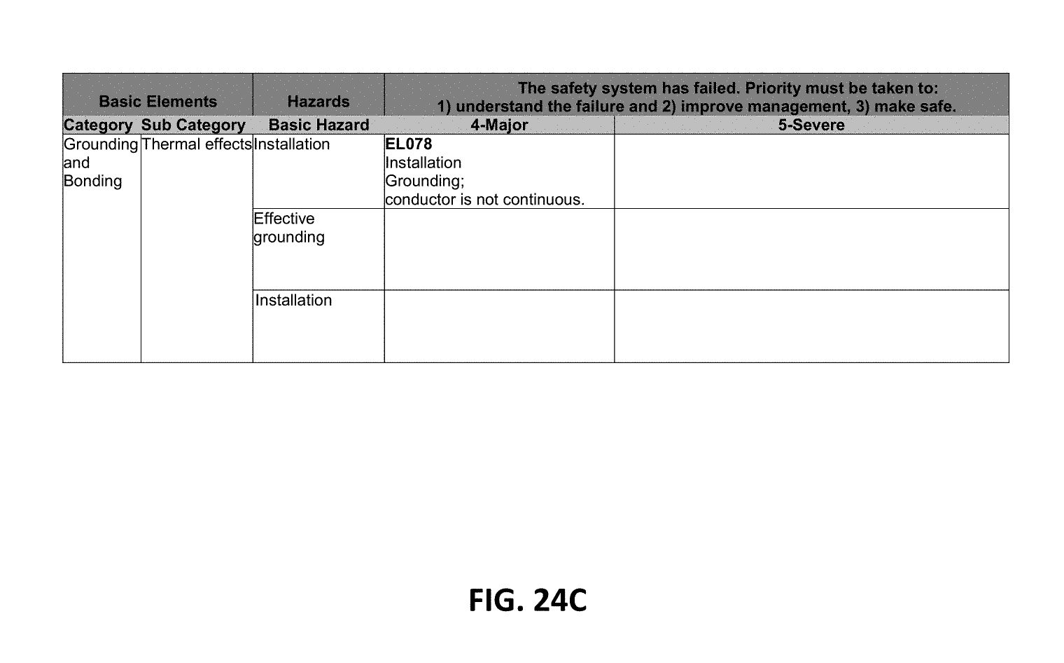

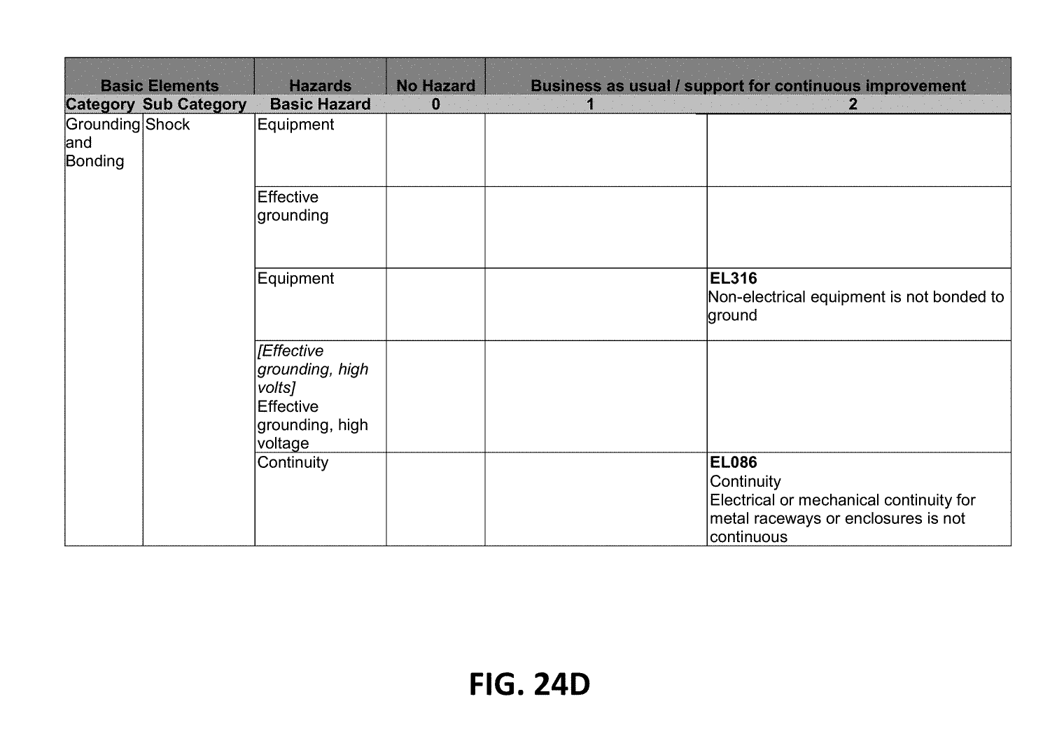

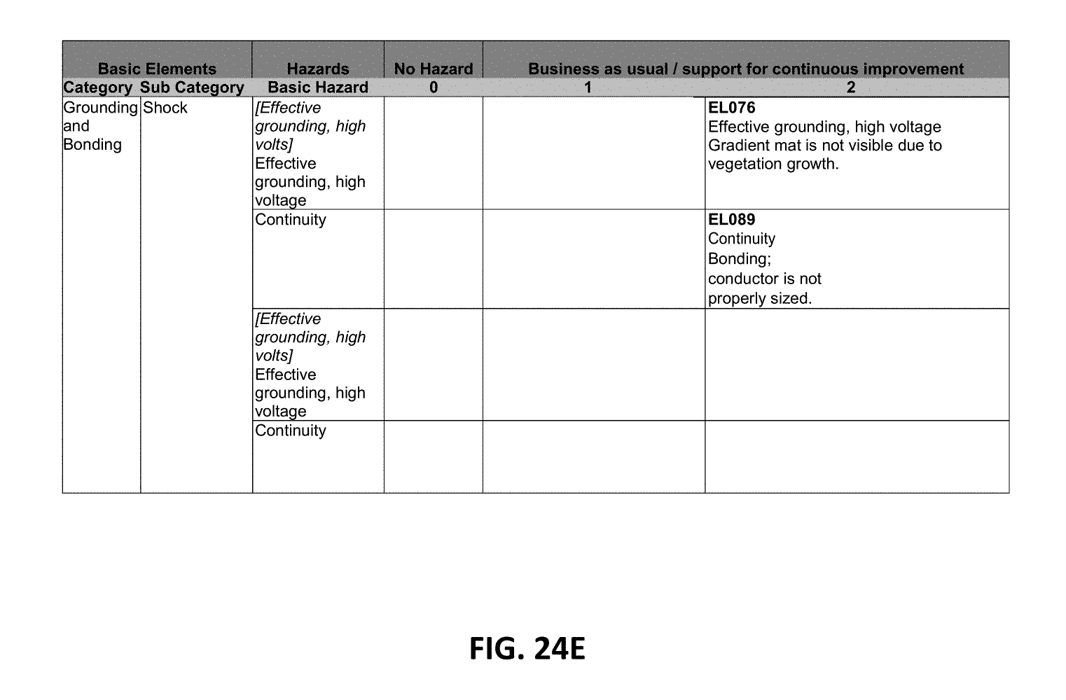

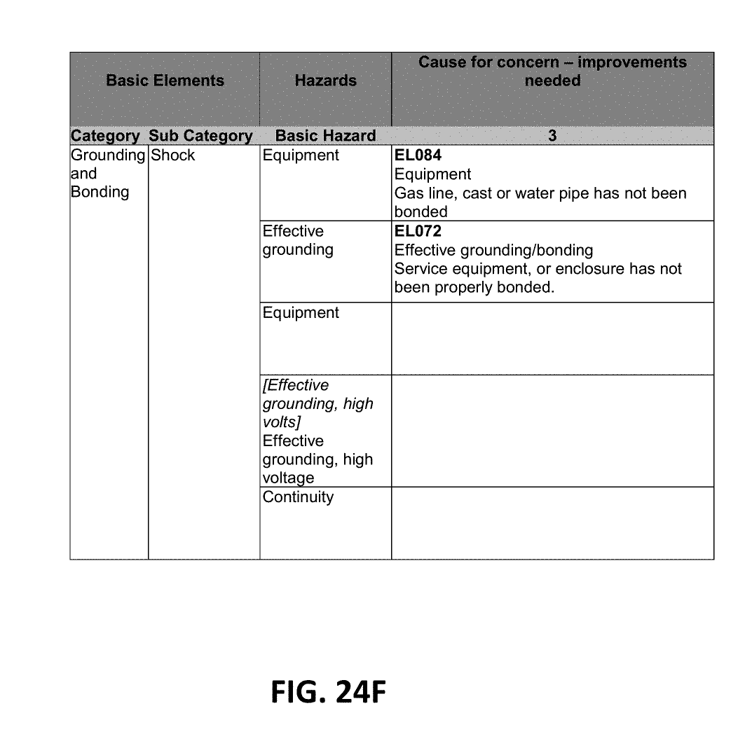

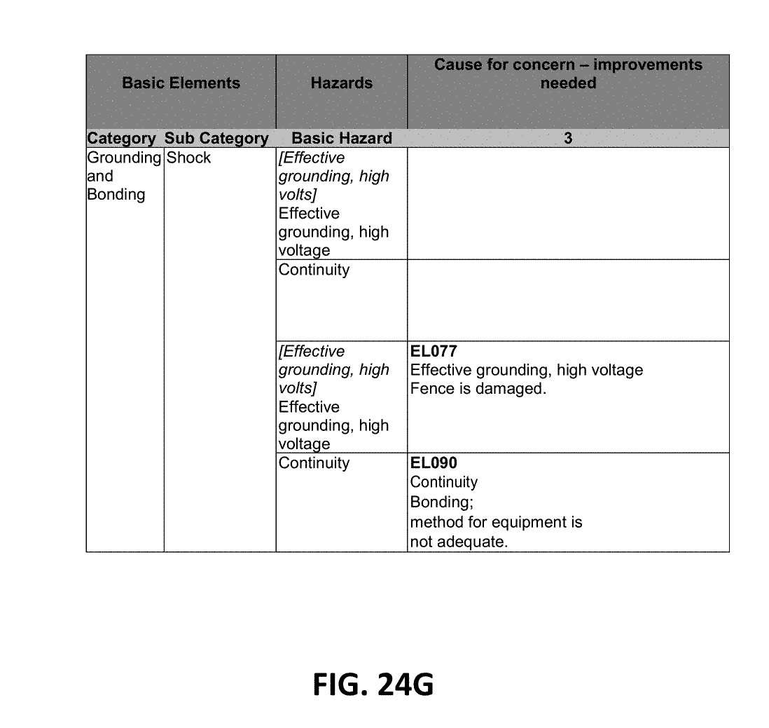

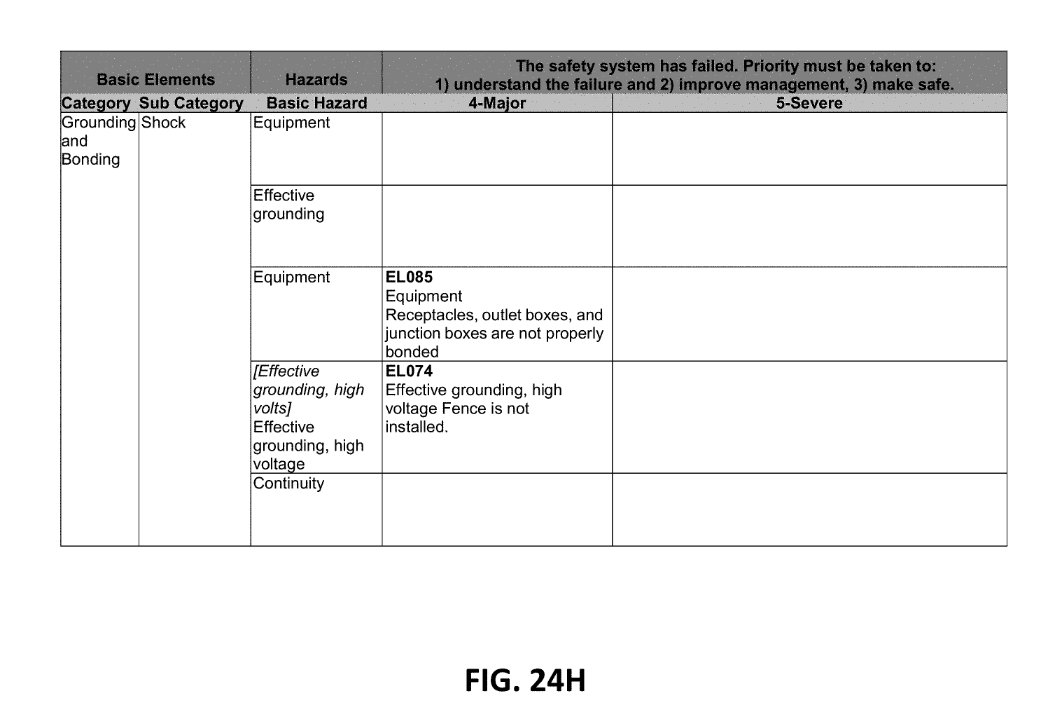

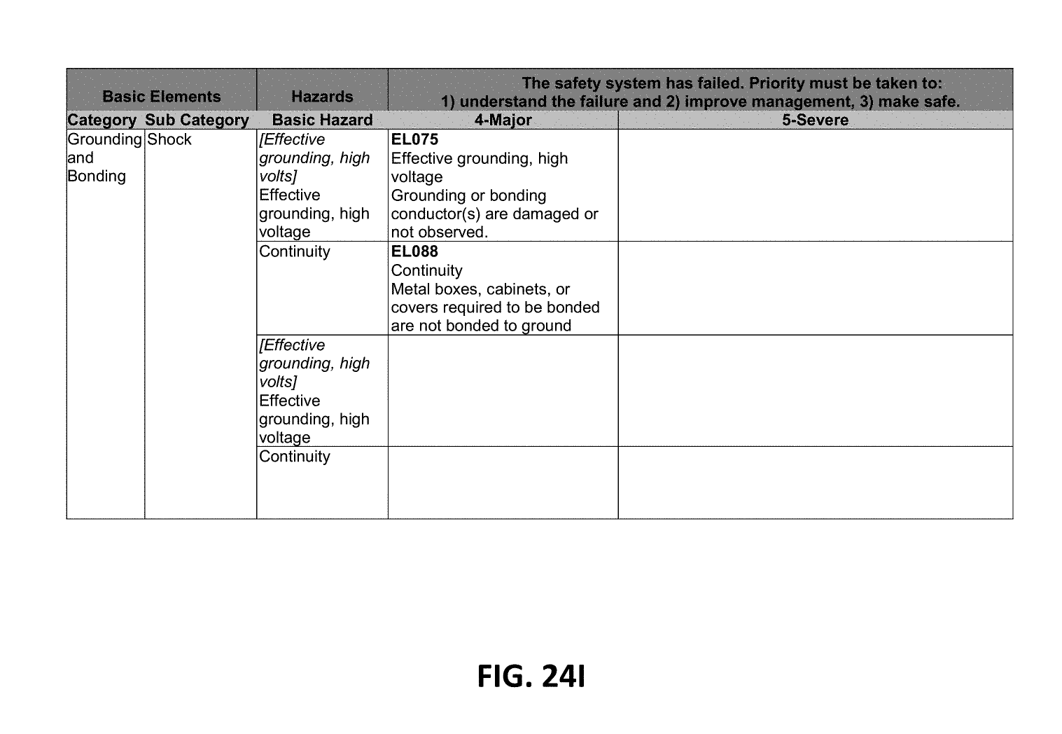

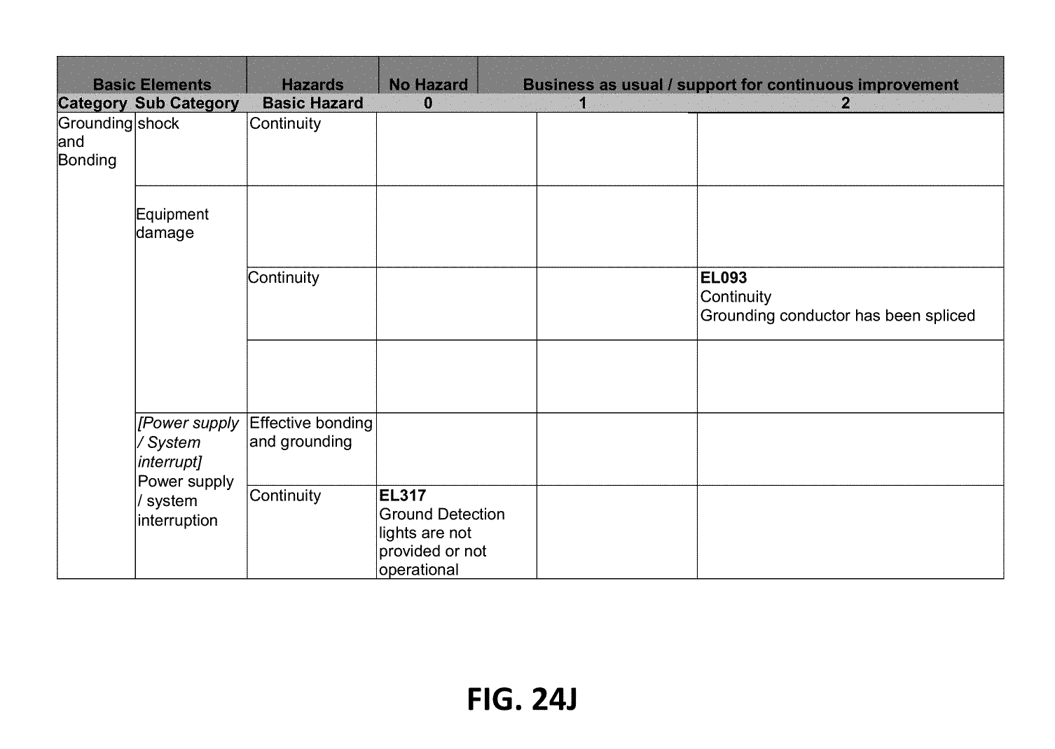

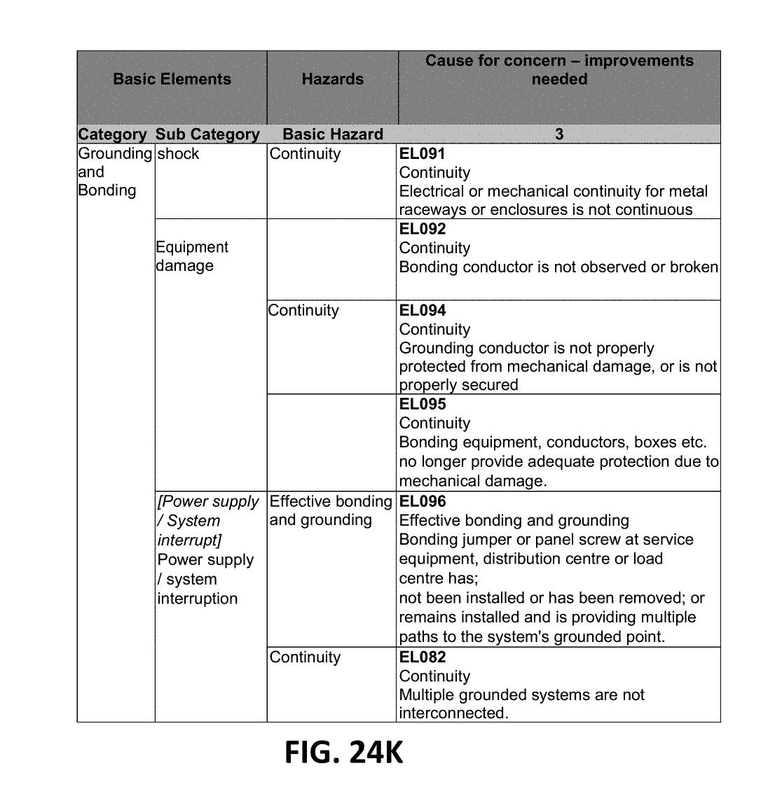

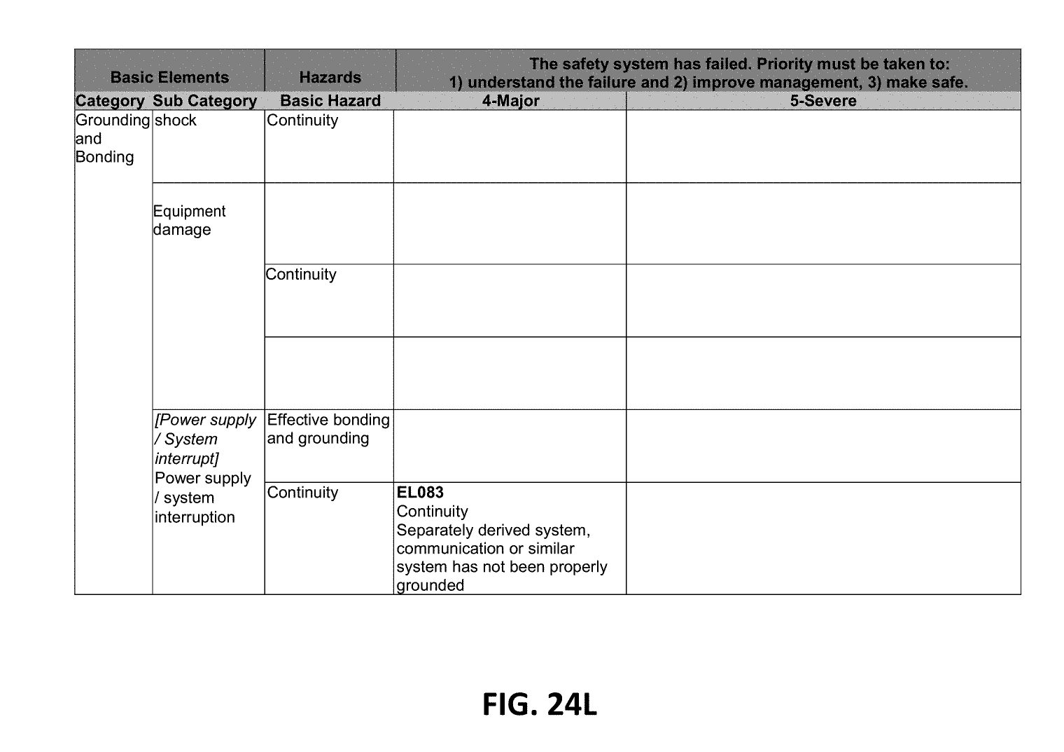

FIG. 24A shows the Hazard Map for Grounding and Bonding—Thermal effects for 0 (No Hazard) and 1-2 (Business as usual/support for continuous improvement).

FIG. 24B shows the Hazard Map for Grounding and Bonding—Thermal effects for 3 (Cause for concern).

FIG. 24C shows the Hazard Map for Grounding and Bonding—Thermal effects for 4-5 (The safety system has failed).

FIG. 24D shows Part 1 of the Hazard Map for Grounding and Bonding—Shock for 0 (No Hazard) and 1-2 (Business as usual/support for continuous improvement).

FIG. 24E shows Part 2 of the Hazard Map for Grounding and Bonding—Shock for 0 (No Hazard) and 1-2 (Business as usual/support for continuous improvement).

FIG. 24F shows Part 1 of the Hazard Map for Grounding and Bonding—Shock for 3 (Cause for concern).

FIG. 24G shows Part 2 of the Hazard Map for Grounding and Bonding—Shock for 3 (Cause for concern).

FIG. 24H shows Part 1 of the Hazard Map for Grounding and Bonding—Shock for 4-5 (The safety system has failed).

FIG. 24I shows Part 2 of the Hazard Map for Grounding and Bonding—Shock for 4-5 (The safety system has failed).

FIG. 24J shows Part 3 of the Hazard Map for Grounding and Bonding—Shock, the Hazard Map for Grounding and Bonding—Equipment damage and Grounding and Bonding—Poser supply/system interruption for 0 (No Hazard) and 1-2 (Business as usual/support for continuous improvement).

FIG. 24K shows Part 3 of the Hazard Map for Grounding and Bonding—Shock, the Hazard Map for Grounding and Bonding—Equipment damage and Grounding and Bonding—Poser supply/system interruption for 3 (Cause for concern).

FIG. 24L shows Part 3 of the Hazard Map for Grounding and Bonding—Shock, the Hazard Map for Grounding and Bonding—Equipment damage and Grounding and Bonding—Poser supply/system interruption for 4-5 (The safety system has failed).

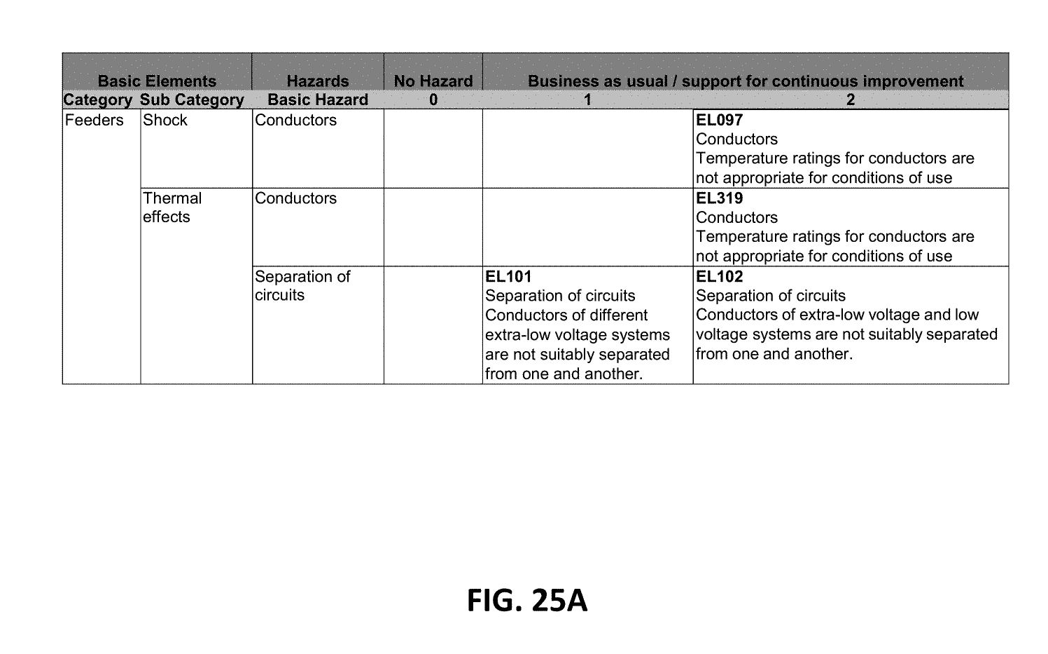

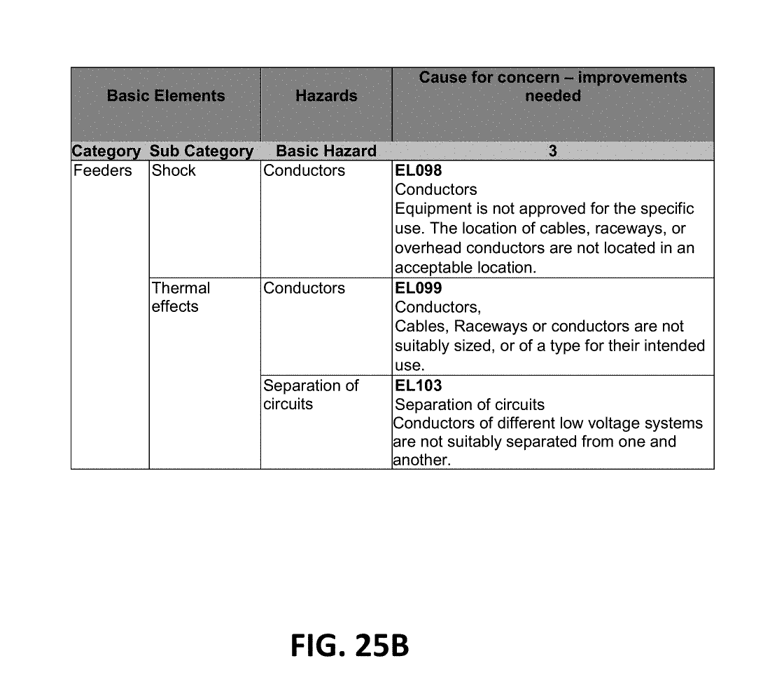

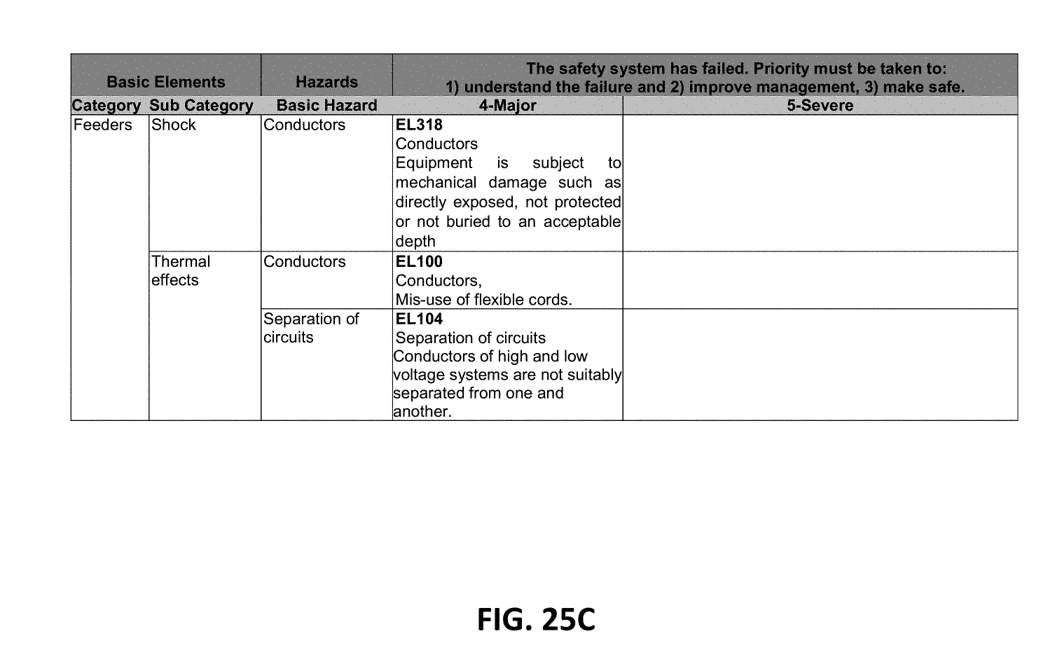

FIG. 25A shows the Hazard Map for Feeders—Shock and Feeders—Thermal effects for 0 (No Hazard) and 1-2 (Business as usual/support for continuous improvement).

FIG. 25B shows the Hazard Map for Feeders—Shock and Feeders—Thermal effects for 3 (Cause for concern).

FIG. 25C shows the Hazard Map for Feeders—Shock and Feeders—Thermal effects for 4-5 (The safety system has failed).

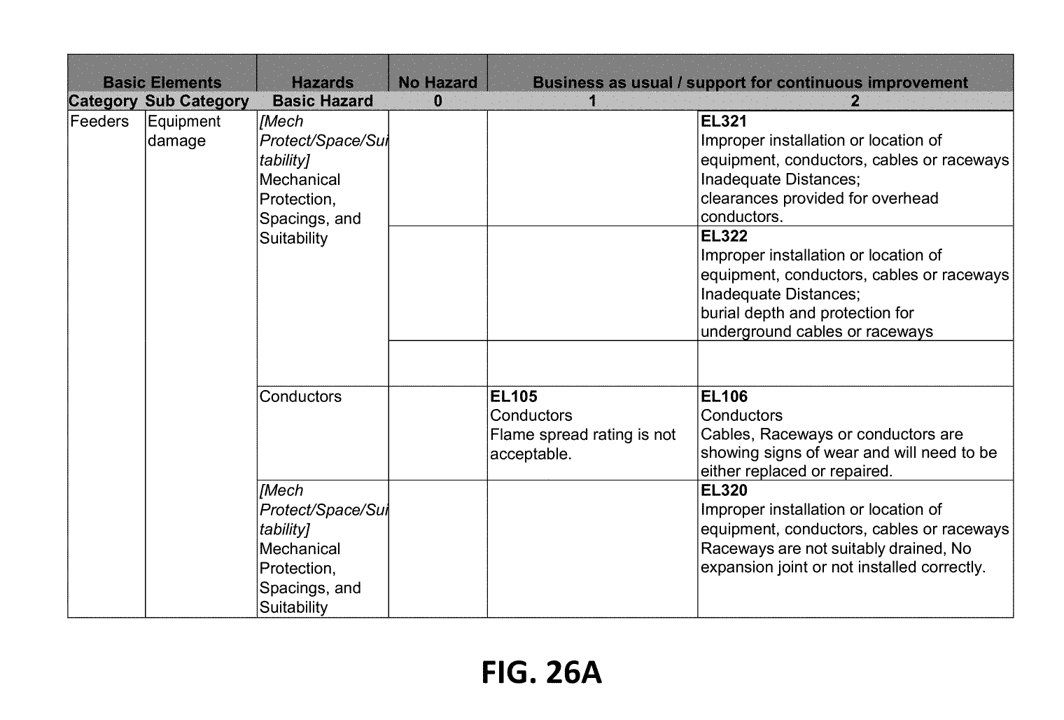

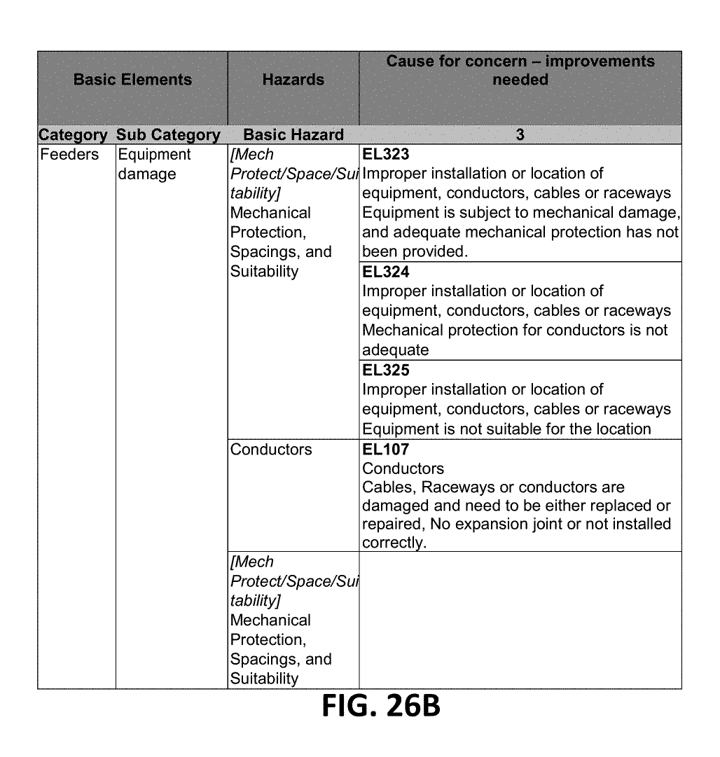

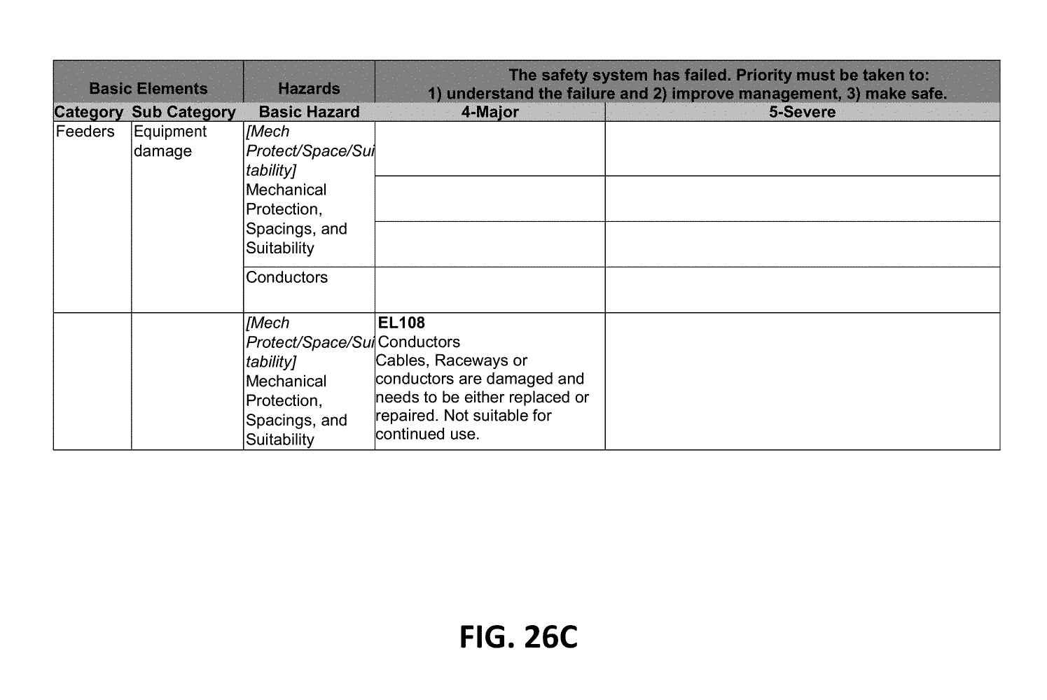

FIG. 26A shows the Hazard Map for Feeders—Equipment damage for 0 (No Hazard) and 1-2 (Business as usual/support for continuous improvement).

FIG. 26B shows the Hazard Map for Feeders—Equipment damage for 3 (Cause for concern).

FIG. 26C shows the Hazard Map for Feeders—Equipment damage for 4-5 (The safety system has failed).

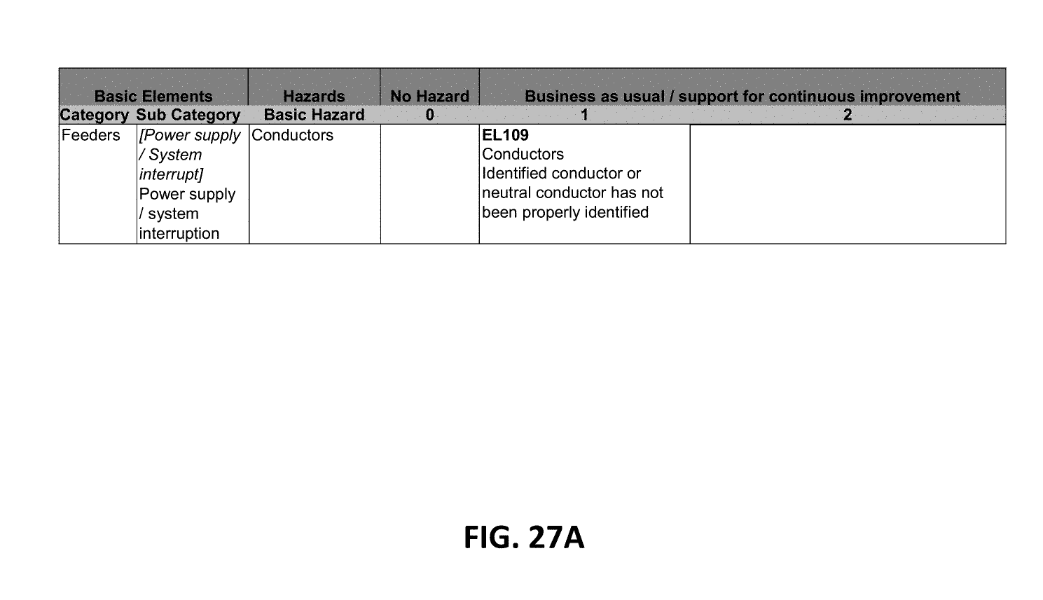

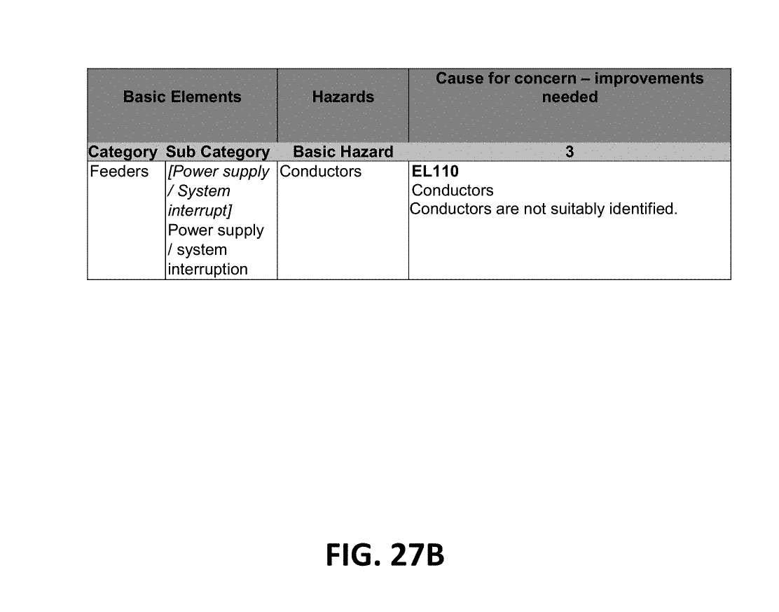

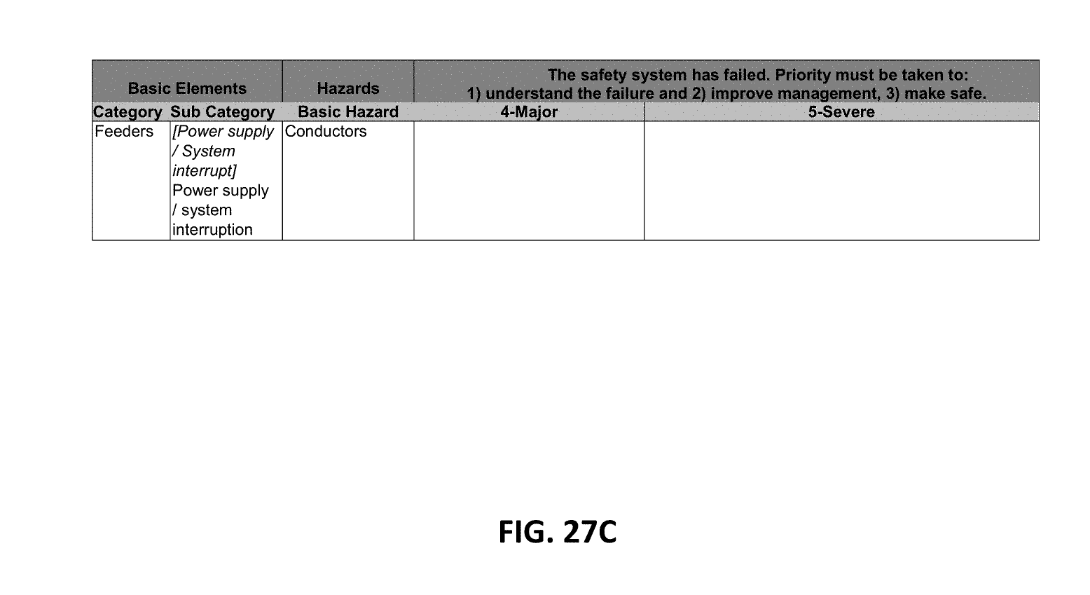

FIG. 27A shows the Hazard Map for Feeders—Conductors for 0 (No Hazard) and 1-2 (Business as usual/support for continuous improvement).

FIG. 27B shows the Hazard Map for Feeders—Conductors for 3 (Cause for concern).

FIG. 27C shows the Hazard Map for Feeders—Conductors for 4-5 (The safety system has failed).

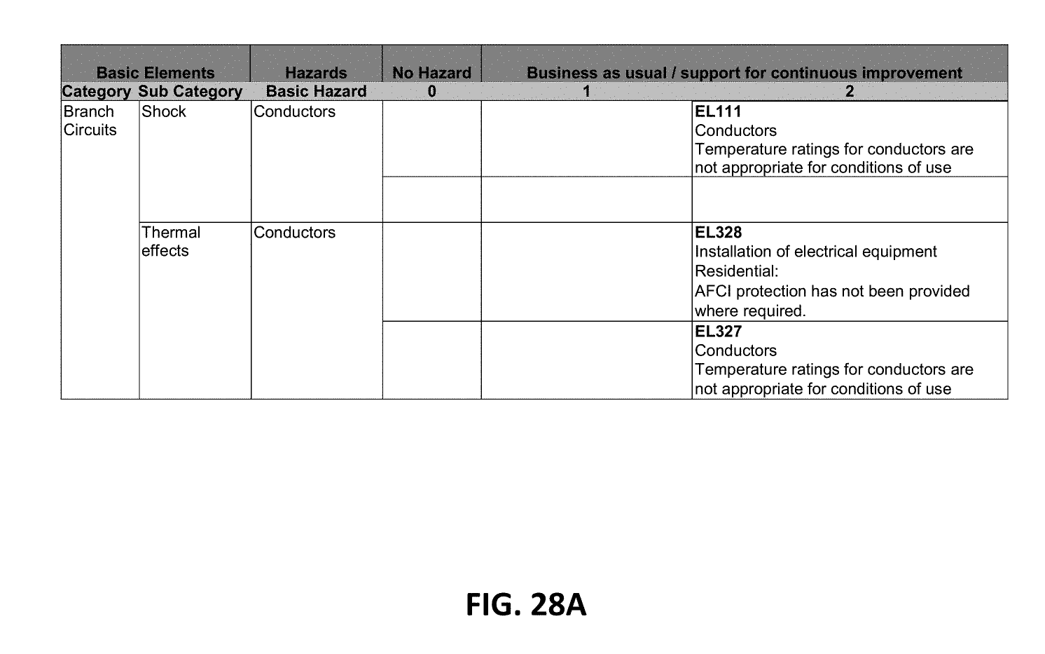

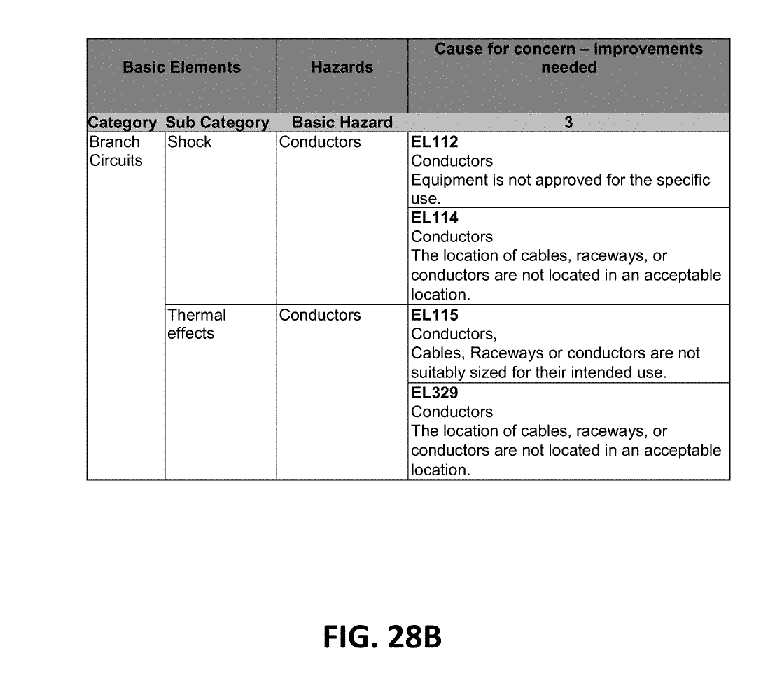

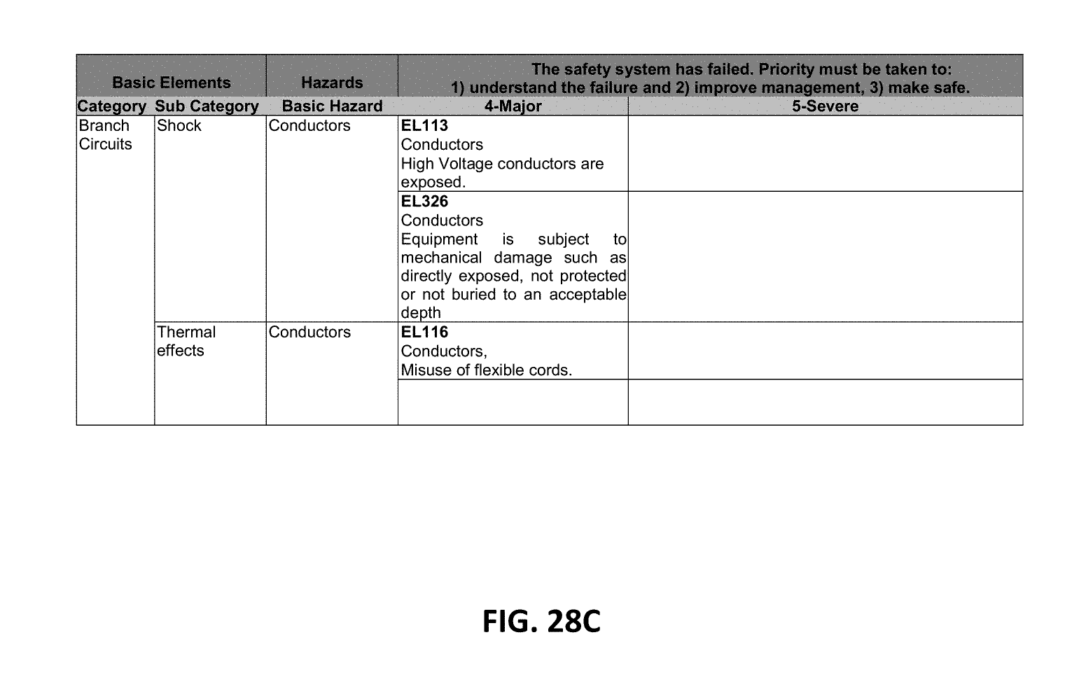

FIG. 28A shows the Hazard Map for Branch Circuits—Shock and Branch Circuits—Thermal effects for 0 (No Hazard) and 1-2 (Business as usual/support for continuous improvement).

FIG. 28B shows the Hazard Map for Branch Circuits—Shock and Branch Circuits—Thermal effects for 3 (Cause for concern).

FIG. 28C shows the Hazard Map for Branch Circuits—Shock and Branch Circuits—Thermal effects for 4-5 (The safety system has failed).

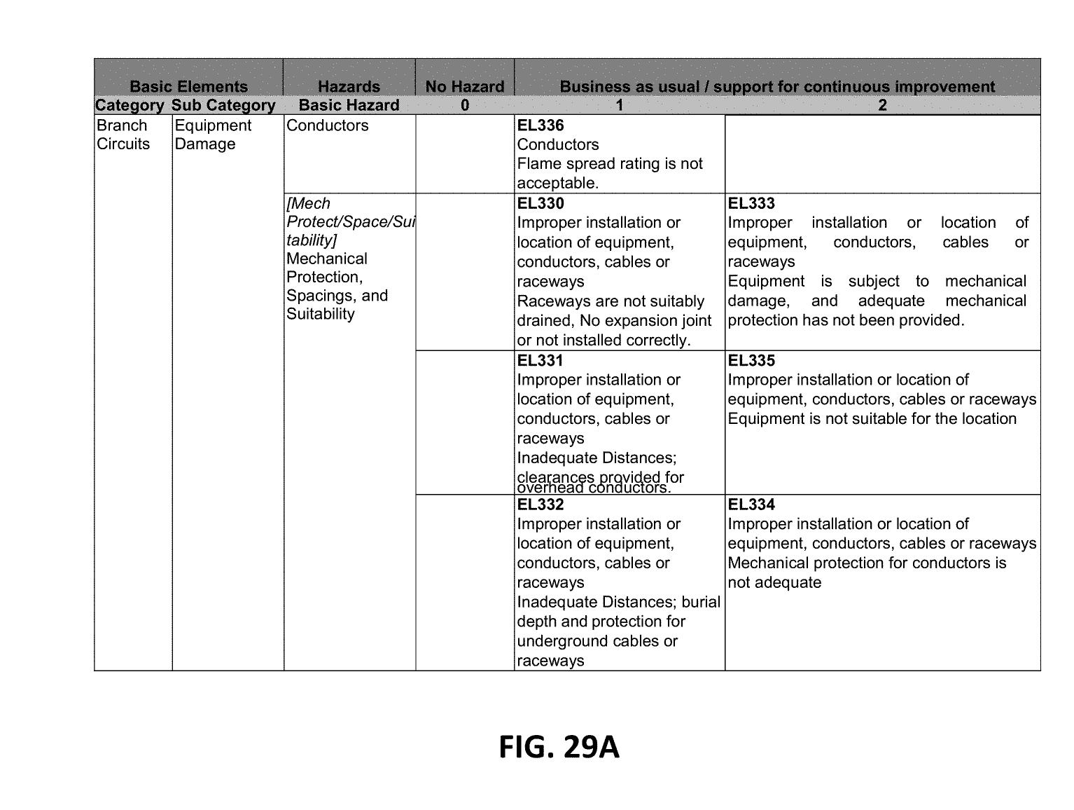

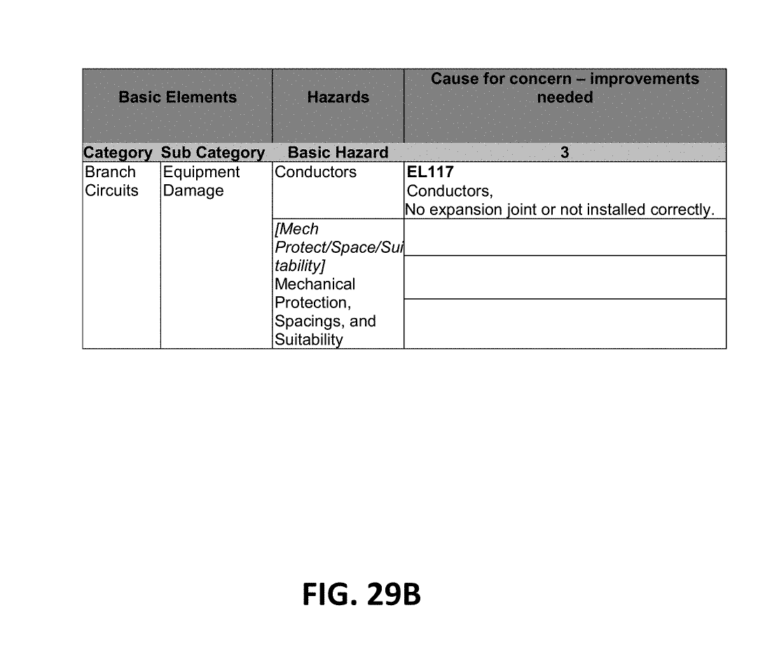

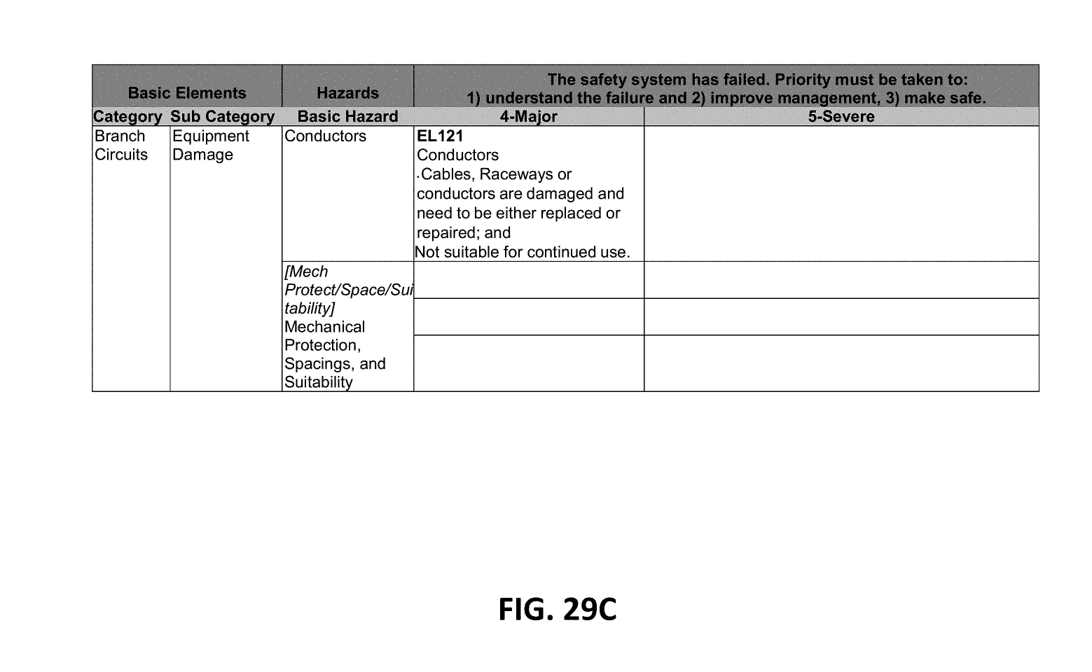

FIG. 29A shows the Hazard Map for Branch Circuits—Equipment Damage for for 0 (No Hazard) and 1-2 (Business as usual/support for continuous improvement).

FIG. 29B shows the Hazard Map for Branch Circuits—Equipment Damage for 3 (Cause for concern).

FIG. 29C shows the Hazard Map for Branch Circuits—Equipment Damage for 4-5 (The safety system has failed).

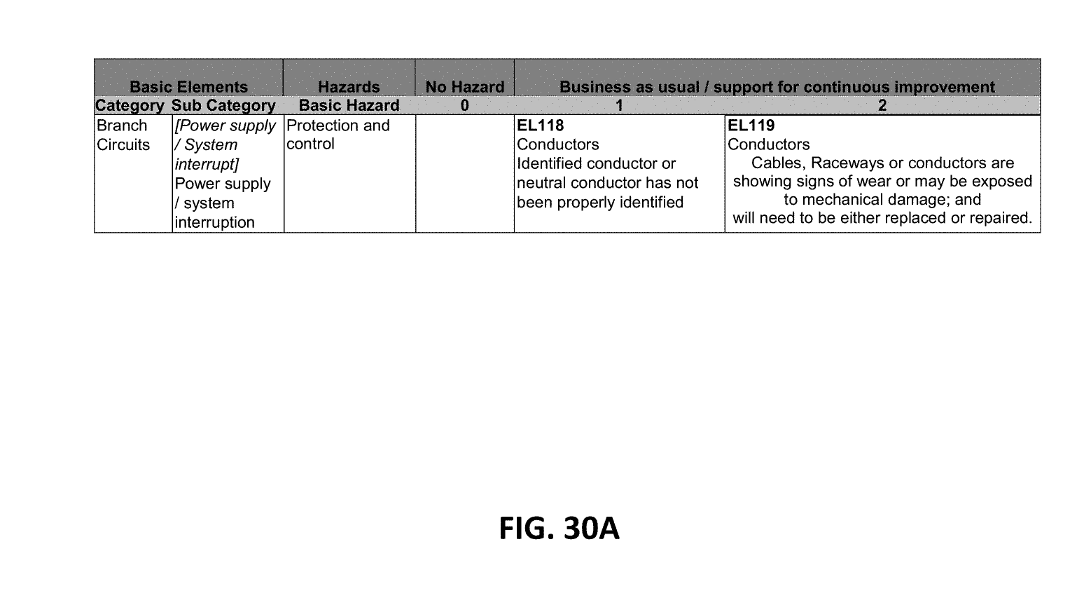

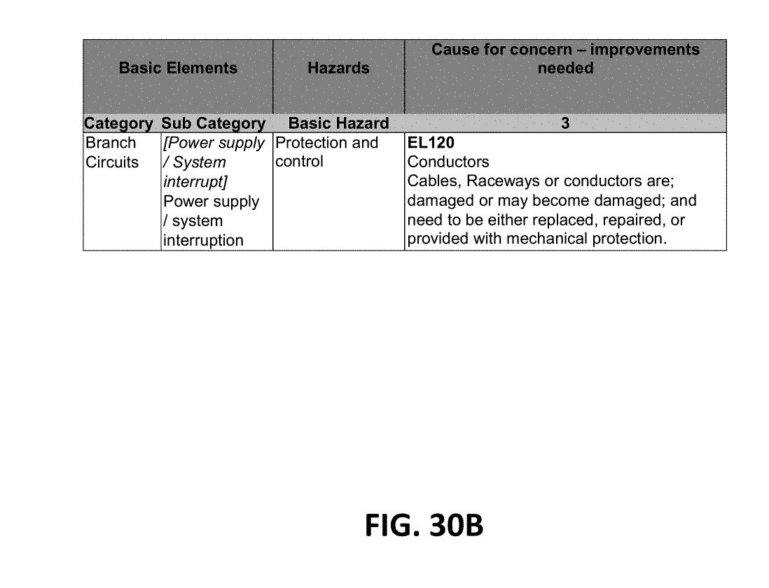

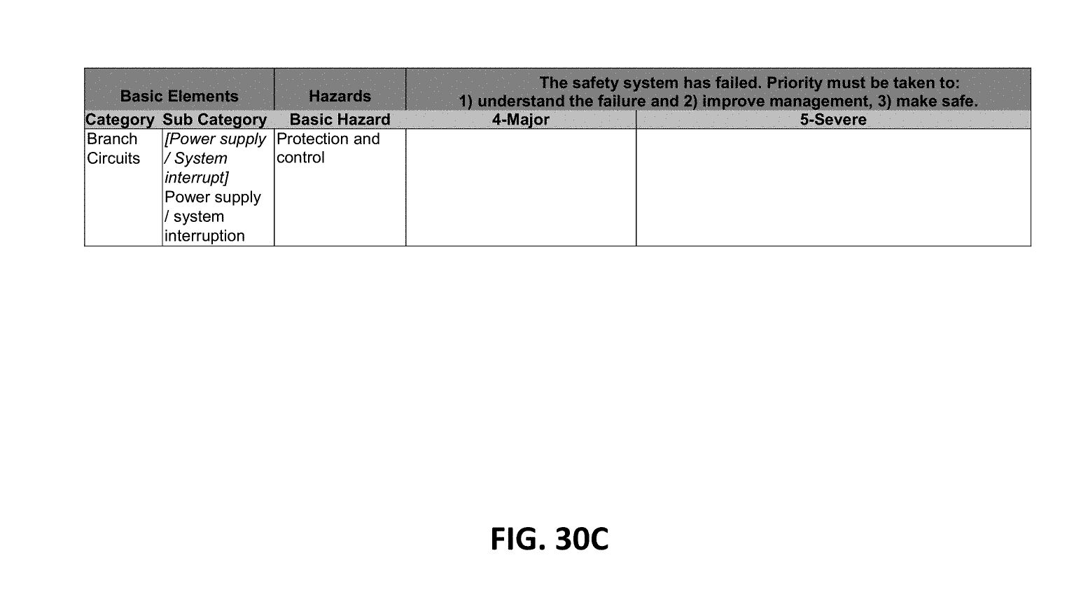

FIG. 30A shows the Hazard Map for Branch Circuits—Power supply/system interruption for 0 (No Hazard) and 1-2 (Business as usual/support for continuous improvement).

FIG. 30B shows the Hazard Map for Branch Circuits—Power supply/system interruption for 3 (Cause for concern).

FIG. 30C shows the Hazard Map for Branch Circuits—Power supply/system interruption for 4-5 (The safety system has failed).

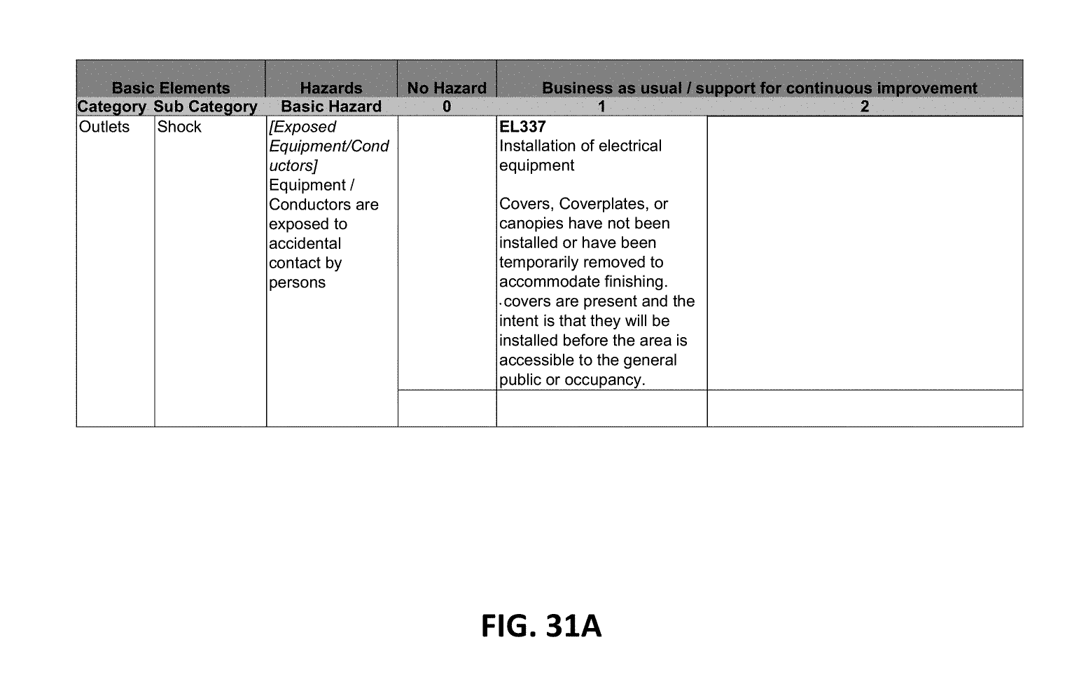

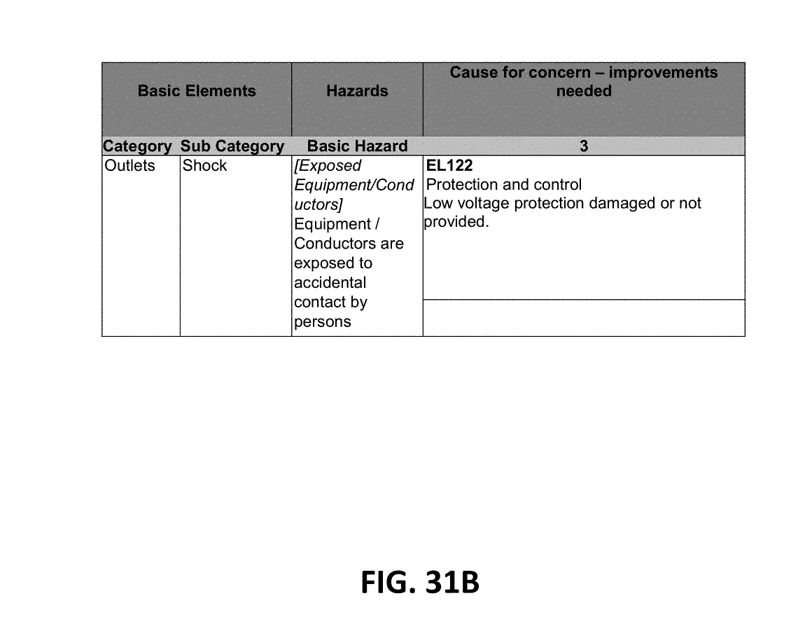

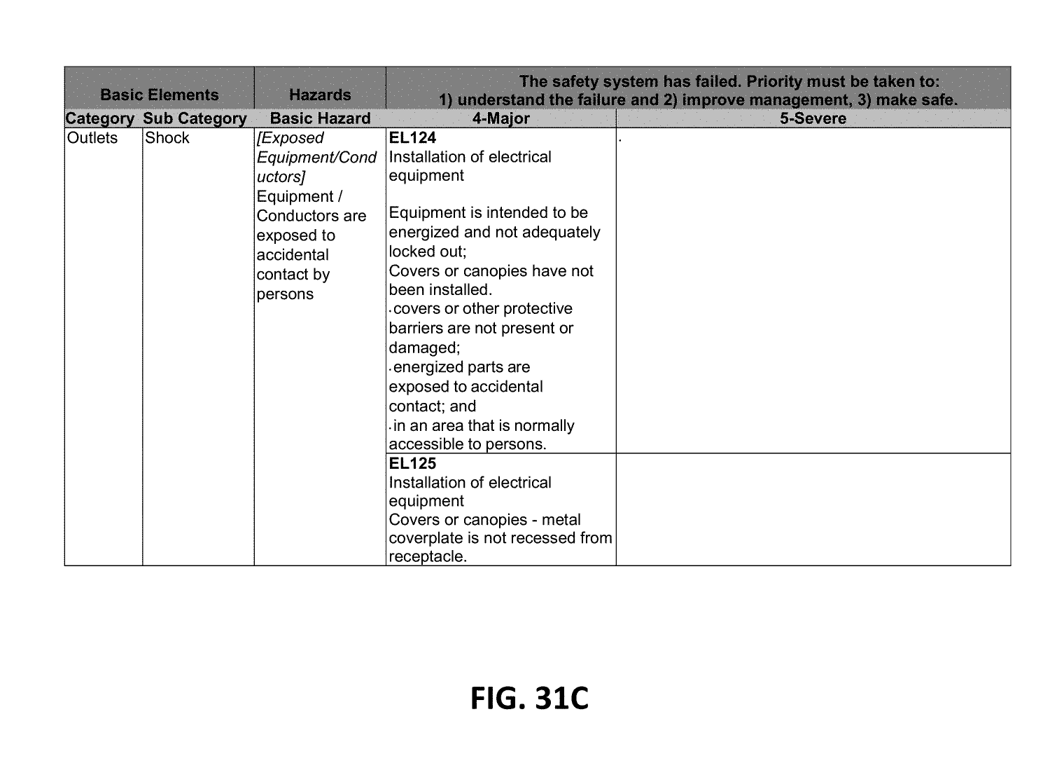

FIG. 31A shows the Hazard Map for Outlets—Shock for 0 (No Hazard) and 1-2 (Business as usual/support for continuous improvement).

FIG. 31B shows the Hazard Map for Outlets—Shock for 3 (Cause for concern).

FIG. 31C shows the Hazard Map for Outlets—Shock for 4-5 (The safety system has failed).

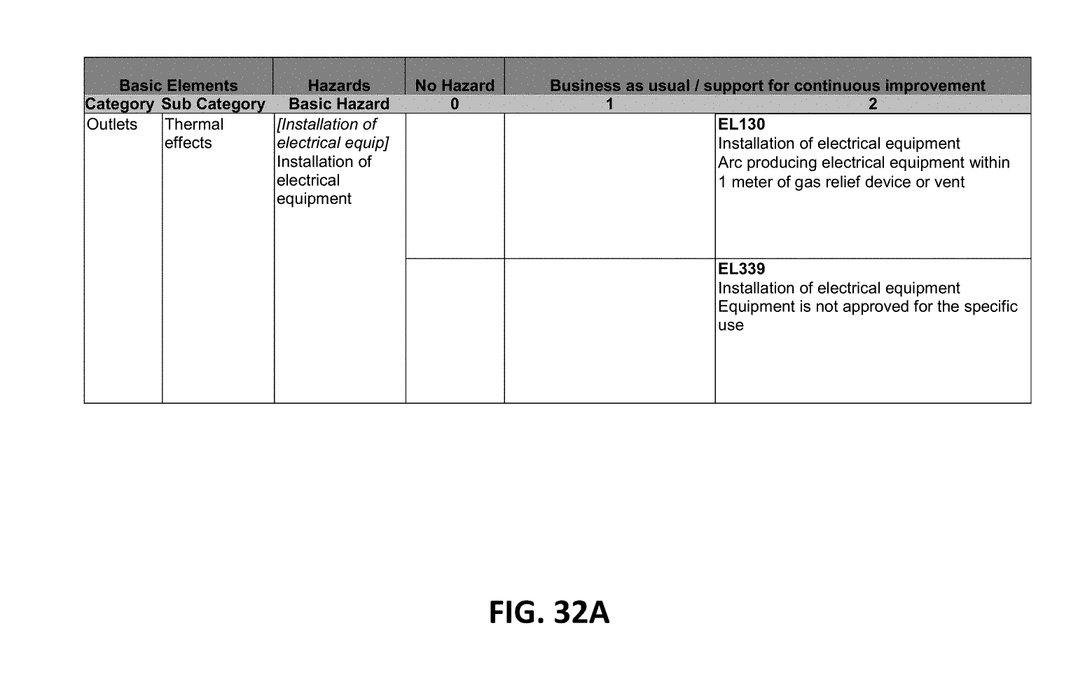

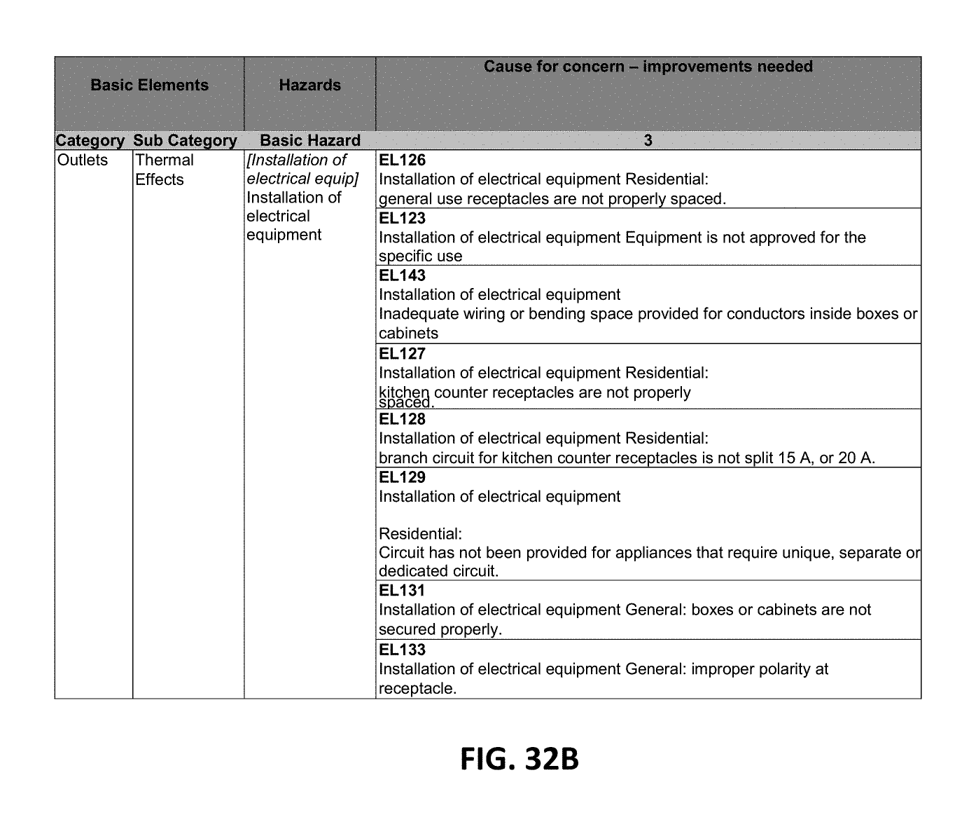

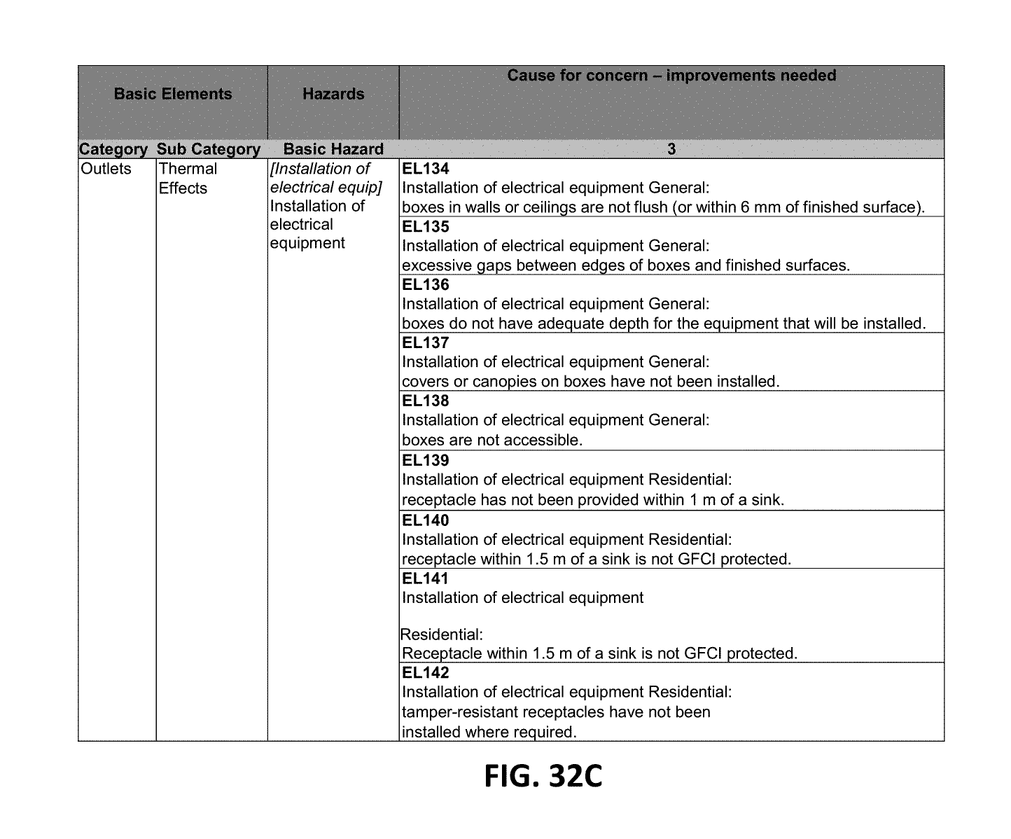

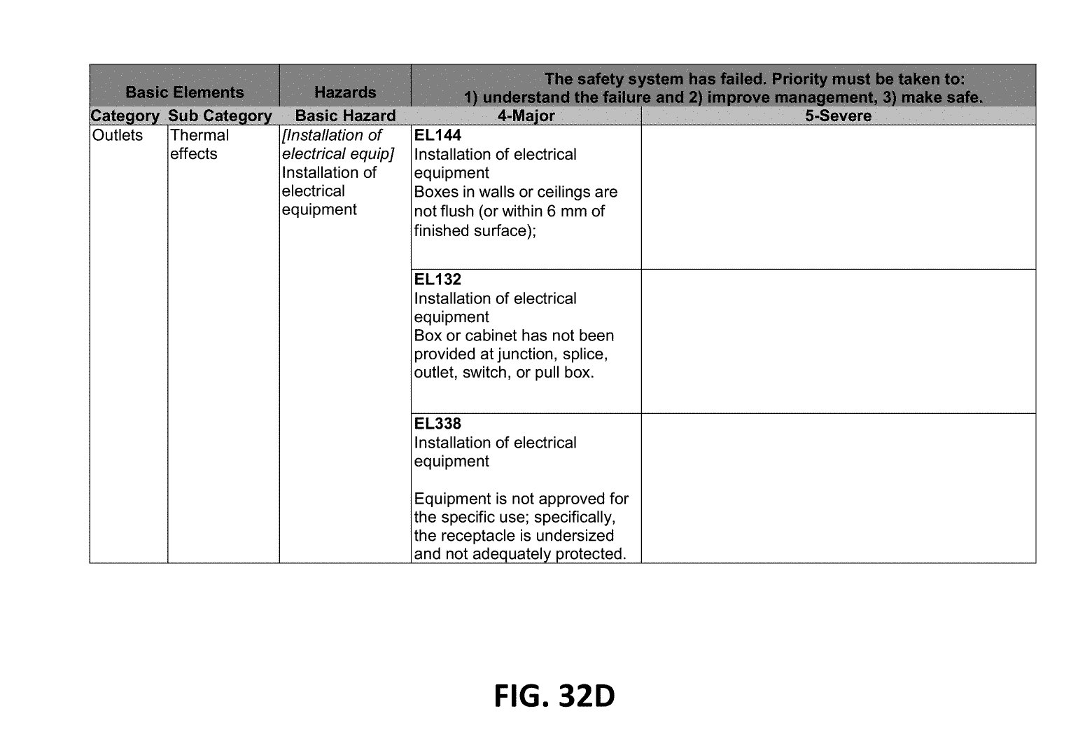

FIG. 32A shows the Hazard Map for Outlets—Thermal effects for 0 (No Hazard) and 1-2 (Business as usual/support for continuous improvement).

FIG. 32B shows Part 1 of the Hazard Map for Outlets—Thermal effects for 3 (Cause for concern).

FIG. 32C shows Part 2 of the Hazard Map for Outlets—Thermal effects for 3 (Cause for concern).

FIG. 32D shows the Hazard Map for Outlets—Thermal effects for 4-5 (The safety system has failed).

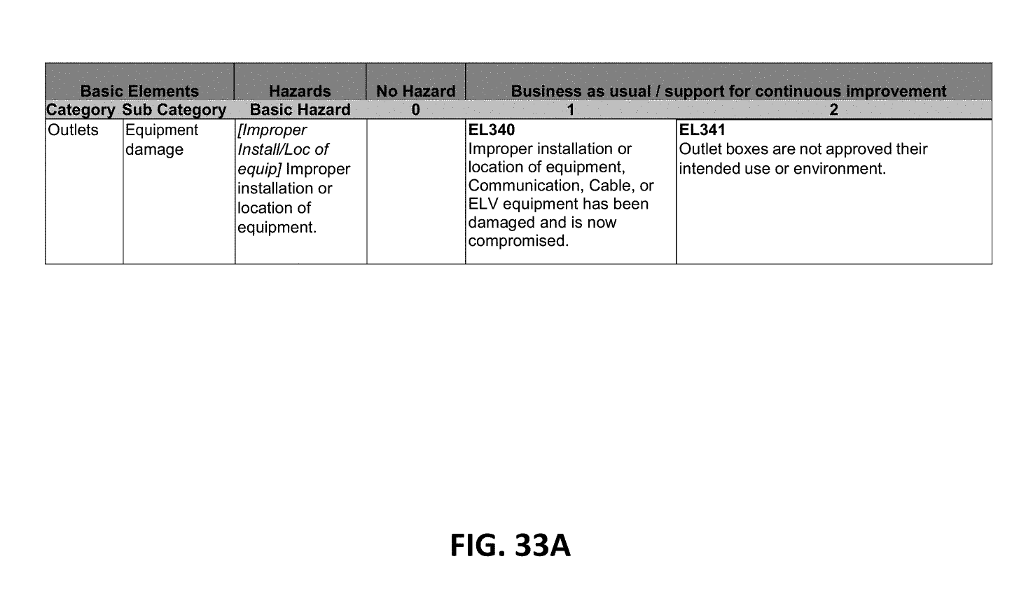

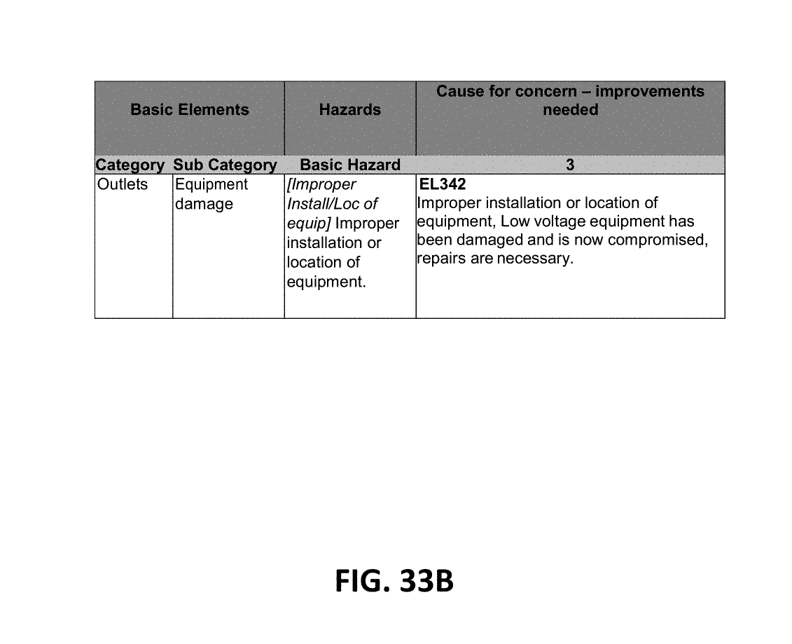

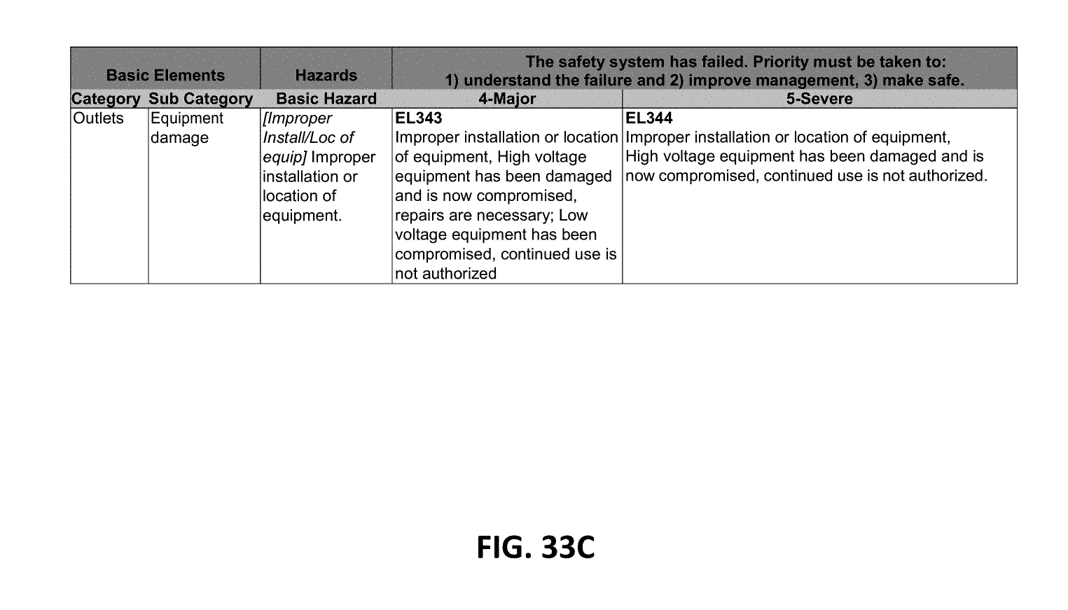

FIG. 33A shows the Hazard Map for Outlets—Equipment damage for 0 (No Hazard) and 1-2 (Business as usual/support for continuous improvement).

FIG. 33B shows the Hazard Map for Outlets—Equipment damage for 3 (Cause for concern).

FIG. 33C shows the Hazard Map for Outlets—Equipment damage for 4-5 (The safety system has failed).

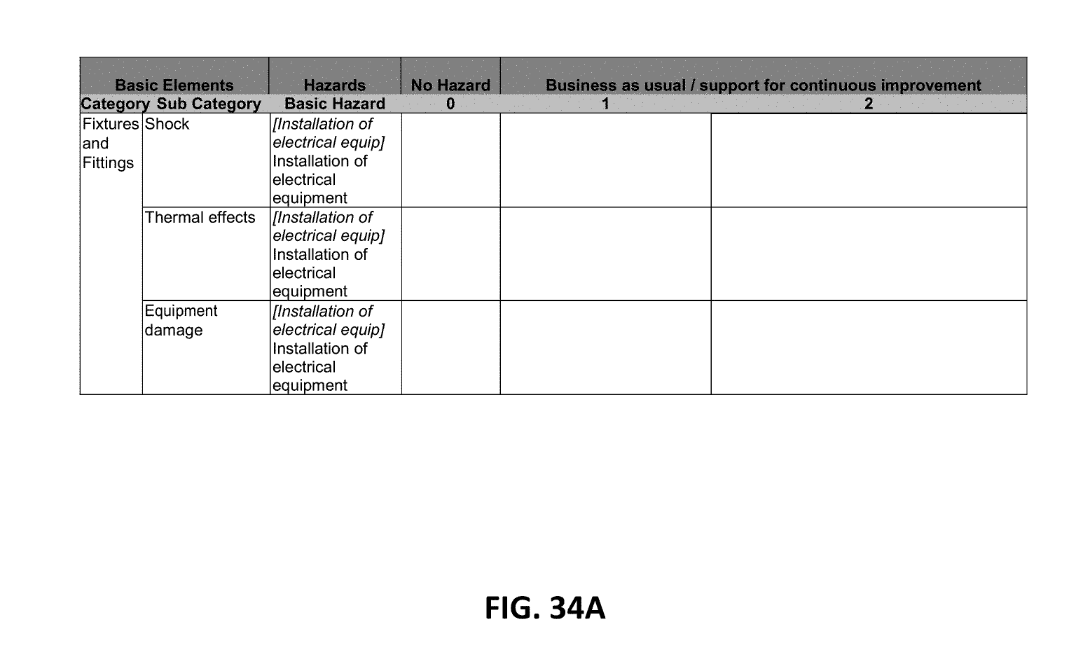

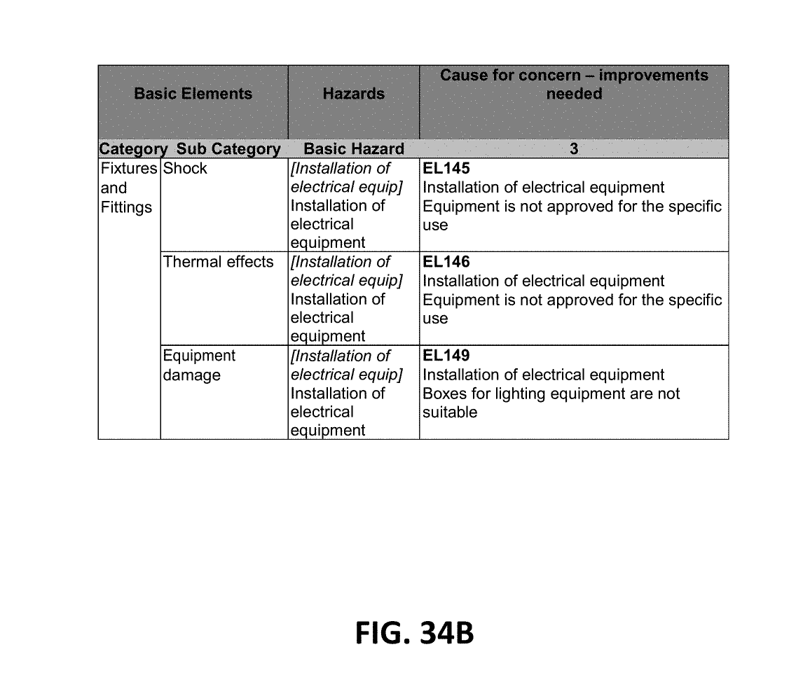

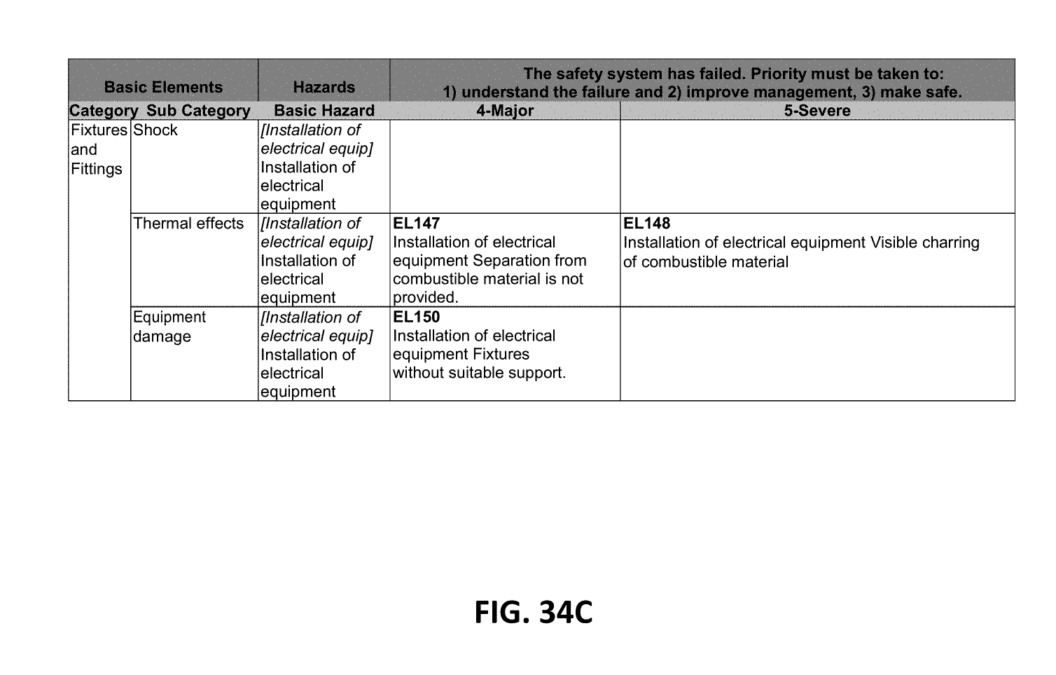

FIG. 34A shows the Hazard Map for Fixtures and Fittings—Shock, Fixtures and Fittings—Thermal effects, and Fixtures and Fittings—Equipment damage for 0 (No Hazard) and 1-2 (Business as usual/support for continuous improvement).

FIG. 34B shows the Hazard Map for Fixtures and Fittings—Shock, Fixtures and Fittings—Thermal effects, and Fixtures and Fittings—Equipment damage for 3 (Cause for concern).

FIG. 34C shows the Hazard Map for Fixtures and Fittings—Shock, Fixtures and Fittings—Thermal effects, and Fixtures and Fittings—Equipment damage for 4-5 (The safety system has failed).

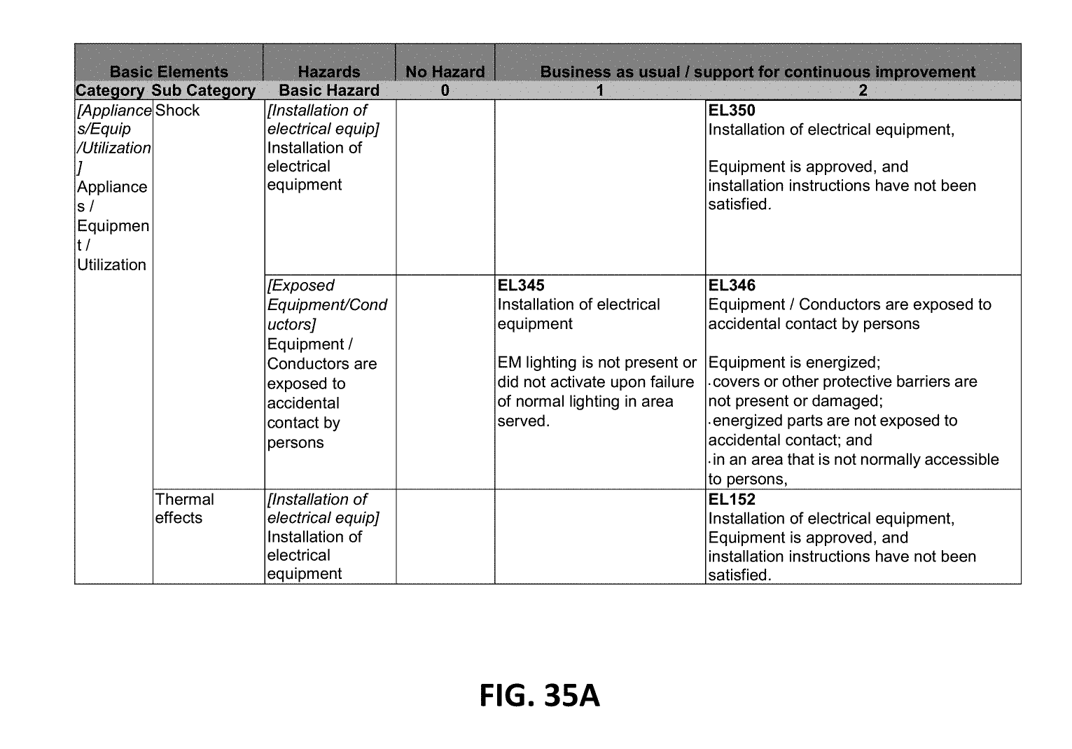

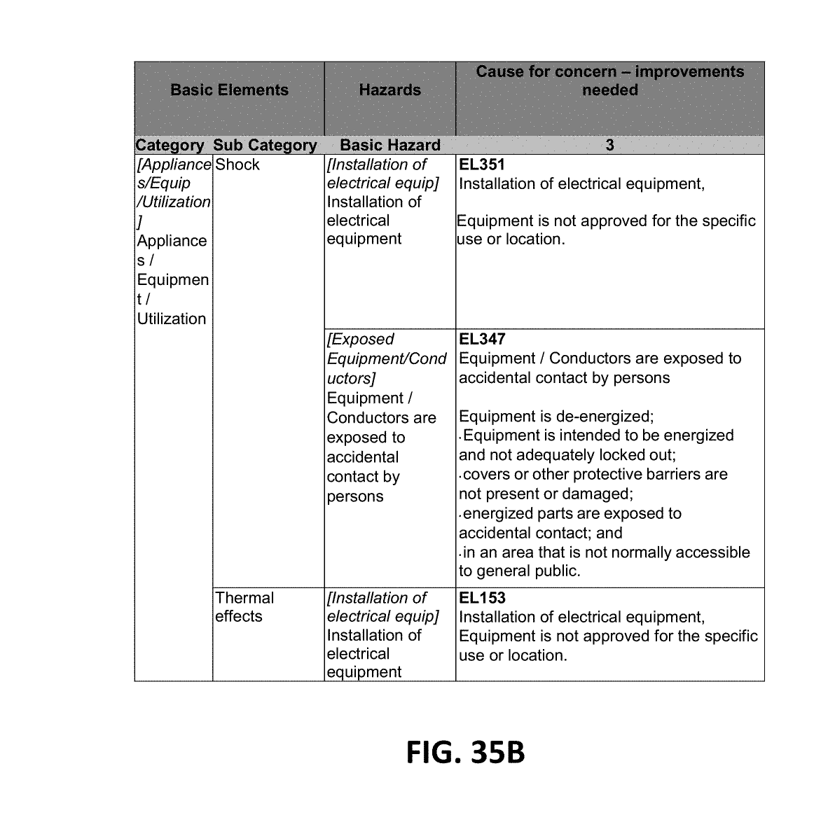

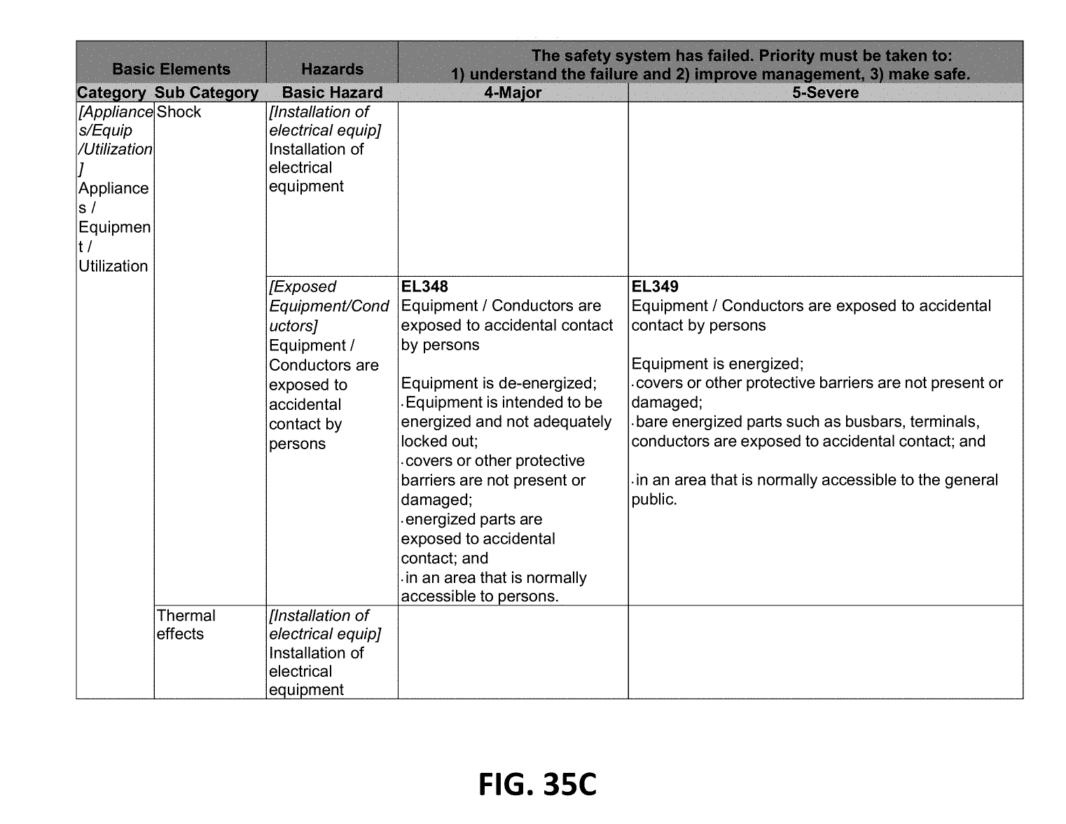

FIG. 35A shows the Hazard Map for Appliances/Equipment/Utilization—Shock and Appliances/Equipment/Utilization—Thermal effect for 0 (No Hazard) and 1-2 (Business as usual/support for continuous improvement).

FIG. 35B shows the Hazard Map for Appliances/Equipment/Utilization—Shock Appliances/Equipment/Utilization—Thermal effect for 3 (Cause for concern).

FIG. 35C shows the Hazard Map for Appliances/Equipment/Utilization—Shock Appliances/Equipment/Utilization—Thermal effect for 4-5 (The safety system has failed).

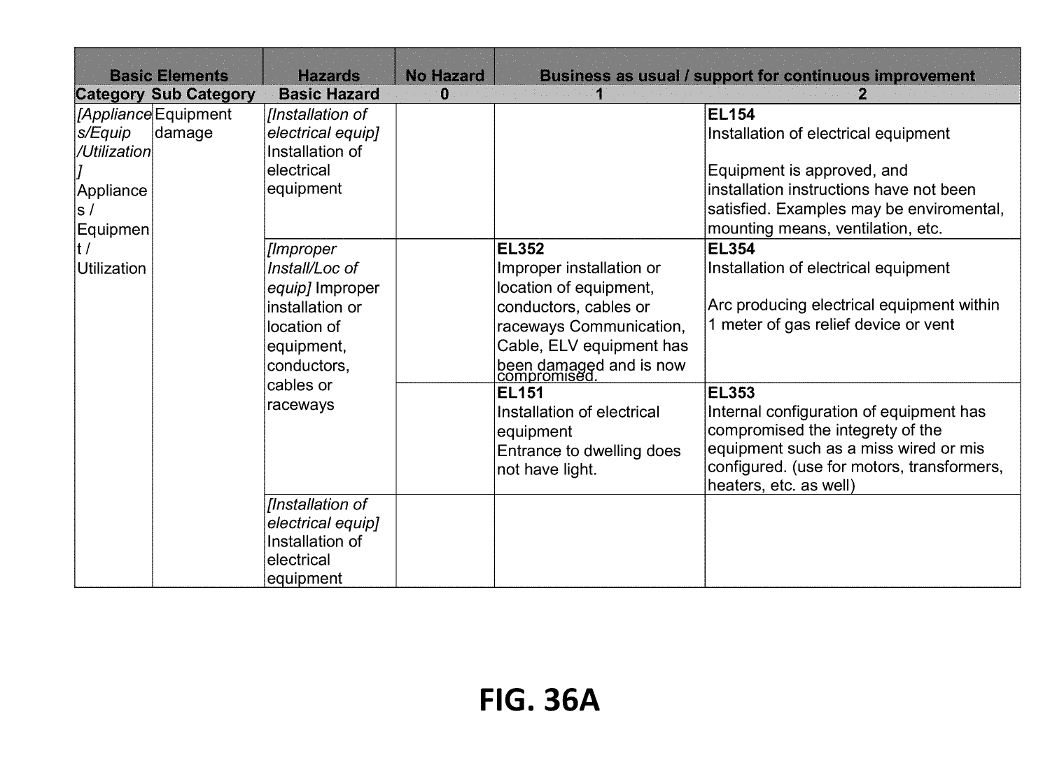

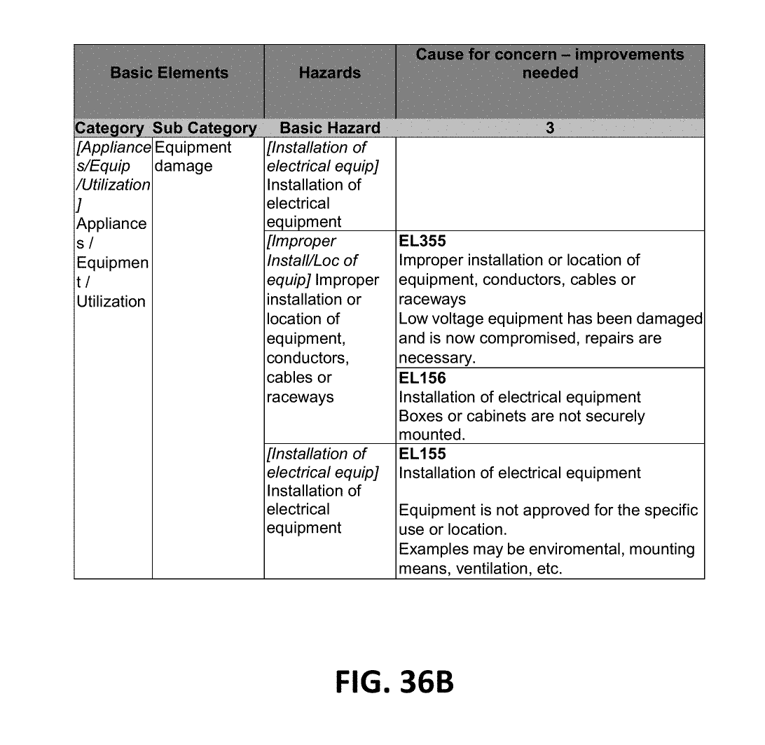

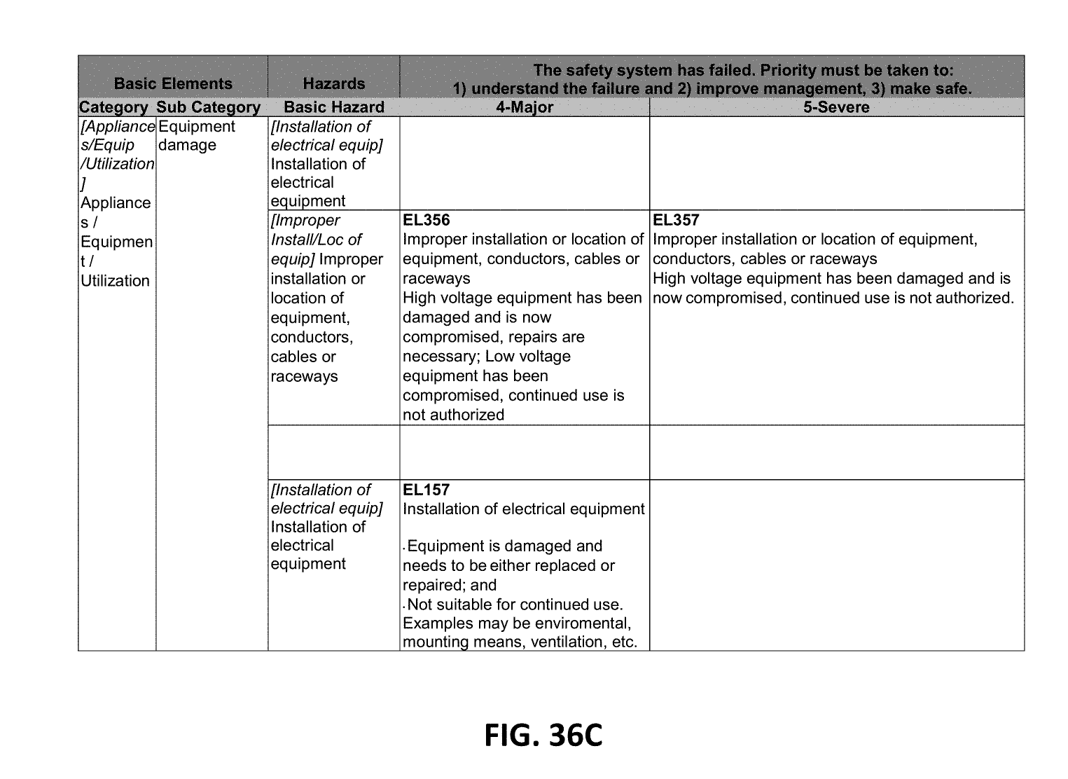

FIG. 36A shows the Hazard Map for Appliances/Equipment/Utilization—Equipment damage for 0 (No Hazard) and 1-2 (Business as usual/support for continuous improvement).

FIG. 36B shows the Hazard Map for Appliances/Equipment/Utilization—Equipment damage for 3 (Cause for concern).

FIG. 36C shows the Hazard Map for Appliances/Equipment/Utilization—Equipment damage for 4-5 (The safety system has failed).

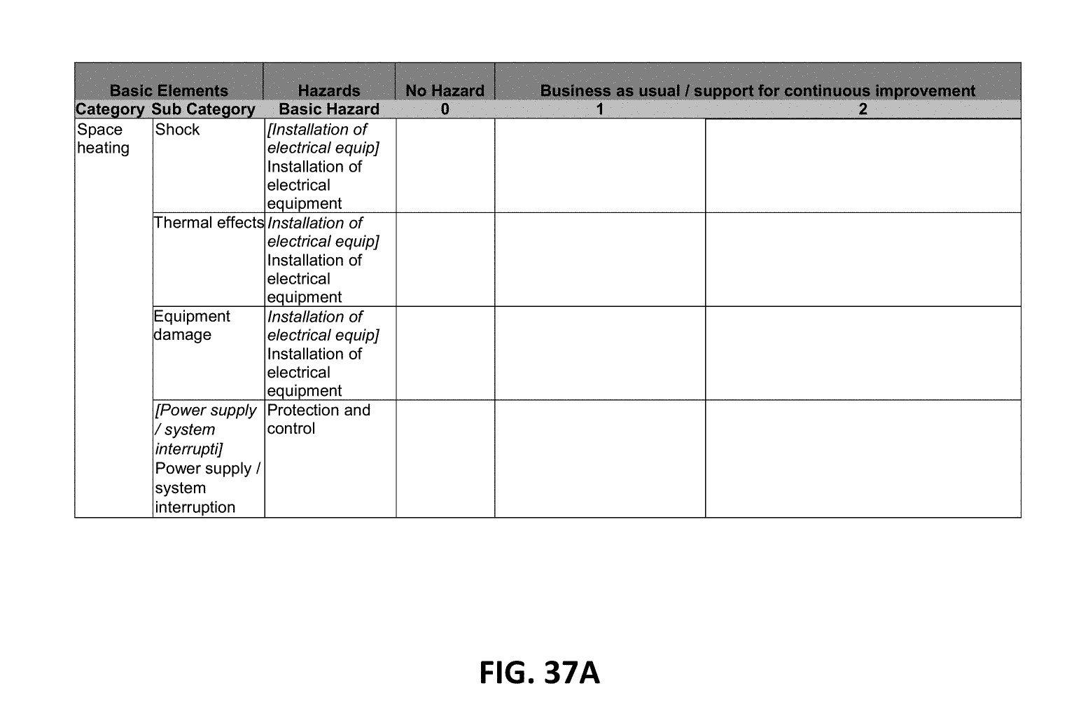

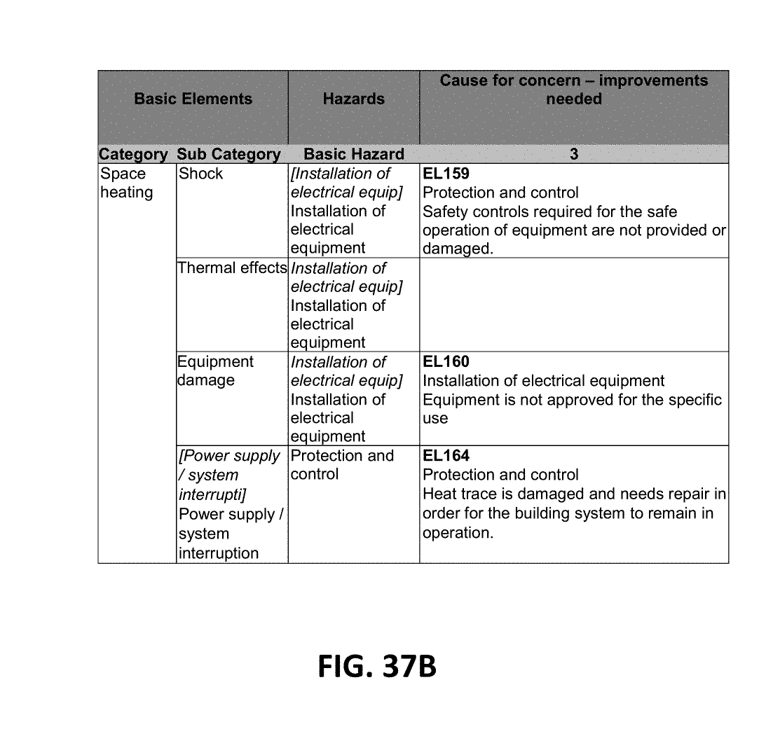

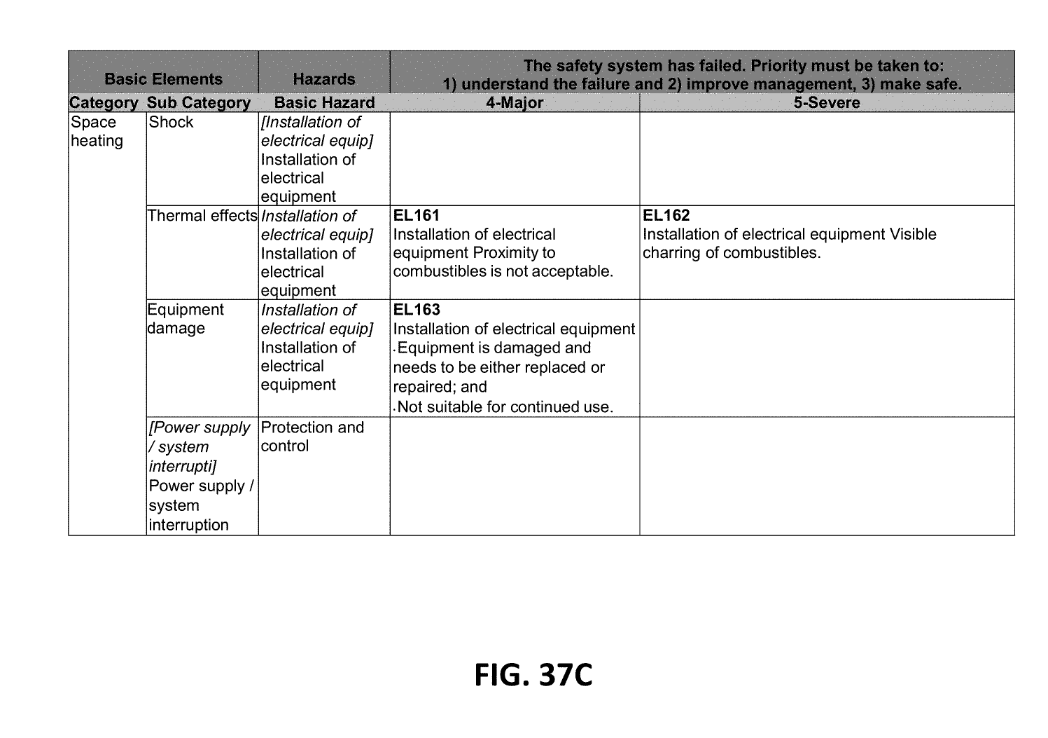

FIG. 37A shows the Hazard Map for Space heating—Shock, Space heating—Thermal effects, Space heating—and Space heating—Equipment damage for 0 (No Hazard) and 1-2 (Business as usual/support for continuous improvement).

FIG. 37B shows the Hazard Map for Space heating—Shock, Space heating—Thermal effects, Space heating—and Space heating—Equipment damage for 3 (Cause for concern).

FIG. 37C shows the Hazard Map for Space heating—Shock, Space heating—Thermal effects, Space heating—and Space heating—Equipment damage for 4-5 (The safety system has failed).

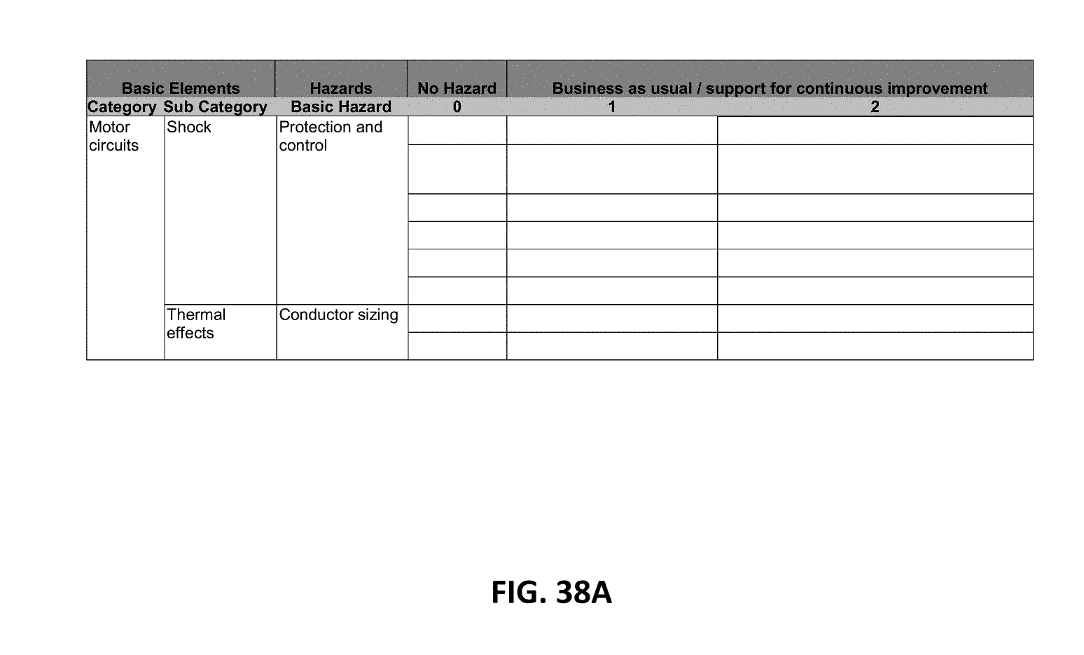

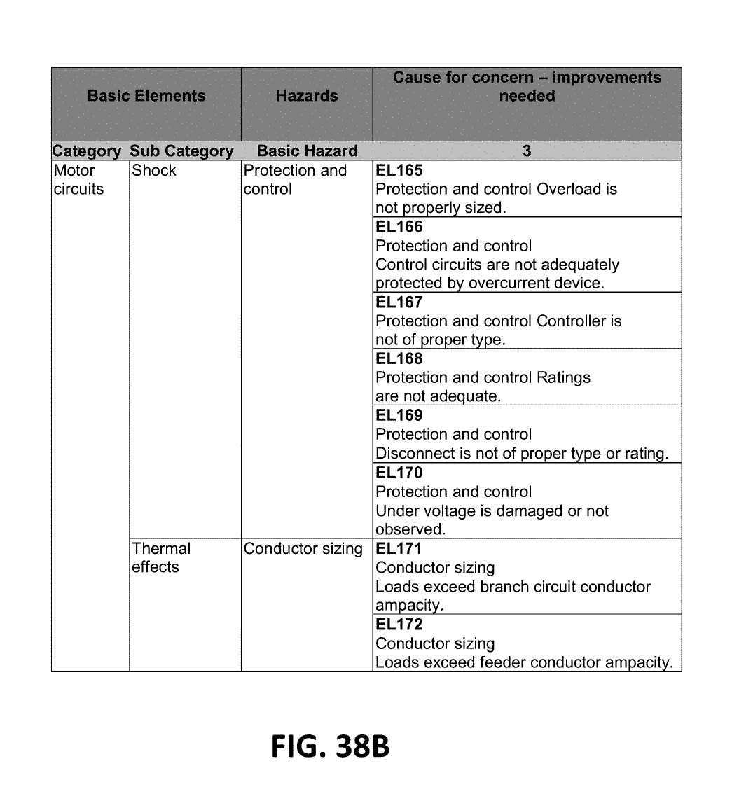

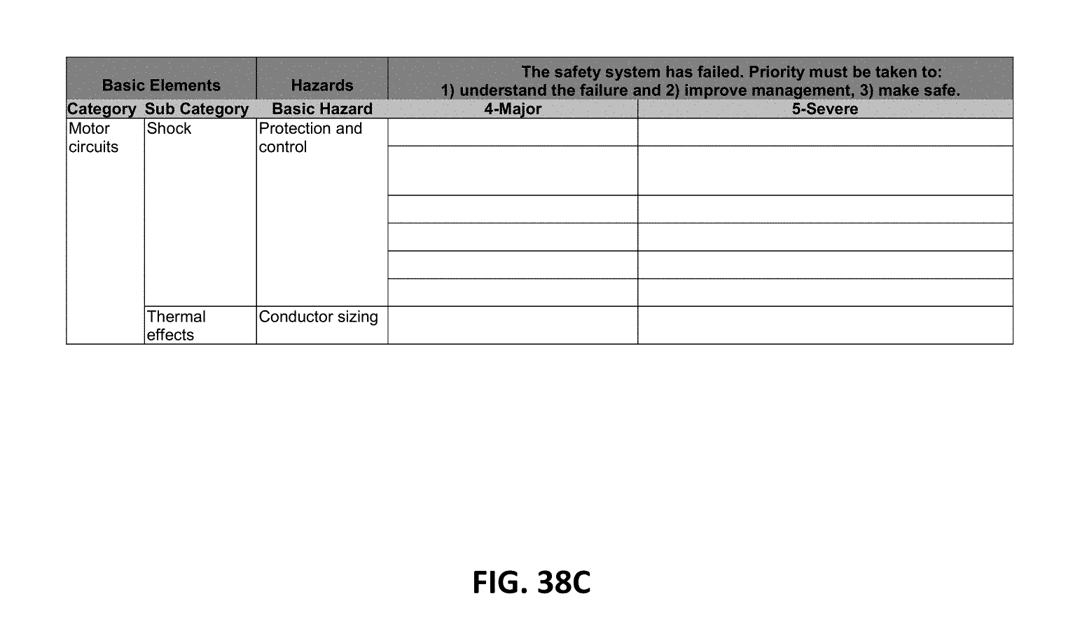

FIG. 38A shows the Hazard Map for Motor circuits—Shock and Motor circuits—Thermal effects for 0 (No Hazard) and 1-2 (Business as usual/support for continuous improvement).

FIG. 38B shows the Hazard Map for Motor circuits—Shock and Motor circuits—Thermal effects for 3 (Cause for concern).

FIG. 38C shows the Hazard Map for Motor circuits—Shock and Motor circuits—Thermal effects for 4-5 (The safety system has failed).

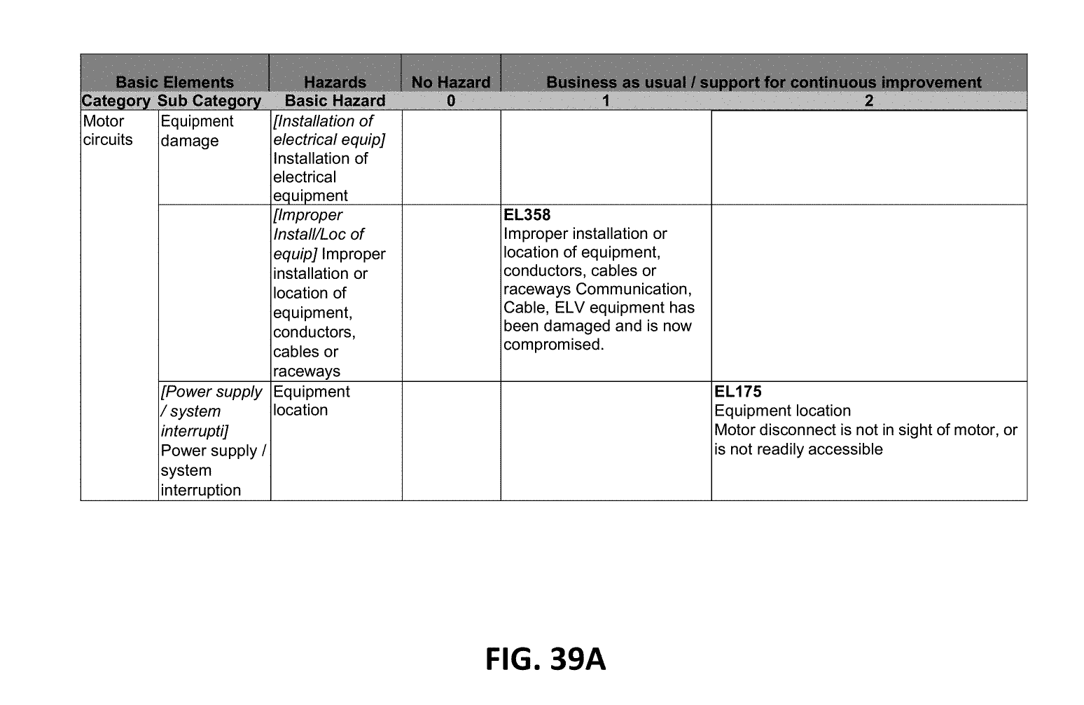

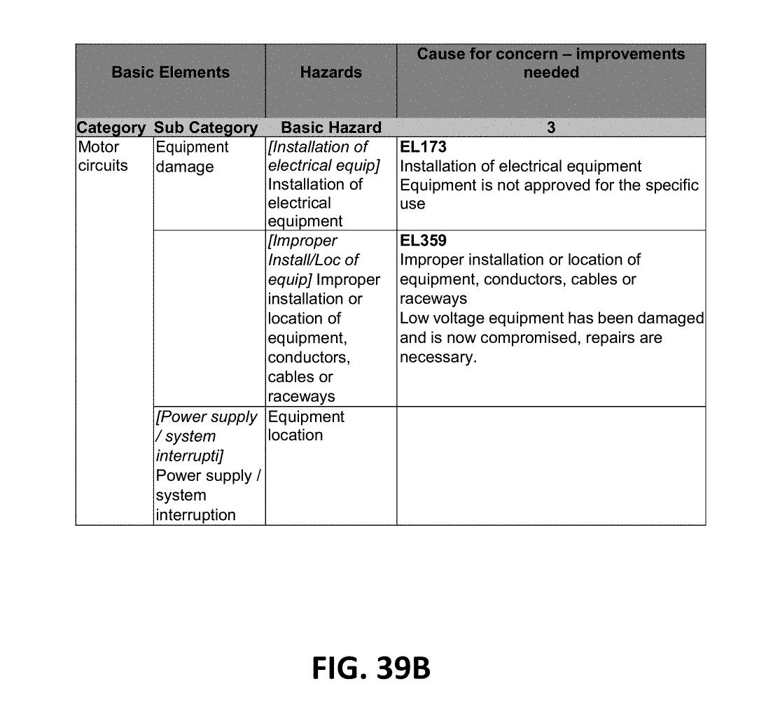

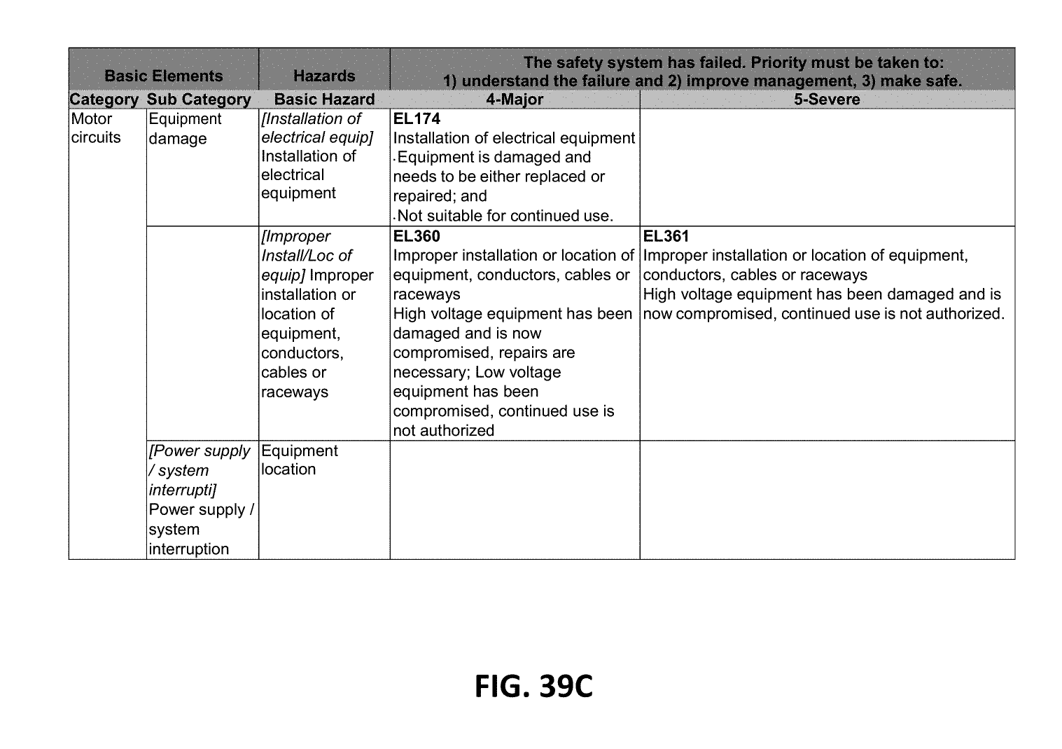

FIG. 39A shows the Hazard Map for Motor circuits—Equipment damage and Motor circuits—Power supply/system interruption for 0 (No Hazard) and 1-2 (Business as usual/support for continuous improvement).

FIG. 39B shows the Hazard Map for Motor circuits—Equipment damage and Motor circuits—Power supply/system interruption for 3 (Cause for concern).

FIG. 39C shows the Hazard Map for Motor circuits—Equipment damage and Motor circuits—Power supply/system interruption for 4-5 (The safety system has failed).

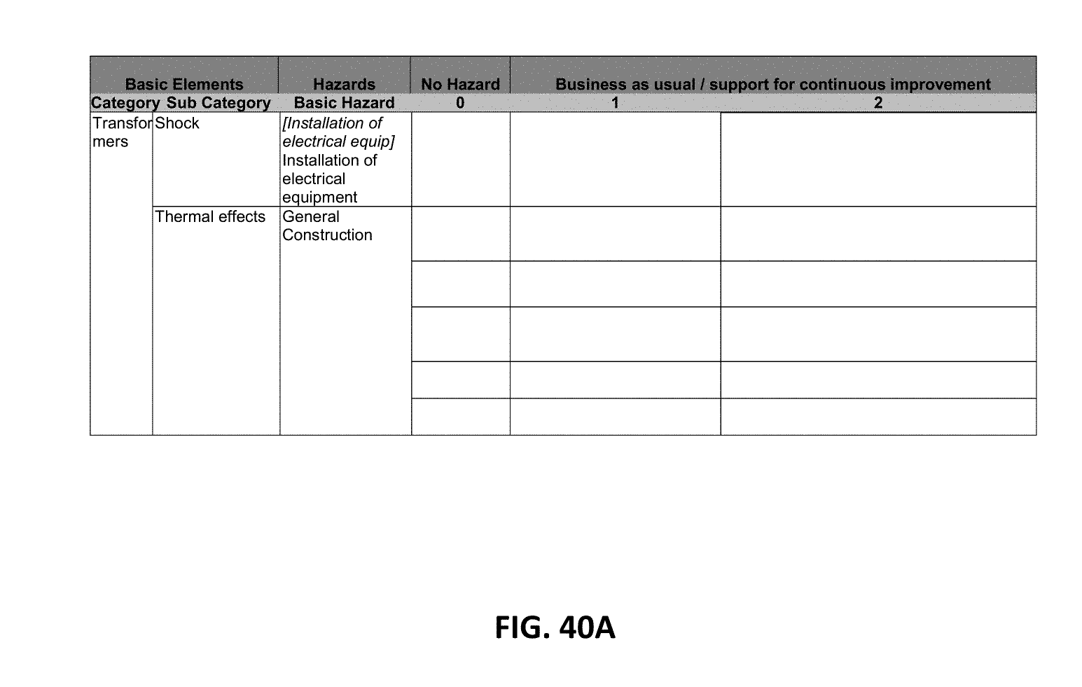

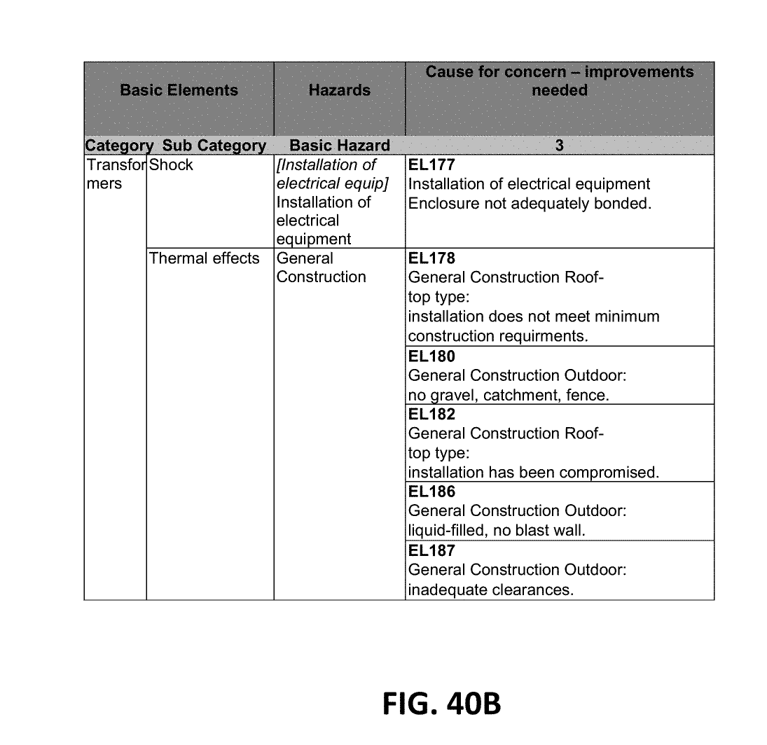

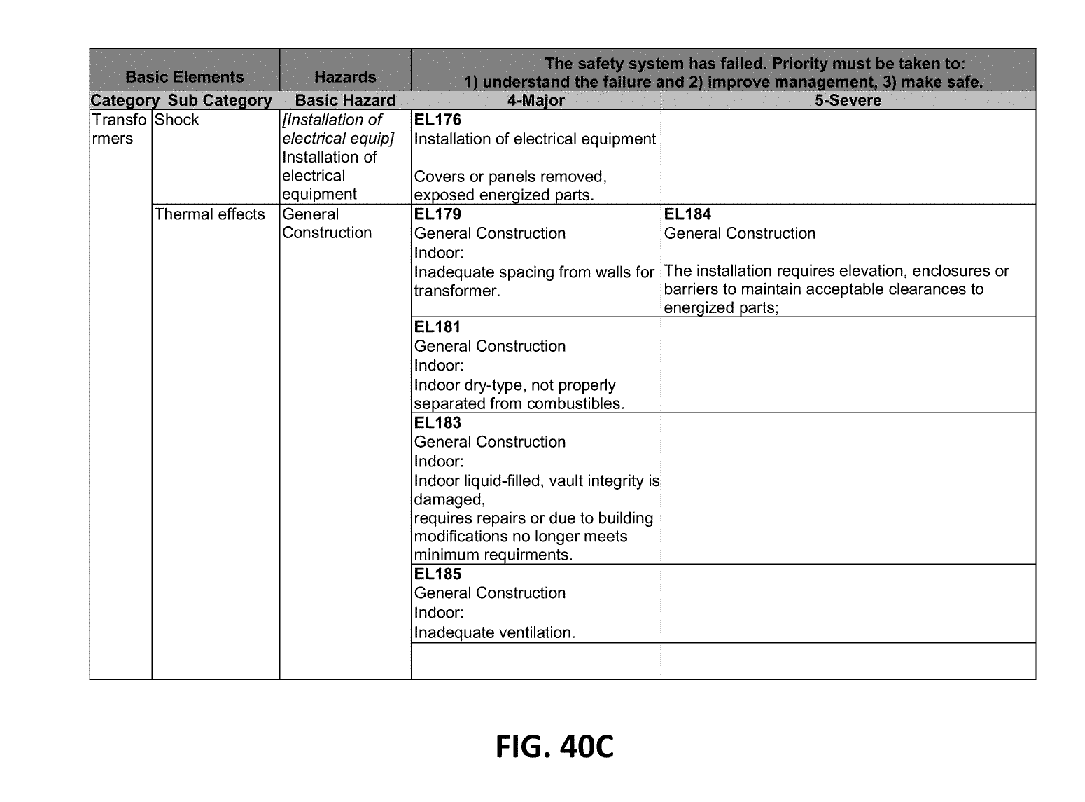

FIG. 40A shows the Hazard Map for Transformers—Shock and Transformers—Thermal effects for 0 (No Hazard) and 1-2 (Business as usual/support for continuous improvement).

FIG. 40B shows the Hazard Map for Transformers—Shock and Transformers—Thermal effects for 3 (Cause for concern).

FIG. 40C shows the Hazard Map for Transformers—Shock and Transformers—Thermal effects for 4-5 (The safety system has failed).

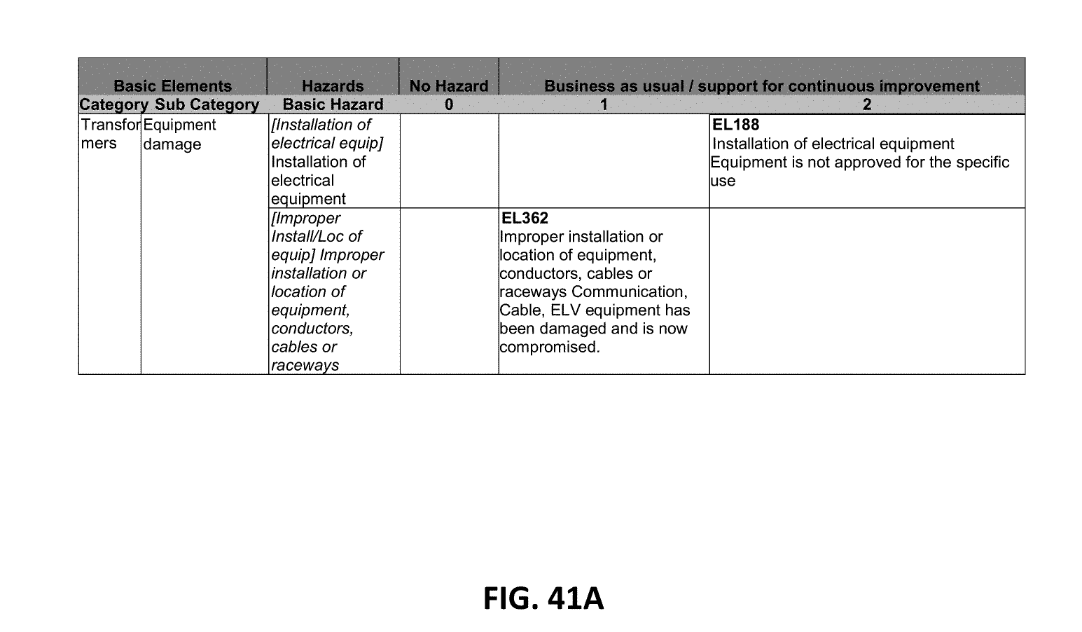

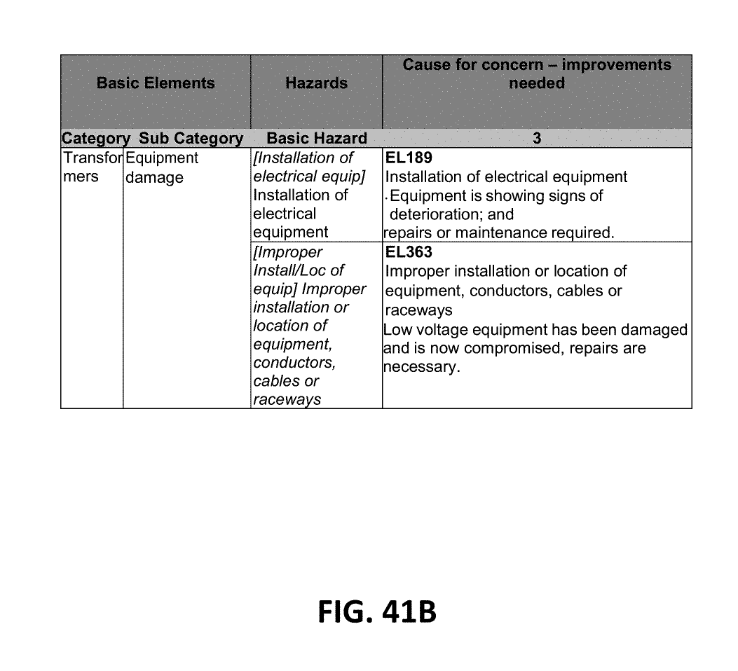

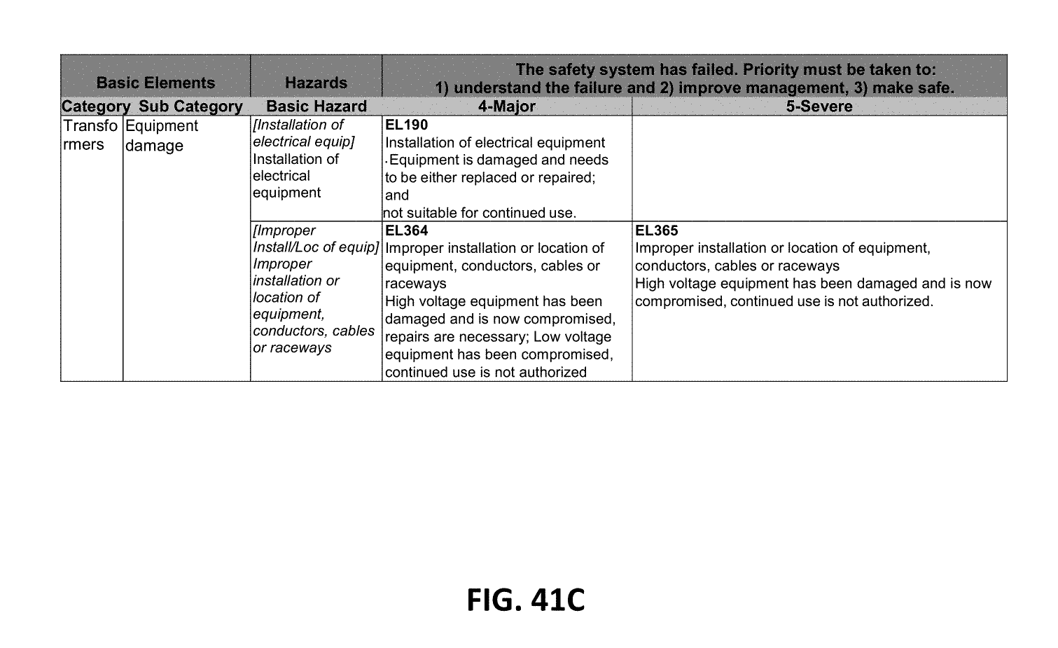

FIG. 41A shows the Hazard Map for Transformers—Equipment damage for 0 (No Hazard) and 1-2 (Business as usual/support for continuous improvement).

FIG. 41B shows the Hazard Map for Transformers—Equipment damage for 3 (Cause for concern).

FIG. 41C shows the Hazard Map for Transformers—Equipment damage for 4-5 (The safety system has failed).

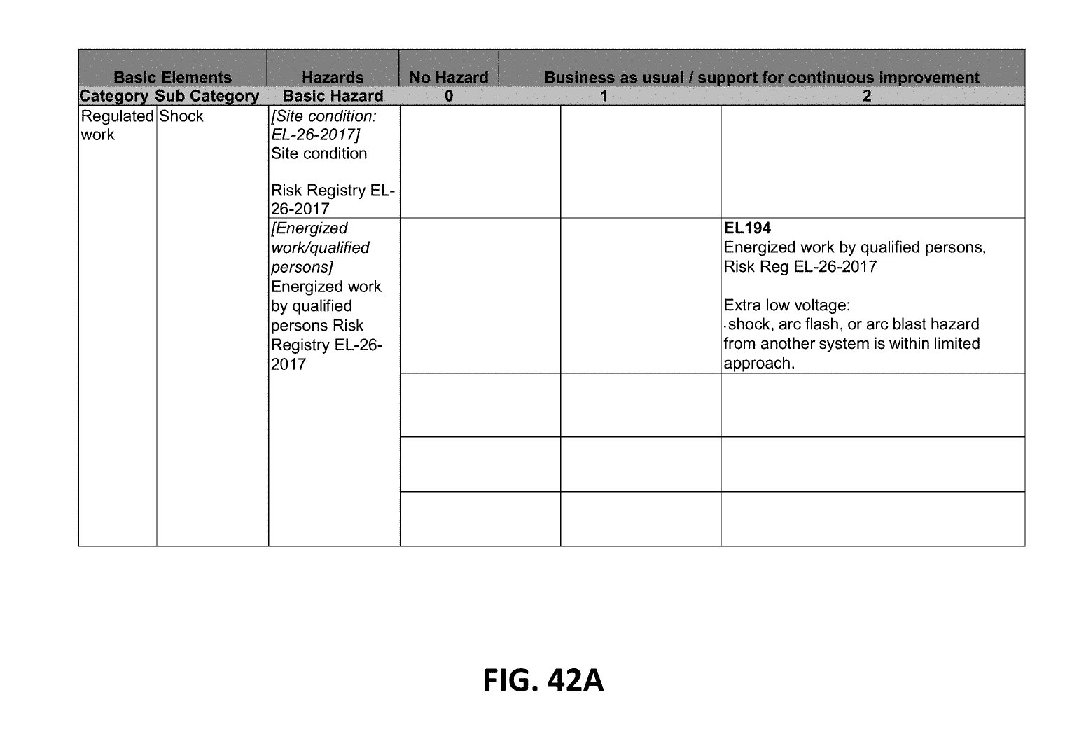

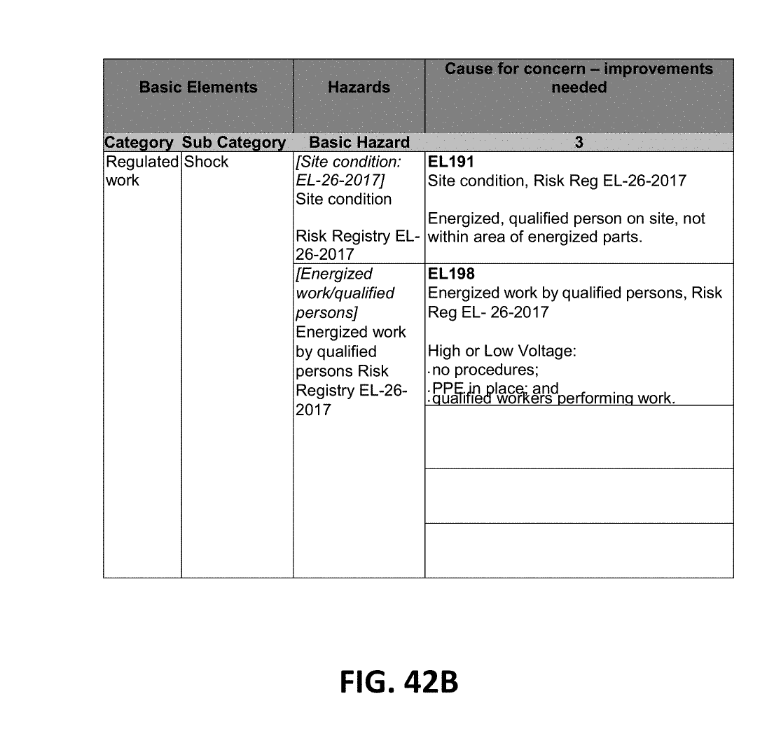

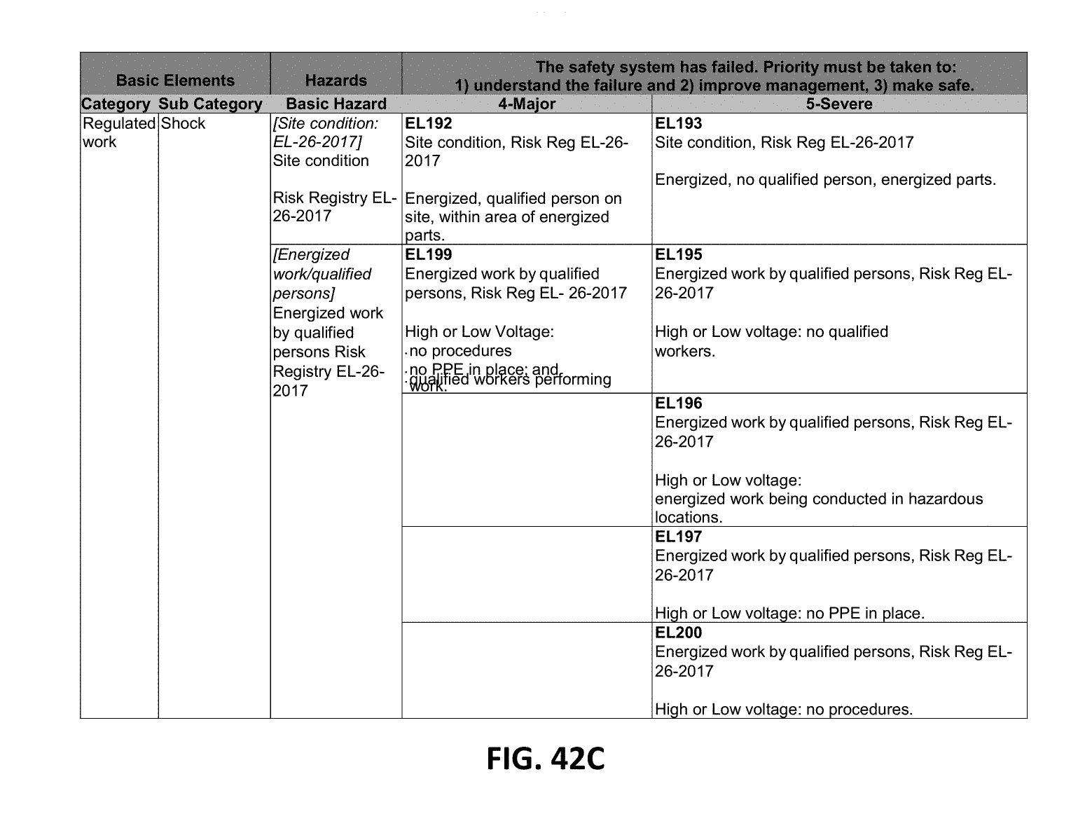

FIG. 42A shows the Hazard Map for Regulated Work—Site condition: EL-26-2017 and Energized work/qualified persons for 0 (No Hazard) and 1-2 (Business as usual/support for continuous improvement).

FIG. 42B shows the Hazard Map for Regulated Work—Site condition: EL-26-2017 and Energized work/qualified persons for 3 (Cause for concern).

FIG. 42C shows the Hazard Map for Regulated Work—Site condition: EL-26-2017 and Energized work/qualified persons for 4-5 (The safety system has failed).

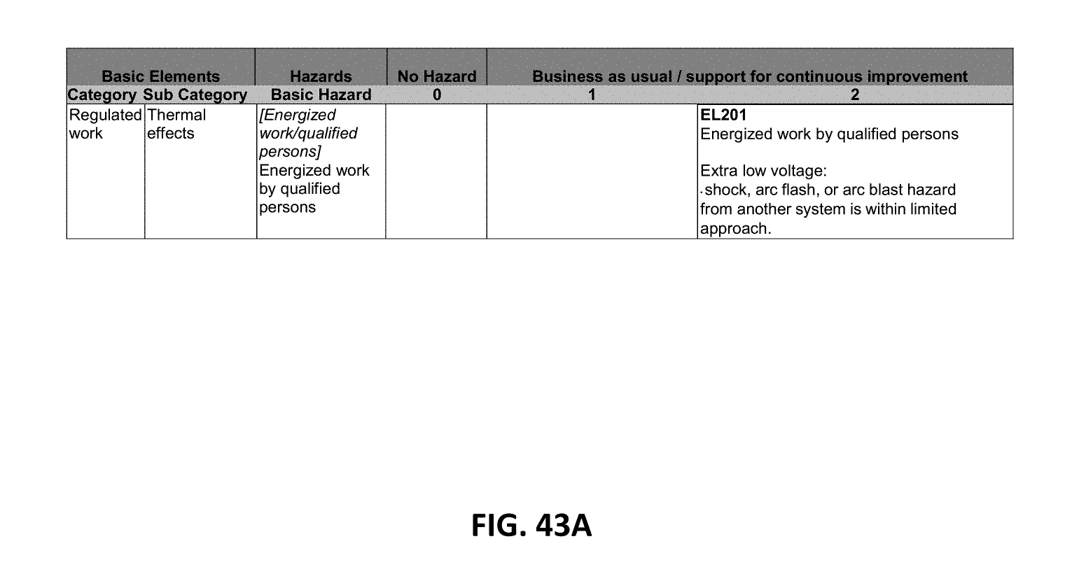

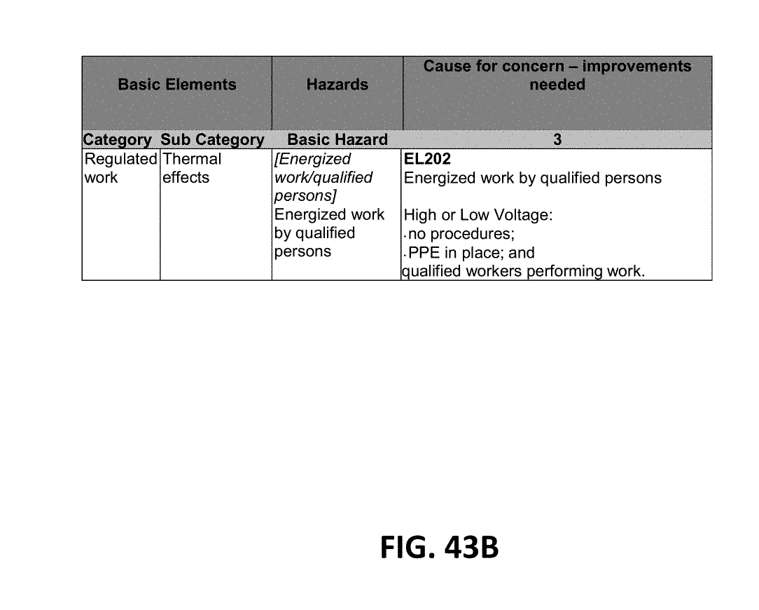

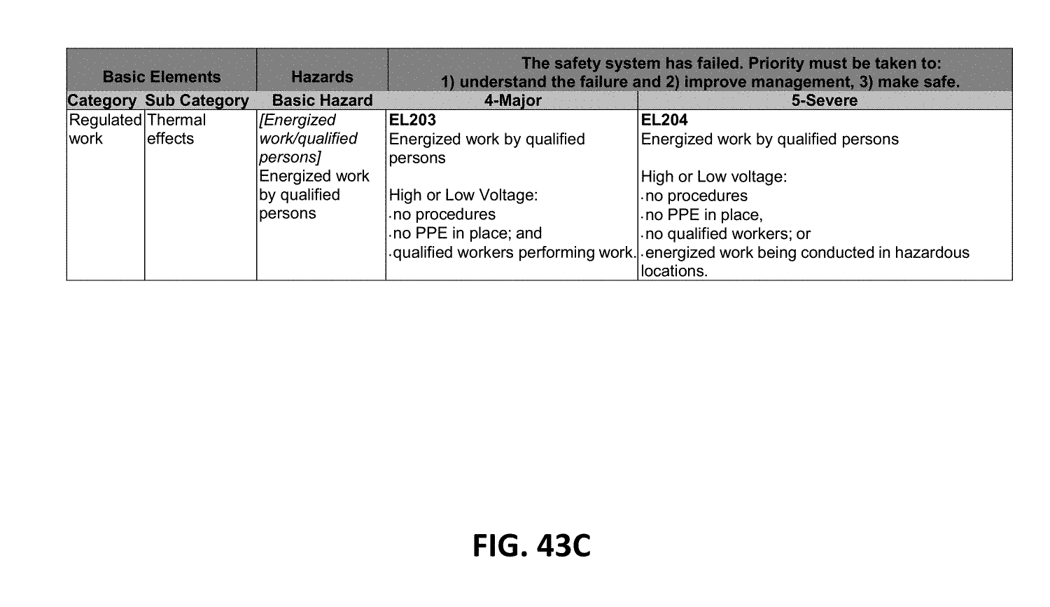

FIG. 43A shows the Hazard Map for Regulated Work—Thermal effects for 0 (No Hazard) and 1-2 (Business as usual/support for continuous improvement).

FIG. 43B shows the Hazard Map for Regulated Work—Thermal effects for 3 (Cause for concern).

FIG. 43C shows the Hazard Map for Regulated Work—Thermal effects for 4-5 (The safety system has failed).

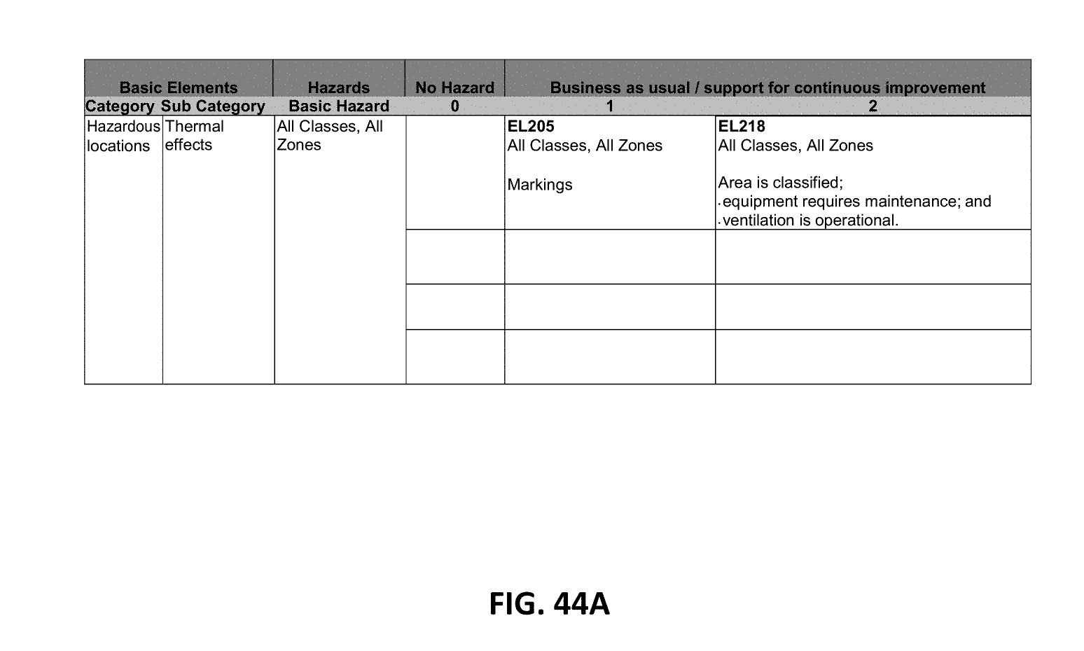

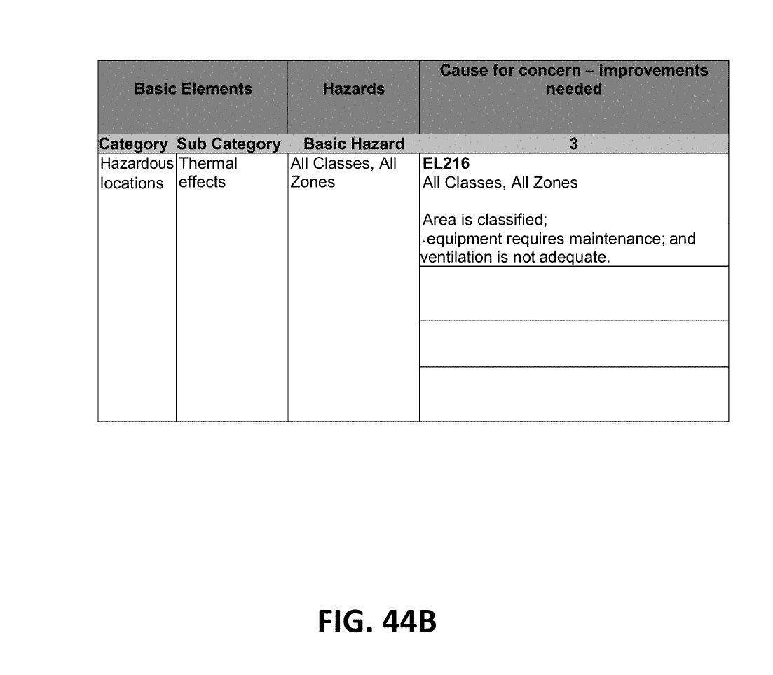

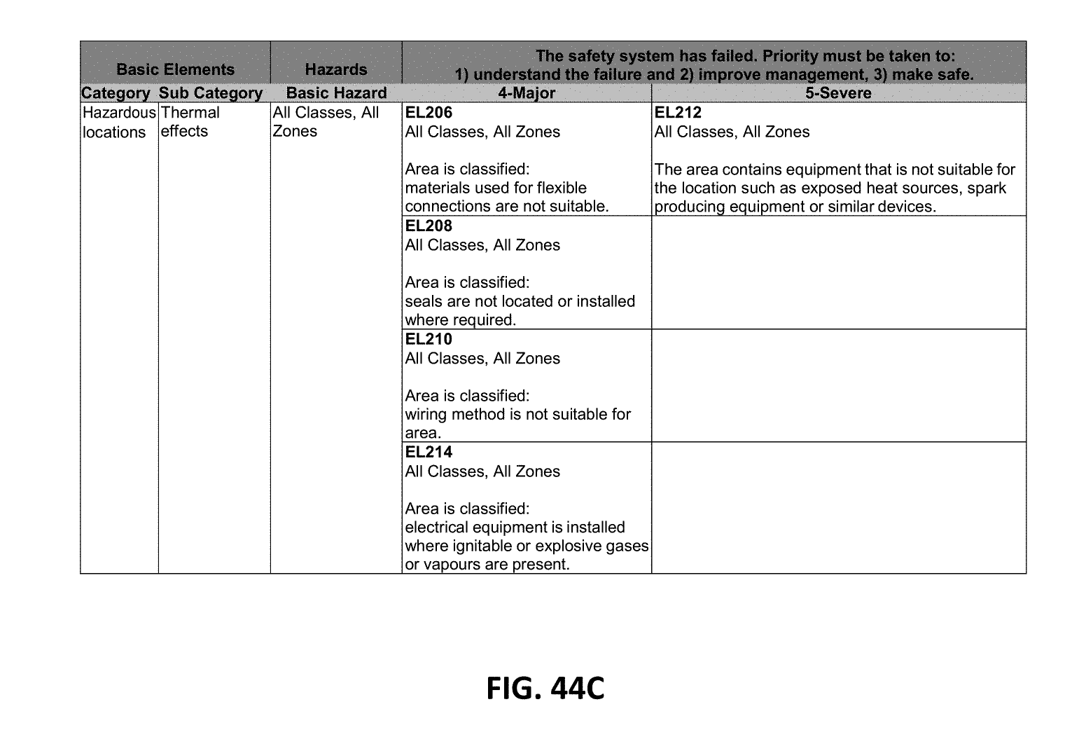

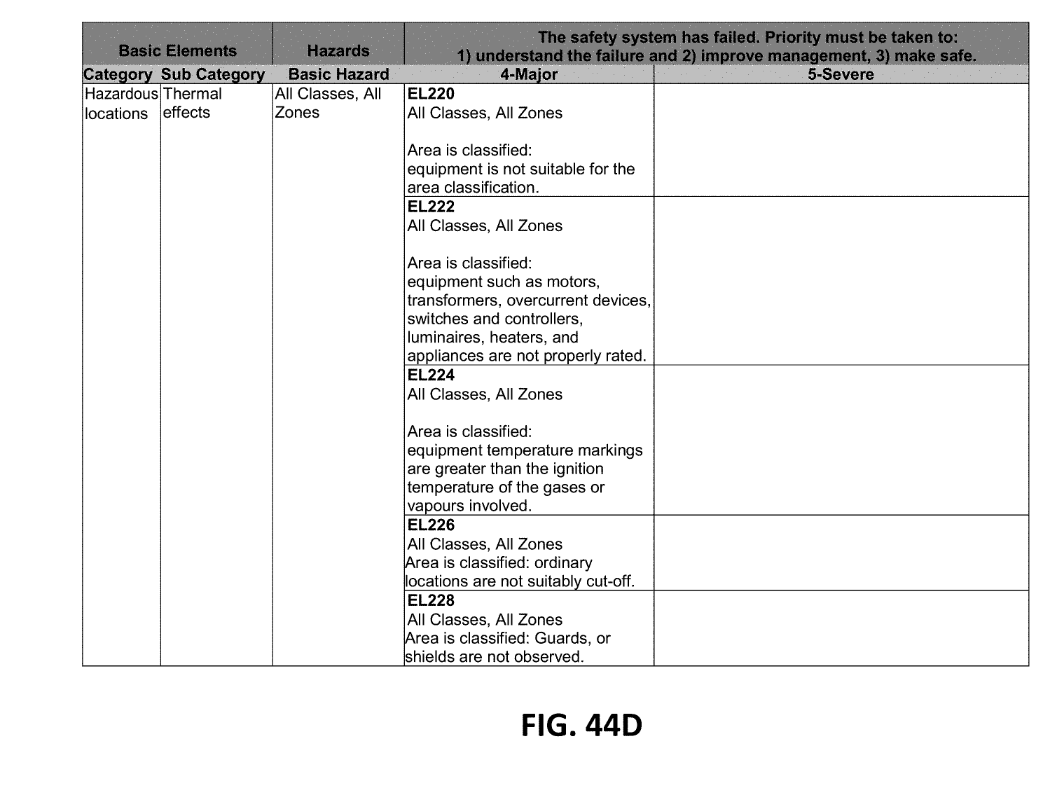

FIG. 44A shows the Hazard Map for Hazardous locations—Thermal effects—All classes, All zones for 0 (No Hazard) and 1-2 (Business as usual/support for continuous improvement).

FIG. 44B shows the Hazard Map for Hazardous locations—Thermal effects—All classes, All zones for 3 (Cause for concern).

FIG. 44C shows Part 1 of the Hazard Map for Hazardous locations—Thermal effects—All classes, All zones for 4-5 (The safety system has failed).

FIG. 44D shows Part 2 of the Hazard Map for Hazardous locations—Thermal effects—All classes, All zones for 4-5 (The safety system has failed).

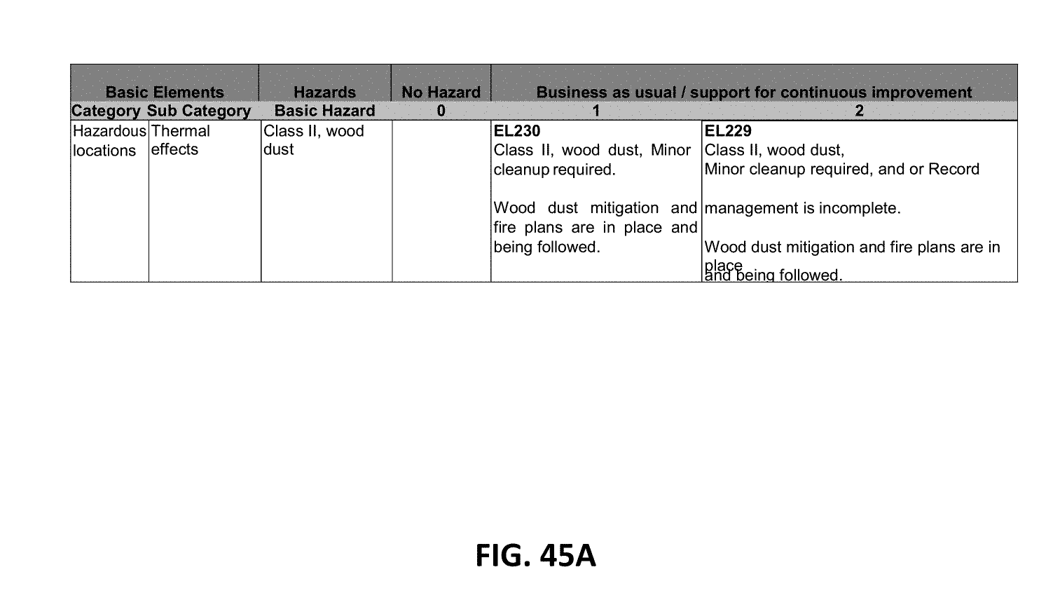

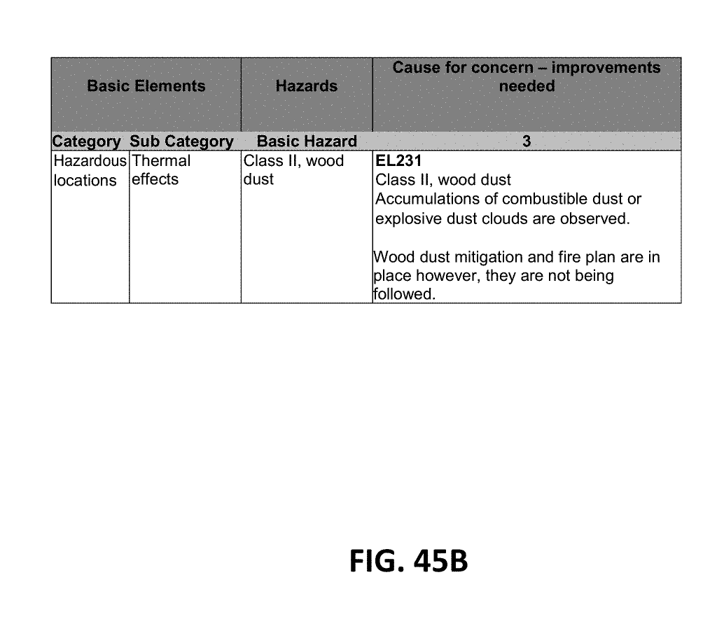

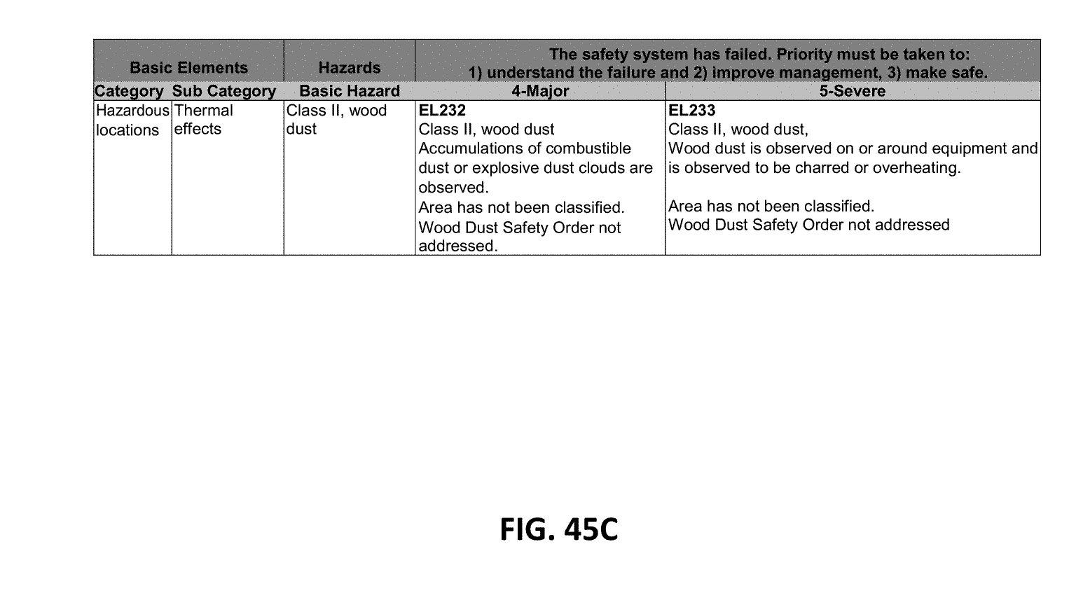

FIG. 45A shows the Hazard Map for Hazardous locations—Thermal effects—Class II, wood dust for 0 (No Hazard) and 1-2 (Business as usual/support for continuous improvement).

FIG. 45B shows the Hazard Map for Hazardous locations—Thermal effects—Class II, wood dust for 3 (Cause for concern).

FIG. 45C shows the Hazard Map for Hazardous locations—Thermal effects—Class II, wood dust for 4-5 (The safety system has failed).

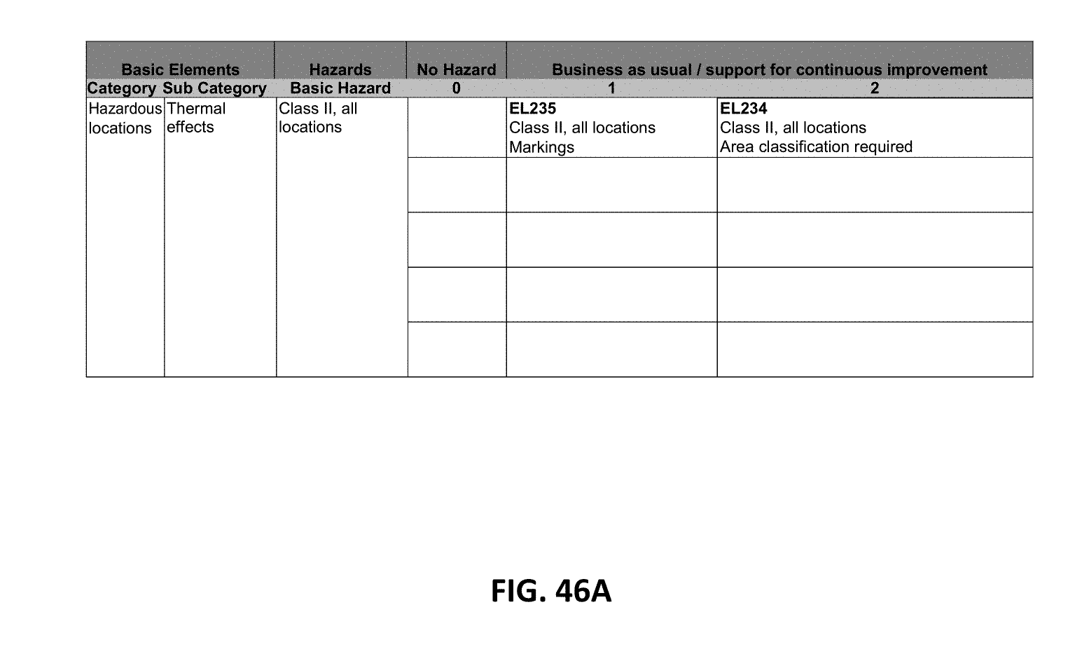

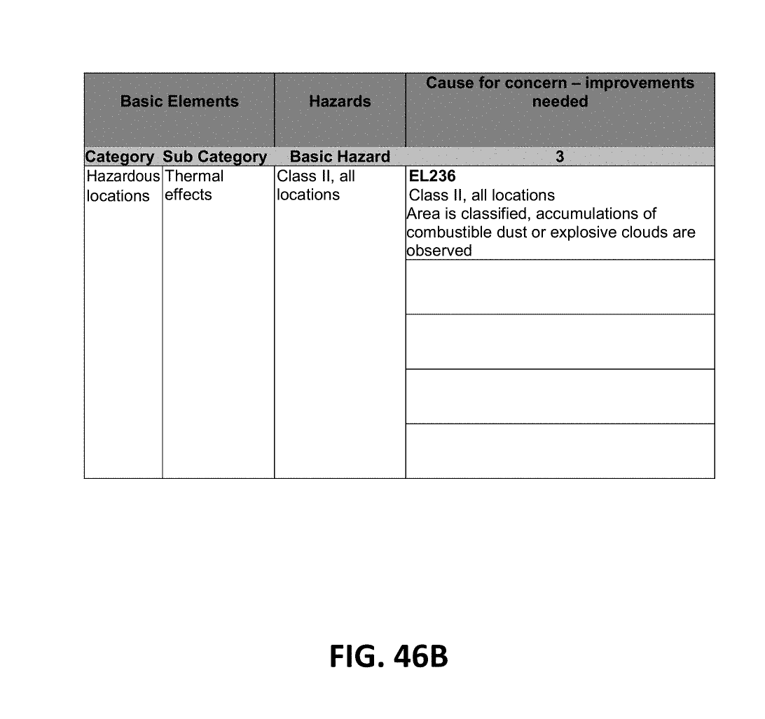

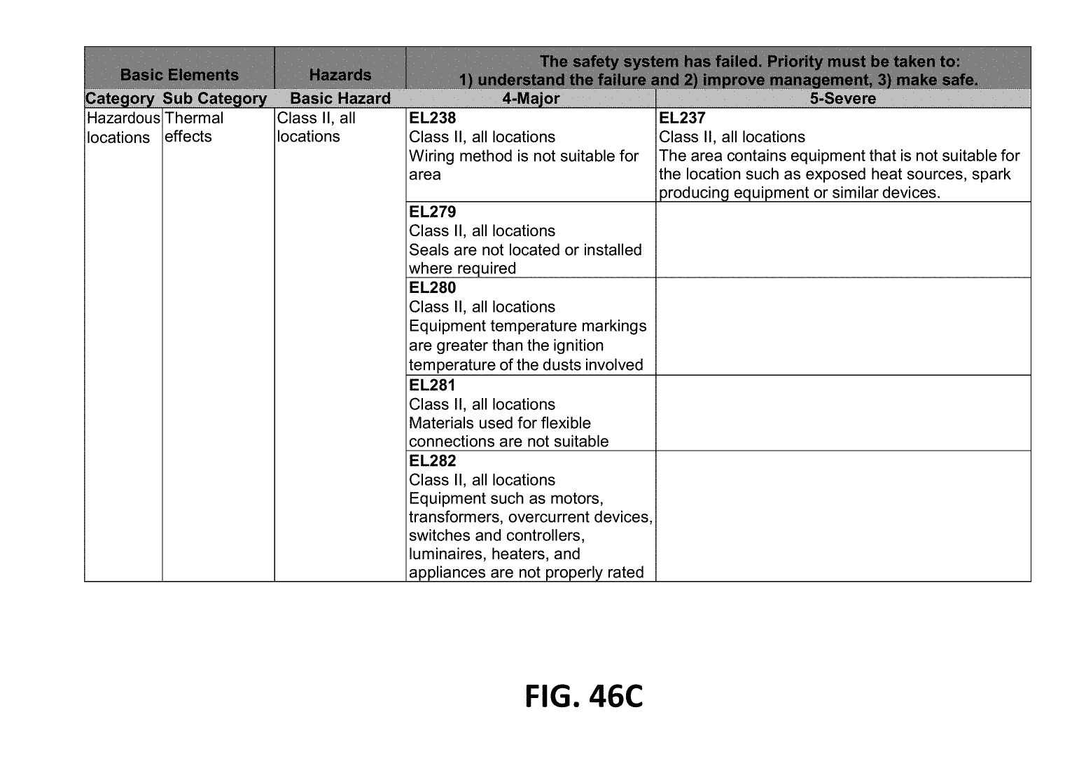

FIG. 46A shows the Hazard Map for Hazardous locations—Thermal effects—Class II, all locations for 0 (No Hazard) and 1-2 (Business as usual/support for continuous improvement).

FIG. 46B shows the Hazard Map for Hazardous locations—Thermal effects—Class II, all locations for 3 (Cause for concern).

FIG. 46C shows the Hazard Map for Hazardous locations—Thermal effects—Class II, all locations for 4-5 (The safety system has failed).

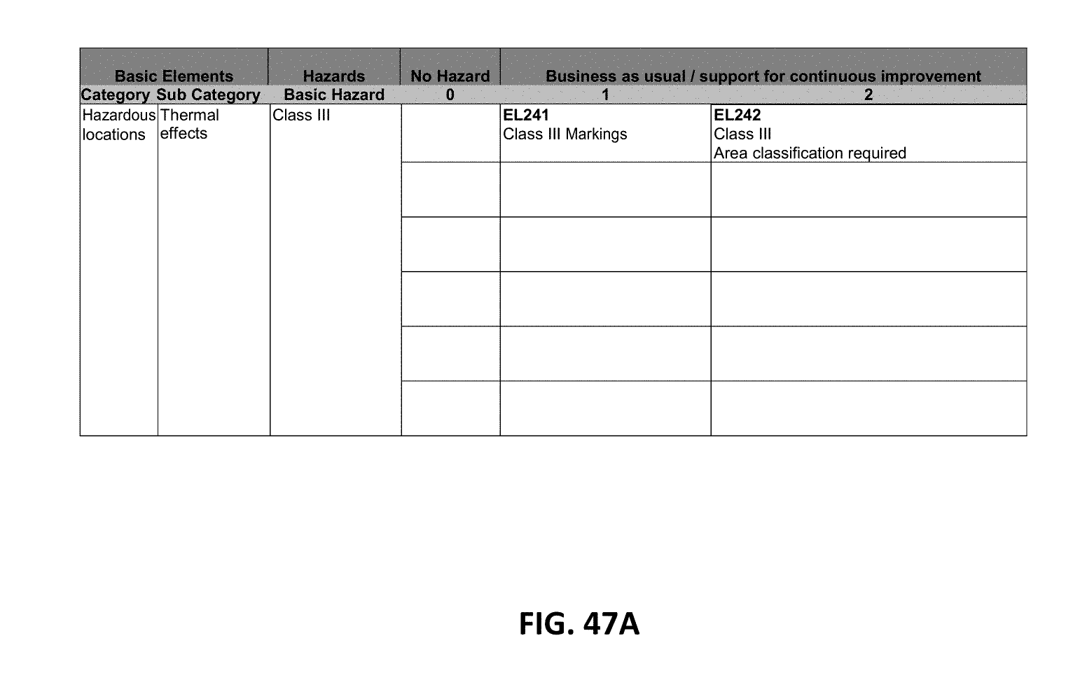

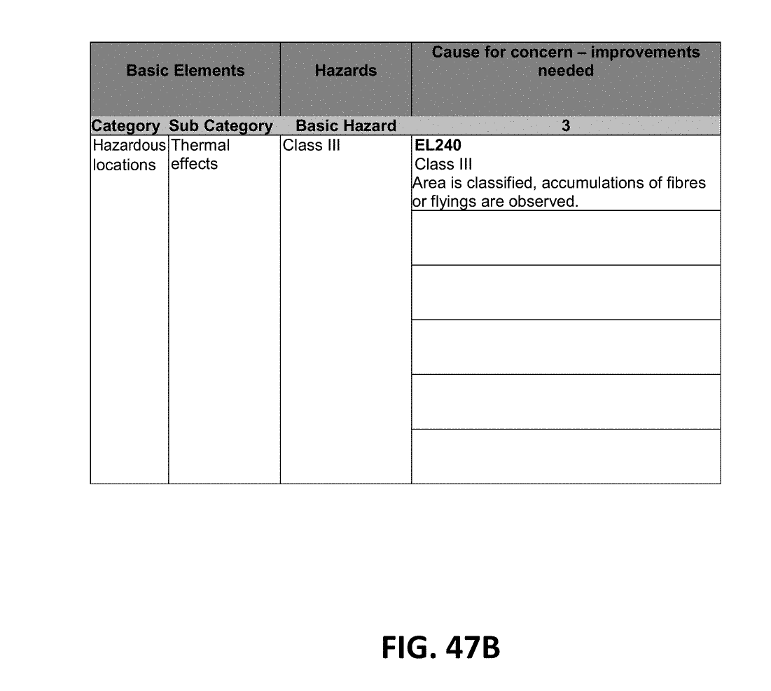

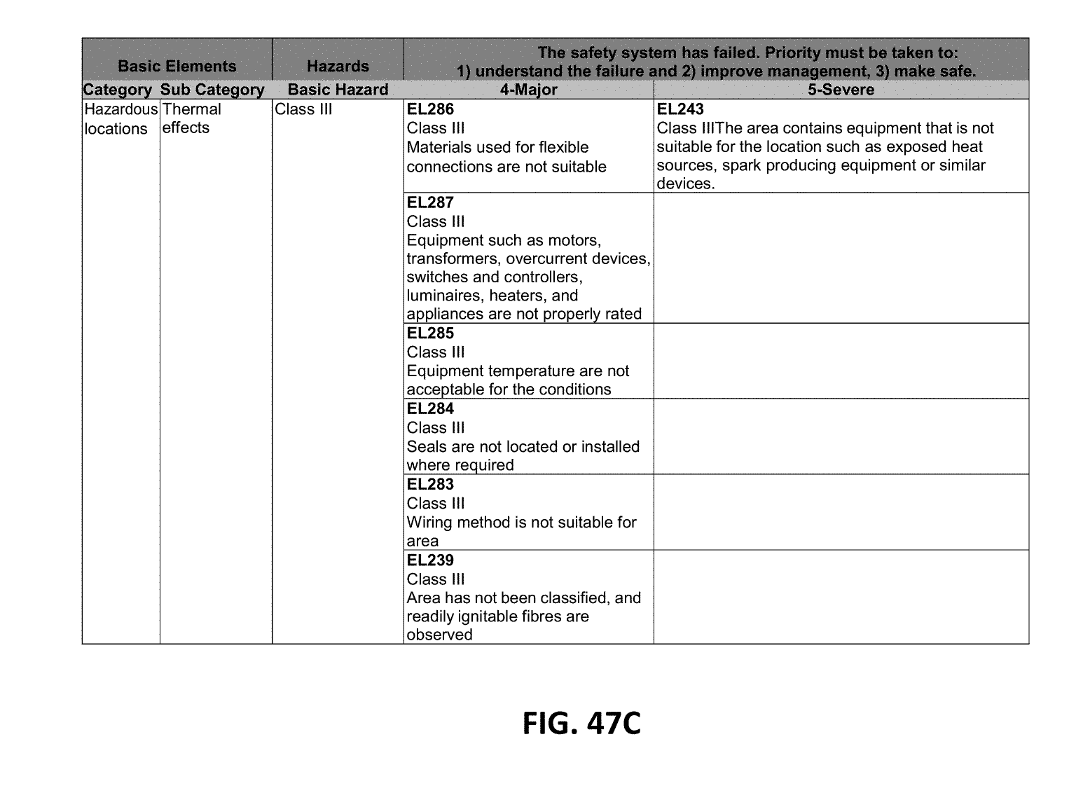

FIG. 47A shows the Hazard Map for Hazardous locations—Thermal effects—Class III for 0 (No Hazard) and 1-2 (Business as usual/support for continuous improvement).

FIG. 47B shows the Hazard Map for Hazardous locations—Thermal effects—Class III for 3 (Cause for concern).

FIG. 47C shows the Hazard Map for Hazardous locations—Thermal effects—Class III for 4-5 (The safety system has failed).

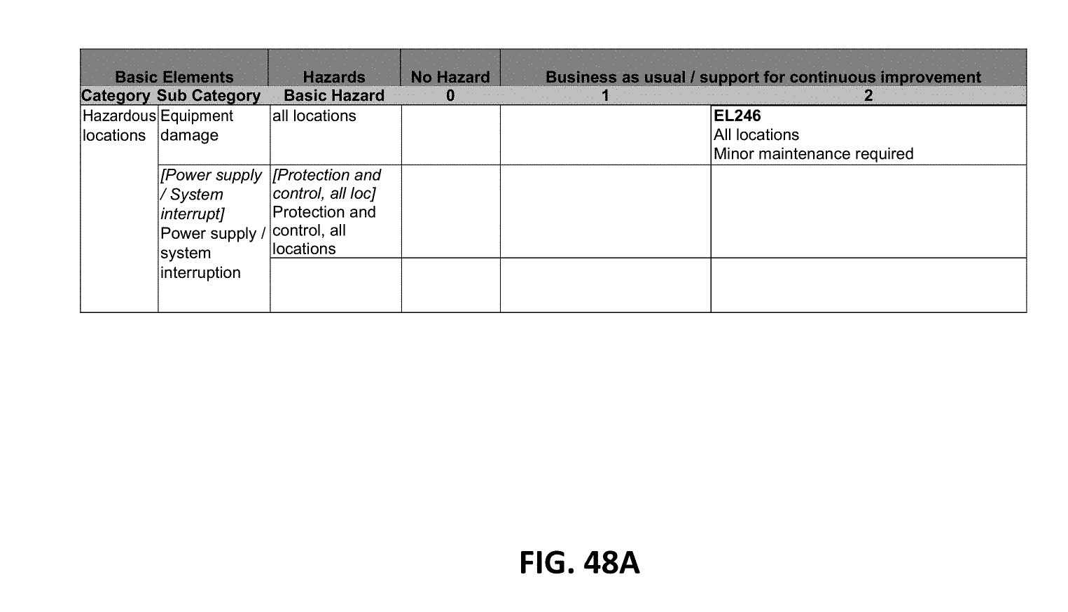

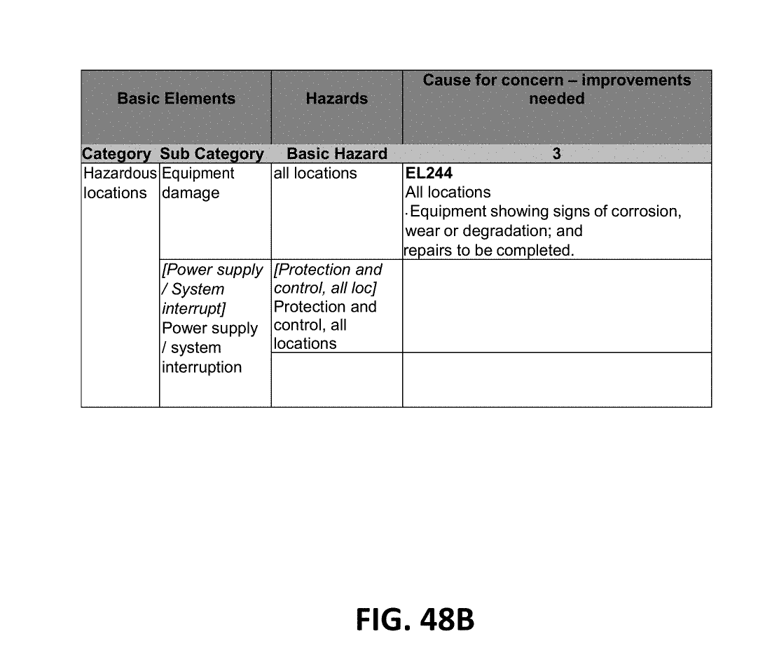

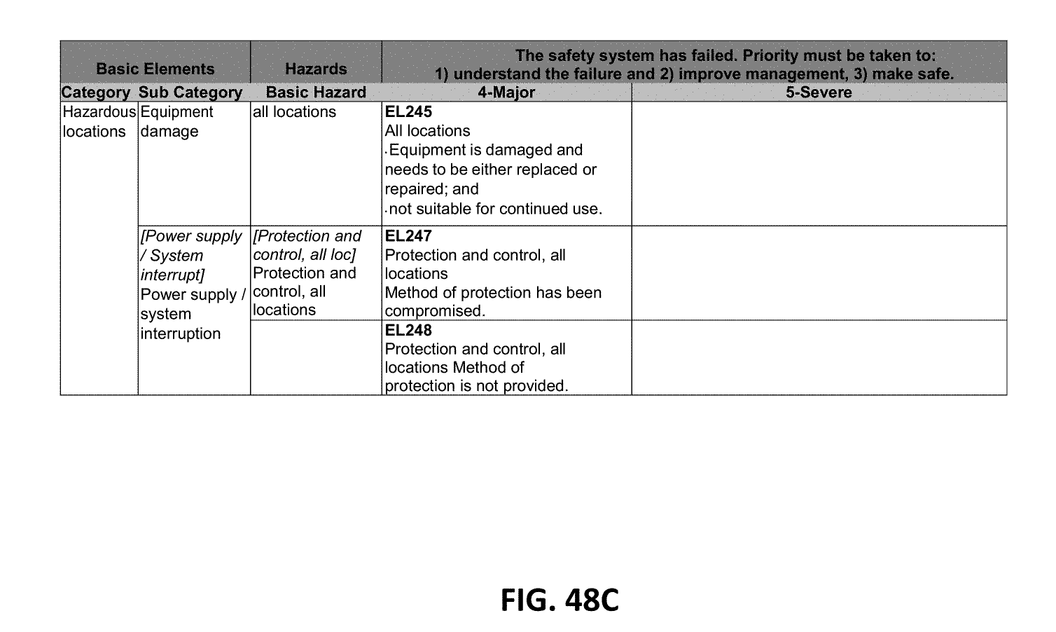

FIG. 48A shows the Hazard Map for Hazardous locations—Equipment damage and Hazardous locations—Power supply/system interruption for 0 (No Hazard) and 1-2 (Business as usual/support for continuous improvement).

FIG. 48B shows the Hazard Map for Hazardous locations—Equipment damage and Hazardous locations—Power supply/system interruption for 3 (Cause for concern).

FIG. 48C shows the Hazard Map for Hazardous locations—Equipment damage and Hazardous locations—Power supply/system interruption for 4-5 (The safety system has failed).

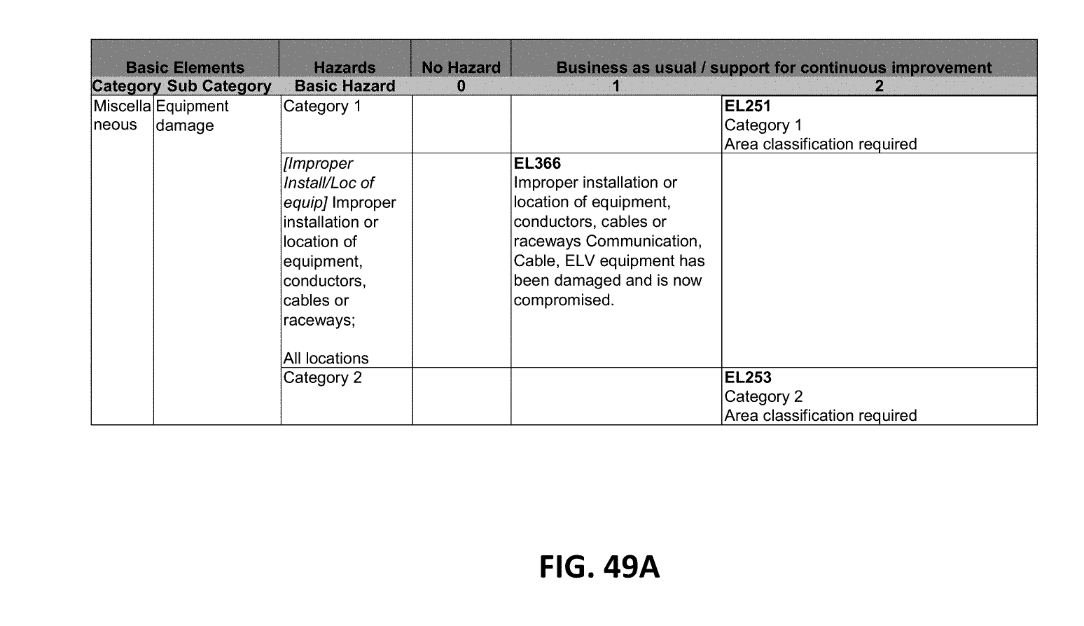

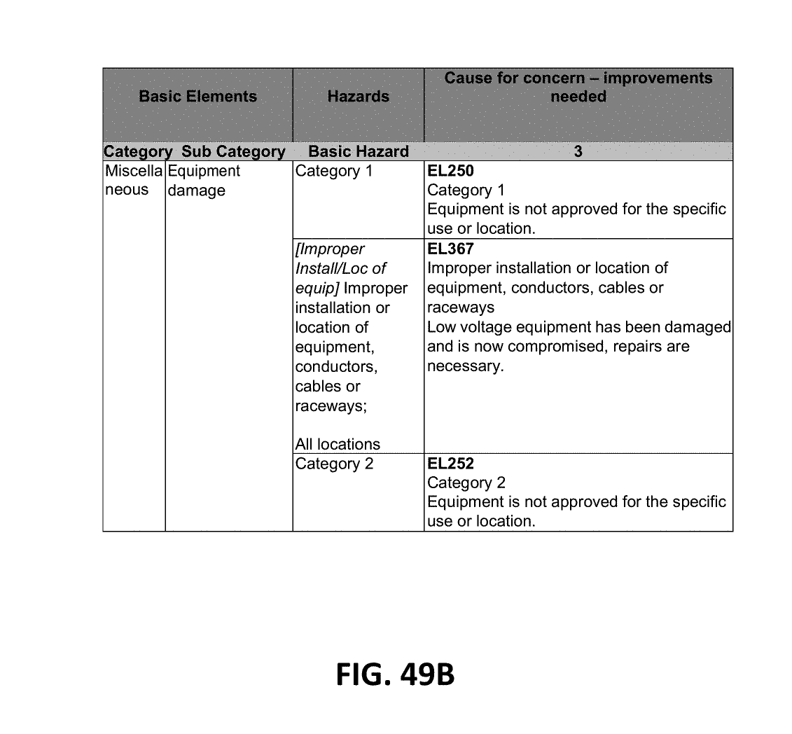

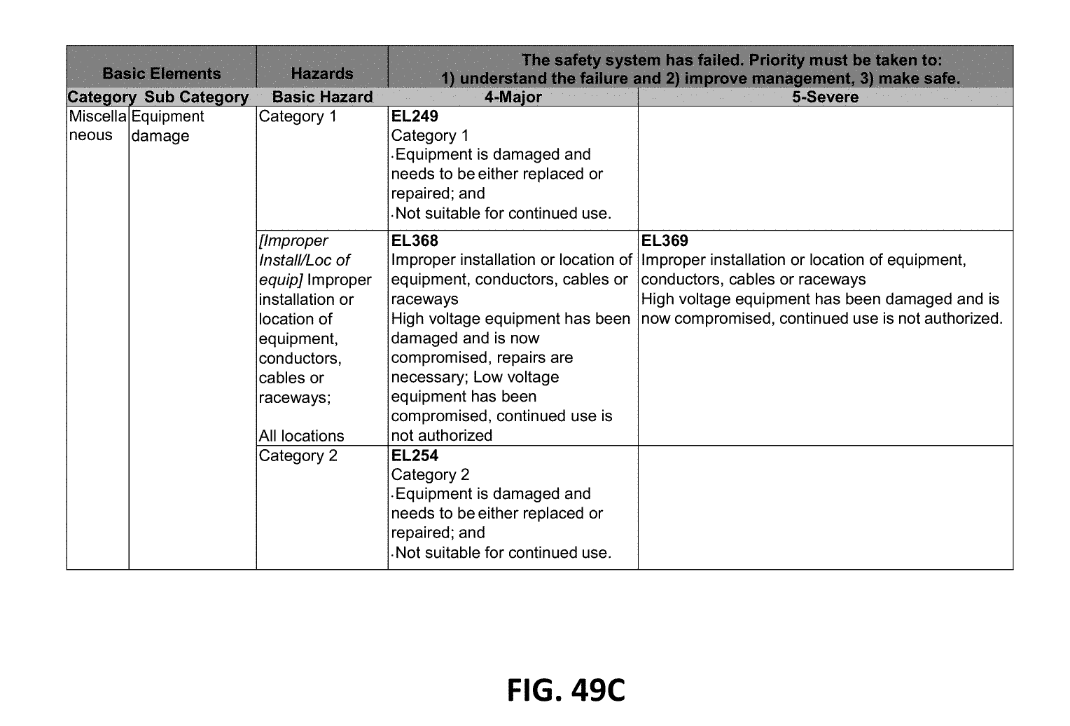

FIG. 49A shows the Hazard Map for Miscellaneous—Equipment damage for 0 (No Hazard) and 1-2 (Business as usual/support for continuous improvement).

FIG. 49B shows the Hazard Map for Miscellaneous—Equipment damage for 3 (Cause for concern).

FIG. 49C shows the Hazard Map for Miscellaneous—Equipment damage for 4-5 (The safety system has failed).

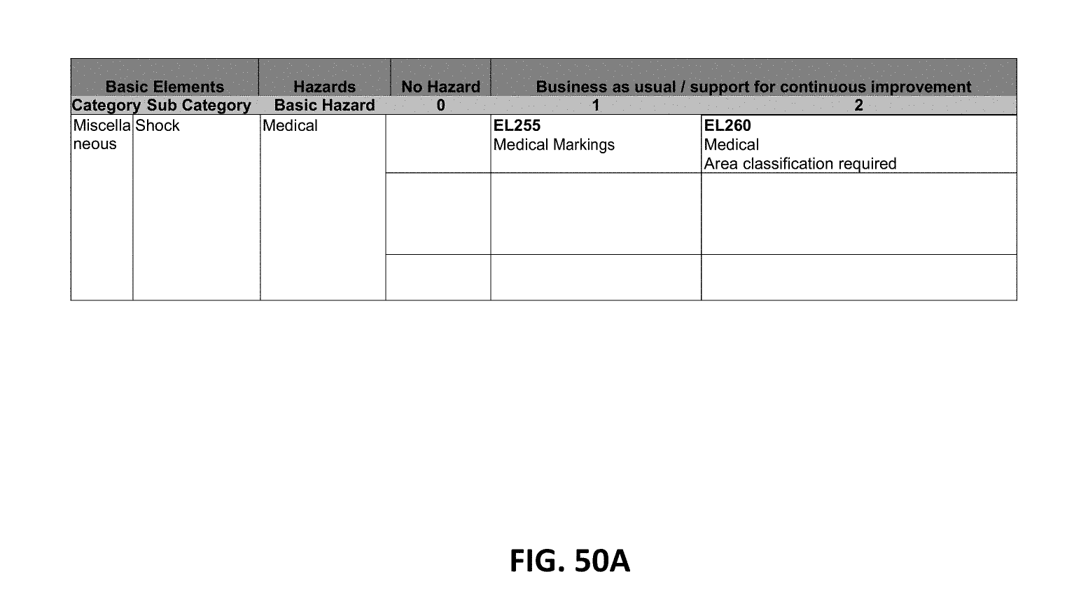

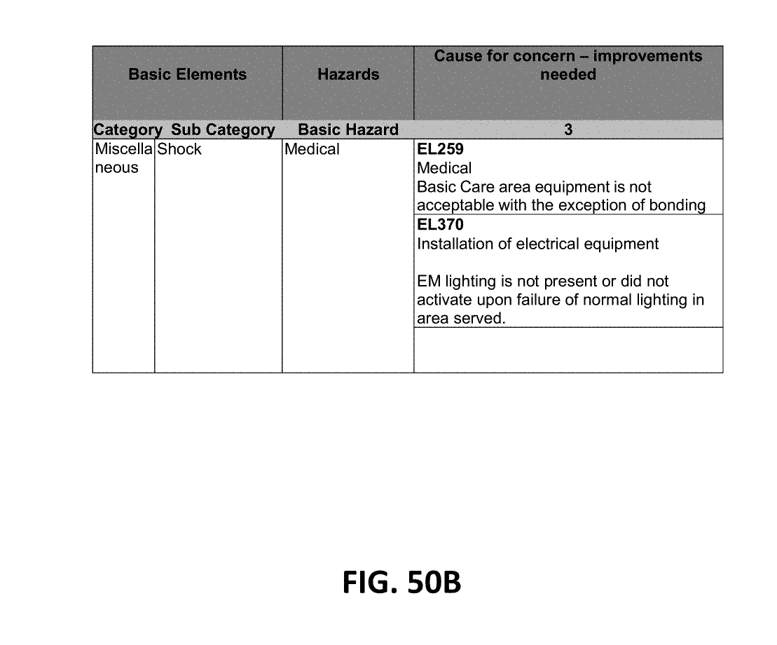

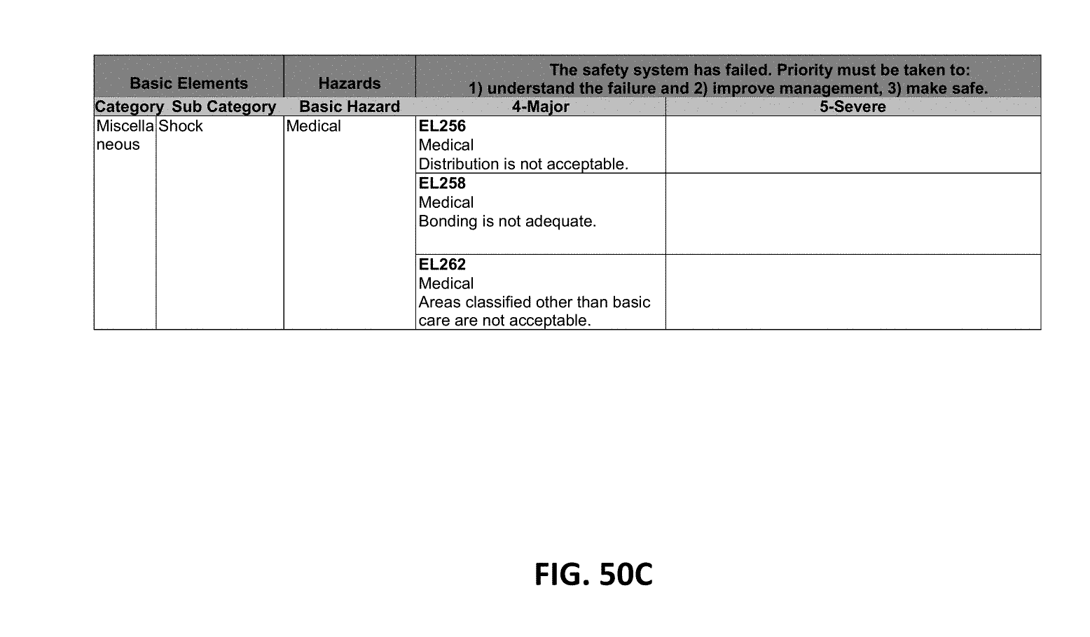

FIG. 50A shows the Hazard Map for Miscellaneous—Shock—Medical for 0 (No Hazard) and 1-2 (Business as usual/support for continuous improvement).

FIG. 50B shows the Hazard Map for Miscellaneous—Shock—Medical for 3 (Cause for concern).

FIG. 50C shows the Hazard Map for Miscellaneous—Shock—Medical for 4-5 (The safety system has failed).

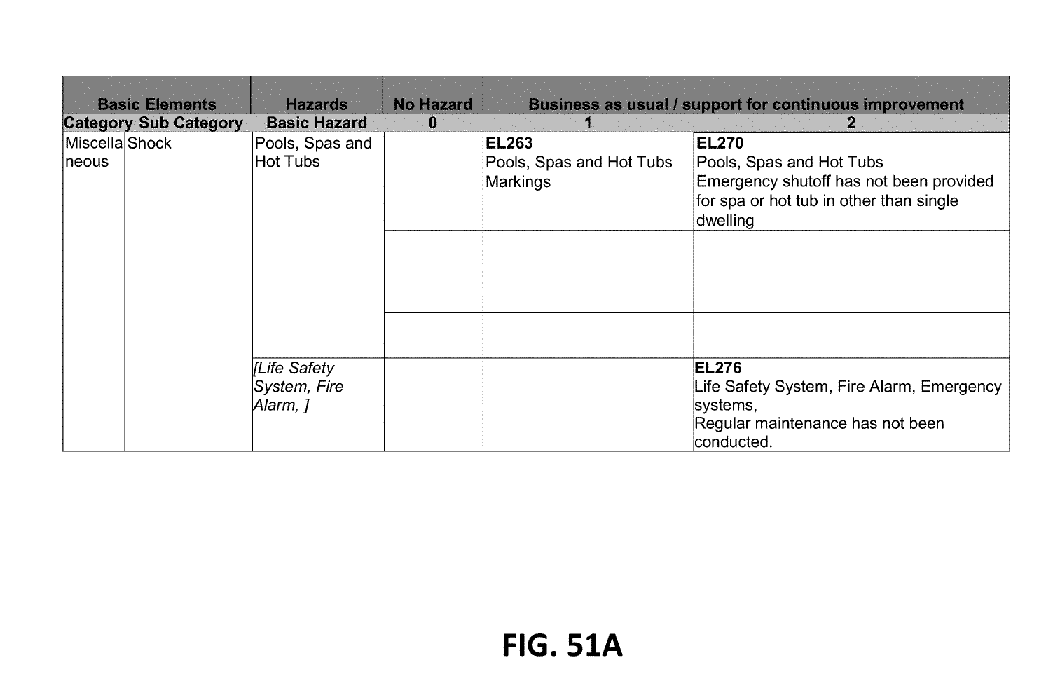

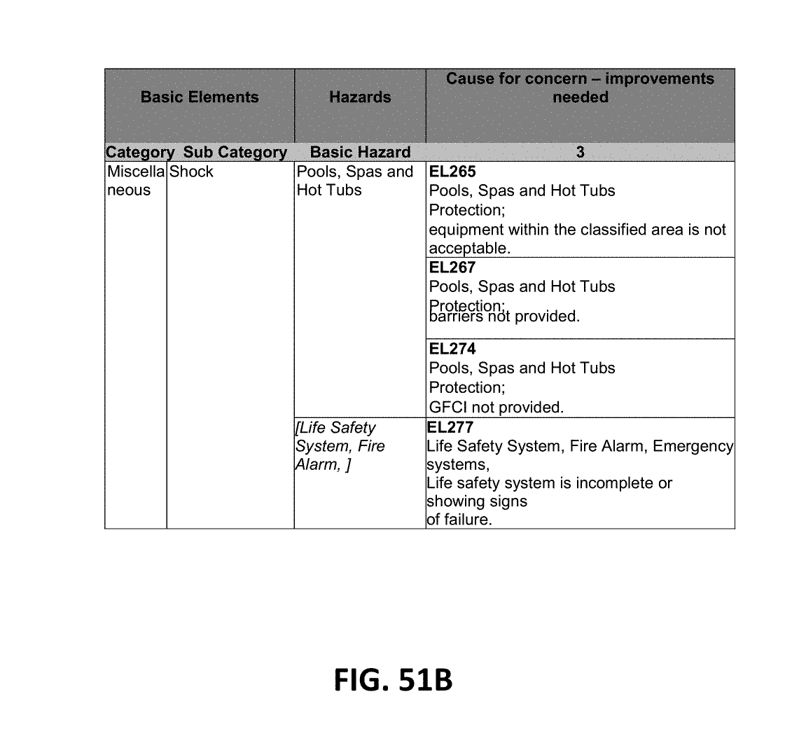

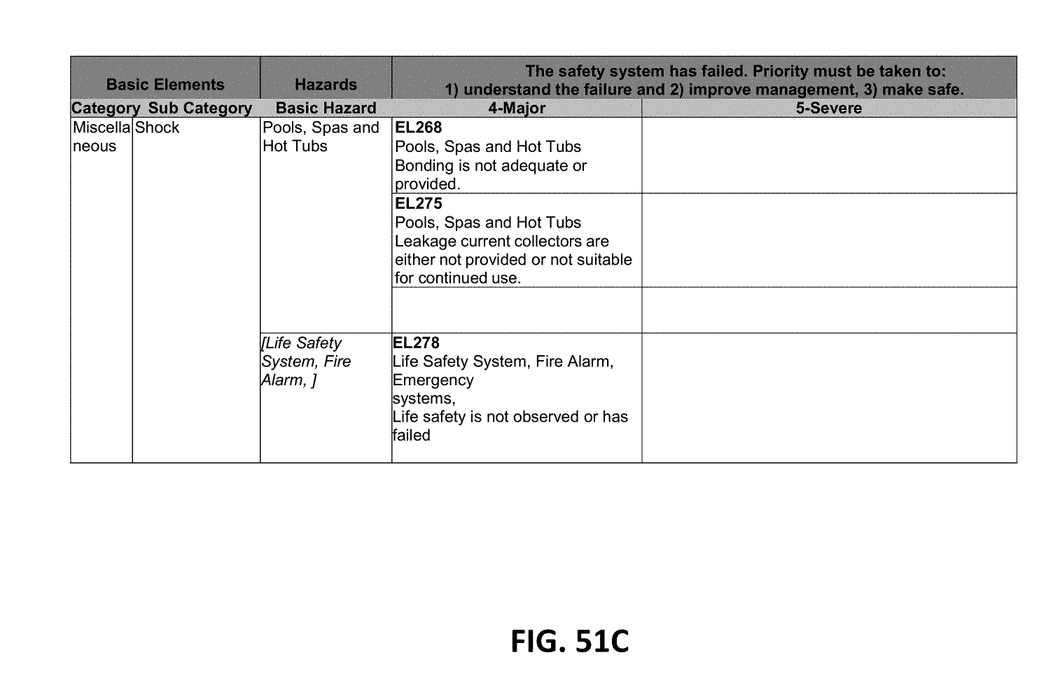

FIG. 51A shows the Hazard Map for Miscellaneous—Shock—Pools, Spas and Hot Tubs and Miscellaneous—Shock Life Safety System, Fire Alarm for 0 (No Hazard) and 1-2 (Business as usual/support for continuous improvement).

FIG. 51B shows the Hazard Map for Miscellaneous—Shock—Pools, Spas and Hot Tubs and Miscellaneous—Shock Life Safety System, Fire Alarm for 3 (Cause for concern).

FIG. 51C shows the Hazard Map for Miscellaneous—Shock—Pools, Spas and Hot Tubs and Miscellaneous—Shock Life Safety System, Fire Alarm for −5 (The safety system has failed).

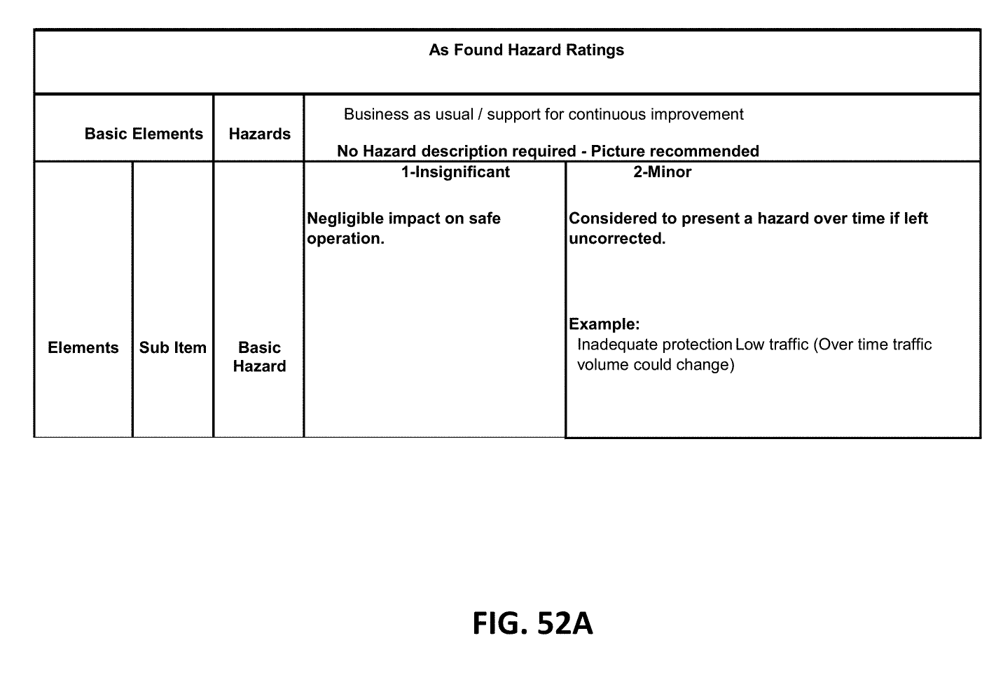

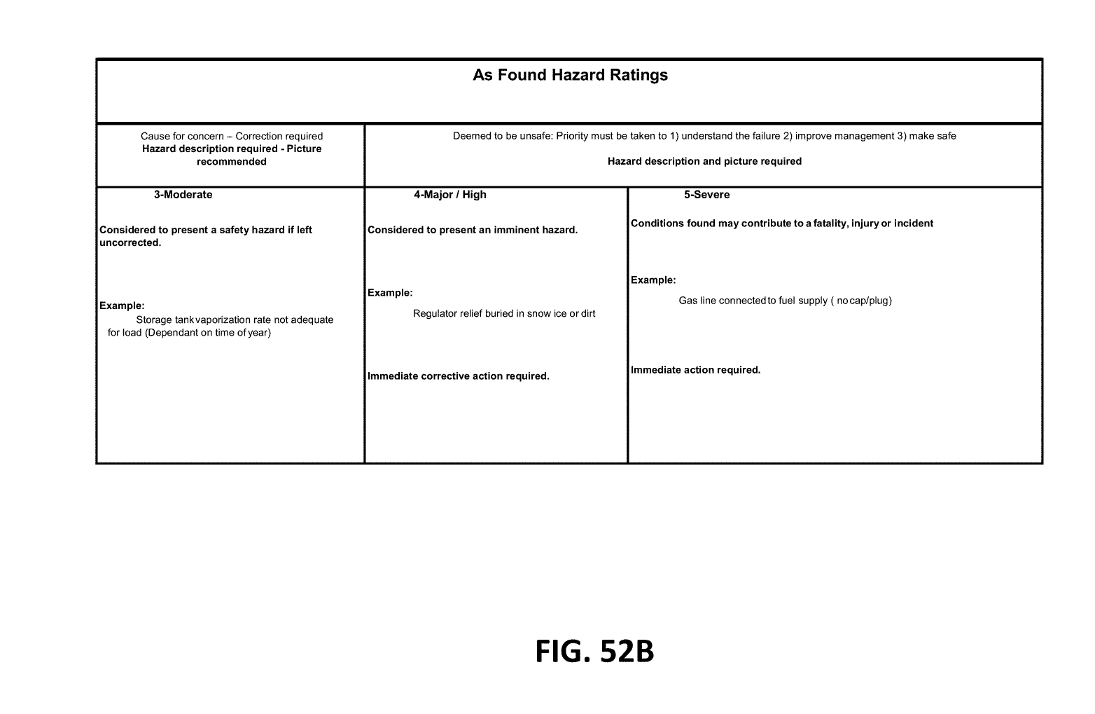

FIG. 52A shows the GA Hazard Map scale for 1-2 (Business as usual/support for continuous improvement).

FIG. 52B shows the GA Hazard Map scale for 3 (Cause for concern) and 4-5 (Deemed to be unsafe).

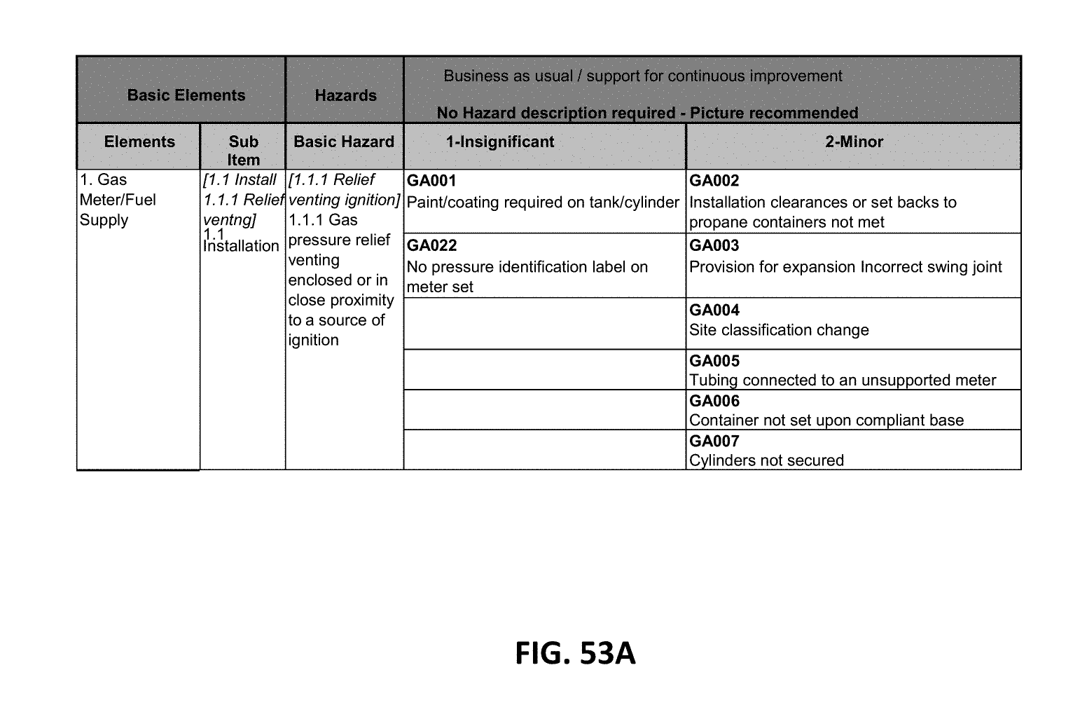

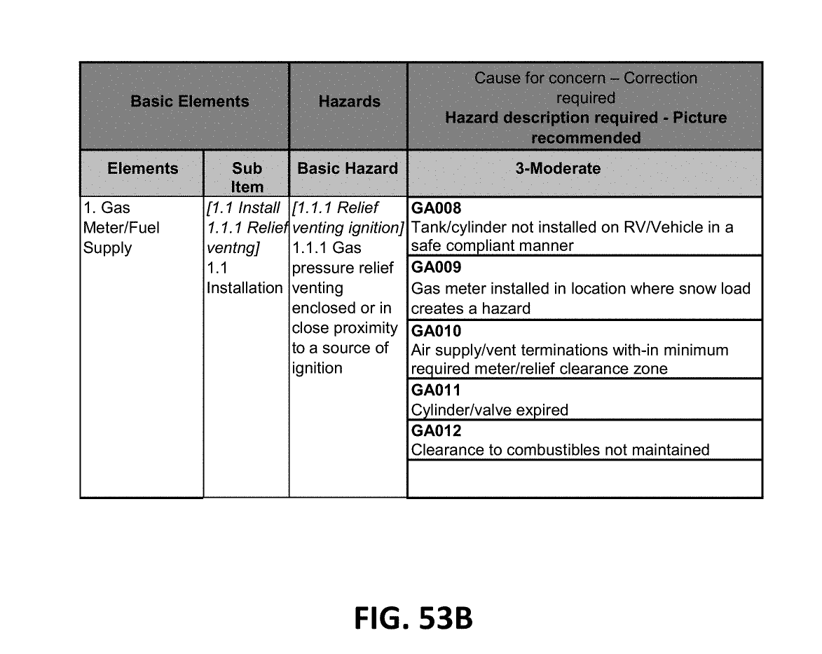

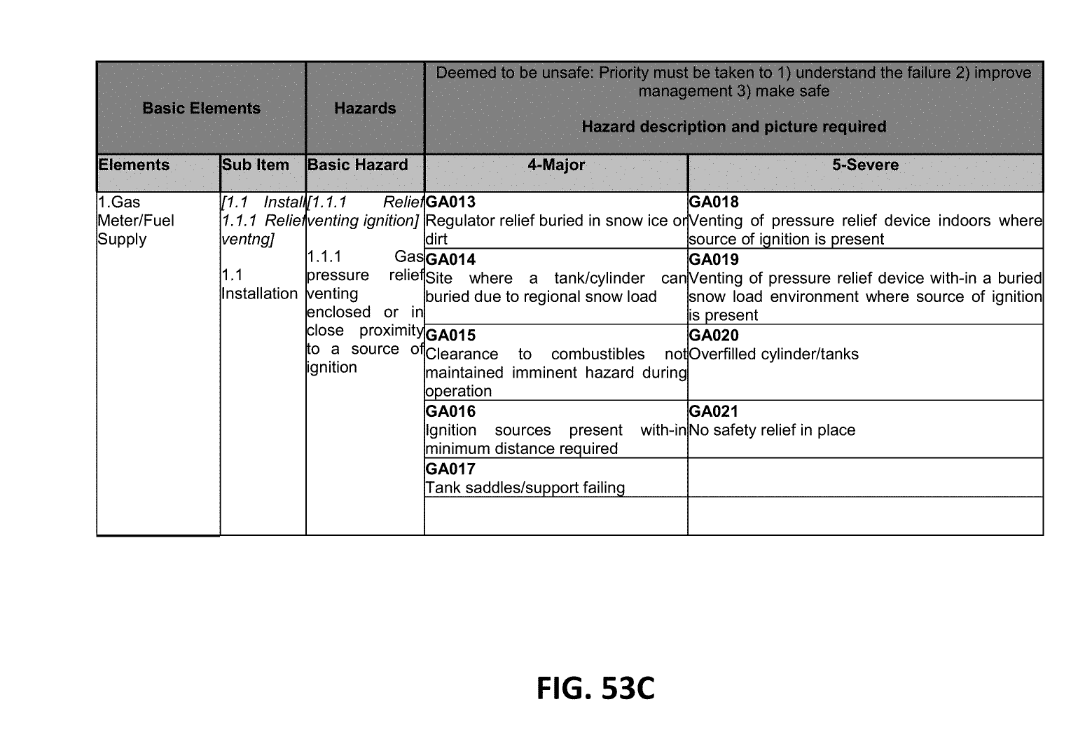

FIG. 53A shows the Hazard Map for Gas Meter/Fuel Supply—Install—Relief venting for 1-2 (Business as usual/support for continuous improvement).

FIG. 53B shows the Hazard Map for Gas Meter/Fuel Supply—Install—Relief venting for 3 (Cause for concern).

FIG. 53C shows the Hazard Map for Gas Meter/Fuel Supply—Install—Relief venting for 4-5 (Deemed to be unsafe).

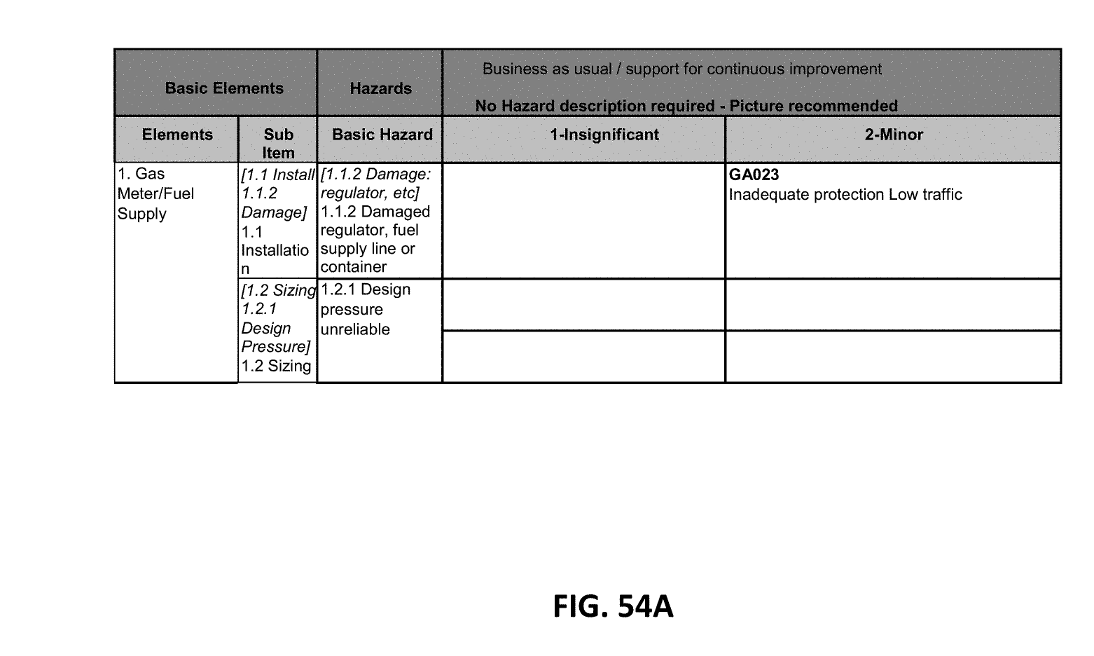

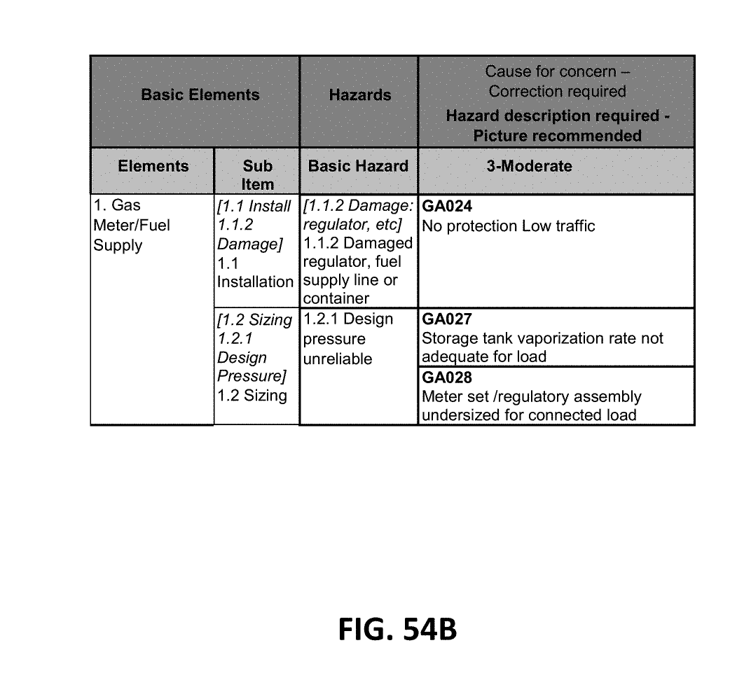

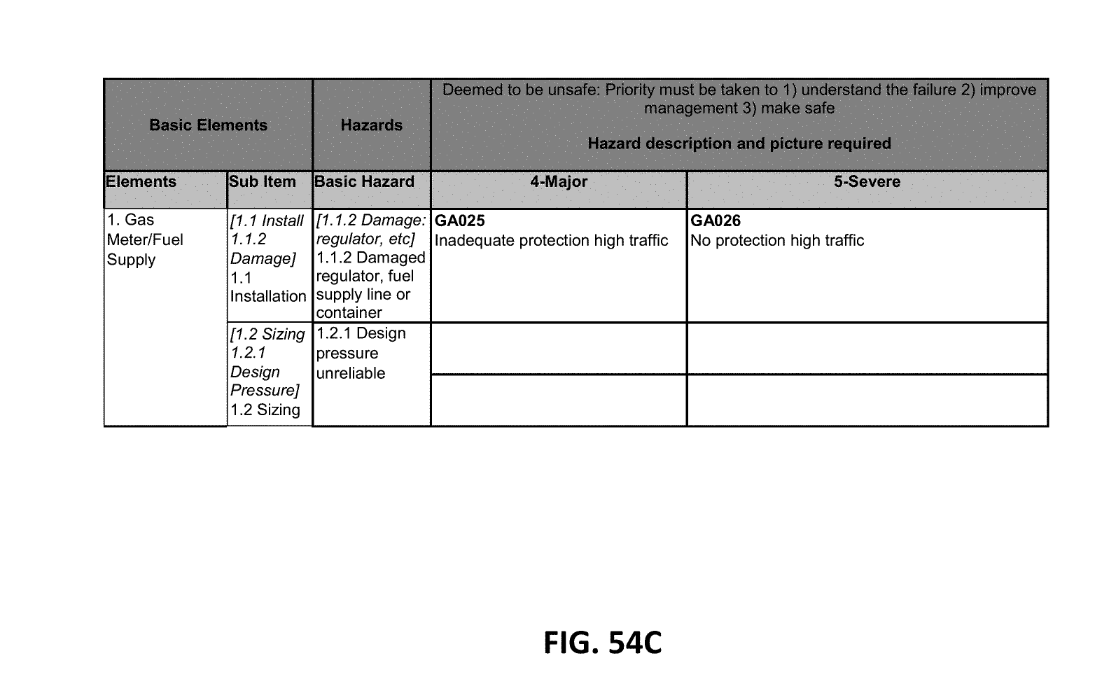

FIG. 54A shows the Hazard Map for Gas Meter/Fuel Supply—Install—Damage and Gas Meter/Fuel Supply—Sizing Design Pressure for 1-2 (Business as usual/support for continuous improvement).

FIG. 54B shows the Hazard Map for Gas Meter/Fuel Supply—Install—Damage and Gas Meter/Fuel Supply—Sizing Design Pressure for 3 (Cause for concern).

FIG. 54C shows the Hazard Map for Gas Meter/Fuel Supply—Install—Damage and Gas Meter/Fuel Supply—Sizing Design Pressure for 4-5 (Deemed to be unsafe).

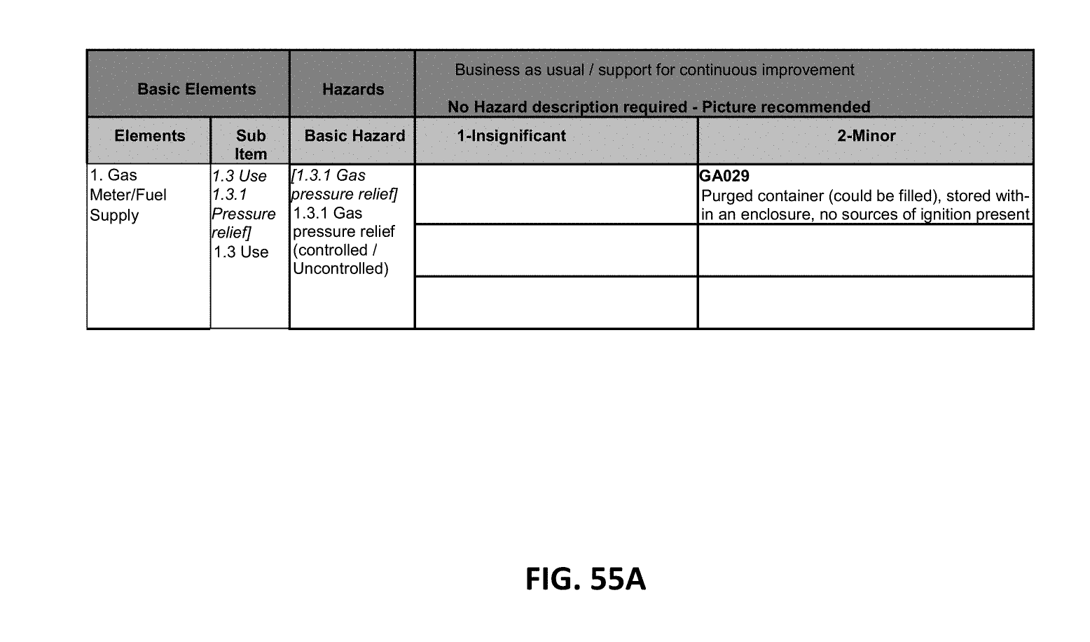

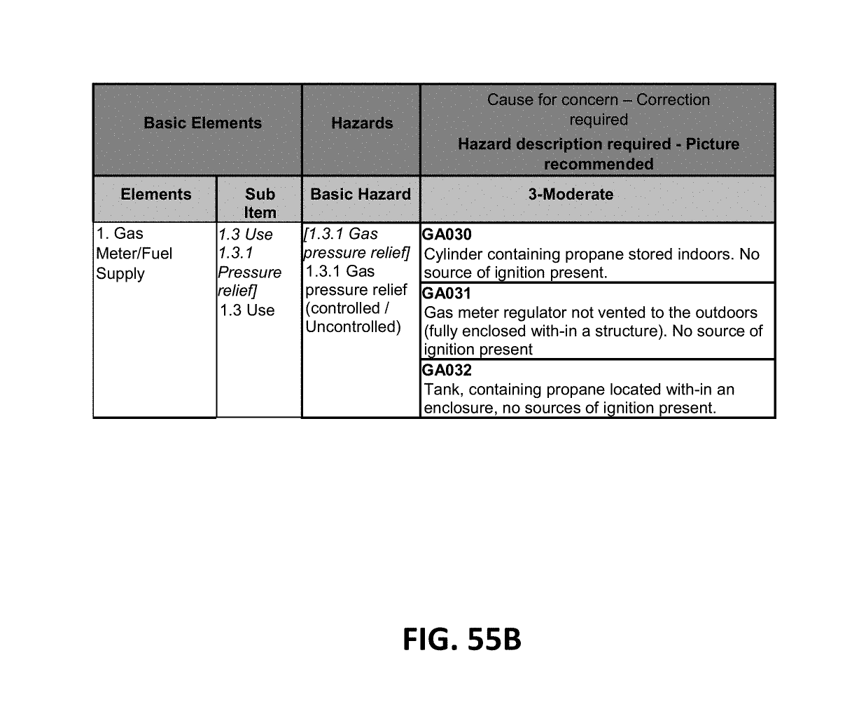

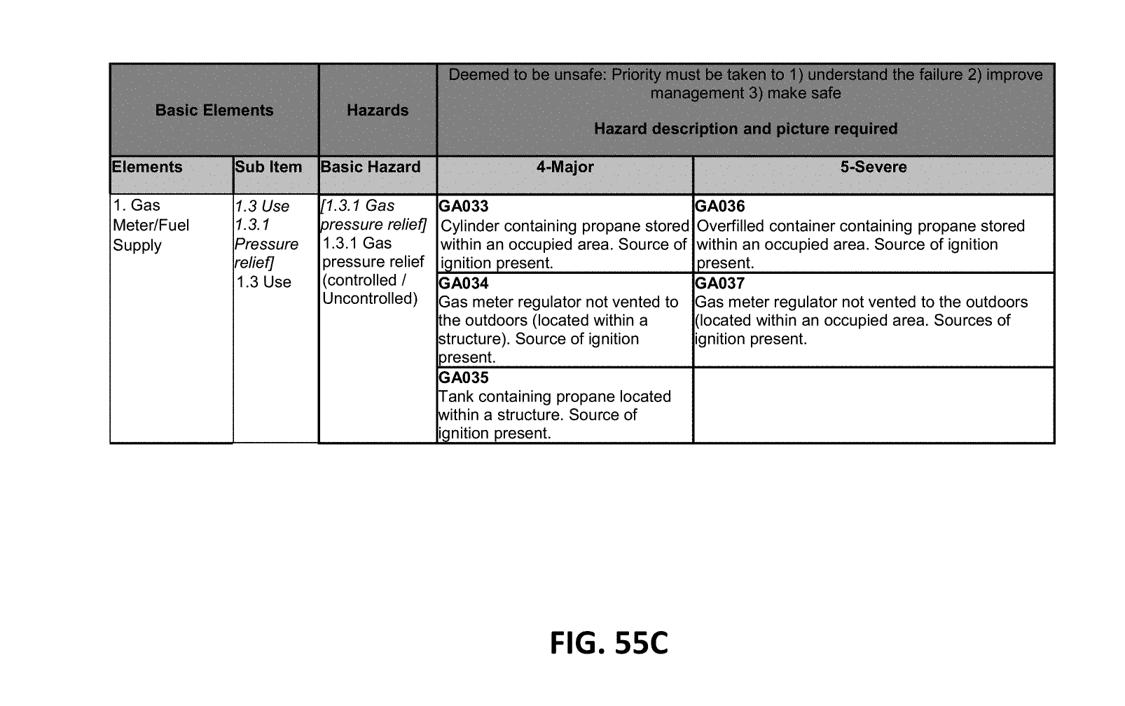

FIG. 55A shows the Hazard Map for Gas Meter/Fuel Supply—Use—Pressure relief for 1-2 (Business as usual/support for continuous improvement).

FIG. 55B shows the Hazard Map for Gas Meter/Fuel Supply—Use—Pressure relief for 3 (Cause for concern).

FIG. 55C shows the Hazard Map for Gas Meter/Fuel Supply—Use—Pressure relief for 4-5 (Deemed to be unsafe).

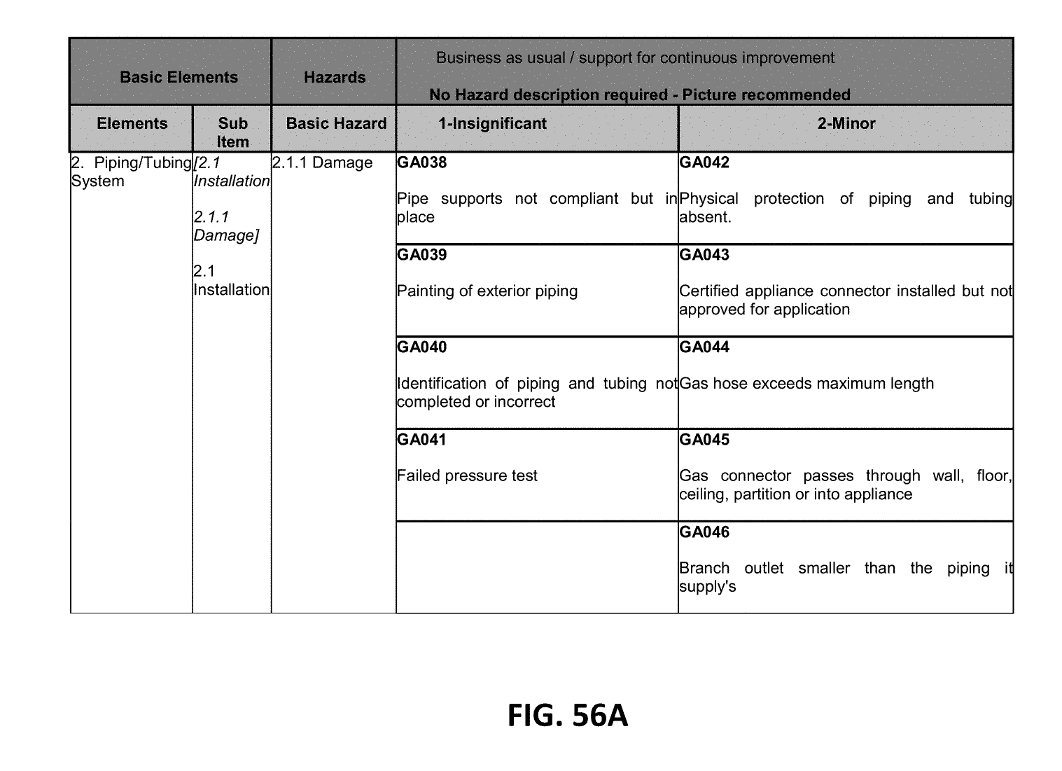

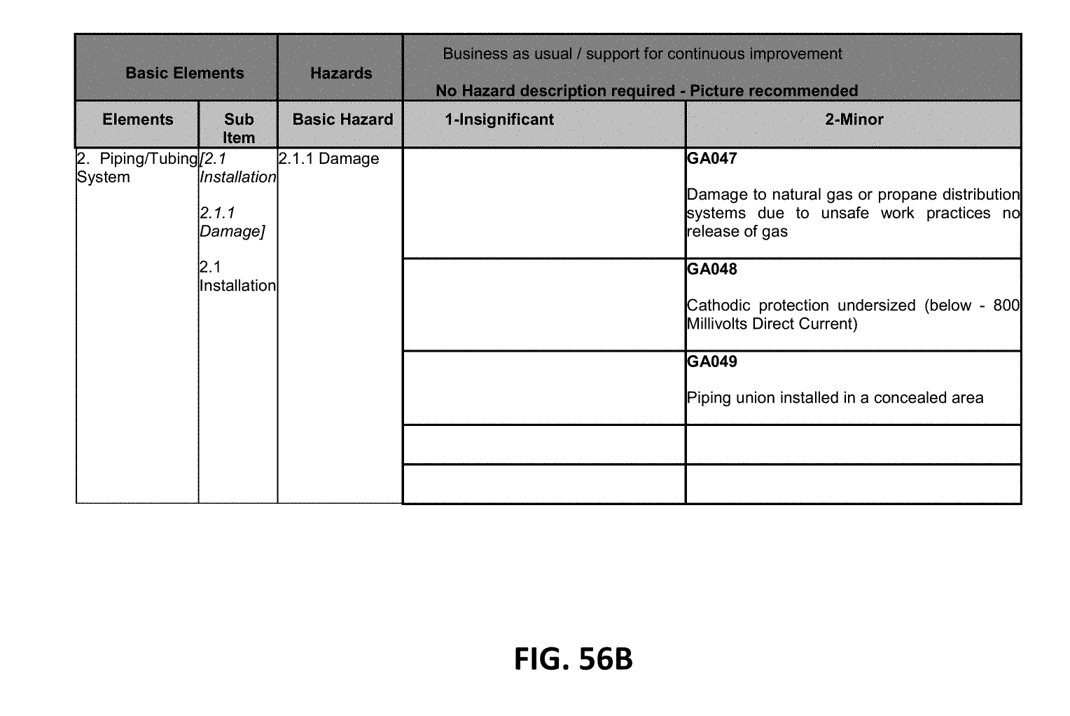

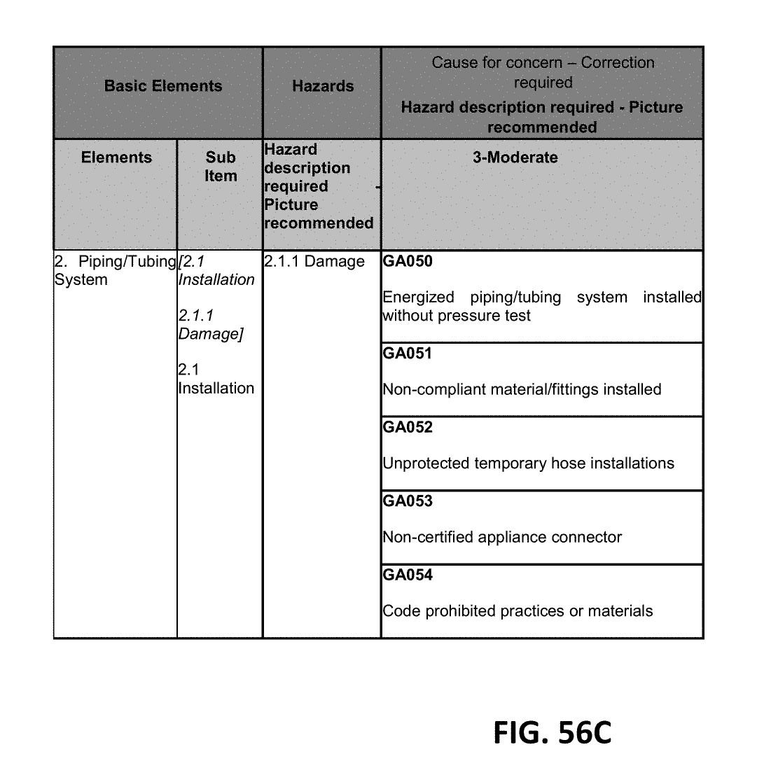

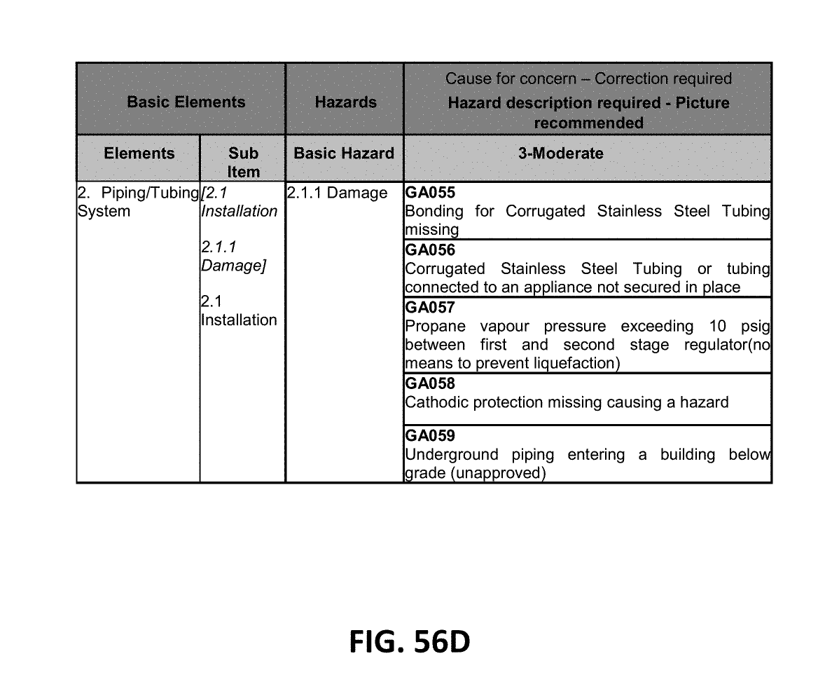

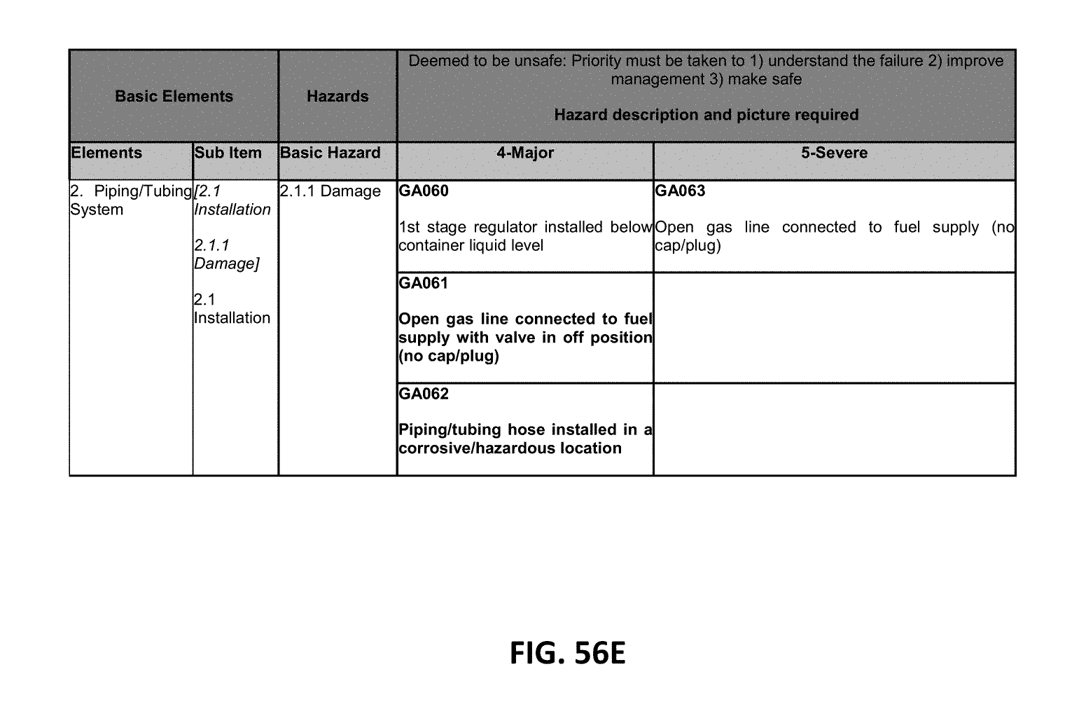

FIG. 56A shows Part 1 of the Hazard Map for Piping/Tubing System—Installation—Damage for 1-2 (Business as usual/support for continuous improvement).

FIG. 56B shows Part 2 of the Hazard Map for Piping/Tubing System—Installation—Damage for 1-2 (Business as usual/support for continuous improvement).

FIG. 56C shows Part 1 the Hazard Map for Piping/Tubing System—Installation—Damage for 3 (Cause for concern).

FIG. 56D shows Part 2 the Hazard Map for Piping/Tubing System—Installation—Damage for 3 (Cause for concern).

FIG. 56E shows the Hazard Map for Piping/Tubing System—Installation—Damage for 4-5 (Deemed to be unsafe).

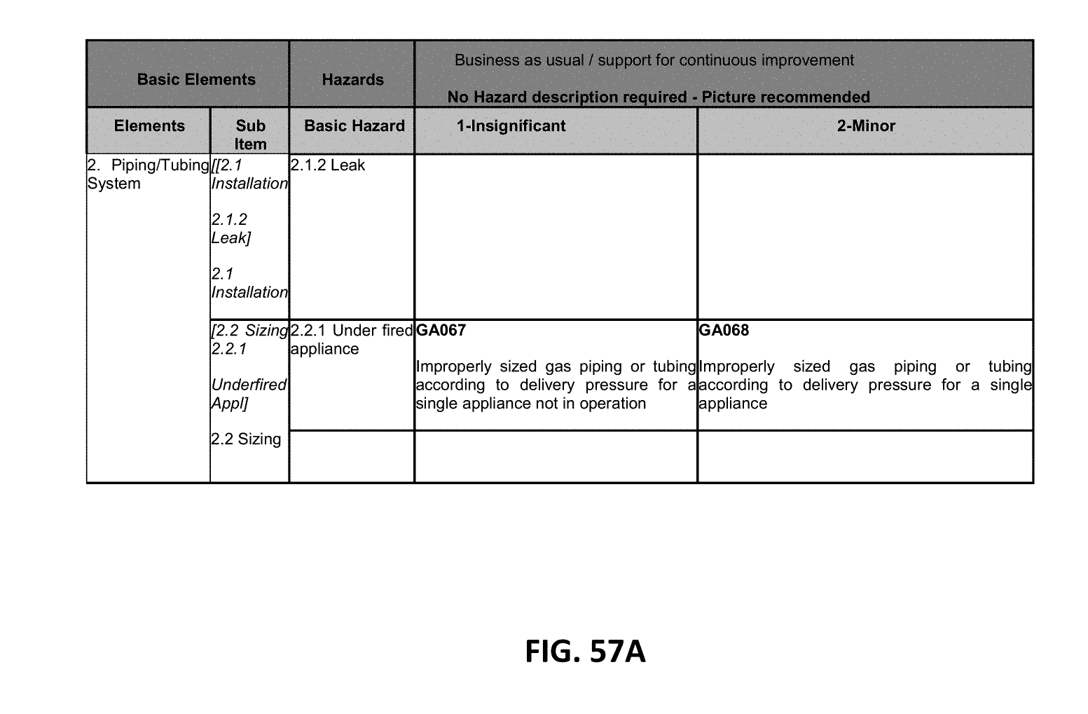

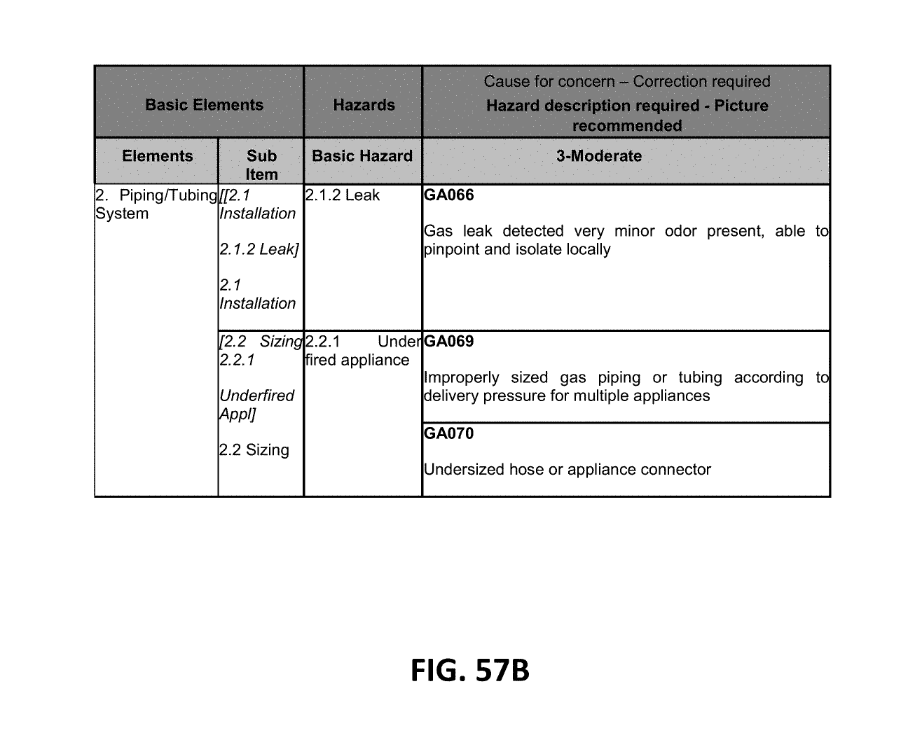

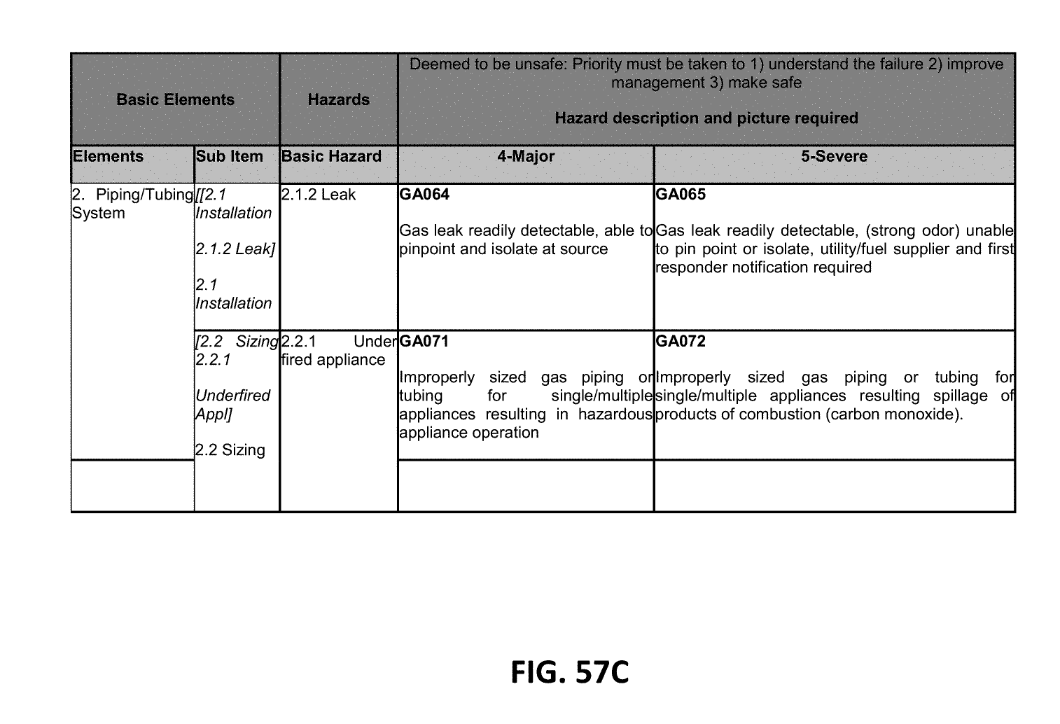

FIG. 57A shows the Hazard Map for Piping/Tubing System—Installation—Leak and Piping/Tubing System—Sizing for 1-2 (Business as usual/support for continuous improvement).

FIG. 57B shows the Hazard Map for Piping/Tubing System—Installation—Leak and Piping/Tubing System—Sizing for 3 (Cause for concern).

FIG. 57C shows the Hazard Map for Piping/Tubing System—Installation—Leak and Piping/Tubing System—Sizing for 4-5 (Deemed to be unsafe).

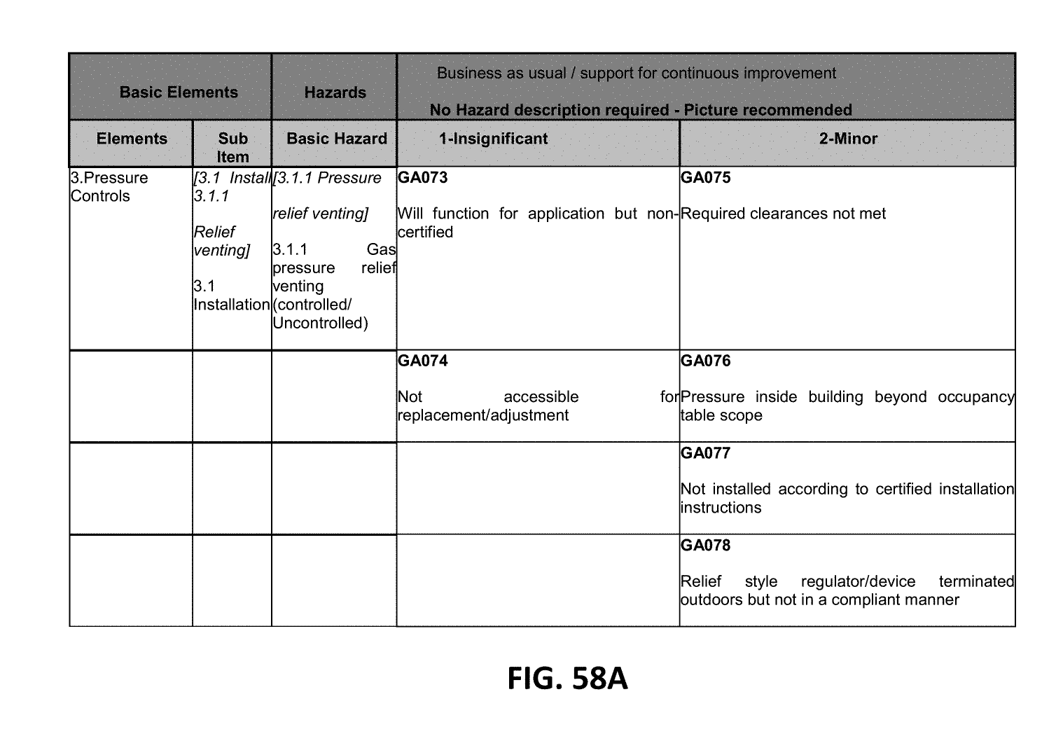

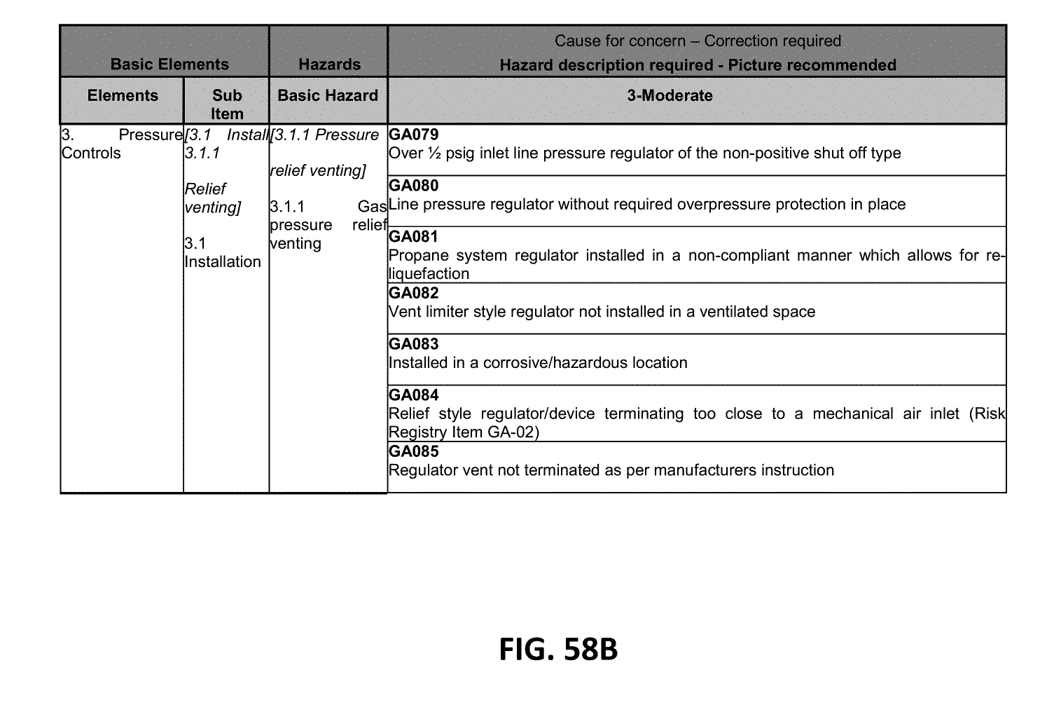

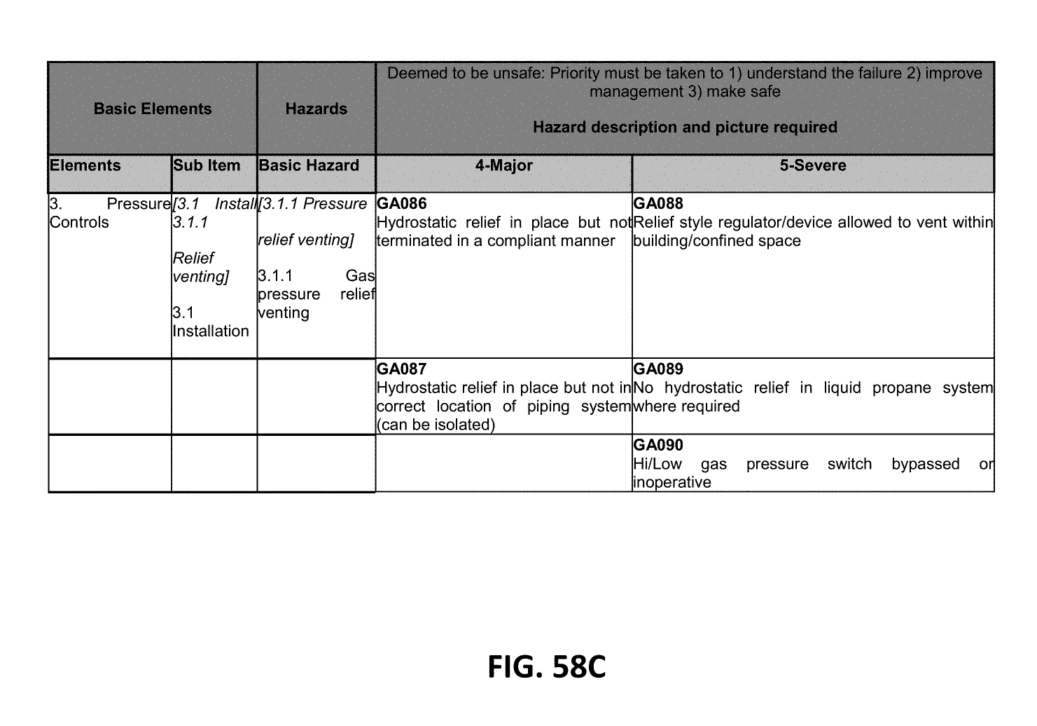

FIG. 58A shows the Hazard Map for Pressure Controls—Install—Relief Venting for 1-2 (Business as usual/support for continuous improvement).

FIG. 58B shows the Hazard Map for Pressure Controls—Install—Relief Venting for 3 (Cause for concern). and 4-5 (The safety system has failed).

FIG. 58C shows the Hazard Map for Pressure Controls—Install—Relief Venting for 4-5 (Deemed to be unsafe).

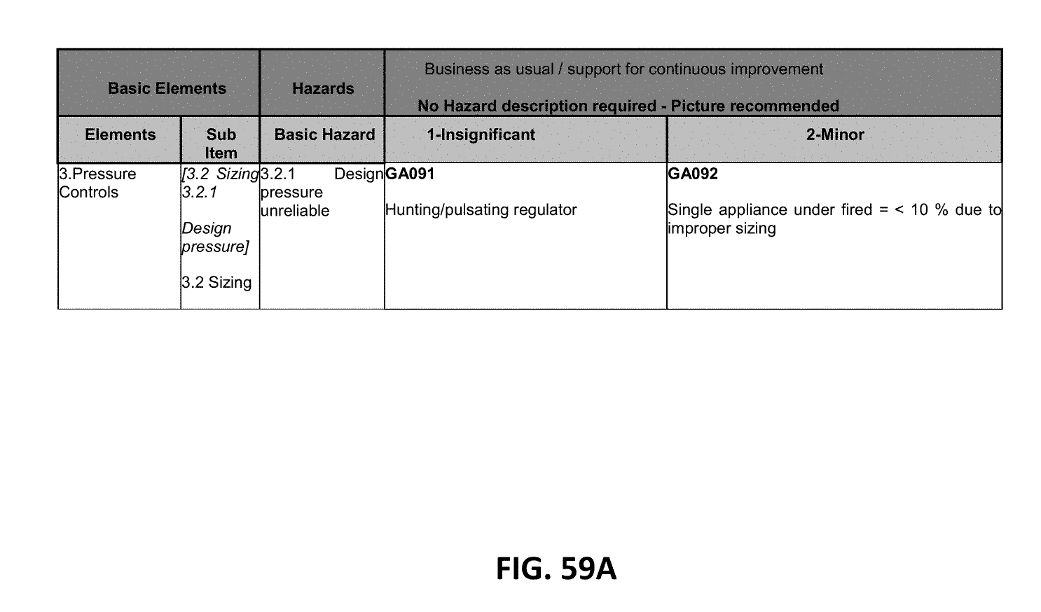

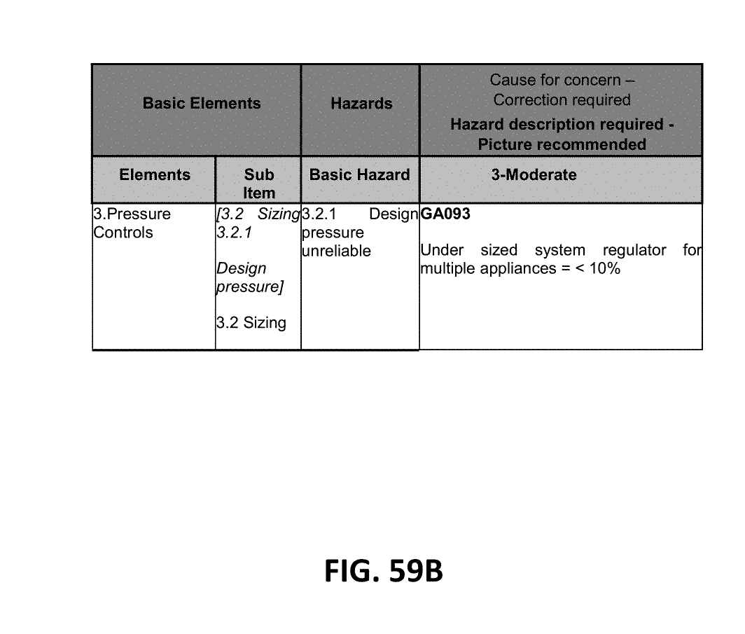

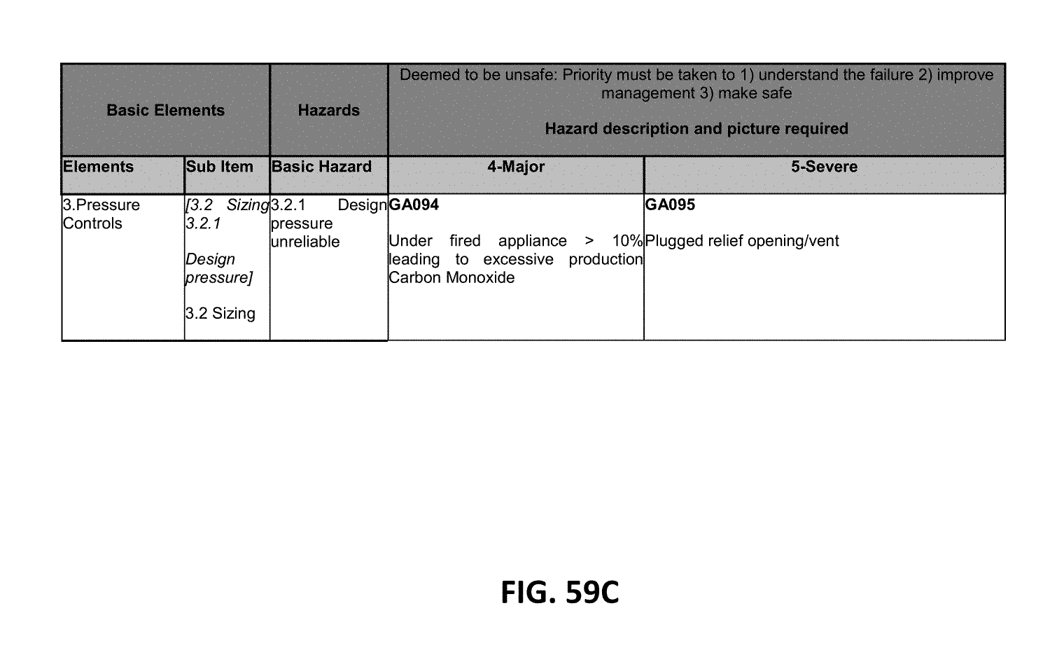

FIG. 59A shows the Hazard Map for Pressure Controls—Sizing—Design pressure for 1-2 (Business as usual/support for continuous improvement).

FIG. 59B shows the Hazard Map for Pressure Controls—Sizing—Design pressure for 3 (Cause for concern).

FIG. 59C shows the Hazard Map for Pressure Controls—Sizing—Design pressure for 4-5 (Deemed to be unsafe).

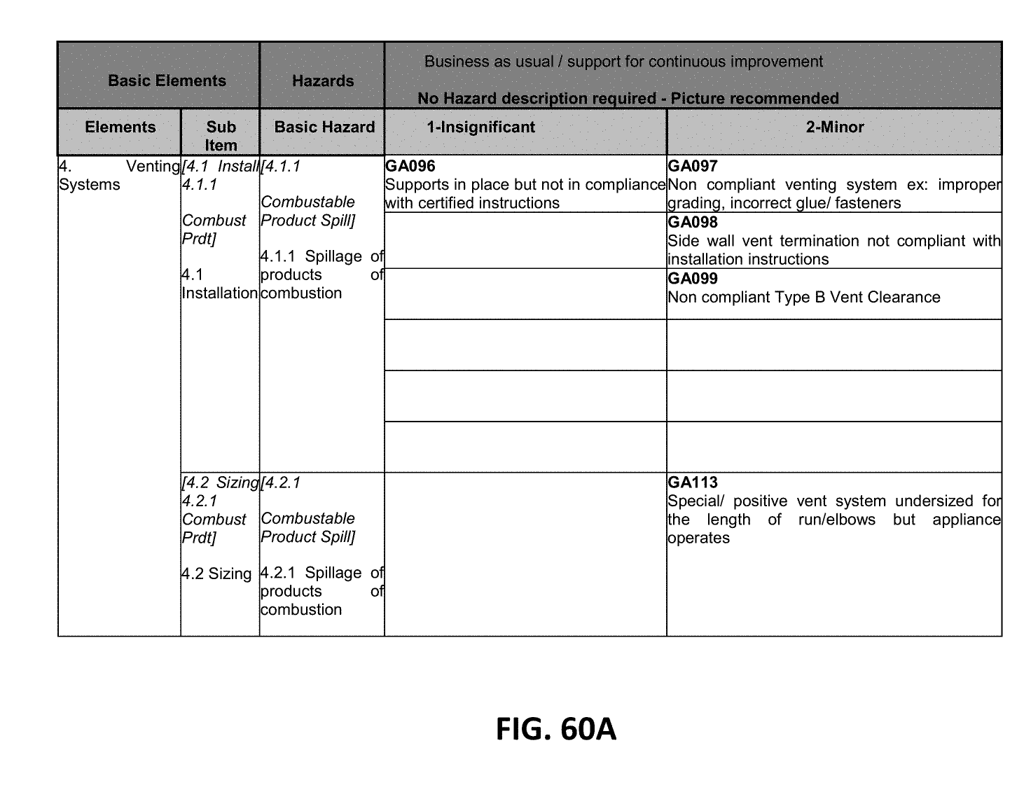

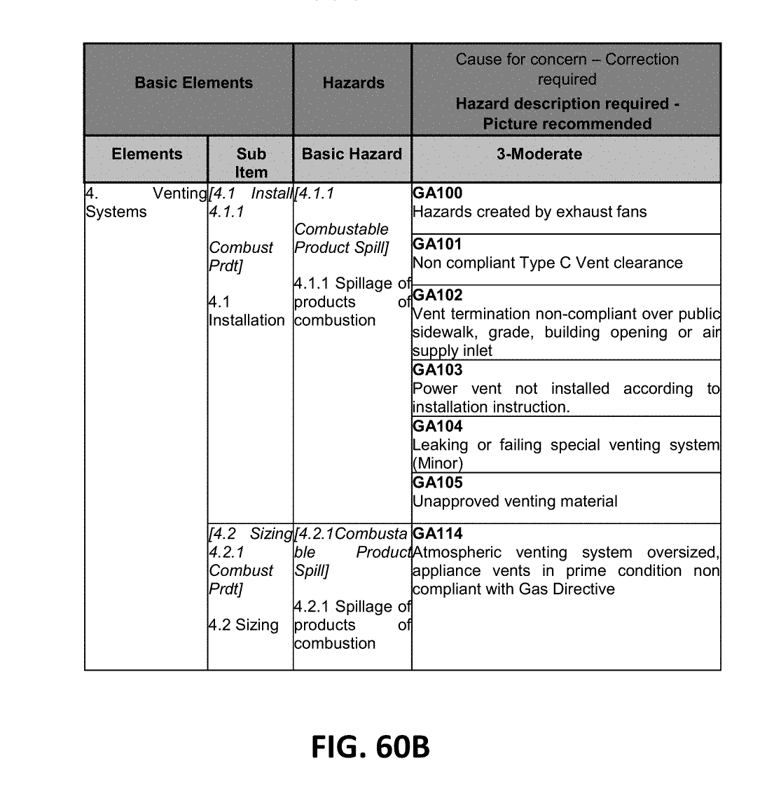

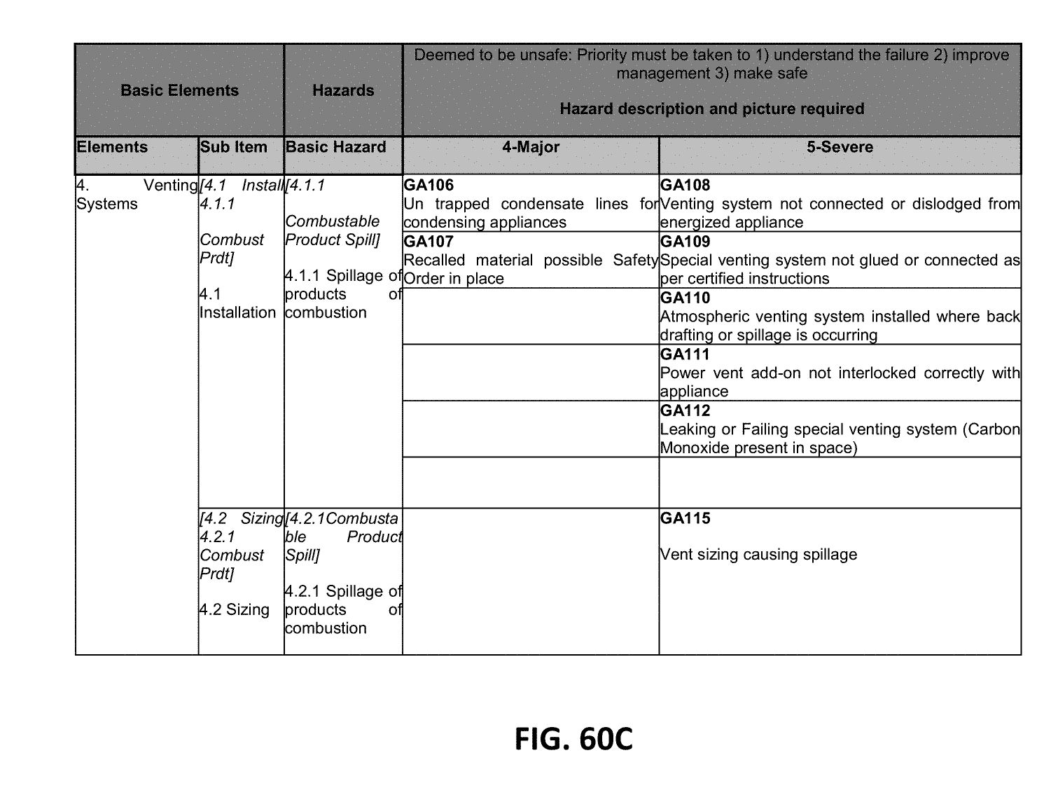

FIG. 60A shows the Hazard Map for Venting Systems—Install—Combust Prdt and Venting Systems—Sizing—Combust Prdt for 1-2 (Business as usual/support for continuous improvement).

FIG. 60B shows the Hazard Map for Venting Systems—Install—Combust Prdt and Venting Systems—Sizing—Combust Prdt for 3 (Cause for concern).

FIG. 60C shows the Hazard Map for Venting Systems—Install—Combust Prdt and Venting Systems—Sizing—Combust Prdt for 4-5 (Deemed to be unsafe).

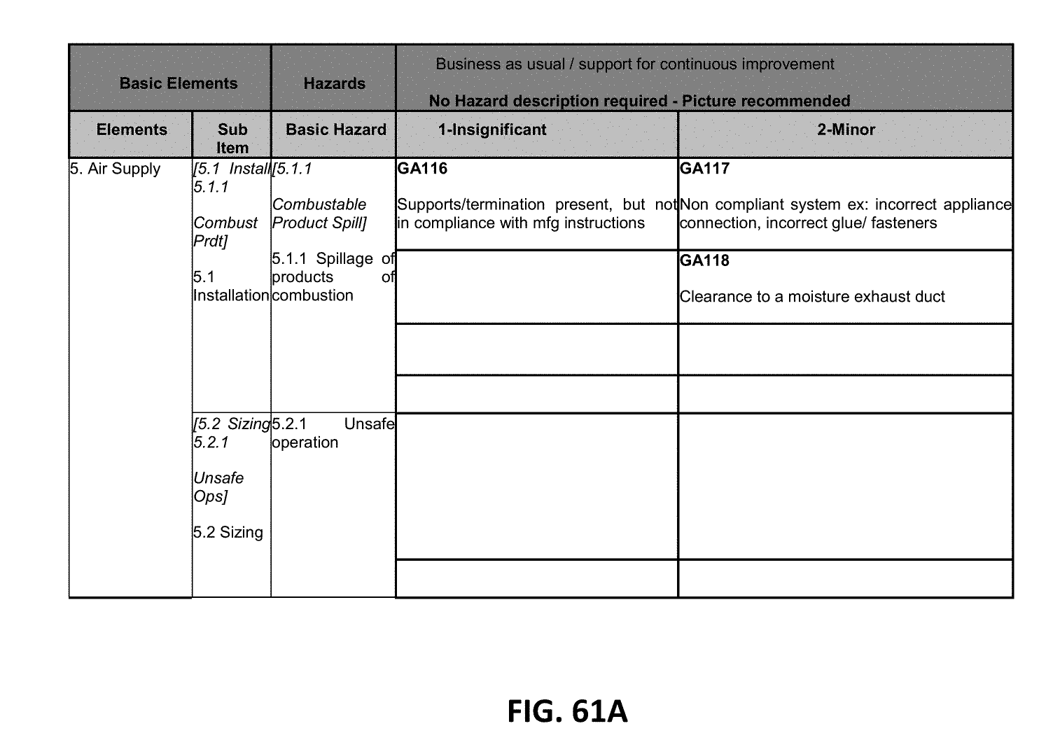

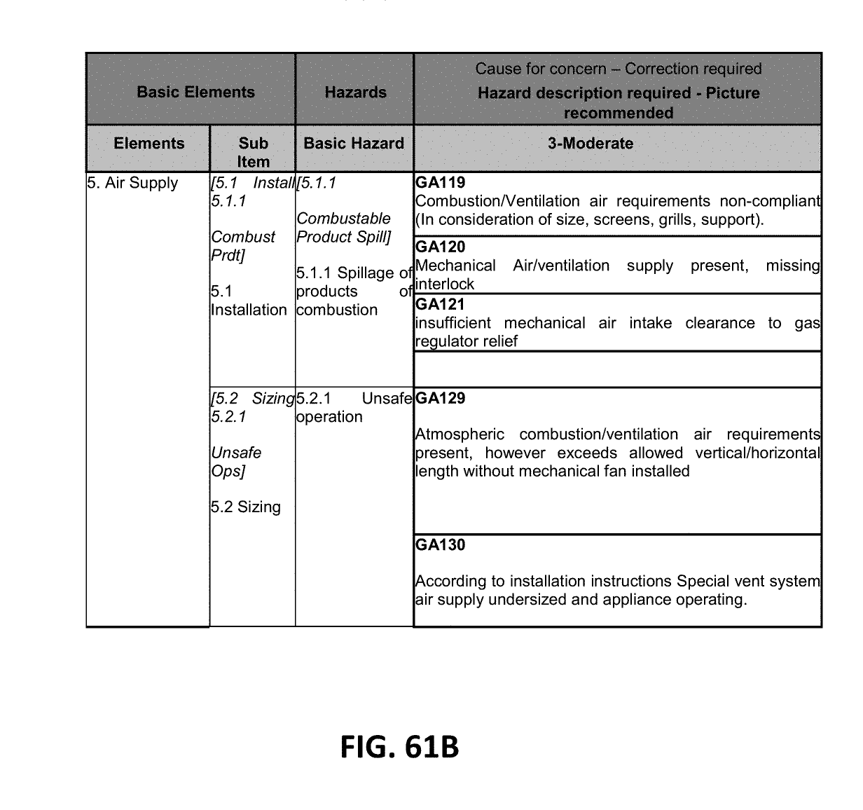

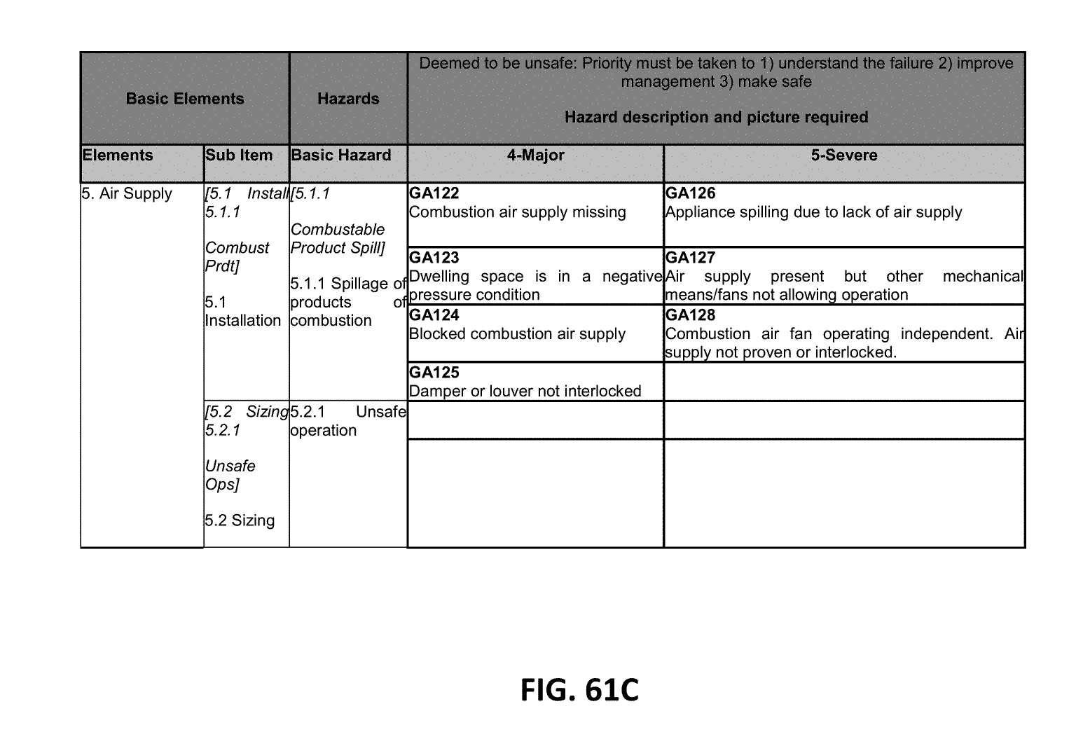

FIG. 61A shows the Hazard Map for Air Supply—Install—Combust Prd and Air Supply—Sizing—Unsafe Ops for 1-2 (Business as usual/support for continuous improvement).

FIG. 61B shows the Hazard Map for Air Supply—Install—Combust Prd and Air Supply—Sizing—Unsafe Ops for 3 (Cause for concern).

FIG. 61C shows the Hazard Map for Air Supply—Install—Combust Prd and Air Supply—Sizing—Unsafe Ops for 4-5 (Deemed to be unsafe).

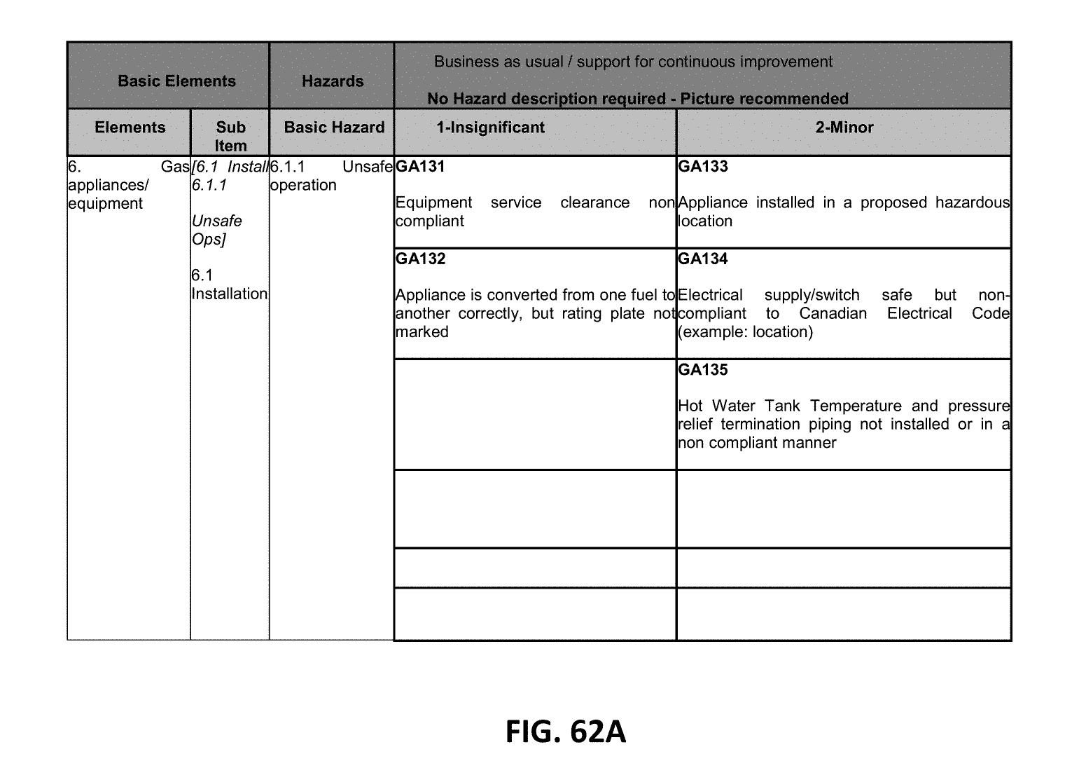

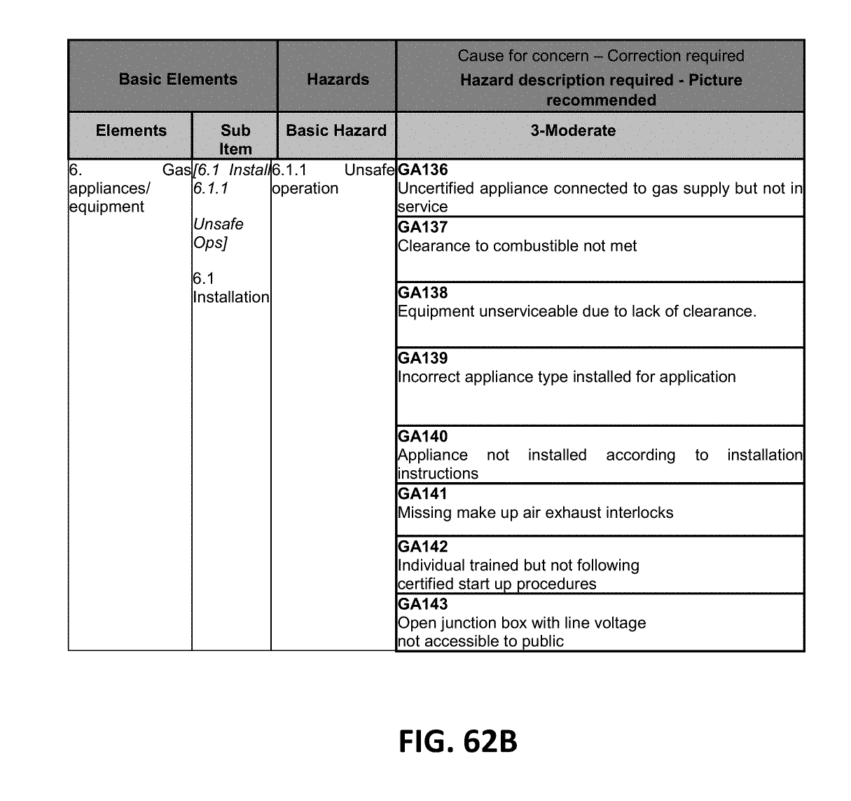

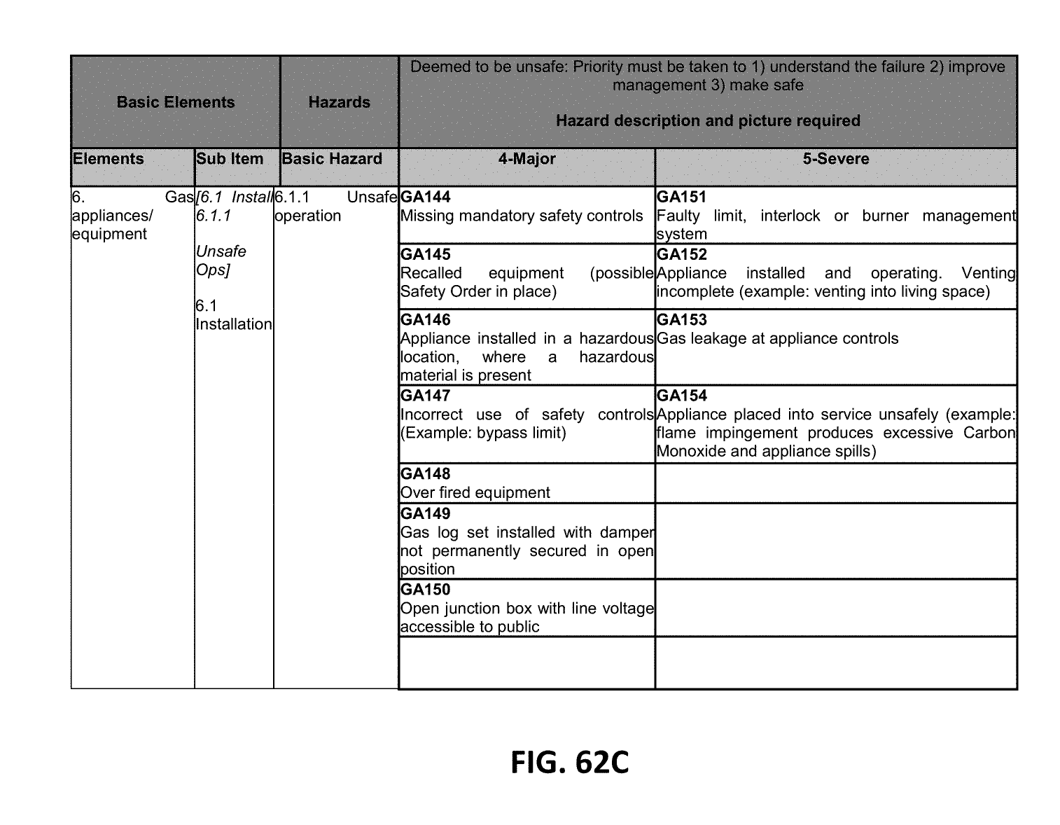

FIG. 62A shows the Hazard Map for Gas appliances/equipment—Install—Unsafe Ops for 1-2 (Business as usual/support for continuous improvement).

FIG. 62B shows the Hazard Map for Gas appliances/equipment—Install—Unsafe Ops for 3 (Cause for concern).

FIG. 62C shows the Hazard Map for Gas appliances/equipment—Install—Unsafe Ops for 4-5 (Deemed to be unsafe).

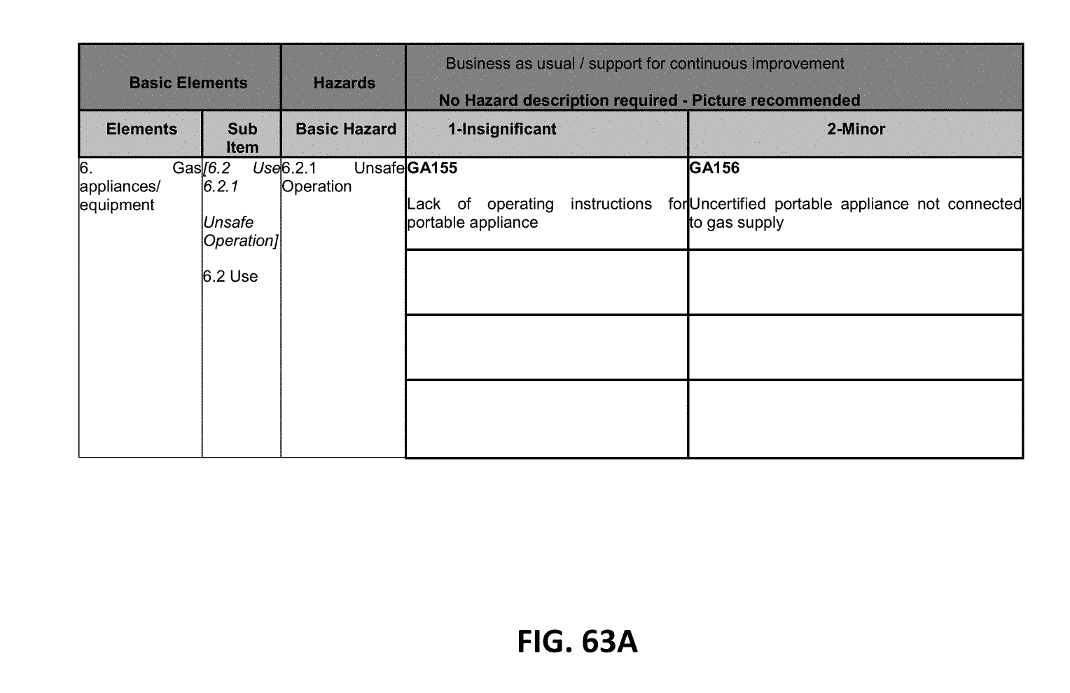

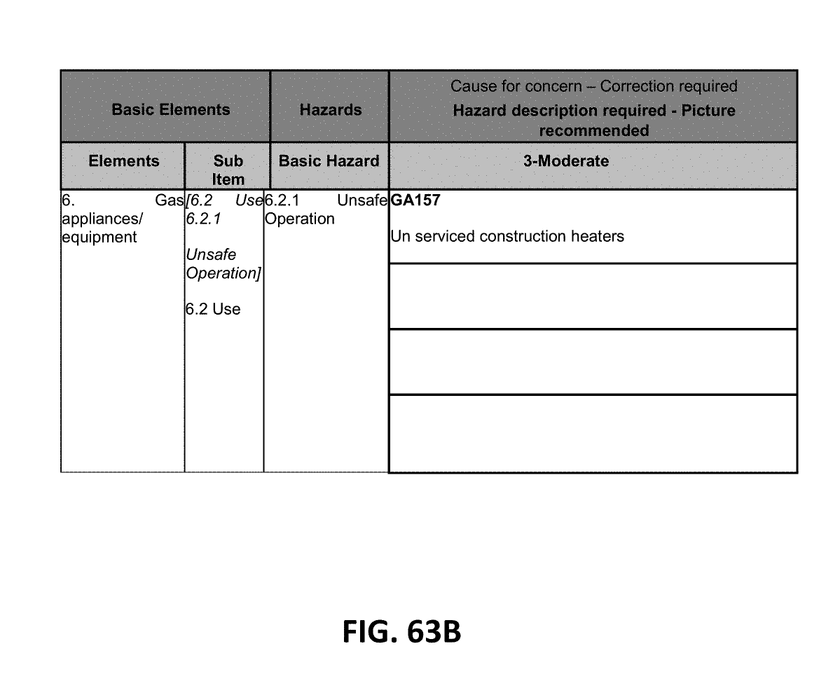

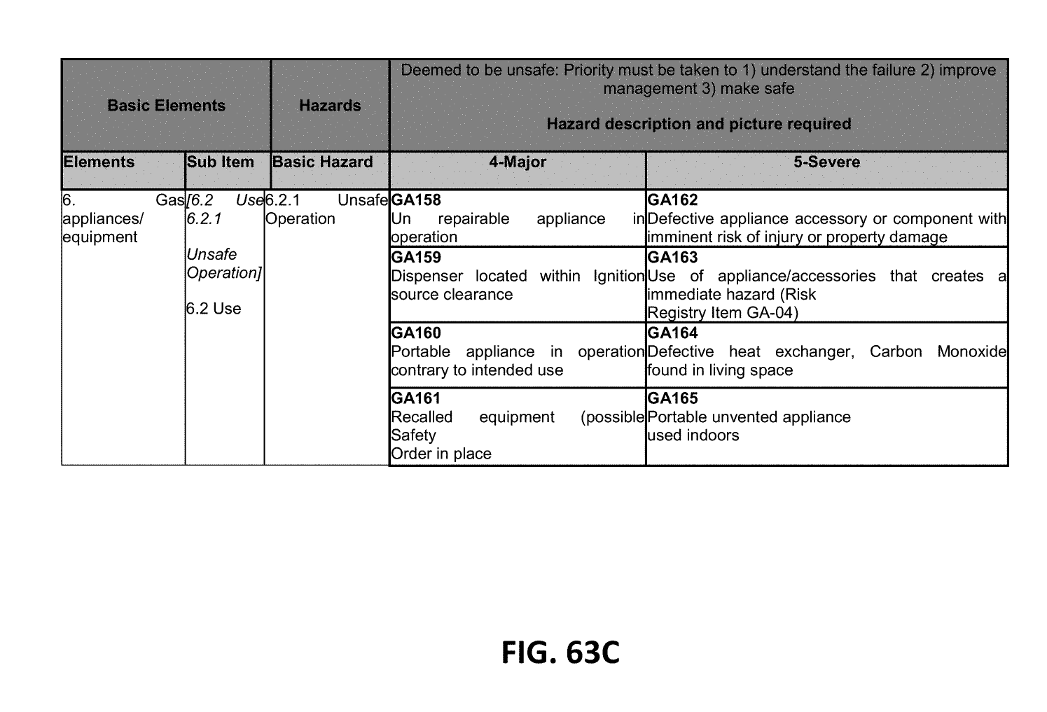

FIG. 63A shows the Hazard Map for Gas appliances/equipment—Use—Unsafe Operation for 1-2 (Business as usual/support for continuous improvement).

FIG. 63B shows the Hazard Map for Gas appliances/equipment—Use—Unsafe Operation for 3 (Cause for concern).

FIG. 63C shows the Hazard Map for Gas appliances/equipment—Use—Unsafe Operation for 4-5 (Deemed to be unsafe).

The scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufactures, compositions of matter, means, methods, or steps, presently existing or later to be developed, that perform substantially the same function or achieve substantially the same result as the corresponding embodiments described herein may be utilized.

What is claimed is:

1. A computer system for allocating inspection resources, the computer system comprising:
a processor; and
a non-transitory computer-readable memory device storing machine-readable instructions;
wherein the processor is configured to, when executing the machine-readable instructions, perform the steps of:
retrieving or receiving electronic signals representing one or more property values for a property;
receiving an electronic request to predict a hazard level;
processing the one or more property values to predict the requested hazard level; and
transmitting the predicted hazard level, in real-time or near real-time, to a display device.

2. The system of claim 1, wherein the one or more property values comprises at least one of: existing hazards, inspection history, permit, owner, contractor, safety officer profile, compliance history and enforcement history.

3. The system of claim 1, wherein the processor is configured to determine the hazard level using a machine learning model.

4. The system of claim 3, wherein the machine learning model is trained to find a hazard level above a pre-determined threshold.

5. The system of claim 3, wherein the machine learning model comprises a tree-based classifier.

6. The system of claim 1, further comprising a database configured to store profiles of one or more safety officers.

7. The system of claim 6, wherein at least one of the stored profiles of the one or more safety officers comprise an assigned zone.

8. The system of claim 6, wherein at least one of the stored profiles of the one or more safety officers comprise a workload value.

9. The system of claim 8, wherein the processor is configured to determine one or more tasks for at least one of the one or more safety officers based on the workload value in the profile of the at least one of the one or more safety officers.

10. The system of claim 9, wherein the processor is configured to determine one or more tasks for at least one of the one or more safety officers based on a geographical location of a property under inspection.

11. A computer-implemented system for allocating inspection resources, the method comprising:
retrieving or receiving, by a computer processor, electronic signals representing one or more property values for a property;
receiving, by the processor, an electronic request to predict a hazard level;
processing, by the processor, the one or more property values to predict the requested hazard level; and
transmitting, by the processor, the predicted hazard level, in real-time or near real-time, to a display device.

12. The method of claim 11, wherein the one or more property values comprises at least one of: existing hazards, inspection history, permit, owner, contractor, safety officer profile, compliance history and enforcement history.

13. The method of claim 11, further comprising prediction of the hazard level using a machine learning model.

14. The method of claim 13, wherein the machine learning model is trained to find a hazard level above a pre-determined threshold.

15. The method of claim 13, wherein the machine learning model comprises a tree-based classifier.

16. The method of claim 11, further comprising storing profiles of one or more safety officers.

17. The method of claim 16, wherein at least one of the stored profiles of the one or more safety officers comprise an assigned zone.

18. The method of claim 16, wherein at least one of the stored profiles of the one or more safety officers comprise a workload value.

19. The method of claim 18, further comprising determining one or more tasks for at least one of the one or more safety officers based on the workload value in the profile of the at least one of the one or more safety officers.

20. The method of claim 19, further comprising determining one or more tasks for at least one of the one or more safety officers based on a geographical location of a property under inspection.
